(19) United States
(12) Patent Application Publication
(10) Pub. No.: US 2004/0142287 A1
(43) Pub. Date: Jul. 22, 2004

(54) Photothermographic material and image forming method

(76) Inventors: Hajime Nakagawa, Kanagawa (JP); Yoshihisa Tsukada, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/751,433

(22) Filed: Jan. 6, 2004

(30) Foreign Application Priority Data
Jan. 10, 2003 (JP) 2003-4045
Jan. 10, 2003 (JP) 2003-4046

(51) Int. Cl. G03C 1/498; G03C 5/16

(52) U.S. Cl. 430/350; 430/264; 430/531; 430/568; 430/607; 430/619; 430/945

(57) ABSTRACT

A photothermographic material including, at least a photosensitive silver halide, a non-photosensitive organic silver salt, a reducing agent and a binder on at least one side of a support, wherein a content of silver iodide in the photosensitive silver halide is 5% by mole or more, the binder contains polymer latex in an amount of 60% by weight or more, and the reducing agent is a compound represented by the following general formula (R):

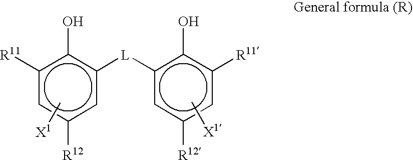

wherein R¹¹ and R^{11′} each independently represent an alkyl group having 1 to 20 carbon atoms, R¹² and R^{12′} each independently represent a hydrogen atom or a group capable of substituting on a benzene ring, L represents a —S— group or a —CHR¹³— group, R¹³ represents a hydrogen atom or an alkyl group having 1 to 20 carbon atoms, and X1 and X1¹ each independently represent a hydrogen atom or a group capable of substituting on a benzene ring.

### CROSS-REFERENCE TO RELATED APPLICATION

This application claims priority under 35 USC 119 from Japanese Patent Application Nos. 2003-4045 and 2003-4046, the disclosures of which are incorporated by reference herein.

### BACKGROUND OF THE INVENTION

1. Field of the Invention

The present invention relates to a photothermographic material and an image forming method using the photothermographic material, and particularly to a photothermographic material including a silver halide emulsion having a high silver iodide content and an image forming method using the same. The invention also relates to a photothermographic material and an image forming method which provide high sensitivity and low fogging, and result in images of excellent image stability after development.

2. Description of the Related Art

In the medical field and the graphic arts field, there has been, in recent years, a strong desire for a dry photographic process from the viewpoint of environmental conservation and space saving. In these fields, digitization has progressed and a system has been rapidly propagated in which image information is captured and stored in a computer. If necessary, the image information is processed by the computer, which can output the image information through communication to a desired location and at the location, further output the image information onto a photosensitive material using a laser image setter or a laser imager, followed by development thereof to form an image on the photosensitive material. The photosensitive material must be able to record an image under exposure to a laser with a high intensity and form a clear black image with a high resolution and sharpness. While various kinds of hard copy systems using pigment or dye such as an ink-jet printer or an electrophotography system have been distributed as general image forming systems using digital imaging recording material, images in the digital imaging recording material obtained by general image forming systems are insufficient in terms of image qualities needed for a diagnostic ability, which are required for a medical image, such as sharpness, granularity, gradation and tone, and in terms of a recording speed (sensitivity); thus the digital imaging recording material has not reached a level at which a medical silver salt film for conventional wet development can be replaced therewith.

A thermographic system using an organic silver salt is described in the literature. Generally, a photothermographic material, in particular, has an image forming layer including a photosensitive silver halide, a reducing agent, a reducible silver salt (for example, an organic silver salt) and if necessary, a toner, controlling a color tone of silver, dispersed in a binder matrix.

A photothermographic material forms a black silver image by being heated to a high temperature (for example, 80° C. or higher) after imagewise exposure to cause an oxidation-reduction reaction between a silver halide or a reducible silver salt (functioning as an oxidizing agent) and a reducing agent. The oxidation-reduction reaction is accelerated by a catalytic action of a latent image on the silver halide generated by exposure. As a result, a black silver image is formed on an exposed region. Fuji medical dry imager FM-DP is a example of a comercial medical image forming system.

Since a thermographic system using an organic silver salt has no fixing step, there has been considerable difficultym in image stability after development, particularly with respect to degradation of a print-out when exposed to light. As means for improving the fogging and the print-out, a method in which silver iodide formed through conversion of an organic silver salt is employed is disclosed in U.S. Pat. No. 6,143,488, EP No. 0922995 and the like. In the method, such as described here, in which an organic silver salt is converted with iodine, however, a sufficient sensitivity cannot be obtained, which has led to difficulty in incorporation into an actual system. As to other photosensitive materials using silver iodide, disclosures thereof are given in WO Nos. 97-48014 and 97-48015; U.S. Pat. No. 6,165,705; Japanese Patent Application Laid-Open (JP-A) No. 8-297345; Japanese Patent No. 2785129, in any of which neither a sufficient sensitivity nor a sufficient fog level is achieved, leading to a poor laser exposure photosensitive material which is not suitable for ptactical use.

As means of increasing the sensitivity of a silver iodide photographic emulsion, academic literature discloses addition of a halogen receptor such as sodium nitrite, pyrogallol, hydroquinone or the like, immersion in an aqueous silver nitrate solution, sulfur sensitization at a pAg of 7.5, and the like. For example, these are described in Journal of Photographic Science, vol.8, p.119 (1960), vol.28, p.163 (1980), Photographic Science and Engineering, vol.5, p.216 (1961), and the like. However, the sensitization effect of these halogen acceptors is very small and extremely insufficient for use in photothermographic materials.

In production of a photothermographic material using an organic silver salt, two methods are available. In one method, a solvent coating is adopted, and in the other method, a coating liquid containing polymer fine particles aqueous dispersion as a main binder is applied and dried. These methods are described in JP-A No.2002-229149, JPO No.11-509332, and the like. In the latter method, since no need for a process of solvent recovery or the like, a production facility is simple and the method is advantageous for mass production.

However, the use of a polymer fine particles as a binder in a photothermographic material including a silver halide with a high content of a silver iodide has been revealed to much lower sensitivity and lower image density. Thus there is a need in the art for improved photothermographic materials using silver halide having a high silver iodide content.

### SUMMARY OF THE INVENTION

It is an object of the present invention to provide a photothermographic material including a silver halide emulsion having a high silver iodide content, which results high sensitivity, low fogging, and excellent image stability, and an image forming method using the photothermographic material.

The aforementioned object of the present invention can be achieved by the following means.

A first aspect of the invention is to provide a photothermographic material comprising, at least a photosensitive silver halide, a non-photosensitive organic silver salt, a reducing agent and a binder on at least one side of a support, wherein a content of silver iodide in the photosensitive silver halide is 5% by mole or more, the binder contains polymer latex in an amount of 60% by weight or more, and the reducing agent is a compound represented by the following general formula (R):

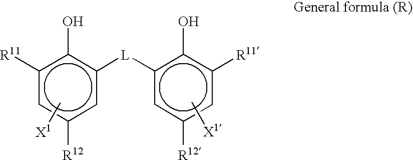

wherein R¹¹ and R^{11′} each independently represent an alkyl group having 1 to 20 carbon atoms, R and R^{12′} each independently represent a hydrogen atom or a group capable of substituting for a hydrogen atom on a benzene ring, L represents a —S— group or a —CHR¹³— group, R¹³ represents a hydrogen atom or an alkyl group having 1 to 20 carbon atoms, and X1 and X1¹ each independently represent a hydrogen atom or a group capable of substituting for a hydrogen atom on a benzene ring.

Second aspect of the invention is to provide an image forming method using the photothermographic material according to the first aspect of the invention, wherein scanning exposure is performed by means of a laser beam.

The present invention provides a photothermographic material having high sensitivity and excellent anti-print-out property, and an image forming method using the same.

### DETAILED DESCRIPTION OF THE INVENTION

The photothermographic materials of the present invention have preferred embodiments 2 to 21, and image forming methods therof in the present invention have preferred embodiments 23 to 25, as described below.

2. The photothermographic material according to embodiment 1, wherein the polymer latex is a polymer having a glass transition temperature of −20° C. to 60° C.

3. A photothermographic material according to embodiment 1, wherein the polymer latex contains a styrene-butadiene copolymer.

4. A photothermographic material according to embodiment 1, wherein the binder contains a polymer latex is copolymerized using 10% by weight to 70% by weight of the monomer represented as the binder by the following general formula (M):

CH₂═CR⁰¹—CR⁰²═CH₂ General formula (M)

wherein R⁰¹ and R⁰² are each independently a hydrogen atom, an alkyl group having 1 to 6 carbon atoms, a halogen atom or a cyano group, with proviso R⁰¹ and R⁰² are not hydrogen atoms at the same time.

5. A photothermographic material according to embodiment 4, wherein, in general formula (M), R⁰¹ is a hydrogen atom and R is a methyl group.

6. A photothermographic material according to embodiment 4, wherein the polymer latex is copolymerized polymer latex using 1% by weight to 20% by weight of a monomer having an acid group.

7. A photothermographic material according to embodiment 4, wherein the glass transition temperature of the polymer latex is −30° C. to 70° C.

8. A photothermographic material according to embodiment 4, wherein the glass transition temperature of the polymer latex is −10° C. to 35° C.

9. A photothermographic material according to embodiment 4, wherein the polymer latex contains 500 ppm or less of a halogen ion in the latex solution.

10. A photothermographic material according to embodiment 4, wherein the polymer latex is a styrene-isoprene copolymer latex.

11. A photothermographic material according to embodiment 1, wherein R¹¹ and R^{11′} are each independently a secondary or a tertiary alkyl group having 3 to 15 carbon atoms, in the reducing agent represented by general formula (R).

12. A photothermographic material according to embodiment 1, further comprising a development accelerator.

13. A photothermographic material according to embodiment 12, wherein the development accelerator contains a compound represented by the following general formula (A-1):

Q₁-NHNH-Q₂ General formula (A-1)

wherein Q₁ is an aromatic group bonding to —NHNH-Q₂ via a carbon atom, or is a heterocyclic group, and Q₂ is a carbamoyl group, an acyl group, an alkoxycarbonyl group, an aryloxycarbonyl group, a sulfonyl group, or a sulfamoyl group.

14. A photothermographic material according to embodiment 12, wherein the development accelerator has a compound represented by the following general formula (A-2):

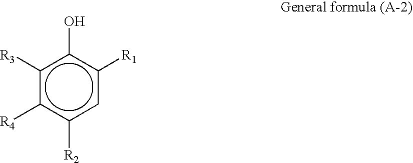

wherein R₁ represents an alkyl group, an acyl group, an acylamino group, a sulfonamide group, an alkoxycarbonyl group, or a carbamoyl group, R₂ represents a hydrogen atom, a halogen atom, an alkyl group, an alkoxy group, an aryloxy group, an alkylthio group, an arylthio group, an acyloxy group, or a carbonic ester group, and R₃ and R₄ each independently represent a group which can be substituted for a hydrogen atom on the benzene ring.

15. A photothermographic material according to embodiment 1, further comprising an organic polyhalogen compound as an antifoggant.

16. A photothermographic material according to embodiment 15, wherein the organic polyhalogen compound is represented by the following general formula (H):

Q-(Y)n-C(Z₁)(Z₂)X General formula (H)

wherein Q is an alkyl group, an aryl group, or a heterocyclic group, Y is a divalent linking group, n is 0 or 1, Z₁ and Z₂ are a halogen atom, and X is a hydrogen atom or an electron attractive group.

17. A photothermographic material according to embodiment 1, wherein the content of the silver iodide is 40% by mole or more.

18. A photothermographic material according to embodiment 1, wherein the average particle size of the photosensitive silver halide is 5 nm to 80 nm.

19. A photothermographic material according to embodiment 1, wherein the average particle size of the photosensitive silver halide is 5 nm to 40 nm.

20. A photothermographic material according to embodiment 1, wherein the photosensitive silver halide is formed in the absence of the non-photosensitive organic-silver salt.

21. A photothermographic material according to embodiment 1, further containing a compound that can be one-electron-oxidized to provide a one-electron oxidation product which releases one or more electrons.

23. An image forming method according to embodiment 22, wherein the laser is a laser diode.

24. A image forming method according to embodiment 23, wherein the laser diode has a peak strength in the wavelength between 350 and 440 nm and has an intensity of 1 mW/mm² to 50 W/mm².

25. A image forming method according to embodiment 23, wherein the laser diode has a peak strength in the wavelength between 380 and 410 nm.

The present invention will be described in detail below.

The photothermographic material of the invention has an image forming layer having a photosensitive silver, a non-photosensitive organic silver salt, a reducing agent for a silver ion, and a binder, on at least one surface of a support. Further, the image forming layer may carry thereon a surface protective layer, or may carry a back layer, a back protective layer and the like on the opposite surface.

The constitutions and preferable components of these layers will be illustrated in detail below.

1. Image Forming Layer

1-1. Photosensitive Silver Halide

1) Halogen Composition

It is important that the photosensitive silver halide in the present invention has a silver iodide content of at least 5 mol % or more. Other components are not particularly limited and can be selected from silver chloride and silver bromide and organic silver salts such as silver thiocyanate, silver phosphate and the like, and particularly, silver bromide and silver chloride are preferable. By using such a silver halide having a high silver iodide content, a preferable photothermographic material having excellent image stability after development treatment, particularly showing remarkably small increase in fogging in irradiation with light can be designed.

Further, it is preferable from the standpoint of image stability against irradiation with light after treatment particularly that the silver iodide content is 40 mol % or more, more preferably 80 mol % or more, and particularly preferably 90 mol % or more.

The distribution of the halogen composition in a grain may be uniform or the halogen composition may be changed stepwise, or it may be changed continuously. Further, a silver halide grain having a core/shell structure can be preferably used. Preferred structure is a twofold to fivefold structure and, more preferably, core/shell grain having a twofold to fourfold structure can be used. A core-high-silver iodide-structure which has a high content of silver iodide in the core part, and a shell-high-silver iodide-structure which has a high content of silver iodide in the shell part can also be preferably used. Further, a technique of localizing silver bromide or silver iodide on the surface of a grain as form epitaxial parts can also be preferably used.

2) Grain Size

The grain size of silver halide of the high silver iodide used in the invention is particularly important. When the size of a silver halide is relatively large, the application amount of a silver halide necessary for attaining required maximum image density. The present inventors have found that the silver halide having high silver iodide content of the invention has a specific action in that the greater the application amount, the larger the development is suppressed and sensitivity is lowered, and it may become unstable against the developing time to obtain uniform image density. It has been found, therefore, that at a certain grain size or more, maximum concentration is not obtained in a given development time, and on the other hand, when the application amount thereof is suppressed to a certain level or less, a sufficient image density is obtained in spite of silver iodide.

Thus, when the high silver iodide is used, it is necessary that the size of a silver halide grain is sufficiently smaller as compared with conventional silver bromide and silver iodide bromide having low iodine content for attaining sufficient maximum optical density. The average grain size of silver halide of high iodide content is preferably 5 nm to 80 nm, more preferably 5 nm to 55 nm. It is particularly preferably 10 nm to 45 nm. The grain size referred to here is observed by an electron microscope, and means the average diameter of a converted circle having the same area as the projected area.

3) Application Amount

The application amount of silver halide grains is 0.5 mol % to 15 mol %, preferably 0.5 mol % to 12 mol %, further preferably 0.5 mol % to 10 mol % per one mol of silver of a non-photosensitive organic silver salt described later. It is more preferably 1 mol % to 9 mol %, particularly preferably 1 mol % to 7 mol %. For preventing remarkable development suppression by the silver halide having high iodide content found by the present inventors, selection of this application amount is extremely important.

4) Grain Formation Method

The method of forming a photosensitive silver halide is well known in the art, and for example, methods described in Research Disclosure No. 170929, June 1978 and U.S. Pat. No. 3,700,458 can be used, and specifically, a method is used in which a photosensitive silver halide is prepared by mixing a silver supplying compound and a halogen supplying compound into a solution of gelatin or other polymers, and then, mixing with an organic silver salt. Further, a method described in JP-A No. 11-119374, paragraph Nos. 0217 to 0224 and a method described in JP-A No. 11-352627 are also preferable.

5) Grain Form

While examples of forms of silver halide grains in the invention are cube grains, octahedron grains, dodecahedron grains, tetrahedron grains, flat plate grains, sphere grains, rod grains, potato grains and the like, particularly preferable in the invention are dodecahedron grains and tetrahedron grains. The term “dodecahedron grain” means a grain having planes of (001), {1(−1)0} and {101} and the term “tetrahedron grain” means a grain having planes of (001), {101} and {100}. The {100} expresses a family of crystallographic planes equivalent to a (100) plane.

Silver iodide of the invention can assume any of a β phase or a γ phase. The term “β phase” described above means a high silver iodide structure having a wurtzite structure of a hexagonal system and the term “γ phase” means a high silver iodide structure having a zinc blend structure of a cubic crystal system.

An average content of γ phase in the present invention is determined by a method presented by C. R. Berry. In the method, an average content of γ phase is calculated from the peak ratio of the intensity owing to γ phase (111) to that owing to P phase (100), (101), 002) in powder X ray diffraction method. Detail description, for example, is described in Physical Review, Volume 161(No.3), p.848 to 851 (1967).

The silver halide having high silver iodide content of the invention can take a complicated form, and as the preferable form, there are listed, for example, connecting particles as shown in R. L. JENKINS et al., J. of Phot. Sci. Vol. 28 (1980), p164, Fig. 1. Flat plate particles as shown in Fig. 1 of the same literature can also be preferably used. Particles obtained by rounding corners of silver halide particles can also be preferably used. The surface index (Miller index) of the outer surface of a photosensitive silver halide particle is not particularly restricted, and it is preferable that the ratio occupied by the [100] surface is plentiful, because of showing high spectral sensitization efficiency when a spectral sensitizing dye is adsorbed. The ratio is preferably 50% or more, more preferably 65% or more, further preferably 80% or more. The ratio of the [100) surface, Mirror index, can be determined by a method described in T. Tani; J. Imaging Sci., 29, 165 (1985) utilizing adsorption dependency of the [111] surface and [100] surface in adsorption of a sensitizing dye.

6) Heavy Metal

The photosensitive silver halide grain of the invention can contain metals or complexes of metals belonging to groups 8 to 10 of the periodical table (showing groups 1 to 18). The metal or the center metal of the metal complex from groups 8 to 10 of the periodical table is preferably rhodium, ruthenium or iridium. The metal complex may be used alone, or two or more kinds of complexes comprising identical or different species of metals may be used together. A preferred content is within a range from 1×10⁻⁹ mol to 1×10⁻³ mol per one mol of silver. The heavy metals, metal complexes and the addition method thereof are described in JP-A No. 7-225449, in paragraph Nos. 0018 to 0024 of JP-A No.11-65021 and in paragraph Nos. 0227 to 0240 of JP-A No. 11-119374.

In the present invention, a silver halide grain having a hexacyano metal complex is present on the outermost surface of the grain is preferred. The hexacyano metal complex includes, for example, [Fe(CN)₆]⁴⁻, [Fe(CN)₆]³⁻, (Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complex is preferred.

Since the hexacyano complex exists in ionic form in an aqueous solution, paired cation is not important and alkali metal ion such as sodium ion, potassium ion, rubidium ion, cesium ion and lithium ion, ammonium ion, alkyl ammonium ion (for example, tetramethyl ammonium ion, tetraethyl ammonium ion, tetrapropyl ammonium ion, and tetra(n-butyl)ammonium ion), which are easily miscible with water and suitable to precipitation operation of a silver halide emulsion are preferably used.

The hexacyano metal complex can be added while being mixed with water, as well as a mixed solvent of water and an appropriate organic solvent miscible with water (for example, alcohols, ethers, glycols, ketones, esters and amides) or gelatin.

The addition amount of the hexacyano metal complex is preferably from 1×10⁻⁵ mol to 1×10⁻² mol and, more preferably, from 1×10⁻⁴ mol to 1×10⁻³ per one mol of silver in each case.

In order to allow the hexacyano metal complex to be present on the outermost surface of a silver halide grain, the hexacyano metal complex is directly added in any stage of: after completion of addition of an aqueous solution of silver nitrate used for grain formation, before completion of emulsion forming step prior to a chemical sensitization step, of conducting chalcogen sensitization such as sulfur sensitization, selenium sensitization and tellurium sensitization or noble metal sensitization such as gold sensitization, during washing step, during dispersion step and before chemical sensitization step. In order not to grow the fine silver halide grain, the hexacyano metal complex is rapidly added preferably after the grain is formed, and it is preferably added before completion of the emulsion forming step.

Addition of the hexacyano complex may be started after addition of 96% by weight of an entire amount of silver nitrate to be added for grain formation, more preferably started after addition of 98% by weight and, particularly preferably, started after addition of 99% by weight.

When any of the hexacyano metal complex is added after addition of an aqueous silver nitrate just before completion of grain formation, it can be adsorbed to the outermost surface of the silver halide grain and most of them form an insoluble salt with silver ions on the surface of the grain. Since the hexacyano iron (II) silver salt is a less soluble salt than AgI, re-dissolution with fine grains can be prevented and fine silver halide grains with smaller grain size can be prepared.

Metal atoms that can be contained in the silver halide grain used in the invention (for example, [Fe(CN)₆]⁴⁻), desalting method of a silver halide emulsion and chemical sensitization method are described in paragraph Nos. 0046 to 0050 of JP-A No.11-84574, in paragraph Nos. 0025 to 0031 of JP-A No.11-65021, and paragraph Nos. 0242 to 0250 of JP-A No.11-119374.

7) Gelatin

As the gelatin contained the photosensitive silver halide emulsion used in the invention, various kinds of gelatins can be used. It is necessary to maintain an excellent dispersion state of a photosensitive silver halide emulsion in an organic silver salt containing coating solution, and low molecular weight gelatin having a molecular weight of 500 to 60,000 is preferably used. These low molecular weight gelatins may be used at grain formation or at the time of dispersion after desalting treatment and it is preferably used at the time of dispersion after desulting treatment.

8) Chemical Sensitization

The photosensitive silver halide in this invention can be used without chemical sensitization, but is preferably chemically sensitized by at least one of chalcogen sensitization method, gold sensitization method and reduction sensitization method. The chalcogen sensitization method includes sulfur sensitization method, selenium sensitization method and tellurium sensitization method.

In sulfur sensitization, unstable sulfur compounds can be used. Such unstable sulfur compounds are described in P. Grafkides, Chemie et Pysique Photographique (Paul Momtel, 1987, 5th ed.,) and Research Disclosure (vol. 307, Item 307105), and the like.

As typical examples of sulfur sensitizer, known sulfur compounds such as thiosulfates (e.g., hypo), thioureas (e.g., diphenylthiourea, triethylthiourea, N-ethyl-N′-(4-methyl-2-thiazolyl)thiourea and carboxymethyltrimethylthiourea), thioamides (e.g., thioacetamide), rhodanines (e.g., diethylrhodanine, 5-benzylydene-N-ethylrhodanine), phosphinesulfides (e.g., trimethylphosphinesulfide), thiohydantoins, 4-oxo-oxazolidin-2-thione derivatives, disulfides or polysulfides (e.g., dimorphorinedisulfide, cystine, hexathiocan-thione), polythionates, sulfur element and active gelatin can be used. Specifically, thiosulfates, thioureas and rhodanines are preferred.

In selenium sensitization, unstable selenium compounds can be used. These unstable selenium compounds are described in JP-B Nos.43-13489 and 44-15748, JP-A Nos.4-25832, 4-109340, 4-271341, 5-40324, 5-11385, 6-51415, 6-175258, 6-180478, 6-208186, 6-208184, 6-317867, 4-692599, 7-98483, 7-140579 and the like.

As typical examples of selenium sensitizer, colloidal metal selenide, selenoureas (e.g., N,N-dimethylselenourea, trifluoromethylcarbonyltrimethylselenourea and acetyltrimethylselemourea), selenamides (e.g., selenamide and N,N-diethylphenylselenamide), phosphineselenides (eg., triphenylphosphineselenide and pentafluorophenyltriphenylphosphineselenide), selenophosphates (e.g., tri-p-tolylselenophosphate and tri-n-butylselenophosphate), selenoketones (e.g., selenobenzophenone), isoselenocyanates, selenocarbonic acids, selenoesters, diacylselenides can be used. Furthermore, non-unstable selenium compounds such as selenius acid, selenocyanic acid, selenazoles and selenides described in JP-B Nos. 46-4553 and 52-34492 can also be used. Specifically, phosphineselenides, selenoureas and salts of selenocyanic acids are preferred.

In the tellurium sensitization, unstable tellurium compounds are used. Unstable tellurium compounds described in JP-A Nos.4-224595, 4-271341, 4-333043, 5-303157, 6-27573, 6-175,258, 6-180478, 6-208186, 6-208184, 6-317867, 7-140579, 7-301879, 7-301880 and the like, can be used as tellurium sensitizer.

As typical examples of tellurium sensitizer, phosphinetellurides (e.g., butyldiisopropylphosphinetelluride, tributylphosphinetelluride, tributoxyphosphinetelluride and ethoxydiphenylphosphinetellride), diacyl(di)tellurides (e.g., bis(diphenylcarbamoyl)ditelluride, bis(N-phenyl-N-methylcarbamoyl)ditelluride, bis(N-phenyl-N-methylcarbamoyl)ditelluride, bis(N-phenyl-N-benzylcarbamoyl)telluride and bis(ethoxycarmonyl)telluride), telluroureas (e.g., N,N′-dimethylethylenetellurourea and N,N′-diphenylethylenetellurourea), telluramides, telluroesters are used. Specifically, diacyl(di)tellurides and phosphinetellurides are preferred. Especially, the compounds described in paragraph No. 0030 of JP-A No.11-65021 and compounds represented by general formula [II], [III] and [IV] in JP-A No.5-313284 are more preferred.

Selenium sensitization and tellurium sensitization are preferred as chalcogen sensitization and specifically, tellurium sensitization is more preferred.

In gold sensitization, gold sensitizer described in P. Grafkides, Chemie et Pysique Photographique (Paul Momtel, 1987, 5th ed.,) and Research Disclosure (vol. 307, Item 307105) can be used. To speak concretely, chloroauric acid, potassium chloroaurate, potassium aurithiocyanate, gold sulfide, gold selenide and the like can be used. In addition to these, the gold compounds described in U.S. Pat. Nos. 2,642,361, 5,049,484, 5,049,485, 5,169,751, and 5252455, Belg. Patent No. 691857, and the like can also be used. And another novel metal salts except gold such as platinum, palladium, iridium and so on described in P. Grafkides, Chemie et Pysique Photographique (Paul Momtel, 1987, 5th ed.,) and Research Disclosure (vol. 307, Item 307,105) can be used.

The gold sensitization can be used independently, but it is preferably used in combination with the above chalcogen sensitization. Specifically, these sensitizations are gold-sulfur sensitization (gold-plus-sulfur sensitization), gold-selenium sensitization, gold-tellurium sensitization, gold-sulfur-selenium sensitization, gold-sulfur-tellurium sensitization, gold-selenium-tellurium sensitization and gold-sulfur-selenium-tellurium sensitization.

In the invention, chemical sensitization can be applied at any time so long as it is after grain formation and before coating, and it can be applied, after desalting, (1) before spectral sensitization, (2) simultaneously with spectral sensitization, (3) after spectral sensitization and (4) just before coating.

The amount of chalcogen sensitizer used in the invention may vary depending on the silver halide grain used, the chemical ripening condition and the like and it is used by about 10⁻⁸ mol to 10⁻¹ mol, preferably, 10⁻⁷ mol to 10⁻² mol per one mol of the silver halide.

Similarly, the addition amount of the gold sensitizer used in the invention may vary depending on various conditions and it is generally about 10⁻⁷ mol to 10⁻² mol and, more preferably, 10⁻⁶ mol to 5×10⁻³ mol per one mol of the silver halide. There is no particular restriction on the condition for the chemical sensitization in the invention and, appropriately, pAg is 8 or less, preferably, 7.0 or less, more preferably, 6.5 or less and, particularly preferably, 6.0 or less, and pAg is 1.5 or more, preferably, 2.0 or more, particularly preferably, 2.5 or more, pH is 3 to 10, preferably, 4 to 9, and temperature is at 20° C. to 95° C., preferably, 25° C. to 80° C.

In the invention, reduction sensitization can also be used in combination with the chalcogen sensitization or the gold sensitization. It is specifically preferred to use in combination with the chalcogen sensitization.

As the specific compound for the reduction sensitization, ascorbic acid, thiourea dioxide or dimethylamine borane is preferred, as well as use of stannous chloride, aminoimino methane sulfonic acid, hydrazine derivatives, borane compounds, silane compounds and polyamine compounds are preferred. The reduction sensitizer may be added at any stage in the photosensitive emulsion production process from crystal growth to the preparation step just before coating. Further, it is preferred to apply reduction sensitization by ripening while keeping pH to 8 or higher and pAg to 4 or lower for the emulsion, and it is also preferred to apply reduction sensitization by introducing a single addition portion of silver ions during grain formation.

The addition amount of the reduction sensitizer may also vary depending on various conditions and it is generally about 10⁻⁷ mol to 10⁻¹ mol and, more preferably, 10⁻⁶ mol to 5×10⁻² mol per one mol of the silver halide.

In the silver halide emulsion used in the invention, a thiosulfonic acid compound may be added by the method shown in EP-A No. 293917.

The photosensitive silver halide grain in the invention can be chemically unsensitized, but is preferably chemically sensitized by at least one method of gold sensitization method and chalcogen sensitization method for the purpose of designing a high-photosensitive photothermographic material.

9) Compound that can be one-electron-oxidized to provide a one-electron oxidation product which releases one or more electrons

The photothermographic material of the invention preferably contains a compound that can be one-electron-oxidized to provide a one-electron oxidation product which releases one or more electrons.

The said compound can be used individually or in combination with various chemical sensitizers described above to increase the sensitivity of silver halide.

As the compound that can be one-electron-oxidized to provide a one-electron oxidation product which releases one or more electrons is a compound selected from the following types 1 to 5.

(Type 1) a compound that can be one-electron-oxidized to provide a one-electron oxidation product which further releases at least two electrons, due to when subjected to a subsequent bond cleavage reaction;

(Type 2) a compound that has at least two groups adsorbable to the silver halide and can be one-electron-oxidized to provide a one-electron oxidation product which further releases one electron, due to when subjected to a subsequent bond cleavage reaction;

(Type 3) a compound that can be one-electron-oxidized to provide a one-electron oxidation product, which further releases at least one electron after being subjected to a subsequent bond formation;

(Type 4) a compound that can be one-electron-oxidized to provide a one-electron oxidation product which further releases at least one electron after a subsequent intramolecular ring cleavage reaction; and

(Type 5) a compound represented by X—Y, in which X represents a reducing group and Y represents a leaving group, and convertable by one-electron-oxidizing the reducing group to a one-electron oxidation product which can be converted into an X radical by eliminating the leaving group in a subsequent X—Y bond cleavage reaction, one electron being released from the X radical.

Each compound of Type 1 and Types 3 to 5 preferably is “a compound having a sensitizing dye moiety” or “a compound having an adsorbable group to the silver halide”. More preferred is “a compound having an adsorbable group to the silver halide”. More preferably, each compound of Types 1 to 4 is “a compound having a heterocyclic group containing nitrogen atom substituted by more than two mercapto groups”.

The compound of Type 1 to 5 will be described below in detail.

In the compound of Type 1, the term “the bond cleavage reaction” specifically means a cleavage reaction of a bond of carbon-carbon, carbon-silicon, carbon-hydrogen, carbon-boron, carbon-tin or carbon-germanium. Cleavage of a carbon-hydrogen bond may be followed after the cleavage reaction. The compound of Type 1 can be one-electron-oxidized to be converted into the one-electron oxidation product, and thereafter can release further two or more electrons, preferably three or more electrons with the bond cleavage reaction.

The compound of Type 1 is preferably represented by any one of general formulae (A), (B), (1), (2) or (3).

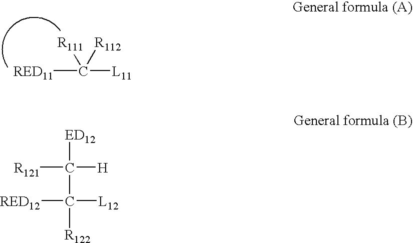

In general formula (A), RED₁₁ represents a reducing group that can be one-electron-oxidized, and L₁₁ represents a leaving group. R₁₁₂ represents a hydrogen atom or a substituent. R₁₁₁ represents a nonmetallic atomic group forming a tetrahydro-, hexahydro- or octahydro-derivative of a 5- or 6-membered aromatic ring including aromatic heterocycles.

In general formula (B), RED₁₂ represents a reducing group that can be one-electron-oxidized, and L₁₂ represents a leaving group. R₁₂₁ and R₁₂₂ each represent a hydrogen atom or a substituent. ED₁₂ represents an electron-donating group. In general formula (B), R₁₂₁ and RED₁₂, R₁₂₁ and R₁₂₂, and ED₁₂ and RED₁₂ may bond together to form a ring structure, respectively.

In the compound represented by general formula (A) or (B), the reducing group of RED₁₁ or RED₁₂ is one-electron-oxidized, and thereafter the leaving group of L₁₁ or L₁₂ is spontaneously eliminated in the bond cleavage reaction. Further two or more, preferably three or more electrons can be released with the bond cleavage reaction.

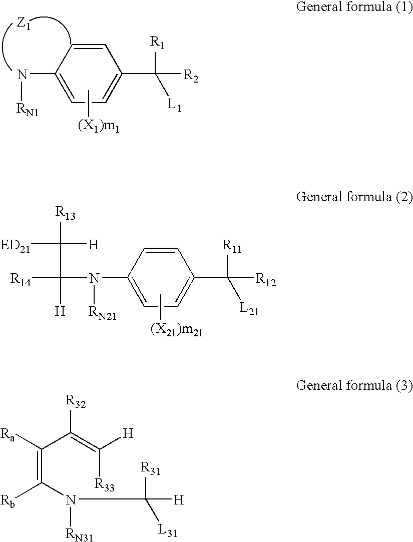

In general formula (1), Z₁ represents an atomic group forming a 6-membered ring with a nitrogen atom and 2 carbon atoms in a benzene ring; R₁, R₂ and R_{N1} each represent a hydrogen atom or a substituent; X₁ represents a substituent capable of substituting for a hydrogen atom on a benzene ring; m₁ represents an integer of 0 to 3; and L₁ represents a leaving group. In general formula (2), ED₂, represents an electron-donating group; R₁₁, R₁₂, R_{N21}, R₁₃ and R₁₄ each represent a hydrogen atom or a substituent; X₂₁ represents a substituent capable of substituting for a hydrogen atom on a benzene ring; m₂, represents an integer of 0 to 3; and L₂₁ represents a leaving group. R_{N21}, R₁₃, R₁₄, X₂, and ED₂₁ may bond to each other to form a ring structure. In general formula (3), R₃₂, R₃₃, R₃₁, R_{N31}, Rₐ and R_{b} each represent a hydrogen atom or a substituent; and L₃₁ represents a leaving group. Incidentally, Rₐ and R_{b} bond together to form an aromatic ring when R_{N31} is not an aryl group.

After the compound is one-electron-oxidized, the leaving group of L₁, L₂₁ or L₃₁ is spontaneously eliminated in the bond cleavage reaction. Further two or more, preferably three or more electrons can be released with the bond cleavage reaction.

First, the compound represented by general formula (A) will be described in detail below.

In general formula (A), the reducing group of RED₁₁ can be one-electron-oxidized and can bond to after-mentioned R¹¹¹ to form the particular ring structure. Specifically, the reducing group may be a divalent group provided by removing one hydrogen atom from the following monovalent group at a position suitable for ring formation.

The monovalent group may be an alkylamino group; an arylamino group such as an anilino group and a naphthylamino group; a heterocyclic amino group such as a benzthiazolylamino group and a pyrrolylamino group; an alkylthio group; an arylthio group such as a phenylthio group; a heterocyclic thio group; an alkoxy group; an aryloxy group such as a phenoxy group; a heterocyclic oxy group; an aryl group such as a phenyl group, a naphthyl group and an anthranil group; or an aromatic or nonaromatic heterocyclic group, containing at least one heteroatom selected from the group consisting of a nitrogen atom, a sulfur atom, an oxygen atom and a selenium atom, which has a 5- to 7-membered, monocyclic or condensed ring structure such as a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzimidazole ring, a benzimidazoline ring, a benzoxazoline ring and a methylenedioxyphenyl ring. RED₁₁ is hereinafter described as the monovalent group for convenience. The monovalent groups may have a substituent.

Examples of the substituent include halogen atoms; alkyl groups including aralkyl groups, cycloalkyl groups, active methine groups, etc.; alkenyl groups; alkynyl groups; aryl groups; heterocyclic groups, which may bond at any position; heterocyclic groups containing a quaternary nitrogen atom such as a pyridinio group, an imidazolio group, a quinolinio group and an isoquinolinio group; acyl groups; alkoxycarbonyl groups; aryloxycarbonyl groups; carbamoyl groups; a carboxy group and salts thereof; sulfonylcarbamoyl groups; acylcarbamoyl groups; sulfamoylcarbamoyl groups; carbazoyl groups; oxalyl groups; oxamoyl groups; a cyano group; carbonimidoyl groups; thiocarbamoyl groups; a hydroxy group; alkoxy groups, which may contain a plurality of ethyleneoxy groups or propyleneoxy groups as a repetition unit; aryloxy groups; heterocyclic oxy groups; acyloxy groups; alkoxy or aryloxy carbonyloxy groups; carbamoyloxy groups; sulfonyloxy groups; amino groups; alkyl, aryl or heterocyclic amino groups; acylamino groups; sulfoneamide groups; ureide groups; thioureide groups; imide groups; alkoxy or aryloxy carbonylamino groups; sulfamoylamino groups; semicarbazide groups; thiosemicarbazide groups; hydrazino groups; ammonio groups; oxamoylamino groups; alkyl or aryl sulfonylureide groups; acylureide groups; acylsulfamoylamino groups; a nitro group; a mercapto group; alkyl, aryl or heterocyclic thio groups; alkyl or aryl sulfonyl groups; alkyl or aryl sulfinyl groups; a sulfo group and salts thereof; sulfamoyl groups; acylsulfamoyl groups; sulfonylsulfamoyl groups and salts thereof; groups containing a phosphoric amide or phosphate ester structure; etc. These substituents may be further substituted by these substituents.

RED₁₁ is preferably an alkylamino group, an arylamino group, a heterocyclic amino group, an aryl group, an aromatic heterocyclic group, or nonaromatic heterocyclic group. RED₁₁ is more preferably an arylamino group (particularly an anilino group), or an aryl group (particularly a phenyl group). When RED₁₁ has a substituent, preferred as a substituent include halogen atoms, alkyl groups, alkoxy groups, carbamoyl groups, sulfamoyl groups, acylamino groups, sulfoneamide groups. When RED₁, is an aryl group, it is preferred that the aryl group has at least one “electron-donating group”. The “electron-donating group” is a hydroxy group; an alkoxy group; a mercapto group; a sulfoneamide group; an acylamino group; an alkylamino group; an arylamino group; a heterocyclic amino group; an active methine group; an electron-excess, aromatic, heterocyclic group with a 5-membered monocyclic ring or a condensed-ring including at least one nitrogen atom in the ring such as an indolyl group, a pyrrolyl group, an imidazolyl group, a benzimidazolyl group, a thiazolyl group, a benzthiazolyl group and an indazolyl group; a nitrogen-containing, nonaromatic heterocyclic group that substituts at the nitrogen atom, such as so-called cyclic amino group like pyrrolidinyl group, an indolinyl group, a piperidinyl group, a piperazinyl group and a morpholino group; etc.

The active methine group is a methine group having two “electron-withdrawing groups”, and the “electron-withdrawing group” is an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. The two electron-withdrawing groups may bond together to form a ring structure.

In general formula (A), specific examples of L₁₁ include a carboxy group and salts thereof, silyl groups, a hydrogen atom, triarylboron anions, trialkylstannyl groups, trialkylgermyl groups and a —CR_{C1}R_{C2}R_{C3} group. When L₁₁ represents a silyl group, the silyl group is specifically a trialkylsilyl group, an aryldialkylsilyl group, a triarylsilyl group, etc, and they may have a substituent.

When L₁₁ represents a salt of a carboxy group, specific examples of a counter ion to form the salt include alkaline metal ions, alkaline earth metal ions, heavy metal ions, ammonium ions, phosphonium ions, etc. Preferred as a counter ion are alkaline metal ions and ammonium ions, most preferred are alkaline metal ions such as Li⁺, Na⁺ and K⁺.

When L₁₁ represents a —CR_{C1}R_{C2}R_{C3} group, R_{C1}, R_{C2} and R_{C3} independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or a hydroxy group. R_{C1}, R_{C2} and R_{C3} may bond to each other to form a ring structure, and may have a substituent. Incidentally, when one of R_{C1}, R_{C2} and R_{C3} is a hydrogen atom or an alkyl group, there is no case where the other two of them are a hydrogen atom or an alkyl group. R_{C1}, R_{C2} and R_{C3} are preferably an alkyl group, an aryl group (particularly a phenyl group), an alkylthio group, an arylthio group, an alkylamino group, an arylamino group, a heterocyclic group, an alkoxy group or a hydroxy group, respectively. Specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, a hydroxy group, etc. Examples of the ring structure formed by R_{C1}, R_{C2} and R_{C3} include a 1,3-dithiolane-2-yl group, a 1,3-dithiane-2-yl group, an N-methyl-1,3-thiazolidine-2-yl group, an N-benzyl-benzothiazolidine-2-yl group, etc.

It is also preferred that the —CR_{C1}R_{C2}R_{C3} group is the same as a residue provided by removing L₁₁ from general formula (A) as a result of selecting each of R_{C1}, R_{C2} and R_{C3} as above.

In general formula (A), L₁₁ is preferably a carboxy group or a salt thereof, or a hydrogen atom, more preferably a carboxy group or a salt thereof.

When L₁₁ represents a hydrogen atom, the compound represented by general formula (A) preferably has a base moiety. After the compound represented by general formula (A) is oxidized, the base moiety acts to eliminate the hydrogen atom of L₁₁ and to release an electron.

The base is specifically a conjugate base of an acid with a pKa value of approximately 1 to 10. For example, the base moiety may contain a structure of a nitrogen-containing heterocycle such as pyridine, imidazole, benzimidazole and thiazole; aniline; trialkylamine; an amino group; a carbon acid such as an active methylene anion; a thioacetic acid anion; carboxylate (—COO⁻); sulfate (—SO₃⁻); amineoxide (>N⁺(O⁻)—); and derivatives thereof. The base is preferably a conjugate base of an acid with a pKa value of approximately 1 to 8, more preferably carboxylate, sulfate or amineoxide, particularly preferably carboxylate. When these bases have an anion, the compound of general formula (A) may have a counter cation. Examples of the counter cation include alkaline metal ions, alkaline earth metal ions, heavy metal ions, ammonium ions, phosphonium ions, etc. The base moiety may be at an optional position of the compound represented by general formula (A). The base moiety may be connected to RED₁₁, R₁₁₁ or R₁₁₂ in general formula (A), and to a substituent thereon.

In general formula (A), R₁₁₂ represents a substituent capable of substituting a hydrogen atom or a carbon atom therewith, provided that R₁₁₂ and L₁₁ do not represent the same group.

R₁₁₂ preferably represents a hydrogen atom, an alkyl group, an aryl group (such as a phenyl group), an alkoxy group (such as a methoxy group, a ethoxy group, a benzyloxy group), a hydroxy group, an alkylthio group, (such as a methylthio group, a butylthio group), and amino group, an alkylamino group, an arylamino group, a heterocyclic amino group or the like; and more preferably represents a hydrogen atom, an alkyl group, an alkoxy group, a hydroxy group, a phenyl group and an alkylamino group.

Ring structures formed by R₁₁₁ in general formula (A) are ring structure corresponding to a tetrahydro structure, a hexahydro structure, or an octahydro structure of a five-membered or six-membered aromatic ring (including an aromatic hetro ring), wherein a hydro structure means a ring structure in which partial hydrogenation is performed on a carbon-carbon double bond (or a carbon-nitrogen double bond) contained in an aromatic ring (an aromatic hetero ring) as a part thereof, wherein the tetrahydro structure is a structure in which 2 carbon-carbon double bonds (or carbon-nitrogen double bonds) are hydrogenated, the hexahydro structure is a structure in which 3 carbon-carbon double bonds (or carbon-nitrogen double bonds) are hydrogenated, and the octahydro structure is a structure in which 4 carbon-carbon double bonds (or carbon-nitrogen double bonds) are hydrogenated. Hydrogenation of an aromatic ring produces a partially hydrogenated non-aromatic ring structure.

Concrete examples include a pyrrolidine ring, an imidazolidine ring, a thiazolidine ring, a pyrazolidine ring, an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, a tetrahydroquinazoline ring and a tetrahydroquinoxaline ring, a tetrahydrocarbazole ring, an octahydrophenanthridine ring and the like. The ring structures may have any substituent therein.

More preferable examples of a ring structure forming R₁₁₁ include a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring and a tetracarbazole ring. Particularly preferable examples include a pyrrolidine ring, a piperidine ring, a piperazine ring, a tetrahydropyridine ring, a tetrahydroquinoline ring, a tetrahydroisoquinoline ring, a tetrahydroquinazoline ring and a tetrahydroquinoxaline ring; and most preferable examples include a pyrrolidine ring, a piperidine ring, a tetrahydropyridine ring, a tetrahydroquinoline ring and a tetrahydroisoquinoline ring.

In general formula (B), RED₁₂ and L₁₂ represent groups having the respective same meanings as RED₁₁ and L₁₁ in general formula (A), and have the respective same preferable ranges as RED₁₁ and L₁₁ in general formula (A). RED₁₂ is a monovalent group except a case where RED₁₂ forms the following ring structure and to be concrete, there are exemplified groups each with a name of a monovalent group described as RED₁₁. RED₁₂₁ and L₁₂₂ represent groups having the same meaning as R₁₁₂ in general formula (A), and have the same preferable range as R₁₁₂ in general formula (A). ED₁₂ represents an electron-donating group. Each pair of R₁₂₁ and RED₁₂; R¹²¹ and R₁₂₂; or ED₁₂ and RED₁₂ may form a ring structure by bonding with each other.

An electron-donating group represented by RED₁₂ in general formula (B) is the same as an electron-donating group described as a substituent when RED₁₁ represents an aryl group. Preferable examples of RED₁₂ include a hydroxy group, an alkoxy group, a mercapto group, a sulfonamide group, an alkylamino group, an arylamino group, an active methine group, an electron-excessive aromatic heterocyclic group in a five-membered single ring or fused ring structure containing at least one nitrogen atom in a ring structure as part of the ring, a non-aromatic nitrogen containing hetrocyclic group having a nitrogen atom as a substitute, and a phenyl group substituted with an electron donating group described above, and more preferable examples thereof include a non-aromatic nitrogen containing heterocyclic group further substituted with a hydroxy group, a mercapto group, a sulfonamide group, an alkylamino group, an arylamino group, an active methine group, or a nitrogen atom; and a phenyl group substituted with an electron-donating group described above (for example, a p-hydroxyphenyl group, a p-dialkylaminophenyl group, an o- or p-dialkoxyphenyl group and the like).

In general formula (B), R₁₂₁ and RED₁₂; R₁₂₂ and R₁₂₁; or ED₁₂ and RED₁₂ may bond to each other to form a ring structure. A ring structure formed here is a non-aromatic carbon ring or hetero ring in a 5- to 7-membered single ring or fused ring structure which is substituted or unsubstituted. Concrete examples of a ring structure formed from R₁₂₁, and RED₁₂ include, in addition to the examples of the ring structure formed by R₁₁₁ in general formula (A), a pyrroline ring, an imidazoline ring, a thiazoline ring, a pyrazoline ring, an oxazoline ring, an indan ring, a morphorine ring, an indoline ring, a tetrahydro-1,4-oxazine ring, 2,3-dihydrobenzo-1,4-oxazine ring, a tetrahydro-1,4-thiazine ring, 2,3-dihydrobenzo-1,4-thiazine ring, 2,3-dihydrobenzofuran ring, 2,3-dihydrobenzothiophene ring and the like. In formation of a ring structure from ED₁₂ and RED₁₂, ED₁₂ is preferably an amino group, an alkylamino group or an arylamino group and concrete examples of the ring structure include a tetrahyropyrazine ring, a piperazine ring, a tetrahydroquinoxaline ring, a tetrahydroisoquinoline ring and the like. Concrete examples of a ring structure formed from R₁₂₂ and R₁₂₁ include a cyclohexane ring, a cyclopentane ring and the like.

Then, description will be given of general formulae (1) to (3).

In general formulae (1) to (3), R₁, R₂, R₁₁, R₁₂ and R₃₁ represent the same meaning as R₁₁₂ of general formula (A) and have the same preferable range as R₁₁₂ of general formula (A). L₁, L₂₁ and L₃₁ independently represents the same leaving groups as the groups shown as concrete examples in description of L₁₁ of general formula (A) and also have the same preferable range as L₁₁ of general formula (A). The substituents represented by X₁ and X₂₁ are the same as the examples of substituents of RED₁₁ of general formula (A) and have the same preferable range as RED₁, of general formula (A). m₁ and m₂ are preferably integers from 0 to 2 and more preferably integers of 0 or 1.

When R_{N1}, R_{N21} and R_{N31} each represents a substituent, preferred as a substituent include an alkyl group, an aryl group or a heterocyclic group, and may further have a substituent. Each of R_{N1}, R_{N21} and R_{N31} is preferably a hydrogen atom, an alkyl group or an aryl group, more preferably a hydrogen atom or an alkyl group.

When R₁₃, R₁₄, R₃₂, R₃₃, Rₐ and R_{b} independently represent a substituent, the substituent is preferably an alkyl group, an aryl group, an acyl group, an alkoxycarbonyl group, a carbamoyl group, a cyano group, an alkoxy group, an acylamino group, a sulfoneamide group, a ureide group, a thiouredide group, an alkylthio group, an arylthio group, an alkylsulfonyl group, an arylsulfonyl group, or a sulfamoyl group.

The 6-membered ring formed by Z₁ in general formula (1) is a nonaromatic heterocycle condensed with the benzene ring in general formula (1). The ring structure containing the nonaromatic heterocycle and the benzene ring to be condensed may be specifically a tetrahydroquinoline ring, a tetrahydroquinoxaline ring, or a tetrahydroquinazoline ring, which may have a substituent.

In general formula (2), ED₂₁ is the same as ED₁₂ in general formula (B) with respect to the meanings and preferred embodiments.

In general formula (2), any two of R_{N21}, R₁₃, R₁₄, X₂₁ and ED₂₁ may bond together to form a ring structure. The ring structure formed by R_{N21} and X₂₁ is preferably a 5- to 7-membered, carbocyclic or heterocyclic, nonaromatic ring structure condensed with a benzene ring, and specific examples thereof include a tetrahydroquinoline ring, a tetrahydroquinoxaline ring, an indoline ring, a 2,3-dihydro-5,6-benzo-1,4-thiazine ring, etc. Preferred are a tetrahydroquinoline ring, a tetrahydroquinoxaline ring and an indoline ring.

When R_{N31} is a group other than an aryl group in general formula (3), Rₐ and R_{b} bond together to form an aromatic ring. The aromatic ring is an aryl group such as a phenyl group and a naphthyl group, or an aromatic heterocyclic group such as a pyridine ring group, a pyrrole ring group, a quinoline ring group and an indole ring group, preferably an aryl group. The aromatic ring group may have a substituent.

In general formula (3), Rₐ and R_{b} preferably bond together to form an aromatic ring, particularly a phenyl group.

In general formula (3), R₃₂ is preferably a hydrogen atom, an alkyl group, an aryl group, a hydroxy group, an alkoxy group, a mercapto group or an amino group. When R₃₂ is a hydroxy group, R₃₃ is preferably an “electron-withdrawing group”. The “electron-withdrawing group” is the same as mentioned above, and is preferably an acyl group, an alkoxycarbonyl group, a carbamoyl group or a cyano group.

The compound of Type 2 will be described below.

According to the compound of Type 2, “the bond cleavage reaction” is a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction.

The compound of Type 2 has two or more, preferably 2 to 6, more preferably 2 to 4, adsorbent groups to the silver halide. The adsorbable group is further preferably a mercapto-substituted, nitrogen-containing, heterocyclic group. The adsorbable group will hereinafter be described.

The compound of Type 2 is preferably represented by the following general formula (C).

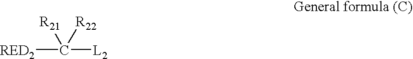

In the compound represented by general formula (C), the reducing group of RED₂ is one-electron-oxidized, and thereafter the leaving group of L₂ is spontaneously eliminated, thus a C (carbon atom)-L₂ bond is cleaved, in the bond cleavage reaction. Further one electron can be released with the bond cleavage reaction.

In general formula (C), RED₂ is the same as RED₁₂ in general formula (B) with respect to the meanings and preferred embodiments. L₂ is the same as L₁₁ in general formula (A) with respect to the meanings and preferred embodiments. Incidentally, when L₂ is a silyl group, the compound of general formula (C) has 2 or more mercapto-substituted, nitrogen-containing, heterocyclic groups as the adsorbent groups. R₂₁ and R₂₂ each represent a hydrogen atom or a substituent, and are the same as R₁₁₂ in general formula (A) with respect to the meanings and preferred embodiments. RED₂ and R₂₁ may bond together to form a ring structure.

The ring structure is a 5- to 7-membered, monocyclic or condensed, carbocyclic or heterocyclic, nonaromatic ring, and may have a substituent. Incidentally, there is no case where the ring structure corresponds to a tetrahydro-, hexahydro- or octahydro-derivative of an aromatic ring or an aromatic heterocycle. The ring structure is preferably such that corresponds to a dihydro-derivative of an aromatic ring or an aromatic heterocycle, and specific examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzoxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, a 1,2-dihydroquinoxaline ring, etc. Preferred are a 2-imidazoline ring, a 2-thiazoline ring, an indoline ring, a benzoimidazoline ring, a benzothiazoline ring, a benzoxazoline ring, a 1,2-dihydro pyridine ring, a 1,2-dihydroquinoline ring, a 1,2-dihydroquinazoline ring and a 1,2-dihydroquinoxaline ring, more preferred are an indoline ring, a benzoimidazoline ring, a benzothiazoline ring and a 1,2-dihydroquinoline ring, particularly preferred is an indoline ring.

The compound of Type 3 will be described below.

According to the compound of Type 3, “bond formation” means that a bond of carbon-carbon, carbon-nitrogen, carbon-sulfur, carbon-oxygen, etc. is formed.

It is preferable that the one-electron oxidation product releases one or more electron after an intramolecular bond-forming reaction between the one-electron-oxidized portion and a reactive site in the same molecular such as a carbon-carbon double bond, a carbon-carbon triple bond, an aromatic group and a benzo-condensed, nonaromatic heterocyclic group.

To be more detailed, a one-electron oxidized product (a cation radical species or a neutral radical species generated by elimination of a proton therefrom) formed by one electron oxidizing a compound of type 3 reacts with a reactive group described above coexisting in the same molecule to form a bond and form a radical species having a new ring structure therein. The radical species have a feature to release a second electron directly or in company with elimination of a proton therefrom. One of compounds of type 3 has a chance to further release one or more electrons, in a ordinary case two or more electrons, after formation of a two-electron oxidized product, after receiving a hydrolysis reaction in one case or after causing a tautomerization reaction accompanying direct migration of a proton in another case. Alternatively, compounds of Type 3 also include a compound having an ability to further release one or more electron, in an ordinary case two or more electrons directly from a two-electron oxidized product, not by way of a tautomerization reaction.

The compound of Type 3 is preferably represented by the following general formula (D).

RED₃-L₃-Y₃ General formula (D)

In general formula (D), RED₃ represents a reducing group that can be one-electron-oxidized, and Y₃ represents a reactive group that reacts with the one-electron-oxidized RED₃, specifically an organic group containing a carbon-carbon double bond, a carbon-carbon triple bond, an aromatic group or a benzo-condensed, nonaromatic heterocyclic group. L₃ represents a linking group that connects RED₃ and Y₃.

In general formula (D), RED₃ has the same meanings as RED₁₂ in general formula (B). In general formula (D), RED₃ is preferably an arylamino group, a heterocyclic amino group, an aryloxy group, an arylthio group, an aryl group, or an aromatic or nonaromatic heterocyclic group that is preferably a nitrogen-containing heterocyclic group. RED₃ is more preferably an arylamino group, a heterocyclic amino group, an aryl group, or an aromatic or nonaromatic heterocyclic group. Preferred as the heterocyclic group are a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzimidazole ring group, a benzoimidazoline ring group, a benzothiazoline ring group, a 3,4-methylenedioxyphenyl-1-yl group, etc.

Particularly preferred as RED₃ are an arylamino group (particularly an anilino group), an aryl group (particularly a phenyl group), and an aromatic or nonaromatic heterocyclic group.

The aryl group represented by RED₃ preferably has at least one electron-donating group. The term “electron-donating group” means the same as above-mentioned electron-donating group.

When RED₃ is an aryl group, more preferred as a substituent on the aryl group are an alkylamino group, a hydroxy group, an alkoxy group, a mercapto group, a sulfoneamide group, an active methine group, and a nitrogen-containing, nonaromatic heterocyclic group that substitutes at the nitrogen atom, furthermore preferred are an alkylamino group, a hydroxy group, an active methine group, and a nitrogen-containing, nonaromatic heterocyclic group that substitutes at the nitrogen atom, and the most preferred are an alkylamino group, and a nitrogen-containing, nonaromatic heterocyclic group that substitutes at the nitrogen atom.

When Y₃ is an organic group containing carbon-carbon double bond (for example a vinyl group) having a substituent, more preferred as the substituent are an alkyl group, a phenyl group, an acyl group, a cyano group, an alkoxycarbonyl group, a carbamoyl group and an electron-donating group. The electron-donating group is preferably an alkoxy group; a hydroxy group (that may be protected by a silyl group, and examples of the silyl-protected group include a trimethylsilyloxy group, a t-butyldimethylsilyloxy group, a triphenylsilyloxy group, a triethylsilyloxy group, a phenyldimethylsilyloxy group, etc); an amino group; an alkylamino group; an arylamino group; a sulfoneamide group; an active methine group; a mercapto group; an alkylthio group; or a phenyl group having the electron-donating group as a substituent.

Incidentally, when the organic group containing the carbon-carbon double bond has a hydroxy group as a substituent, Y₃ contains a moiety of >C₁═C₂(—OH)—, which may be tautomerized into a moiety of >C₁H—C₂(═O)—. In this case, it is preferred that a substituent on the C₁ carbon is an electron-withdrawing group, and as a result, Y₃ has a moiety of an “active methylene group” or an “active methine group”. The electron-withdrawing group, which can provide such a moiety of an active methylene group or an active methine group, may be the same as above-mentioned electron-withdrawing group on the methine group of “the active methine group”.

When Y₃ is an organic group containing a carbon-carbon triple bond (for example a ethynyl group) having a substituent, preferred as the substituent are an alkyl group, a phenyl group, an alkoxycarbonyl group, a carbamoyl group, an electron-donating group, etc.

When Y₃ is an organic group containing an aromatic group, preferred as the aromatic group is an aryl group, particularly a phenyl group, having an electron-donating group as a substituent, and an indole ring group. The electron-donating group is preferably a hydroxy group, which may be protected by a silyl group; an alkoxy group; an amino group; an alkylamino group; an active methine group; a sulfoneamide group; or a mercapto group.

When Y₃ is an organic group containing a benzo-condensed, nonaromatic heterocyclic group, preferred as the benzo-condensed, nonaromatic heterocyclic group are groups having an aniline moiety, such as an indoline ring group, a 1,2,3,4-tetrahydroquinoline ring group, a 1,2,3,4-tetrahydroquinoxaline ring group and a 4-quinolone ring group.

The reactive group of Y₃ is more preferably an organic group containing a carbon-carbon double bond, an aromatic group, or a benzo-condensed, nonaromatic heterocyclic group. Furthermore preferred are an organic group containing a carbon-carbon double bond; a phenyl group having an electron-donating group as a substituent; an indole ring group; and a benzo-condensed, nonaromatic heterocyclic group having an aniline moiety. The carbon-carbon double bond more preferably has at least one electron-donating group as a substituent.

It is also preferred that the reactive group represented by Y₃ contains a moiety the same as the reducing group represented by RED₃ as a result of selecting the reactive group as above.

L₃ represents a linking group that connects RED₃ and Y₃, specifically a single bond, an alkylene group, an arylene group, a heterocyclic group, —O—, —S—, —NR_{N}—, —C(═O)—, —SO₂—, —SO—, —P(═O)—, or a combination thereof. R_{N} represents a hydrogen atom, an alkyl group, an aryl group or a heterocyclic group. The linking group represented by L₃ may have a substituent. The linking group represented by L₃ may bond to each of RED₃ and Y₃ at an optional position such that the linking group substitutes optional one hydrogen atom of each RED₃ and Y₃. Preferred examples of L₃ include a single bond; alkylene groups, particularly a methylene group, an ethylene group or a propylene group; arylene groups, particularly a phenylene group; a —C(═O)— group; a —O— group; a —NH— group; —N(alkyl)- groups; and divalent linking groups of combinations thereof.

When a cation radical (X⁺.) provided by oxidizing RED₃ or a radical (X.) provided by eliminating a proton therefrom reacts with the reactive group represented by Y₃ to form a bond, it is preferable that they form a 3 to 7-membered ring structure containing the linking group represented by L₃. Thus, the radical (X⁺. or X.) and the reactive group of Y are preferably connected though 3 to 7 atoms.

Next, the compound of Type 4 will be described below.

The compound of Type 4 has a reducing group-substituted ring structure. After the reducing group is one-electron-oxidized, the compound can release further one or more electron with a ring structure cleavage reaction. The ring cleavage reaction proceeds as follows.

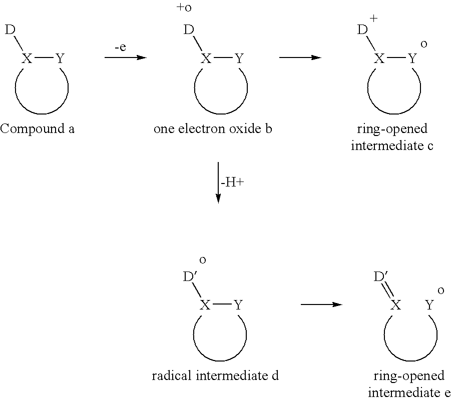

In the formula, compound a is the compound of Type 4. In compound a, D represents a reducing group, and X and Y each represent an atom forming a bond in the ring structure, which is cleaved after the one-electron oxidation. First, compound a is one-electron-oxidized to generate one-electron oxidation product b. Then, the X—Y bond is cleaved with conversion of the D-X single bond into a double bond, whereby ring-opened intermediate c is provided. Alternatively, there is a case where one-electron oxidation product b is converted into radical intermediate d with deprotonation, and ring-opened intermediate e is provided in the same manner. Subsequently, further one or more electrons are released form thus-provided ring-opened intermediate c or e.

The ring structure in the compound of Type 4 is a 3 to 7-membered, carbocyclic or heterocyclic, monocyclic or condensed, saturated or unsaturated, nonaromatic ring. The ring structure is preferably a saturated ring structure, more preferably 3- or 4-membered ring. Preferred examples of the ring structure include a cyclopropane ring, a cyclobutane ring, an oxirane ring, an oxetane ring, an aziridine ring, an azetidine ring, an episulphide ring and a thietane ring. More preferred are a cyclopropane ring, a cyclobutane ring, an oxirane ring, an oxetane ring and an azetidine ring, particularly preferred are a cyclopropane ring, a cyclobutane ring and an azetidine ring. The ring structure may have a substituent.

The compound of Type 4 is preferably represented by the following general formula (E) or (F).

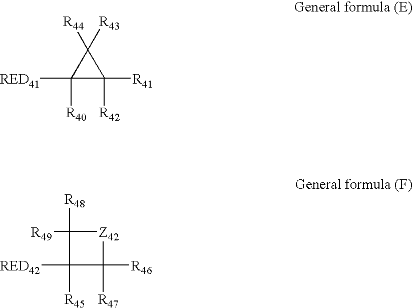

In general formulae (E) and (F), RED₄₁ and RED₄₂ are the same as RED₁₂ in general formula (B) with respect to the meanings and preferred embodiments, respectively. R₄₀ to R₄₄ and R₄₅ to R₄₉ each represents a hydrogen atom or a substituent. In general formula (F), Z₄₂ represents —CR₄₂₀R₄₂₁—, —NR₄₂₃—, or —O—, R₄₂₀ and R₄₂₁ each represent a hydrogen atom or a substituent, and R₄₂₃ represents a hydrogen atom, an alkyl group, an aryl group or a heterocyclic group.

In general formulae (E) and (F), each of R₄₀ and R₄₅ is preferably a hydrogen atom, an alkyl group or an aryl group, more preferably, a hydrogen atom, an alkyl group or an aryl group. Each of R₄₁ to R₄₄ and R₄₆ to R₄₉ is preferably a hydrogen atom, an alkyl group, an alkenyl group, an aryl group, a heterocyclic group, an arylthio group, an alkylthio group, an acylamino group or a sulfoneamide group, more preferably a hydrogen atom, an alkyl group, an aryl group or a heterocyclic group,

It is preferred that at least one of R₄₁ to R₄₄ is a donor group, and it is also preferred that both of R₄₁ and R₄₂, or both of R₄₃ and R₄₄ are an electron-withdrawing group. It is more preferred that at least one of R₄₁ to R₄₄ is a donor group. It is furthermore preferred that at least one of R₄₁ to R₄₄ is a donor group and R₄₁ to R₄₄ other than the donor group are selected from a hydrogen atom and an alkyl group.

A donor group referred to here is an “electron-donating group” or an aryl group substituted with at least one “electron-donating group.” Preferable examples of donor groups include an alkylamino group, an arylamino group, a heterocyclicamino group, an electron-excessive aromatic heterocyclic group in a five-membered single ring or fused ring structure containing at least one nitrogen atom in a ring structure as part of the ring, a non-aromatic nitrogen containing hetrocyclic group having a nitrogen atom as a substitute and a phenyl group substituted with at least one electron-donating group. More preferable examples thereof include an alkylamino group, an aryamino group, an electron excessive aromatic heterocyclic group in a five-membered single ring or fused ring containing at least one nitrogen atom in a ring structure as a part (an indol ring, a pyrrole ring, a carbazole ring and the like), and a phenyl group substituted with an electron-donating group (a phenyl group substituted with three or more alkoxy groups, a phenyl group substituted with a hydroxy group, an alkylamino group, or an arylamino group and the like). Particularly preferable examples thereof include an aryamino group, an electron excessive aromatic heterocyclic group in a five-membered single ring or fused ring containing at least one nitrogen atom in a ring structure as a part (especially, a 3-indolyl group), and a phenyl group substituted with an electron-donating group (especially, a trialkoxyphenyl group and a phenyl group substituted with an alkylamino group or an arylamino group).

Z₄₂ is preferably —CR₄₂₀R₄₂₁— or —NR₄₂₃—, more preferably —NR₄₂₃—. Each of R₄₂₀ and R₄₂₁ is preferably a hydrogen atom, an alkyl group, an aryl group, a heterocyclic group, an acylamino group or a sulfoneamino group, more preferably a hydrogen atom, an alkyl group, an aryl group or a heterocyclic group. R₄₂₃ is preferably a hydrogen atom, an alkyl group, an aryl group or an aromatic heterocyclic group, more preferably a hydrogen atom, an alkyl group or an aryl group.

The substituent represented by each of R₄₀ to R₄₉, R₄₂₀, R₄₂₁ and R₄₂₃ preferably has 40 or less carbon atoms, more preferably has 30 or less carbon atoms, particularly preferably 15 or less carbon atoms. The substituents of R₄₀ to R₄₉, R₄₂₀, R₄₂₁ and R₄₂₃ may bond to each other or to the other portion such as RED₄₁, RED₄₂ and Z₄₂, to form a ring.

In the compounds of Types 1 to 4 used in the invention, the adsorbable group to the silver halide is such a group that is directly adsorbed on the silver halide or promotes adsorption of the compound onto the silver halide. Specifically, the adsorbable group is a mercapto group or a salt thereof; a thione group (—C(═S)—); a heterocyclic group containing at least one atom selected from the group consisting of a nitrogen atom, a sulfur atom, a selenium atom and a tellurium atom; a sulfide group; a cationic group; or an ethynyl group. Incidentally, the adsorbable group in the compound of Type 2 is not a sulfide group.

The mercapto group or a salt thereof used as the adsorbable group may be a mercapto group or a salt thereof itself, and is more preferably a heterocyclic group, an aryl group or an alkyl group having a mercapto group or a salt thereof as a substituent. The heterocyclic group is a 5- to 7-membered, monocyclic or condensed, aromatic or nonaromatic, heterocyclic group. Examples thereof include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, etc. The heterocyclic group may contain a quaternary nitrogen atom, and in this case, the mercapto group bonding to the heterocyclic group may be dissociated into a mesoion. Such heterocyclic group may be an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group, etc. Preferred among them is a triazolium ring group such as a 1,2,4-triazolium-3-thiolate ring group. Examples of the aryl group include a phenyl group and a naphthyl group. Examples of the alkyl group include straight, branched or cyclic alkyl groups having 1 to 30 carbon atom. When the mercapto group forms a salt, a counter ion of the salt may be a cation of an alkaline metal, an alkaline earth metal, a heavy metal, etc. such as Li⁺, Na⁺, K⁺, Mg²⁺, Ag⁺ and Zn²⁺; an ammonium ion; a heterocyclic group containing a quaternary nitrogen atom; a phosphonium ion; etc.

Further, the mercapto group used as the adsorbable group may be tautomerized into a thione group. Specific examples of the thione group include a thioamide group (herein a —C(═S)—NH— group); and groups containing a structure of the thioamide group, such as linear or cyclic thioamide groups, a thiouredide group, a thiourethane group and a dithiocarbamic acid ester group. Examples of the cyclic thioamide group include a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group, etc.

The thione group used as the adsorbent group, as well as the thione group derived from the mercapto group by tautomerization, may be a linear or cyclic, thioamide, thiouredide, thiourethane or dithiocarbamic acid ester group that cannot be tautomerized into the mercapto group or has no hydrogen atom at α-position of the thione group.

The heterocyclic group containing at least one atom selected from the group consisting of a nitrogen atom, a sulfur atom, a selenium atom and tellurium atom, which is used as the adsorbent group, is a nitrogen-containing heterocyclic group having a —NH— group that can form a silver imide (>NAg) as a moiety of the heterocycle; or a heterocyclic group having a —S— group, a —Se— group, a —Te— group or a ═N— group that can form a coordinate bond with a silver ion as a moiety of the heterocycle. EXAMPLEs of the former include a benzotriazole group, a triazole group, an indazole group, a pyrazole group, a tetrazole group, a benzimidazole group, an imidazole group, a purine group, etc. Examples of the latter include a thiophene group, a thiazole group, an oxazole group, a benzothiazole group, a benzoxazole group, a thiadiazole group, an oxadiazole group, a triazine group, a selenazole group, a benzselenazole group, a tellurazole group, a benztellurazole group, etc. The former is preferable.

The sulfide group used as the adsorbable group may be any group with a —S— moiety, and preferably has a moiety of: alkyl or alkylene-S-alkyl or alkylene; aryl or arylene-S-alkyl or alkylene; or aryl or arylene-S-aryl or arylene. The sulfide group may form a ring structure, and may be a —S—S— group. Specific examples of the ring structure include groups with a thiolane ring, a 1,3-dithiolane ring, a 1,2-dithiolane ring, a thiane ring, a dithiane ring, a tetrahydro-1,4-thiazine ring (a thiomorpholine ring), etc. Particularly preferred as the sulfide groups are groups having a moiety of alkyl or alkylene-S-alkyl or alkylene.

The cationic group used as the adsorbable group is a quaternary nitrogen-containing group, specifically a group with an ammonio group or a quaternary nitrogen-containing heterocyclic group. Incidentally, there is no case where the cationic group partly composes an atomic group forming a dye structure, such as a cyanine chromophoric group. The ammonio group may be a trialkylammonio group, a dialkylarylammonio group, an alkyldiarylammonio group, etc., and examples thereof include a benzyldimethylammonio group, a trihexylammonio group, a phenyldiethylammonio group, etc. Examples of the quaternary nitrogen-containing heterocyclic group include a pyridinio group, a quinolinio group, an isoquinolinio group, an imidazolio group, etc. Preferred are a pyridinio group and an imidazolio group, and particularly preferred is a pyridinio group. The quaternary nitrogen-containing heterocyclic group may have an optional substituent. Preferred as the substituent in the case of the pyridinio group and the imidazolio group are alkyl groups, aryl groups, acylamino groups, a chlorine atom, alkoxycarbonyl groups and carbamoyl groups. Particularly preferred as the substituent in the case of the pyridinio group is a phenyl group.

The ethynyl group used as the adsorbable group means a —C≡CH group, in which the hydrogen atom may be substituted.

The adsorbable group may have an optional substituent.

Specific examples of the adsorbable group further include groups described in pages 4 to 7 of a specification of JP-A No. 11-95355.

Preferred as the adsorbable group used in the invention are mercapto-substituted, nitrogen-containing, heterocyclic groups such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group and a 1,5-dimethyl-1,2,4-triazolium-3-thiolate group; and nitrogen-containing heterocyclic groups having a —NH— group that can form a silver imide (>NAg) as a moiety of the heterocycle, such as a benzotriazole group, a benzimidazole group and an indazole group. Particularly preferred are a 5-mercaptotetrazole group, a 3-mercapto-1,2,4-triazole group and a benzotriazole group, and the most preferred are a 3-mercapto-1,2,4-triazole group and a 5-mercaptotetrazole group.

Among these compounds, it is particularly preferred that the compound has two or more mercapto groups as a moiety. The mercapto group (—SH) may be converted into a thione group in the case where it can be tautomerized. The compound may have two or more adsorbent groups containing above-mentioned mercapto or thione group as a moiety, such as a cyclic thioamide group, an alkylmercapto group, an arylmercapto group and a heterocyclic mercapto group. Further, the compound may have one or more adsorbable group containing two or more mercapto or thione groups as a moiety, such as a dimercapto-substituted, nitrogen-containing, heterocyclic group.

Examples of the adsorbable group containing two or more mercapto group, such as a dimercapto-substituted, nitrogen-containing, heterocyclic group, include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)-pyrimidine group, a 2,6,8-trimercaptopurine group, a 6,8-dimercaptopurine group, a 3,5,7-trimercapto-s-triazolotriazine group, a 4,6-dimercaptopyrazolo pyrimidine group, a 2,5-dimercapto-imidazole group, etc. Particularly preferred are a 2,4-dimercaptopyrimidine group, a 2,4-dimercaptotriazine group, and a 3,5-dimercapto-1,2,4-triazole group.

The adsorbable group may be connected to any position of the compound represented by each of general formulae (A) to (F) and (1) to (3). Preferred portions, which the adsorbable group bonds to, are RED₁₁, RED₁₂, RED₂ and RED₃ in general formulae (A) to (D), RED₄₁, R₄₁, RED₄₂, and R₄₆ to R₄₈ in general formulae (E) and (F), and optional portions other than R₁, R₂′ R₁₁, R₁₂, R₃₁, L₁, L₂₁ and L₃₁ in general formulae (1) to (3). Further, more preferred portions are RED₁₁ to RED₄₂ in general formulae (A) to (F).

The spectral sensitizing dye moiety is a group containing a spectral sensitizing dye chromophore, a residual group provided by removing an optional hydrogen atom or substituent from a spectral sensitizing dye compound. The spectral sensitizing dye moiety may be connected to any position of the compound represented by each of general formulae (A) to (F) and (1) to (3). Preferred portion, which the spectral sensitizing dye moiety bonds to, are RED₁₁, RED₁₂, RED₂ and RED₃ in general formulae (A) to (D), RED₄₁, R₄₁, RED₄₂, and R₄₆ to R₄₈ in general formulae (E) and (F), and optional portions other than R₁, R₂, R₁₁, R₁₂, R₃₁, L₁₁ L₂₁ and L₃₁ in general formulae (1) to (3). Further, more preferred portions are RED₁₁ to RED₄₂ in general formulae (A) to (F). The spectral sensitizing dye is preferably such that typically used in color sensitizing techniques. Examples thereof include cyanine dyes, composite cyanine dyes, merocyanine dyes, composite merocyanine dyes, homopolar cyanine dyes, styryl dyes, and hemicyanine dyes. Typical spectral sensitizing dyes are disclosed in Research Disclosure, Item 36544, September 1994. The dyes can be synthesized by one skilled in the art according to procedures described in the above Research Disclosure and F. M. Hamer, The Cyanine dyes and Related Compounds, Interscience Publishers, New York, 1964. Further, dyes described in pages 4 to 7 of a specification of JP-A No. 11-95355 (U.S. Pat. No. 6,054,260) may be used in the invention.

Compounds of Types 1 to 4 used in the invention preferably have 10 to 60 carbon atoms, more preferably 15 to 50 carbon atoms, furthermore preferably 18 to 40 carbon atoms, particularly preferably 18 to 30 carbon atoms.

When a silver halide photosensitive material using the compounds of Types 1 to 4 is exposed, the compound is one-electron-oxidized. After the subsequent reaction, the compound is further oxidized while releasing one or more electrons, or two or more electrons depending on Type. An oxidation potential in the first one-electron oxidation is preferably 1.4 V or less, more preferably 1.0 V or less. This oxidation potential is preferably 0 V or more, more preferably 0.3 V or more. Thus, the oxidation potential is preferably approximately 0 V to 1.4 V, more preferably approximately 0.3 V to 1.0 V.

The oxidation potential may be measured by a cyclic voltammetry technique. Specifically, a sample is dissolved in a solution of acetonitrile/water containing 0.1 M lithium perchlorate=80/20 (volume nitrogen gas is passed through the resultant solution for 10 minutes, and then the oxidation potential is measured at 2° C. at a potential scanning rate of 0.1 V/second by using a glassy carbon disk as a working electrode, using a platinum wire as a counter electrode, and using a calomel electrode (SCE) as a reference electrode. The oxidation potential per SCE is obtained at peak potential of cyclic voltammetric curve.

In the case where the compound of Types 1 to 4 is one-electron-oxidized and release further one electron after the subsequent reaction, an oxidation potential in the subsequent oxidation is preferably −0.5 V to −2 V, more preferably −0.7 V to −2 V, furthermore preferably −0.9 V to −1.6 V.

In the case where the compound of Types 1 to 4 is one-electron-oxidized and release further two or more electrons after the subsequent reaction, oxidation potentials in the subsequent oxidation are not particularly limited. The oxidation potentials in the subsequent oxidation often cannot be measured precisely, because an oxidation potential in releasing the second electron cannot be clearly differentiated from an oxidation potential in releasing the third electron.

Next, the compound of Type 5 will be described.

The compound of Type 5 is represented by X—Y, in which X represents a reducing group and Y represents a leaving group. The reducing group represented by X can be one-electron-oxidized to provide a one-electron oxidation product, which can be converted into an X radical by eliminating the leaving group of Y with a subsequent X—Y bond cleavage reaction. The X radical can release further one electron. The oxidation reaction of the compound of Type 5 may be represented by the following formula.

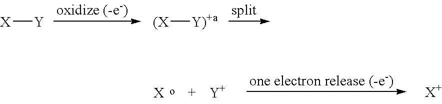

The compound of Type 5 exhibits an oxidation potential of preferably 0 V to 1.4 V, more preferably 0.3 V to 1.0 V. The radical X generated in the formula exhibits an oxidation potential of preferably −0.7 V to −2.0 V, more preferably −0.9 V to −1.6 V.

The compound of Type 5 is preferably represented by the following general formula (G).

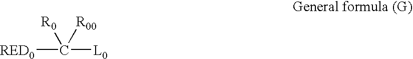

In general formula (G), RED₀ represents a reducing group, L₀ represents a leaving group, and R₀ and R₀₀ each represent a hydrogen atom or a substituent. RED₀ and R₀, and R₀ and R₀₀ may be bond together to form a ring structure, respectively. RED₀ is the same as RED₂ in general formula (C) with respect to the meanings and preferred embodiments. R₀ and R₀₀ are the same as R₂₁ and R₂₂ in general formula (C) with respect to the meanings and preferred embodiments, respectively. Incidentally, R₀ and R₀₀ are not the same as the leaving group of L₀ respectively, except for a hydrogen atom. RED₀ and R₀ may bond together to form a ring structure with examples and preferred embodiments the same as those of the ring structure formed by bonding RED₂ and R₂₁ in general formula (C). Examples of the ring structure formed by bonding R₀ and R₀₀ each other include a cyclopentane ring, a tetrahydrofuran ring, etc.

In general formula (G), L₀ is the same as L₂ in general formula (C) with respect to the meanings and preferred embodiments.

The compound represented by general formula (G) preferably has an adsorbable group to the silver halide or a spectrally sensitizing dye moiety. However, the compound does not have two or more adsorbable groups when L₀ is a group other than a silyl group. Incidentally, the compound may have two or more sulfide groups as the adsorbent groups, not depending on L₀.

The adsorbable group to the silver halide in the compound represented by general formula (G) may be the same as those in the compounds of Types 1 to 4, and further may be the same as all of the compounds and preferred embodiments described as “an adsorbable group to the silver halide” in pages 4 to 7 of a specification of JP-A No. 11-95355.

The spectral sensitizing dye moiety in the compound represented by general formula (G) is the same as in the compounds of Types 1 to 4, and may be the same as all of the compounds and preferred embodiments described as “photoabsorptive group” in pages 7 to 14 of a specification of JP-A No. 11-95355.

Specific examples of the compounds of Types 1 to 5 used in the invention are illustrated below without intention of restricting the scope of the invention.

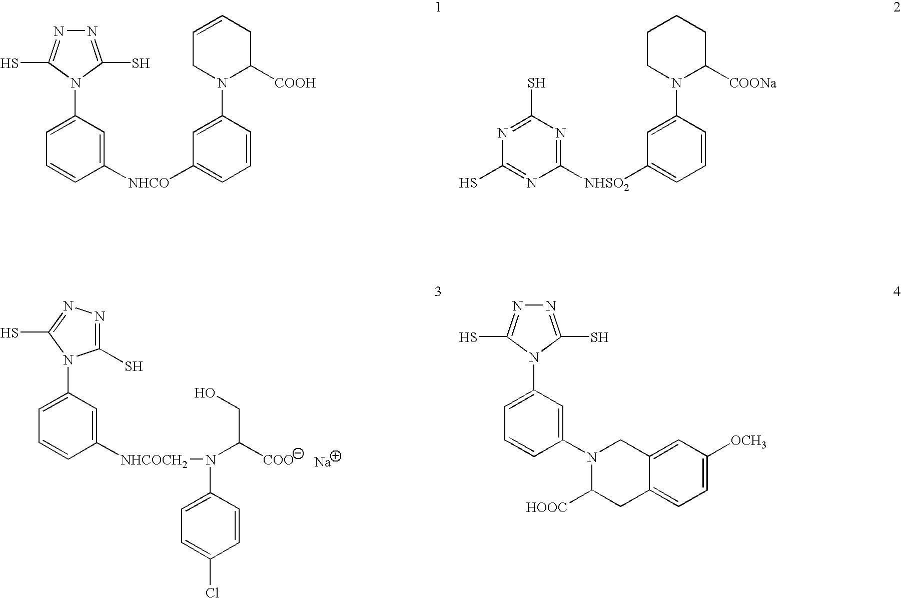

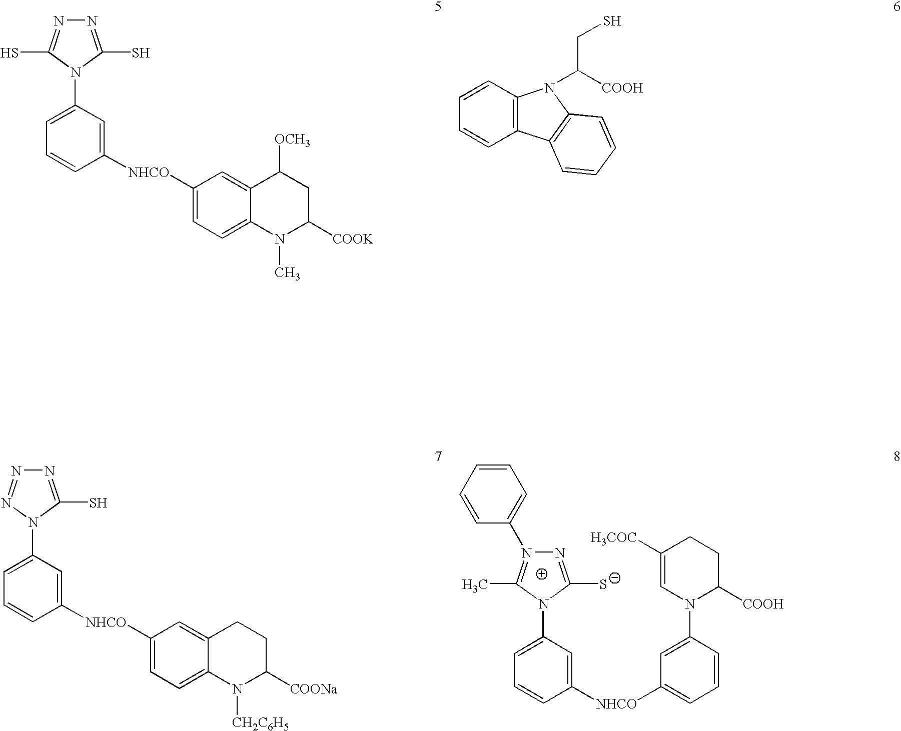

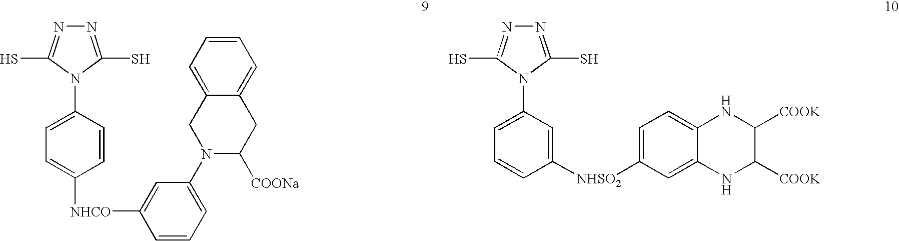

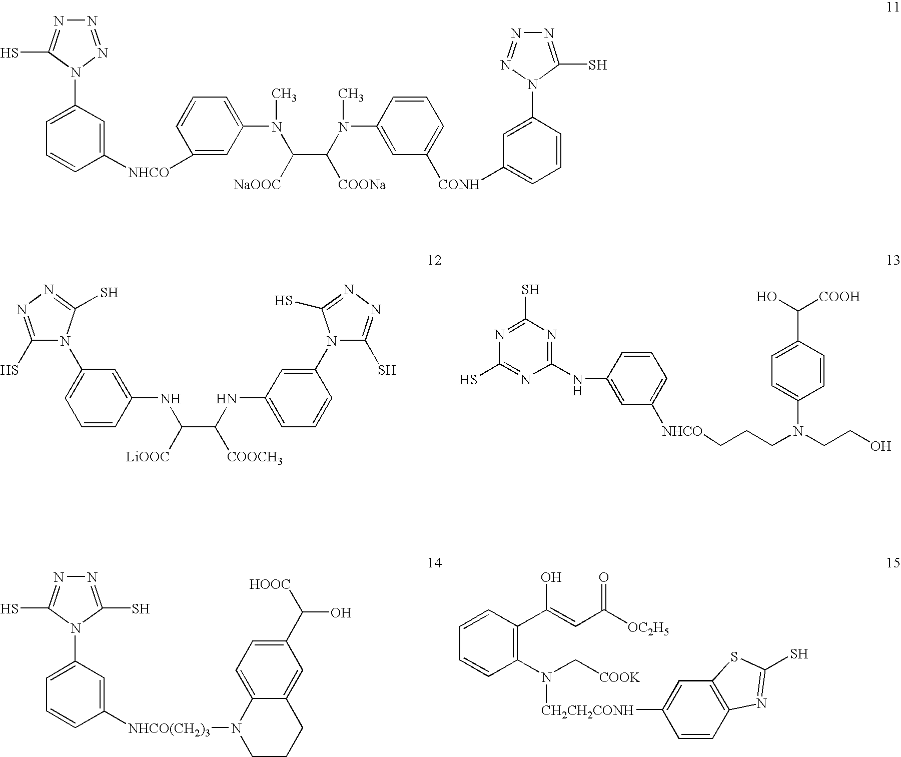

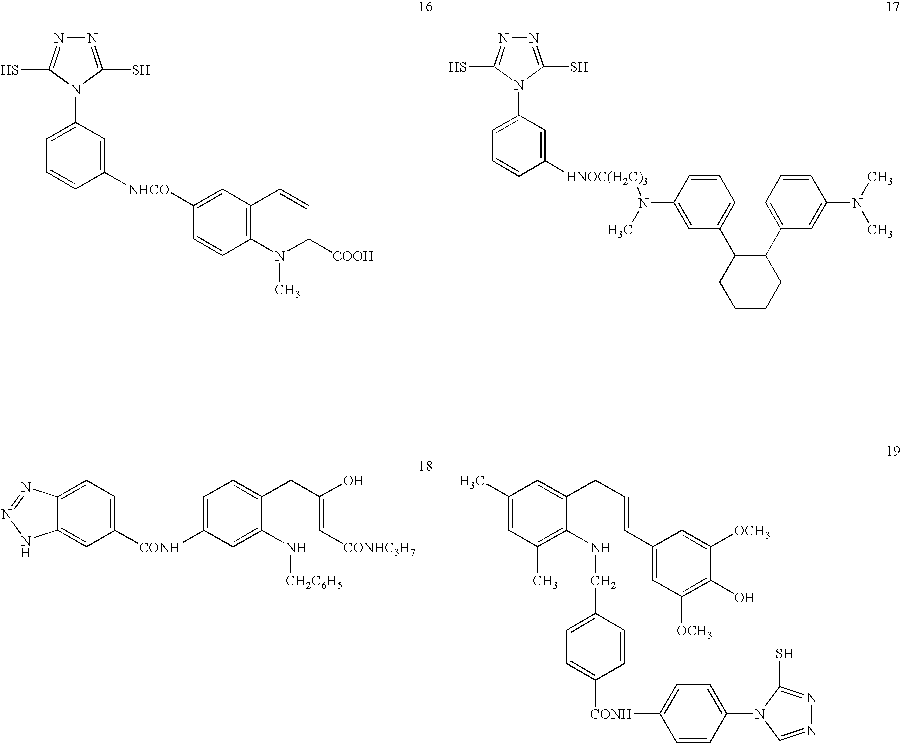

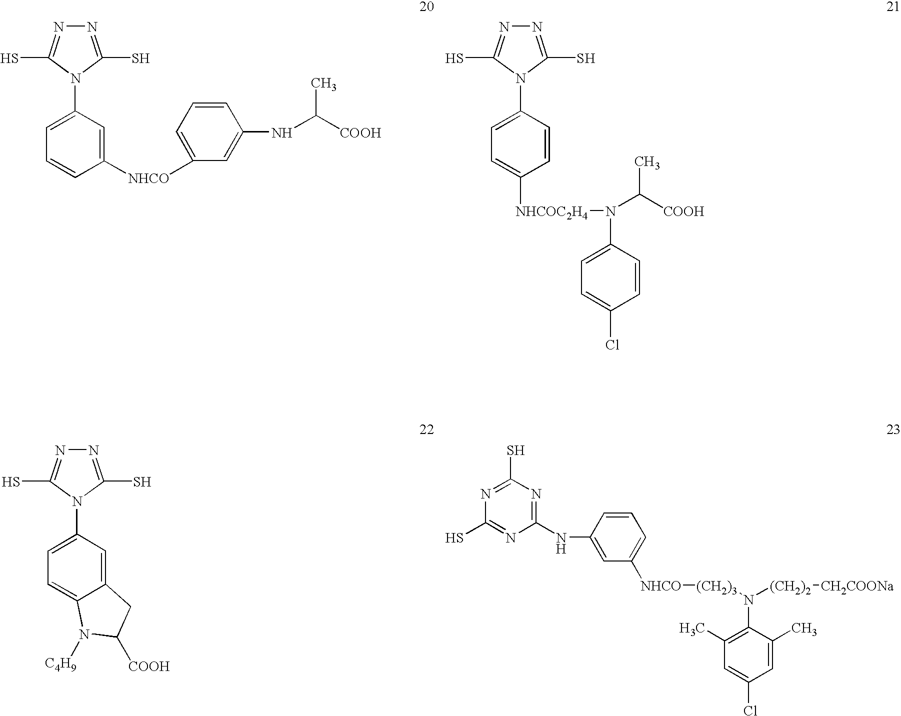

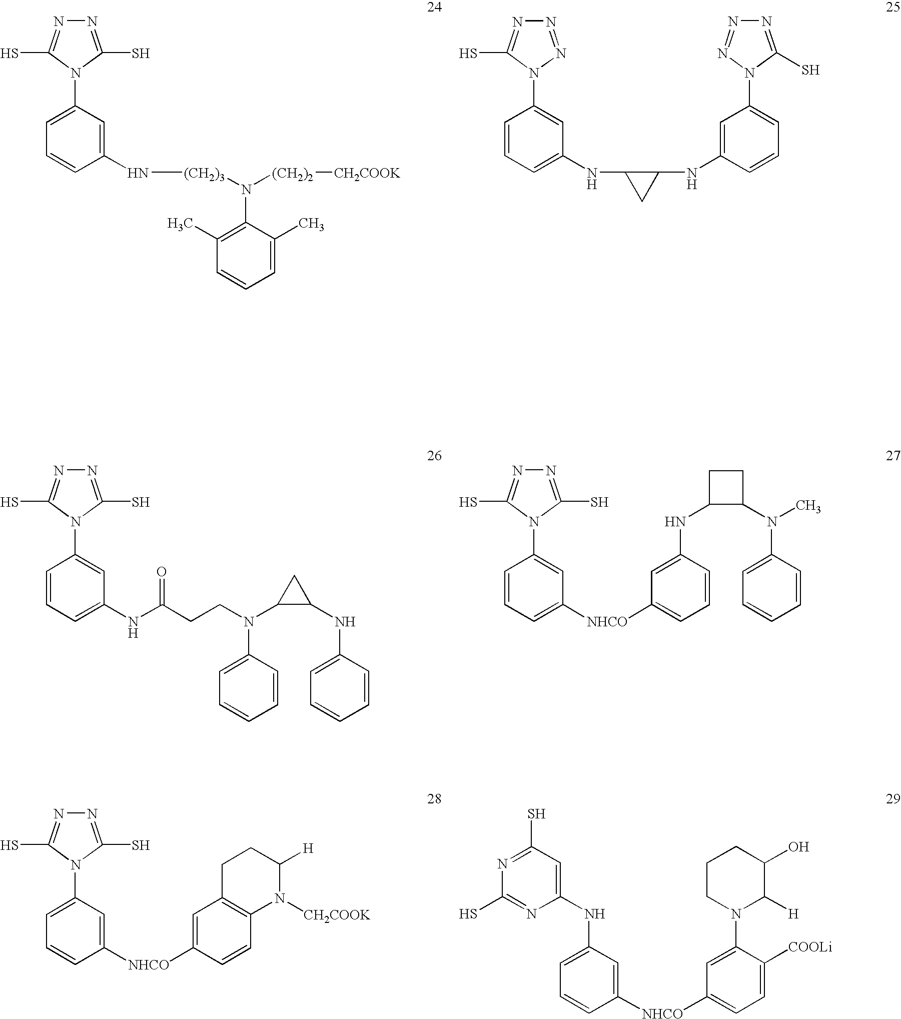

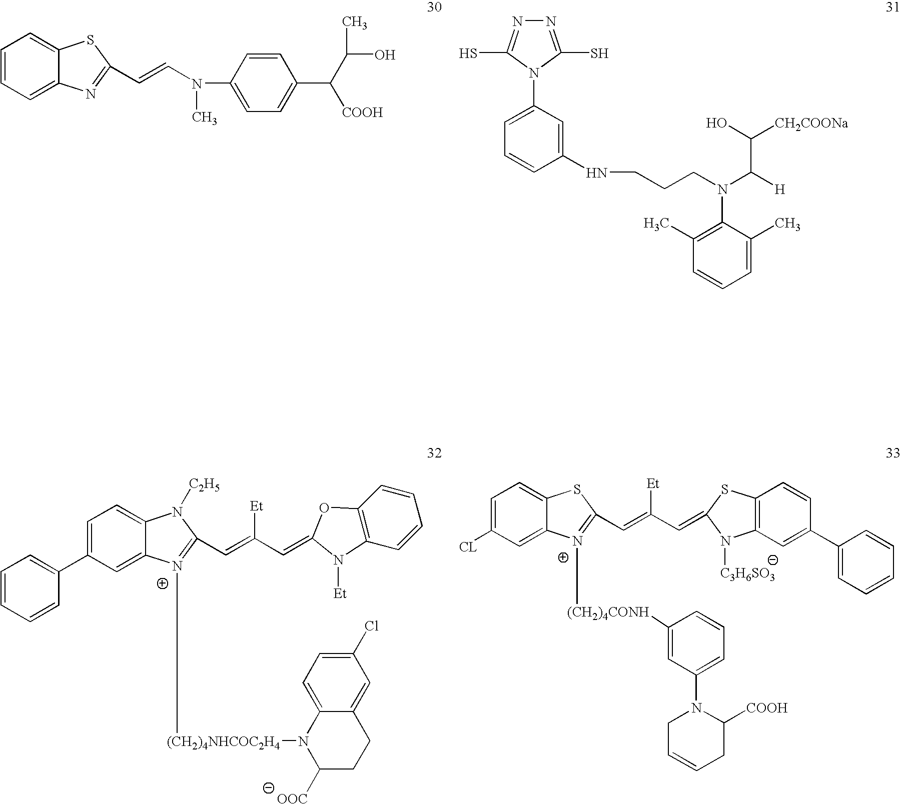

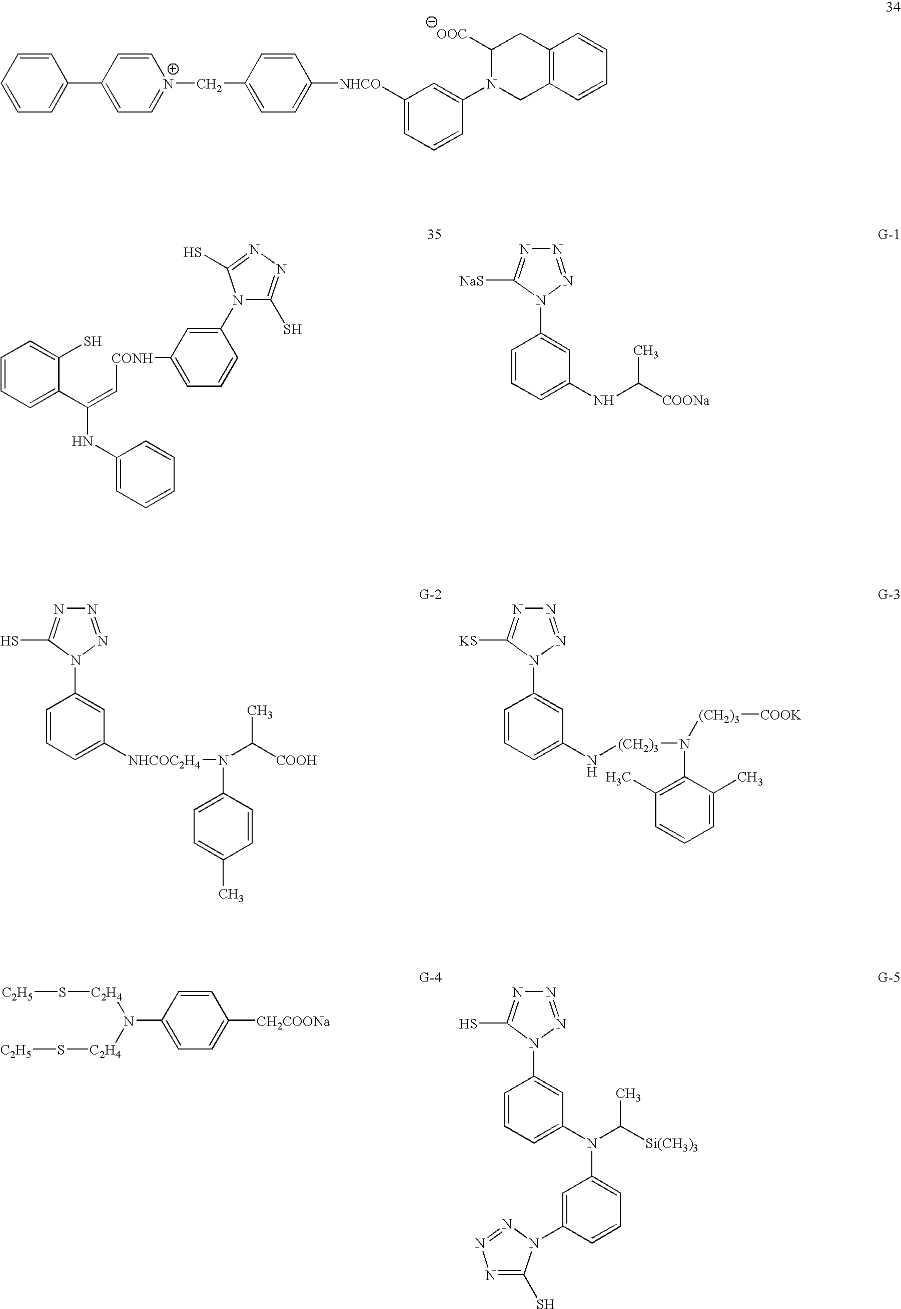

The compounds of Types 1 to 4 used in the invention are the same as compounds described in detail in Japanese Patent Application Nos. 2002-192373, 2002-188537, 2002-188536 and 2001-272137, respectively. The specific examples of the compounds of Types 1 to 4 used in the invention further include compound examples disclosed in the specifications. Synthesis examples of the compounds of Types 1 to 4 used in the invention may be the same as described in the specifications.

Specific examples of the compound represented by general formula (G) further include examples of compound referred to as “one photon two electrons sensitizer” or “deprotonating electron-donating sensitizer” described in JP-A No. 9-211769 (Compound PMT-1 to S-37 in Tables E and F, pages 28 to 32); JP-A No. 9-211774; JP-A No. 11-95355 (Compound INV 1 to 36); JP-W No. 2001-500996 (Compound 1 to 74, 80 to 87, and 92 to 122); U.S. Pat. Nos. 5,747,235 and 5,747,236; EP No. 786692 A1 (Compound INV 1 to 35); EP No. 893732 A1; U.S. Pat. Nos. 6,054,260 and 5,994,051; etc.

The compounds of Types 1 to 5 may be used at any time during preparation of the photosensitive silver halide emulsion and production of the photothermographic material. For example, the compound may be used, in a photosensitive silver halide grains-forming step, in a desalination step, in a chemical sensitization step, before application, etc. The compound may be added in numbers, in these steps. The compound is preferably added, after the photosensitive silver halide grains-forming step and before the desalination step; in the chemical sensitization step (just before the chemical sensitization to immediately after the chemical sensitization); or before the application. The compound is more preferably added, just before the chemical sensitization step to before mixing with the non-photosensitive organic silver salt.

It is preferred that the compound of Types 1 to 5 used in the invention is dissolved in water, a water-soluble solvent such as methanol and ethanol, or a mixed solvent thereof, to be added. In the case where the compound is dissolved in water and solubility of the compound is increased by increasing or decreasing a pH value of the solvent, the pH value may be increased or decreased to dissolve and add the compound.

The compound of Types 1 to 5 used in the invention is preferably added to the image forming layer comprising the photosensitive silver halide and the non-photosensitive organic silver salt. The compound may be added to a surface protective layer, an intermediate layer, as well as the image forming layer comprising the photosensitive silver halide and the non-photosensitive organic silver salt, to be diffused to the image forming layer in the application step. The compound may be added before or after addition of a sensitizing dye. A mol value of the compound per one mol of the silver halide is preferably 1×10⁻⁹ mol to 5×10⁻¹ mol, more preferably 1×10⁻⁸ mol to 5×10⁻² mol, in a layer comprising the photosensitive silver halide emulsion.

10) Compound Having Adsorption Group and Reducing Group

It is preferred that the photothermographic material of the present invention contains the compound having an adsorption group and a reducing group represented by general formula (1). The said compound can be used individually or with various chemical sensitizers described above, to provide an increase of the sensitivity of silver halide.

A-(W)n-B General formula (I)

In general formula (I), A represents a group capable of adsorption to a silver halide (hereafter, it is called an adsorption group) and W represents a divalent connecting group and n represents 0 or 1 and B represents a reducing group.

Next, general formula (I) is explained in more detail.

In general formula (I), the adsorption group represented by A is a group to adsorp directly to a silver halide or a group to promote adsorption to a silver halide. As typical examples, a mercapto group (or the salt thereof), a thione group (—C(═S)—), a nitrogen atom, a heterocyclic ring containing at least one atom selected from a nitrogen atom, a sulfur atom, a selenium atom and a tellurium atom, a sulfide group, a disulfide group, a cationic group, an ethynyl group and the like are described.

The mercapto group as an adsorption group means a mercapto group (and the salt thereof) itself and simultaneously more preferably represents a heterocyclic ring group or an aryl group or an alkyl group substituted by at least one mercapto group (or the salt thereof). Herein, as the heterocyclic ring group, a monocyclic or a condensed aromatic or nonaromatic heterocyclic ring group having at least a 5 to 7 membered ring, e.g., an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group and the like are described. A heterocyclic ring having quarternalized nitrogen atom may also be adopted, wherein a mercapto group as a substituent may dissociate to form a mesoion. As examples of such heterocyclic ring group, an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group and the like are described and among them, a triazolium ring group (e.g., a 1,2,4-triazolium-3-thiolate ring group) is preferable. As an aryl group, a phenyl group or a naphthyl group is described. As an alkyl group, an alkyl group having 1 to 30 straight chain, branched chain or cyclic carbon atoms is described. As a counter ion, whereby a mercapto group forms the salt thereof, a cation such as an alkali metal, an alkali earth metal, a heavy metal and the like (Li⁺, Na⁺, K⁺, Mg²⁺, Ag⁺, Zn²⁺ and the like), an ammonium ion, a heterocyclic ring group having quaternalized nitrogen atom, a phosphonium ion and the like are described. Further, the mercapto group as an adsorption group may become a thione group by a tautomerization. For example, a thioamide group (herein —C(═S)—NH— group) and the group containing the said thioaminde group as a partial structure, namely a chain or a cyclic thioamide, thioureide, thiourethane or dithiocarbanic ester group and the like are described. Herein, as cyclic examples, a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group and the like are described.

The thione group as an adsorption group may also contain a chain or a cyclic thioamide group, a thioureido group, a thiouretane group or a thioester group which can not tautomerize to a mercapto group (having no hydrogen atom on the α-position of a thione group) with containing a mercapto group capable to become a thion group by tautomerization.

The heterocyclic ring group containing at least one atom selected from a nitrogen atom, a sulfur atom, a selenium atom and a tellurium atom represents a nitrogen atom containing heterocyclic ring group having —NH— group, as a partial structure of hetero ring, capable to form a silver iminate (>NAg) or a heterocyclic ring group, having —S— group, —Se— group, —Te— group or ═N— group as a partial structure of hetero ring, and capable to coordinate to a silver ion by a chelate bonding. As the former examples, a benzotriazole group, a triazole group, an indazole group, a pyrazole group, a tetrazole group, a benzimidazole group, a purine group and the like are described. As the latter examples, a thiophene group, a thiazole group, a benzoxazole group, a thiadiazole group, an oxadiazole group, a triazine group, a selenoazole group, a benzoselenazole group, a tellurazole group, a benzotellurazole group and the like are described. The former is preferable.

The sulfide group or disulfide group as an adsorption group contains all groups having “—S—” or “—S—S—” as a partial structure, but the group having “alkyl (or an alkylene)-X-alkyl (or alkylene)”, “aryl (or arylene)-X-alkyl (or alkylene)”, and “aryl (or arylene)-X-aryl (or arylene)” as a partial structure are preferably, wherein X represents “—S— group” or “—S—S— group”. Further, these sulfide groups or disulfide groups may form a cyclic structure. As typical examples of a cyclic structure formation, the group containing a thiorane ring, a 1,3-dithiorane ring, a 1,2-dithiorane ring, a thiane ring, a dithiane ring, a thiomorphorine ring and the like are described. As a sulfide group, the group having “alkyl (or alkylene)-S-alkyl (or alkylene)” as a partial structure and as a disulfide group, a 1,2-dithiorane ring group are particularly preferably described.

The cationic group as an adsorption group means the group containing a quaternalized nitrogen atom, such as an ammonio group or a nitrogen containing heterocyclic ring group containing a quaternalized nitrogen atom. Herein, an ammonio group means a trialkylammonio group, a dialkylarylammonio group, an alkyldiarylammonio group, such as a benzyldimethylammonio group, a trihexylammonio group, a phenyldiethylammonio group and the like are described. As examples of the heterocyclic ring group containing a quaternalized nitrogen atom, a pyridinio group, a quinolinio group, an isoquinolinio group, an imidazolio group and the like are described. A pyridinio group and an imidazolio group are preferable and a pyridinio group is particularly preferable. These nitrogen containing heterocyclic ring groups containing a quaternalized nitrogen atom may have any substituent, but in the case of a pyridinio group and an imidazolio group, an alkyl group, an aryl group, an acylamino group, a chlorine atom, an alkoxycarbonyl group, a carbamoyl group and the like are preferably as a substituent and in a pyridinio group, a phenyl group is particularly preferable as a substituent.

The ethynyl group as an adsorption group means —C≡CH group and the said hydrogen atom may be substituted.

The adsorption group described above may have any substituent. As examples of a substituent, a halogen atom (a fluorine atom, a chlorine atom, a bromine atom or an iodine atom), an alkyl group (a straight chain alkyl group, a branched chain alkyl group, a cyclic alkyl group and a bicyclic alkyl group and an active methine group are contained), an alkenyl group, an alkynyl group, an aryl group, a heterocyclic ring group (irrelevant to a substituting position), an acyl group, an alkoxycarbonyl group, an aryloxycarbonyl group, a heterocyclic oxycarbonyl ring group, a carbamoyl group, a N-hydroxycarbamoyl group, a N-acylcarbamoyl group, a N-sulfonylcarbamoyl group, a N-carbamoylcarbamoyl group, a thiocarbamoyl group, a N-sulfamoylcarbamoyl group, a carbazoyl group, a carboxy group or a salt thereof, an oxalyl group, an oxamoyl group, a cyano group, a carbonimidoyl group, a formyl group, a hydroxy group, an alkoxy group (a group containing an ethyleneoxy group or a propyleneoxy group as repeating unit is contained), an aryloxy group, an oxy group substituted to heterocyclic ring, an acyloxy group, (an alkoxy or an aryloxy)carbonyloxy group, a carbamoyloxy group, a sulfonyloxy group, an amino group, (an alkyl, an aryl or a heterocyclic ring)amino group, an acylamino group, a sulfonamide group, an ureido group, a thioureido group, a N-hydroxyureido group, an imide group, (an alkoxy or aryloxy)carbonylamino group, a sulfamoylamino group, a semicarbazide group, a thiosemicarbazide group, a hydrazino group, an ammonio group, an oxamoylamino group, a N-(alkyl or aryl)sulfonylureido group, a N-acylureido group, a N-acylsulfamoylamino group, a hydroxyamino group, a nitro group, a heterocyclic ring group containing quaternalized nitrogen atom (e.g., a pyridinio group, an imidazolio group, a quinolinio group, an isoquinolinio group), an isocyano group, an imino group, a mercapto group, (an alkyl, an aryl or a heterocyclic ring)thio group, (an alkyl, an aryl or a heterocyclic ring)dithio group, (an alkyl, or an aryl)sulfonyl group, (an alkyl or an aryl)sulfinyl group, a sulfo group and the salt thereof, a sulfamoyl group, a N-acylsulfamoyl group, a N-sulfonylsulfamoyl group and a salt thereof, a phosphino group, a phosphinyl group, a phosphinyloxy group, a phosphinylamino group, a silyl group and the like are described. Herein, the active methine group means a mathine group subsutituted by two electron-withdrawing group, wherein the electron-withdrawing group means an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group and a carbonimidoyl group. Herein, two electron-withdrawing groups may bind each other to form a cyclic structure. The salt means a cation such as from an alkali metal, an alkali earth metal and a heavy metal and an organic cation such as an ammonium ion, a phosphonium ion and the like.

Further, as typical examples of an adsorption group, the compounds described in pages 4 to 7 in the specification of JP-A No.11-95355 are described.

As an adsorption group represented by A in general formula (I), a heterocyclic ring group substituted by a mercapto group (e.g., a 2-mercaptothiadiazole group, a 3-mercapto-1,2,4-triazole group, a 5-mercaptotetrazole group, a 2-mercapto-1,3,4-oxadiazole group, a 2-mercaptobenzothiazole group, a 2-mercaptobenzimidazole group, a 1,5-dimethyl-1,2,4-triazorium-3-thiolate group and the like), a heterocyclic ring group substituted by two mercapto groups (e.g., a 2,4-dimercaptopyrimidine group, a 2,4-dimercatotriazine group, a 3,5-dimercapto-1,2,4-triazole group, a 2,5-dimercapto-1,3-thiazole group and the like) or a nitrogen atom containing heterocyclic ring group having a —NH— group capable to form an imino-silver (>NAg) as a partial structure of heterocyclic ring (e.g., a benzotriazole group, a benzimidazole group, an indazole group and the like) are more preferably and a heterocyclic ring group substituted by two mercapto groups is particularly preferable.

In general formula (I), W represents a divalent connection group. The said connection group may be any divalent connection group, as far as it does not give a bad effect toward a photographic property. For example, a divalent connection group composed of a carbon atom, a hydrogen atom, an oxygen atom a nitrogen atom and a sulfur atom can be used. As typical examples, an alkylene group having 1 to 20 carbon atoms (eg., a methylene group, an ethylene group, a trimethylene group, a tetramethylene group, a hexamethylene group and the like), an arylene group having 6 to 20 carbon atoms (e.g., a phenylene group, a nephthylene group and the like), —CONR₁—, —SO₂NR₂—, —O—, —S—, —NR₃—, —NR₄CO—, —NR₅SO₂—, —NR₆CONR₇—, —COO—, —OCO— and the combination of these connecting groups are described. Herein, R₁, R₂, R₃, R₄, R₅, R₆ and R₇ independently represent a hydrogen atom, an aliphatic group and an aryl group. As preferred aliphatic group represented by R₁, R₂, R₃, R₄, R₅, R₆ and R₇, a straight chain, branched chain or cyclic alkyl group, an alkenyl group, an alkynyl group, an aralkyl group having 1 to 30 carbon atoms, particularly 1 to 20 carbon atoms (e.g., a methyl group, an ethyl group, an isopropyl group, a t-butyl group, a n-octyl group, a n-decyl group, a n-hexadecyl group, a cyclopropyl group, a cyclopentyl group, a cyclohexyl group, an aryl group, a 2-butenyl group, a 3-pentenyl group, a propargyl group, a 3-pentynyl group, a benzyl group and the like) are described. In general formula (I), as an aryl group represented by R₁, R₂, R₃′ R₄, R₅, R₆ and R_{7,} a monocyclic or condensed ring aryl group having 6 to 30 carbon atoms is preferable and that having 6 to 20 carbon atoms is more preferable. For example, a phenyl group and a naphthyl group and the like are described. The above substituent represented by R₁, R₂, R₃, R₄, R₅, R₆ and R_{7,} may have still more any substituent, whereby the substituent defined as similar to the substituent for an adsorption group described above.

In general formula (I), a reducing group represented by B represents the group capable to reduce a silver ion. As the examples, a formyl group, an amino group, a triple bond group such as an acetylene group, a propargyl group and the like, an alkylmercapto group or an arylmercapto group, hydroxylamines, hydroxamic acids, hydroxyureas, hydroxyurethanes, hydroxysemicarbazides, reductones (reductone derivatives are contained), anilines, phenols (chroman-6-ols, 2,3-dihydrobenzofuran-5-ols, aminophenols, sulfonamidophenols and polyphenols such as hydroquinones, catechols, resorcinols, benzenetriols, bisphenols are contained), hydrazines, hydrazides and phenidones can be described.

The hydroxylamines are the compounds represented by general formula (B1), the hydroxamic acids are the compounds represented by general formula (B2), the hydroxyureas are the compounds represented by general formula (B3), the hydroxyuretanes are the compounds represented by general formula (B4), the hydroxysemicarbazides are the compounds represented by general formula (B5), the reductones are the compounds represented by general formula (B6), the anilines are the compounds represented by general formula (B7), the phenols are the compounds represented by general formula (B8), (B9) and (B10), the hydrazines are the compounds represented by general formula (B11), the hydrazides are the compounds represented by general formula (B12) and the phenidones are the compounds represented by general formula (B13).

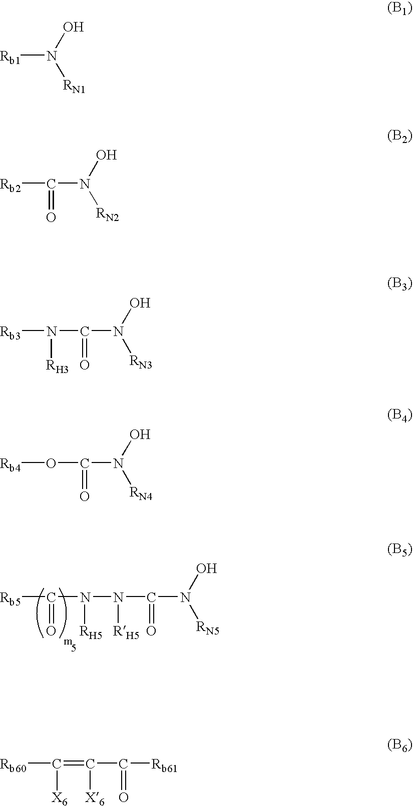

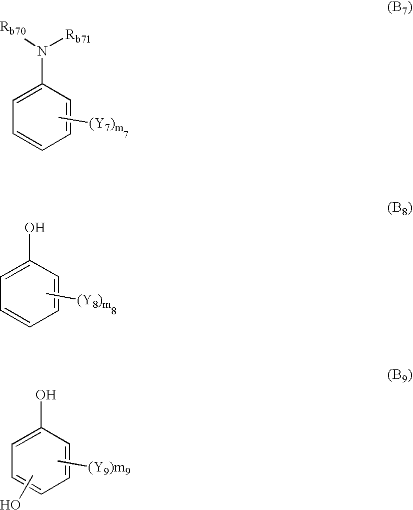

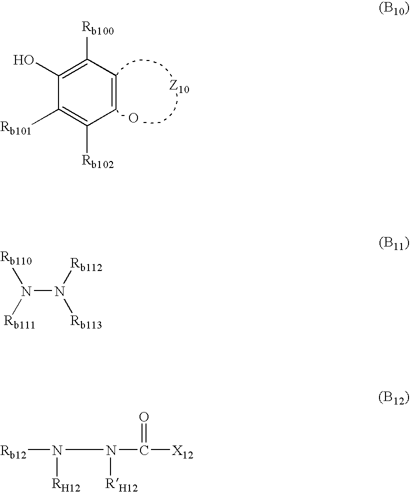

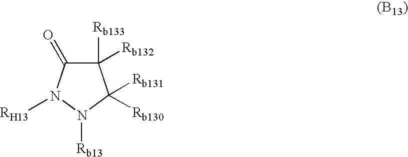

In general formulae (B1) to (B13), R_{b1}, R_{b2}, R_{b3}, R_{b4}, R_{b5}, R_{b70}, R_{b71}, R_{b110}, R_{b111}, R_{b112}, R_{b113}, R_{b12}, R_{b13}, R_{N1}, R_{N2}, R_{N3}, R_{N4}, and R_{N5} represent a hydrogen atom, an alkyl group, an aryl group, and a heterocyclic ring group, and R_{H3}, R_{H5}, R′_{H5}, R_{H12}, R′_{H12}, and R_{H13} represent a hydrogen atom, an alkyl group, an aryl group, an acyl group, an alkylsulfonyl group or an arylsulfonyl group and among them, R_{H3} may still more represents a hydroxy group. R_{b100}, R_{b101}, R′_{b102}, and R_{b130} to R_{b133} represent a hydrogen atom or a substituent. Y₇ and Y₈ represent a substituent except for a hydroxy group and Y₉ represents a substituent and m₅ represents 0 or 1 and m₇ represents an integral number 0 to 5 and m₈ represents an integral number 1 to 5 and m₉ represents an integral number 0 to 4. Y₇, Y₈ and Y₉ may still more represent an aryl group condensed to a benzene ring (e.g., a benzene condensed ring) and further more may have a substituent. Z₁₀ represents a non-metal atomic group capable to form a ring and X12 represents a hydrogen atom, an alkyl group, an aryl group, a heterocyclic ring group, an alkoxy group, an amino group (an alkylamino group, an arylamino group, an amino group substituted to a heterocyclic ring or a cyclic amino group are contained) and a carbamoyl group.

In general formula (B6), X₆ and X′₆ each represents a hydroxy group, an alkoxy group, a mercapto group, an alkylthio group, an amino group (an alkylamino group, an arylamino group, an amino group substituted to a heterocyclic ring group or a cyclic amino group are contained), an acylamino group, a sulfonamide group, an alkoxycarbonylamino group, an ureido group, an acyloxy group, an acylthio group, an alkylaminocarbonyloxy group or an arylaminocarbonyloxy group. R_{b60} and R_{b61} represent an alkyl group, an aryl group, an amino group, an alkoxy group and an aryloxy group and R_{b60} and R_{b61} may bind each other to form a cyclic structure.

In the explanation of each group in above general formula (B1) to (B13), an alkyl group means a straight chain, branched chain or cyclic and a substituted or unsubstituted alkyl group having 1 to 30 carbon atoms and an aryl group means a monocyclic or condensed and a substituted or unsubstituted aromatic alicyclic ring such as a phenyl group and a naphthyl group and a heterocyclic ring group means an aromatic or nonaromatic and a monocyclic or condensed and a substituted or unsubstituted heterocyclic ring group having at least one hetero atom.

And the substituent described in the explanation of each substituent in general formula (B1) to (B13) means the same as the substituent for an adsorption group described above. These substituents may be more substituted by these substituents.

In general formula (B1) to (B5), R_{N1}, R_{N2}, R_{N3}, R_{N4} and R_{N5} are preferably a hydrogen atom or an alkyl group and herein, an alkyl group is preferably a straight, branched or cyclic and a substituted or unsubstituted alkyl group having 1 to 12 carbon atoms and more preferably a straight, branched or cyclic and a substituted or unsubstituted alkyl group having 1 to 6 carbon atoms such as a methyl group, an ethyl group, a propyl group, a benzyl group and the like.

In general formula (B1), R_{b1} is preferably an alkyl group and a heterocyclic ring group and herein, an alkyl group means a straight, branched or cyclic and a substituted or unsubstituted alkyl group and is preferably an alkyl group having 1 to 30 carbon atoms and more preferably an alkyl group having 1 to 8 carbon atoms. A heterocyclic ring group means a 5 or 6 membered monocyclic or condensed ring and an aromatic or nonaromatic heterocyclic ring group and may have a substituent. As a heterocyclic ring group, an aromatic heterocyclic ring group is preferable, for examples, a pyridine ring group, a pyrimidine ring group, a triazine ring group, a thiazole ring group, a benzothiazole ring group, an oxazole ring group, a benzoxazole ring group, an imidazole ring group, a benzimidazole ring group, a pyrazole ring group, an indazole ring group, an indole ring group, a purine ring group, a quinoline ring group, an isoquinoline ring group, a quinazoline ring group and the like are described. Especially, a triazine ring group and a benzothiazole ring group are preferable. The case, wherein an alkyl group or a heterocyclic ring group represented by R_{b1} further has one or two or more of —NH(R_{N1})OH group as its substituent is one of preferred embodiments of the compound represented by general formula (B1).

In general formula (B2), R_{b2} is preferably an alkyl group an aryl group or a heterocyclic ring group and more preferably is an alkyl group or an aryl group. Preferred range of alkyl group is similar to that in the explanation of R_{b1}. As an aryl group, a phenyl group or a naphthyl group is preferable and a phenyl group is particularly preferable and may have a substituent. The case, wherein the group represented by R_{b2} further has one or two or more of —NH(R_{N2})OH group as its substituent is one of preferred embodiments of the compound represented by general formula (B2).

In general formula (B3), R_{b3} is preferably an alkyl group or an aryl group, wherein a preferred range thereof is similar to that in the explanation of R_{b1} and R_{b2}, R_{H3} is preferably a hydrogen atom, an alkyl group or a hydroxy group and more preferably a hydrogen atom. The case, wherein the group represented by R_{b3} further has one or two or more of —NH(R_{N3})CON(R_{N3})OH group as its substituent is one of preferred embodiments of the compound represented by general formula (B3). And R_{b3} and R_{N3} may bind each other to form a cyclic structure (preferably a 5 or 6 membered saturated heterocyclic ring).

In general formula (B4), R_{b4} is preferably an alkyl group, wherein a preferred range thereof is similar to that in the explanation of R_{b1}. The case where the group represented by R_{b4} further has one or two or more of —OCON(R_{N4})OH group as its substituent is one of preferred embodiments of the compound represented by general formula (B4).

In general formula (B5), R_{b5} preferably is an alkyl group or an aryl group and more preferably is an aryl group, wherein a preferred range is similar to that in the explanation of R_{b1} and R_{b2}. R_{H5} and R′_{H5} are preferably a hydrogen atom or an alkyl group and more preferably a hydrogen atom.

In general formula (B6), it is preferred that R_{b60} and R_{b61} bind each other to form a cyclic structure. The cyclic structure formed herein is 5 to 7 membered nonaromatic carbon ring or a heterocyclic ring and may be monocyclic or condensed ring. As typical examples of preferred cyclic structure, a 2-cyclopentene-1-one ring, a 2,5-dihydrofurane-2-one ring, a 3-pyrroline-2-one ring, a 4-pyrazoline-3-one ring, a 2-cyclohexene-1-one ring, a 4-pyrazoline-3-one ring, a 2-cyclohexene-1-one ring, a 5,6-dihydro-2H-pyrane-2-one ring, a 5,6-dihydro-2-pyridone ring, a 1,2-dihydronaphthalene-2-one ring, a cumarin ring (a benzo-α-pyrane-2-one ring), a 2-quinolone ring, a 1,4-dihydronaphthalene-1-one ring, a chromone ring (a benzo-γ-pyrane-4-one ring), a 4-quinolone ring, an indene-1-one ring, a 3-pyrroline-2,4-dione ring, an uracil ring, a thiouracil ring, a dithiouracil ring and the like are described and a 2-cycolopentene-1-one ring, a 2,5-dihydrofurane-2-one ring, 3-pyrroline-2-one ring, a 4-pyrazoline-3-one ring, a 1,2-dihydronaphthalene-2-one ring, a cumarin ring (a benzo-α-pyrane-2-one ring), a 2-quinolone ring, a 1,4-dihydronaphthalene-1-one ring, a chromone ring (a benzo-γ-pyrane-4-one ring), a 4-quinolone ring, an indene-1-one ring, a dithiouracil ring and the like are more preferably and a 2-cycolopentene-1-one ring, a 2,5-dihydrofurane-2-one ring, a 3-pyrroline-2-one ring, an indene-1-one ring and a 4-pyrazoline-3-one ring are still more preferable.

When X₆ and X′₆ represent a cyclic amino group, a cyclic amino group means a nonaromatic nitrogen atom containing heterocyclic ring group bound at a nitrogen atom, e.g., a pyrrolidino group, a pyperidino group, a pyperadino group, a morphorino group, a 1,4-thiazine-4-yl group, a 2,3,5,6-tetrahydro-1,4-thiazine-4-yl group, an indolyl group and the like are included.

As X₆ and X′₆, a hydroxy group, a mercapto group, an amino group (an alkylamino group, an arylamino group or a cyclic amino group are contained), an acylamino group, a sulfonamide group, or an acyloxy group and an acylthio group are preferabley and a hydroxy group, a mercapto group, an amino group, an alkylamino group, a cyclic amino group, a sulfonamide group, an acylamino group or an acyloxy group are more preferable and a hydroxy group, an amino group, an alkylamino group and a cyclic amino group are particularly preferable. Further, it is preferred that at least one of X₆ and X′₆ is a hydroxy group.

In general formula (B7), R_{b70} and R_{b71} preferably are a hydrogen atom, an alkyl group or an aryl group and more preferably an alkyl group. The preferred range of alkyl group is similar to that in the explanation of R_{b1}. R_{b70} and R_{b71} may bind each other to form a cyclic structure (e.g., a pyrrolidine ring, a pyperidine ring, a morphorino ring, a thiomorphorino ring and the like). As the substituent represented by Y₇, an alkyl group (that preferred range is the same as the explanation of R_{b1}), an alkoxy group, an amino group, an acylamino group, a sulfonamide group, an ureido group, an acyl group, an alkoxycarbonyl group, a carbamoyl group, a sulfamoyl group, a chlorine atom, a sulfo group or the salt thereof, a carboxy group or the salt thereof and the like are preferable and m₇ represents preferably 0 to 2.

In general formula (B8), m₈ is preferably 1 to 4 and the plural Y₈ may be same or different. Y₈ in the case, wherein m₈ is 1 or at least one of the plural Y₈ in the case, wherein m₈ is 2 or more, is preferably an amino group (an alkylamino group and an arylamino group are contained), a sulfonamide group or an acylamino group. In the case, wherein m₈ is 2 or more, remaining Y₈ is preferably a sulfonamide group, an acylamino group, an ureido group, an alkyl group, an alkylthio group, an acyl group, an alkoxycarbonyl group a carbamoyl group, a sulfo group or the salt thereof, a carboxy group or the salt thereof, a chlorine atom and the like. Herein, in the case, wherein o′-(or p′-)hydroxyphenylmethyl group (may have more substituents) is substituted at the ortho or para position toward a hydroxy group as the substituent represented by Y₈, these compounds represent a compound group generally called as a bisphenol. The said compound is one of the preferred examples represented by general formula (B8) too. Further, the case, wherein B8 represent a benzene condensed ring and results to represent naphthols for general formula (B8) is very preferable. It is also probable that general formula (B8) represents naphthols, wherein Y₈ is a benzene condensed ring.

In general formula (B8), the substitution position of two hydroxy groups may be each other an ortho position (catechols), a meta position (resorcinols) or a para position (hydroquinones). m₉ is preferably 1 to 2 and the plural Y₉ may be the same or different. As preferred substituents represented by Y₉, a chlorine atom, an acylamino group, an ureido group, a sulfonamide group, an alkyl group, an alkylthio group, an alkoxy group, an acyl group, an alkoxycarbonyl group, a carbamoyl group, a sulfo group or the salt thereof, a carboxy group or the salt thereof, a hydroxy group, an alkylsulfonyl group, an arylsulfonyl group and the like are described. The case where Y₉ represents a benzene condensed ring and results to represent 1,4-naphthohydroquinones for general formula (B9) is also preferable. When general formula (B9) represents catechols, Y₉ is particularly preferably a sulfo group or the salt thereof and a hydroxy group.

In general formula (B10), when R_{b100}, R_{b101} and R_{b102} represent substituents, preferred examples of substituent are similar to that in preferred examples of Y₉. Among them, an alkyl group (particularly a methyl group) is preferable. As preferred examples of a cyclic structure to form Z₁₀, are a chroman ring and a 2,3-dihydrobenzofurane ring are described and these cyclic structures may have a substituent and may form a spiro ring.

In general formula (B11), as preferred examples of R_{b111}, R_{b112} and R_{b113} are an alkyl group, an aryl group or a heterocyclic ring group and their preferred ranges are similar to that in the explanation of R_{b1} and R_{b2}. Among them, an alkyl group is preferable and two alkyl groups in R_{b110} to R_{b113} may bind to form a cyclic structure. Herein, a cyclic structure means 5 to 7 membered nonaromatic heterocyclic ring, e.g., a pyrrolidine ring, a pyperidine ring, a morphorino group, a thiomorphorino group, a hexahydropyridazine ring and the like.

In general formula (B12), R_{b12} preferably is an alkyl group, an aryl group or a heterocyclic ring group and their preferred ranges are similar to that in the explanation of R_{b1} and R_{b2}. X₁₂ preferably is an alkyl group, an aryl group (particularly a phenyl group), a heterocyclic ring group, an alkoxy group, an amino group (an alkylamino group, an arylamino group, an amino group sunstitiuted to a heterocyclic ring or a cyclic amino group are contained), and a carbamoyl group and more preferably is an alkyl group (particularly, an alkyl group having 1 to 8 carbon atoms is preferable), an aryl group (particularly, a phenyl group is preferable), an amino group (an alkylamino group, an arylamino group or a cyclic amino group are contained). R_{H12} and R′_{H12}, preferably are a hydrogen atom or an alkyl group and more preferably is a hydrogen atom.

In general formula (B13), Rb₁₃ preferably is an alkyl group or an aryl group and their preferred ranges are similar to that in the explanation of R_{b1} and R_{b2}. Rb₁₃₀, Rb₁₃₁, Rb₁₃₂ and Rb₁₃₃ preferably are a hydrogen atom, an alkyl group (particularly, 1 to 8 carbon atoms are preferable) and an aryl group (particularly, a phenyl group is preferable). R_{H13} preferably is a hydrogen atom or an acyl group and more preferably is a hydrogen atom.

In general formula (I), a reduction group represented by B preferably is hydroxylamines, hydroxamic acids, hydroxyureas, hydroxysemicarbazides, phenols, hydrazines, hydrazides and phenidones and more preferably is hydroxyureas, hydroxysemicarbazides, phenols, hydrazides and phenidones.

The oxidation potential of a reduction group represented by B in general formula (I), can be measured by using the measuring method described in Akira Fujishima, “DENKIKAGAKU SOKUTEIHO”, pages 150 to 208, GIHODO SHUPPAN and NIHON KAGAKUKAI, “ZIKKEN KAGAKUKOUZA”, 4th ed., vol. 9, pages 282 to 344, MARUZEN. Foe example, the method of rotating disc voltammetry can be used; namely the sample is dissolved in the solution (methanol: pH 6.5 Britton-Robinson buffer=10%:90%(% by volume)) and after bubbling with nitrogen gas during 10 minutes the voltamograph can be measured under the condition of 1000 rotations/minute, the sweep rate 20 mV/second, at 25° C. by using a rotating disc electrode (RDE) made by glassy carbon as a working electrode, a platinum electrode as a counter electrode and a saturated calomel electrode as a reference electrode. The half wave potential (E½) can be calculated by that obtained voltamograph.

When a reduction group represented by B in the present invention is measured by the method described above, an oxidation potential preferably is in the range about −0.3 V or more and about 1.0 V or less and more preferably is in the range about −0.1 V or more and about 0.8 V or less and most preferably is in the range about 0 V or more and about 0.7 V or less.

Most of the reduction group represented by B in the present invention are known in the photographic industry and that examples are described in the following patents. For example, JP-A Nos. 2001-42466, 8-114884, 8-314051, 8-333325, 9-133983, 11-282117, 10-246931, 10-90819, 9-54384, 10-171060 and 7-77783 can be described. And as en example of phenols, the compound described in U.S. Pat. No. 6,054,260 (general formula and the compound described in columns 60 to 63) is described too.

The compound of general formula (I) in the present invention may have the ballasted group or polymer chain in it generally used in the nonmoving photographic additives as a coupler. And as a polymer, for example, the polymer described in JP-A No. 1-100530 can be described.

The compound of general formula (I) in the present invention may be bis or tris type of compound. The molecular weight of the compound represented by general formula (I) in the present invention is preferably 100 to 10000 and more preferably 120 to 1000 and particularly preferably 150 to 500.

The examples of the compound represented by general formula (I) in the present invention are shown below, but the present invention is not limited in these.

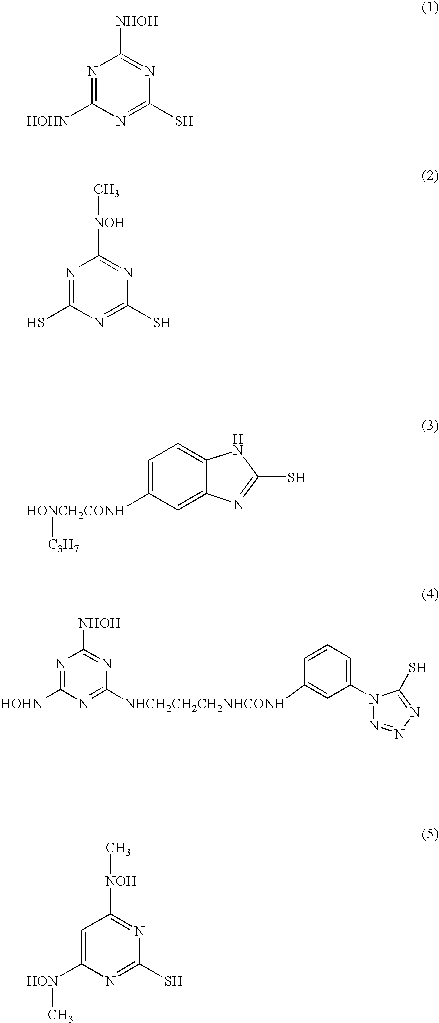

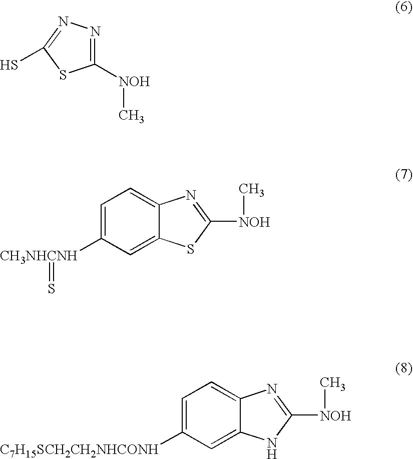

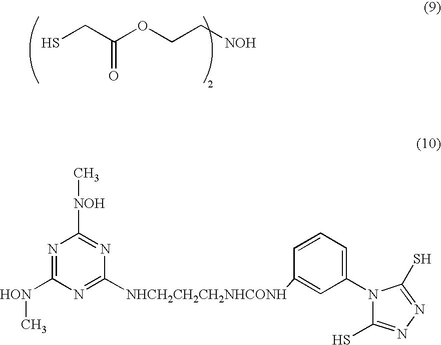

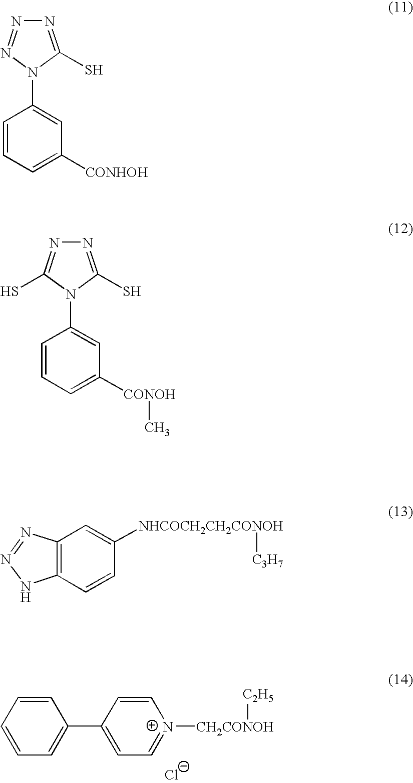

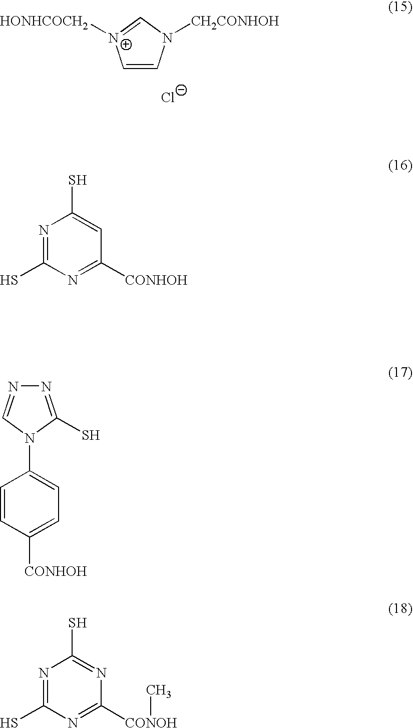

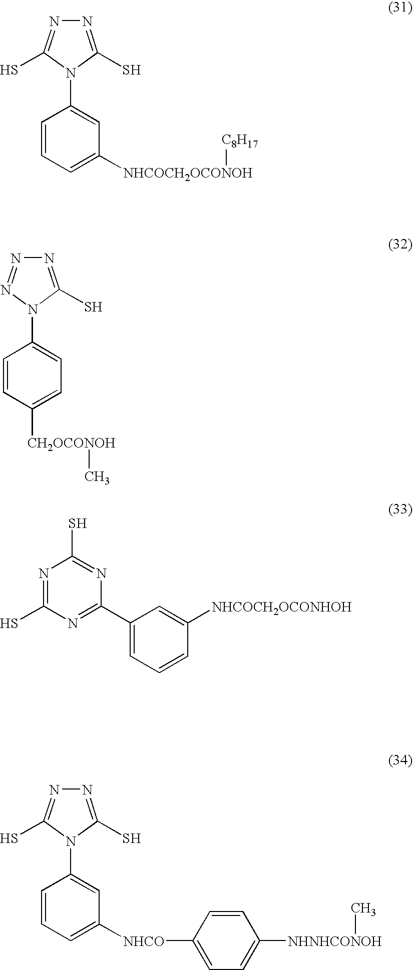

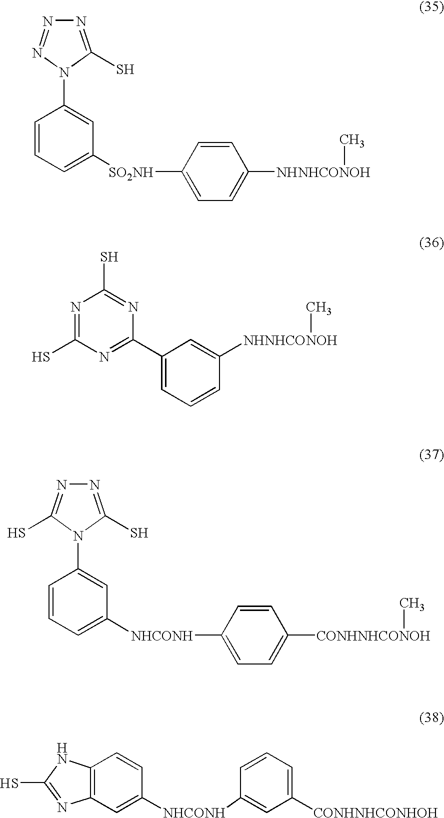

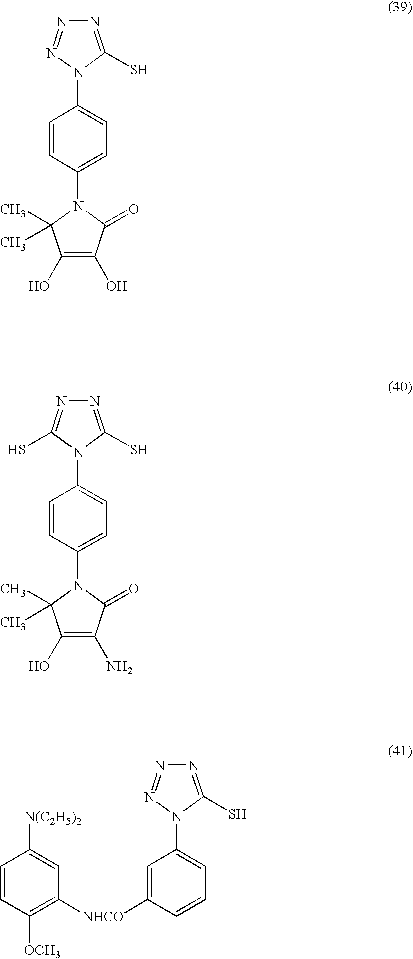

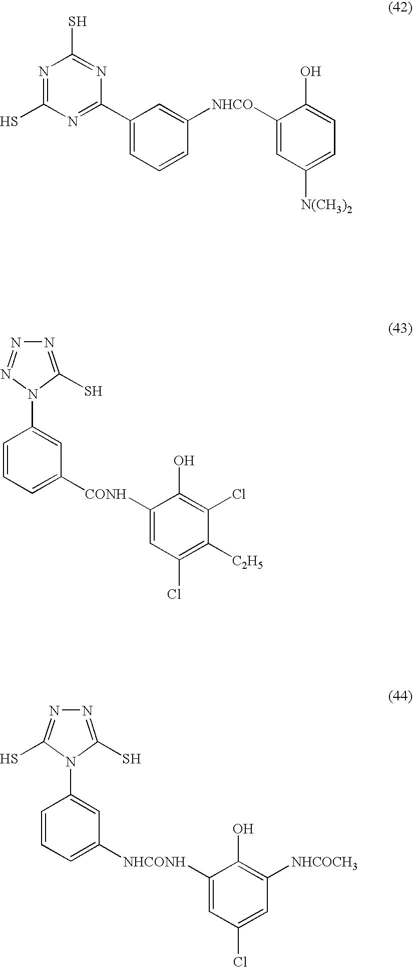

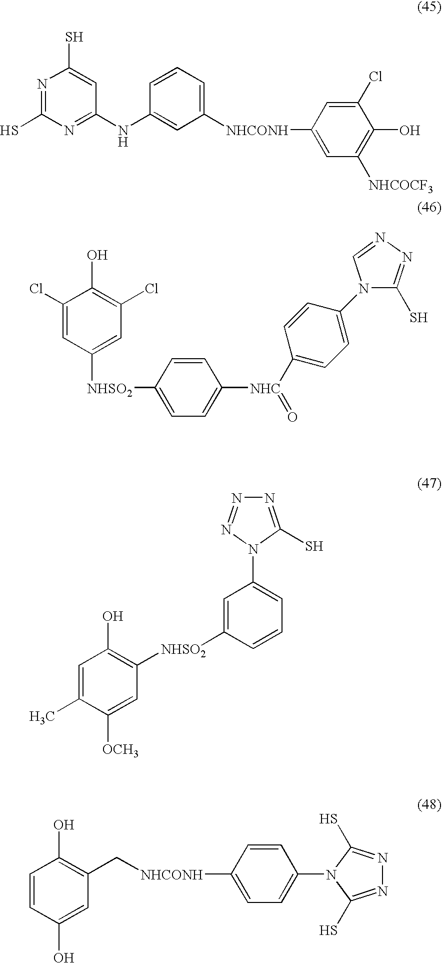

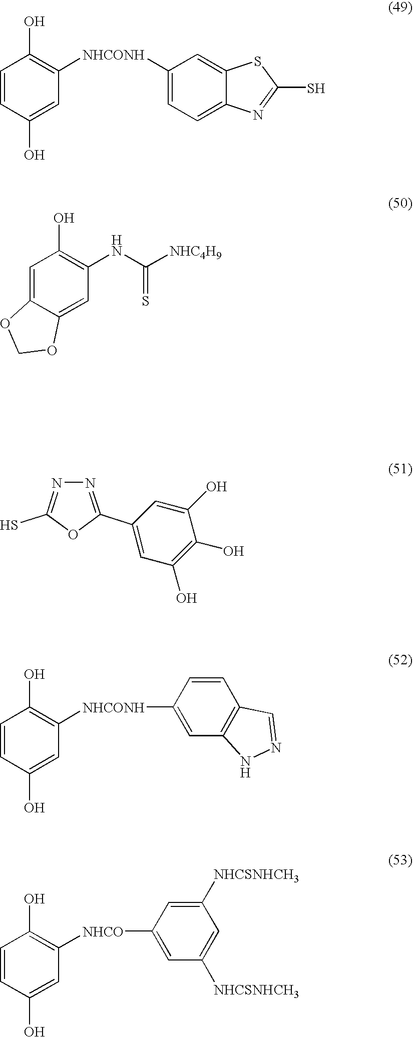

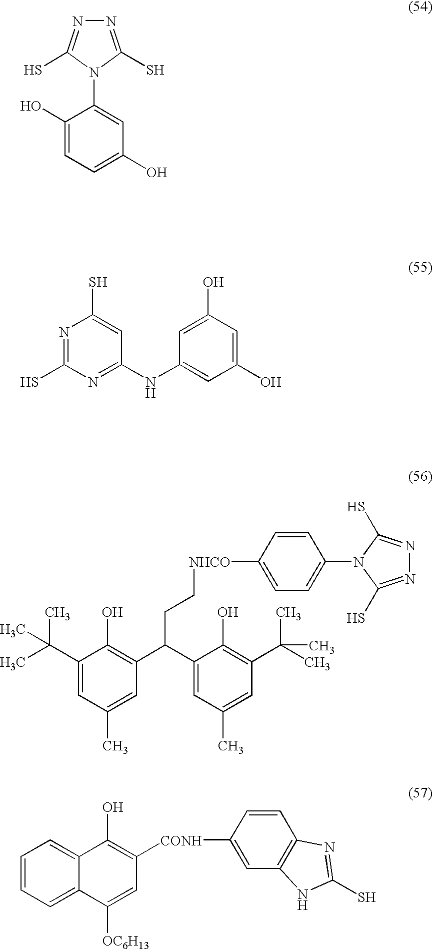

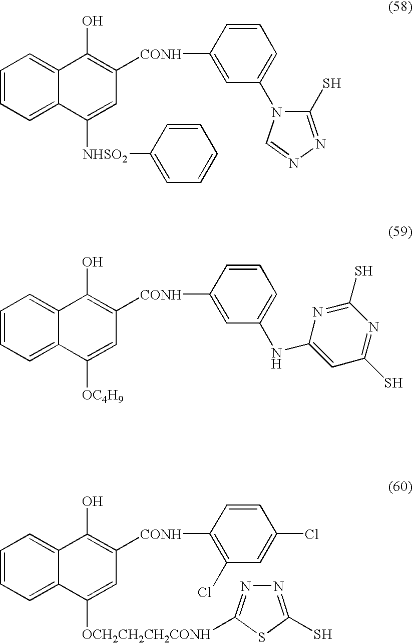

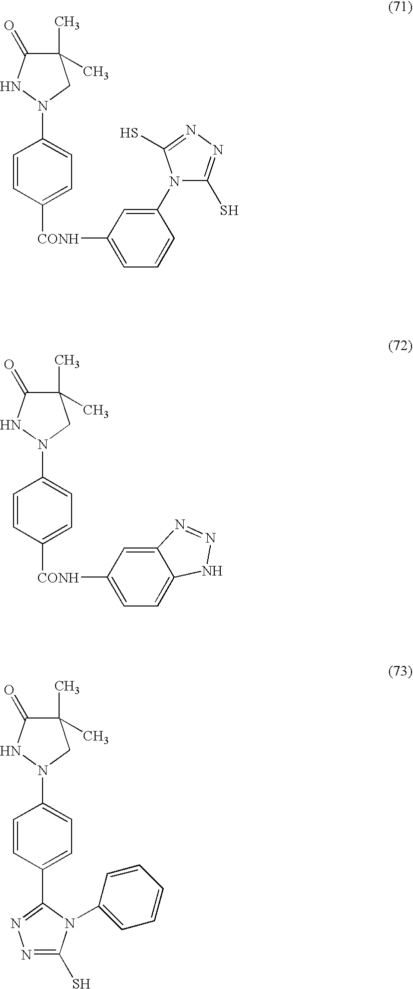

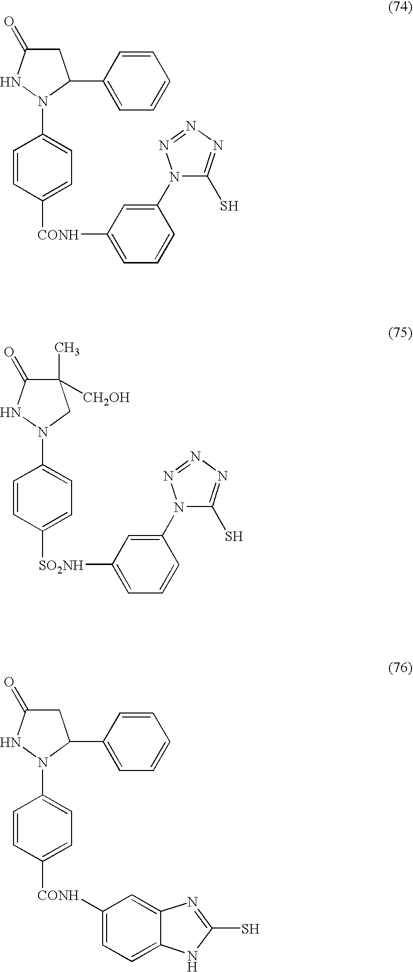

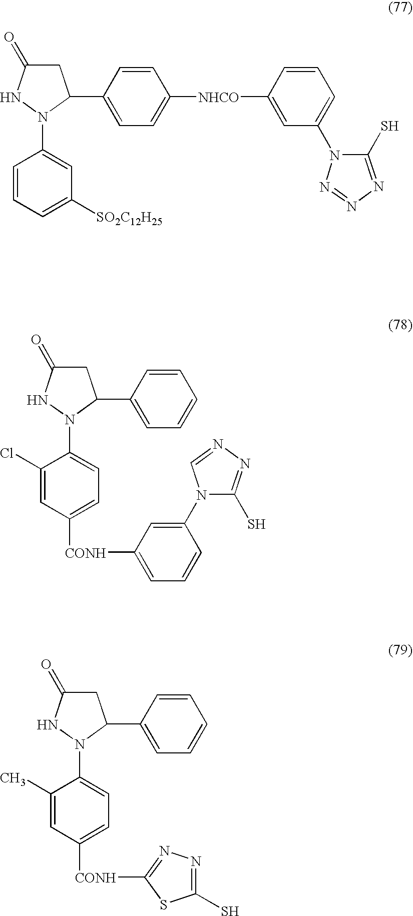

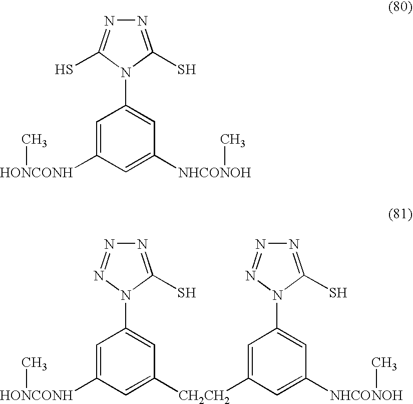

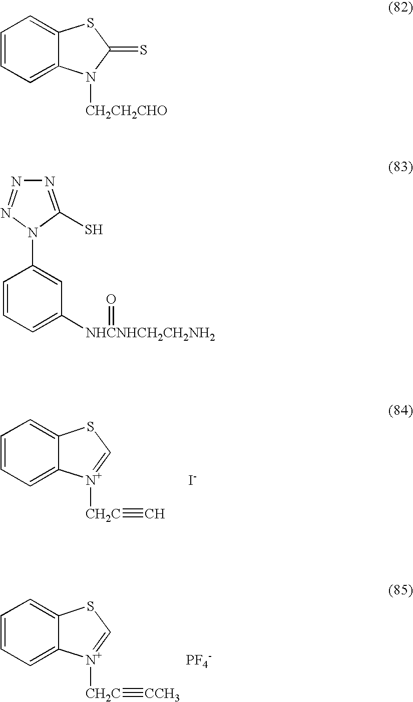

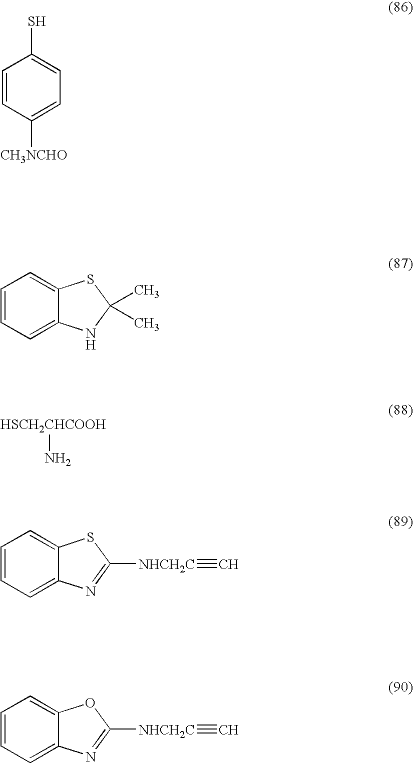

These compounds can be easily synthesized by the known method.

The compound of general formula (I) in the present invention can be used independently as only one compound, but it is preferred to use two compounds or more in combination. When two or more types of compounds are used in combination, those may be added to the same layer or the different layers, whereby an addition methods may be different each other.

The compound represented by general formula (I) in the present invention preferably is added to a image forming layer and more preferably is to be added at an emulsion making process. In the case, wherein these compounds are added at an emulsion making process, these compounds may be added at any step in the process. For example, the silver halide grain forming step, a step before starting of salt washing-out step, the salt washing-out step, the step before chemical ripening, the chemical ripening step, the step before prepraring a final emulsion and the like are described. Also, the addition can be performed in the plural divided steps in the process. It is preferred to be added in an image forming layer, but also to be diffused at a coating from a protective layer or an interlayer adjacent to the image forming layer, wherein these compounds are added in the protective layer or the interlayer in combination with their addtion to the image forming layer.

The preferred addition amount is largely depend on the addition method or the type of compound described above, but generally 1×10⁻⁶ mol to 1 mol per one mol of photosensitive silver halide and preferably 1×10⁻⁵ mol to 5×10⁻¹ mol and more preferably 1×10⁻⁴ mol to 1×10¹ mol.

The compound represented by general formula (I) in the present invention can be added by dissolving in water or water-soluble solvent such as methanol, ethanol and the like or a mixed solution thereof. At this time, pH may be arranged suitably by an acid or an alkaline and a surfactant can be coexisted. Further, these compounds may be added by dissolving in an organic solvent having high boiling point as an emulsion dispersion and also may be added as a solid dispersion.

11) Sensitizing Dye

As the sensitizing dye applicable in the invention, those capable of spectrally sensitizing silver halide grains in a desired wavelength region upon adsorption to silver halide grains having spectral sensitivity suitable to spectral characteristic of an exposure light source can be selected advantageously. In the present invention, photothermographic materials are preferably spectrally sensitized by spectral sensitizers having maximum sensitivity in a wavelength from 600 nm to 900 nm or from 300 nm to 500 nm. The sensitizing dyes and the addition method are disclosed, for example, JP-A No. 11-65021 (paragraph Nos. 0103 to 0109), as a compound represented by general formula (II) in JP-A No. 10-186572, dyes represented by general formula (I) in JP-A No. 11-119374 (paragraph No. 0106), dyes described in U.S. Pat. Nos. 5,510,236 and 3,871,887 (Example 5), dyes disclosed in JP-A Nos. 2-96131 and 59-48753, as well as in page 19, line 38 to page 20, line 35 of EP-A No. 0803764A1, and in JP-A Nos. 2001-272747, 2001-290238 and 2002-23306. The sensitizing dyes described above may be used alone or two or more of them may be used in combination.

In the invention, the sensitizing dye may be added at any amount according to the property of photosensitivity and fogging, but it is preferably added from 1×10⁻⁶ mol to 1 mol, and more preferably, from 1×10⁻⁴ mol to 1×10⁻¹ mol per one mol of silver in each case.

The photothermographic material of the invention may also contain super sensitizers in order to improve spectral sensitizing effect. The super sensitizers usable in the invention can include those compounds described in EP-A No. 587,338, U.S. Pat. Nos. 3,877,943 and 4,873,184 and JP-A Nos. 5-341432, 11-109547, and 10-111543.

12) Combined use of a Plurality of Silver Halides

The photosensitive silver halide emulsion in the photosensitive material used in the invention may be used alone, or two or more kinds of them (for example, those of different average particle sizes, different halogen compositions, different crystal habits and of different conditions for chemical sensitization) may be used together. Gradation can be controlled by using a plural kinds of photosensitive silver halides of different sensitivity. The relevant techniques can include those described, for example, in JP-A Nos. 57-119341, 53-106125, 47-3929, 48-55730, 46-5187, 50-73627, and 57-150841. It is preferred to provide a sensitivity difference of 0.2 or more in terms of log E between each of the emulsions.

13) Mixing Silver Halide and Organic Silver Salt

The photosensitive silver halide in the invention is particularly preferably formed under the absence of the non-photosensitive organic silver salt and then mixed in the process for preparing the organic silver salt. This is because a sufficient sensitivity can not sometimes be attained by the method of forming the silver halide by adding a halogenating agent to the organic silver salt.

The method of mixing the silver halide and the organic silver salt can include a method of mixing a separately prepared photosensitive silver halide and an organic silver salt by a high speed stirrer, ball mill, sand mill, colloid mill, vibration mill, or homogenizer, or a method of mixing a photosensitive silver halide completed for preparation at any timing in the preparation of an organic silver salt and preparing the organic silver salt. The effect of the invention can be obtained preferably by any of the methods described above.

14) Mixing Silver Halide into Coating Solution

In the invention, the time of adding silver halide to the coating solution for the image forming layer is preferably in the range from 180 minutes before to just prior to the coating, more preferably, 60 minutes before to 10 seconds before coating. But there is no restriction for mixing method and mixing condition as far as the effect of the invention appears sufficient. As an embodiment of a mixing method, there is a method of mixing in the tank controlling the average residence time to be desired. The average residence time herein is calculated from addition flux and the amount of solution transferred to the coater. And another embodiment of mixing method is a method using a static mixer, which is described in 8th edition of “Ekitai kongou gijutu” by N. Harnby and M. F. Edwards, translated by Kouji Takahashi (Nikkankougyou shinbunsya, 1989).

1-2. Non-Photosensitive Organic Silver Salt

The organic silver salt particle according to the invention is relatively stable to light but serves as to supply silver ions and forms silver images when heated to 80° C. or higher under the presence of an exposed photosensitive silver halide and a reducing agent. The organic silver salt may be any organic material containing a source capable of reducing silver ions. Such non-photosensitive organic silver salt is disclosed, for example, in JP-A Nos. 10-62899 (paragraph Nos. 0048 to 0049), 10-94074. EP-A No. 0803764A1 (page 18, line 24 to page 19, line 37), EP-A No. 962812A1, JP-A Nos. 11-349591, 2000-7683, and 2000-72711, and the like. A silver salt of organic acid, particularly, a silver salt of long chained fatty acid carboxylic acid (having 10 to 30 carbon atoms, preferably, 15 to 28 carbon atoms) is preferable. Preferred examples of the silver salt of the organic acid can include, for example, silver lignocerate, silver behenate, silver arachidinic acid, silver stearate, silver oleate, silver laurate, silver capronate, silver myristate, silver palmitate, silver erucic acid and mixtures thereof. Among the organic silver salts, it is preferred to use an organic silver salt with the silver behenate content of 30 mol % or more, more preferably, 50 mol % or more, further preferably, 85 mol % or more, most preferably, 95 mol % or more. And, it is preferred to use an organic silver salt with the silver erucic acid content of 2 mol % or less, more preferably, 1 mol % or less, further preferably, 0.1 mol % or less.

It is preferred that the content of the silver stearate is 1 mol % or less. When the content of the the silver stearate is 1 mol % or less, a silver salt of organic acid having low Dmin, high photosensitivity and excellent image stability can be obtained. The content of the silver stearate above-mentioned, is preferably 0.5 mol % or less, more preferably, the silver stearate is not substantially contained.

Further, in the case the silver salt of organic acid includes silver arachidinic acid, it is preferred that the content of the silver arachidinic acid is 6 mol % or less in order to obtain a silver salt of organic acid having low Dmin and excellent image stability. The content of the silver arachidinic acid is more preferably 3 mol % or less.

There is no particular restriction on the shape of the organic silver salt usable in the invention and it may needle-like, bar-like, plate-like or flaky shape.

In the invention, a flaky shaped organic silver salt is preferred. In the present specification, the flaky shaped organic silver salt is defined as described below. When an organic acid silver salt is observed under an electron microscope, calculation is made while approximating the shape of an organic acid silver salt particle to a rectangular body and assuming each side of the rectangular body as a, b, c from the shorter side (c may be identical with b) and determining x based on numerical values a, b for the shorter side as below.

x=b/a

As described above, x is determined for the particles by the number of about 200 and those capable of satisfying the relation: x (average)≧1.5 as an average value x is defined as a flaky shape. The relation is preferably: 30≧=x (average)≧=1.5 and, more preferably, 15≧x (average)>1.5. By the way, needle-like is expressed as 1≦x (average)<1.5.

In the flaky shaped particle, a can be regarded as a thickness of a plate particle having a main plate with b and c being as the sides. a in average is preferably 0.01 μm to 0.3 μm and, more preferably, 0.1 μm to 0.23 μm. c/b in average preferably 1 to 9, more preferably, 1 to 6, further preferably, 1 to 4 and, particularly preferably, 1 to 3, and most preferably, 1 to 2.

By controlling the sphere equivalent diameter to 0.05 μm to 1 μm, it causes less agglomeration in the photosensitive material and image stability is improved. The spherical equivalent diameter is preferably 0.1 μm to 1 μm. In the invention, the sphere equivalent diameter can be measured by a method of photographing a sample directly by using an electron microscope and then image-processing negative images.

In the flaky shaped particle, the sphere equivalent diameter of the particle/a is defined as an aspect ratio. The aspect ratio of the flaky particle is, preferably, 1.1 to 30 and, more preferably, 1.1 to 15 with a view point of causing less agglomeration in the photosensitive material and improving the image stability.

As the particle size distribution of the organic silver salt, mono-dispersion is preferred. In the mono-dispersion, the percentage for the value obtained by dividing the standard deviation for the length of minor axis and major axis by the minor axis and the major axis respectively is, preferably, 100% or less, more preferably, 80% or less and, further preferably, 50% or less. The shape of the organic silver salt can be measured by determining dispersion of an organic silver salt as transmission type electron microscopic images. Another method of measuring the mono-dispersion is a method of determining of the standard deviation of the volume weighted mean diameter of the organic silver salt in which the percentage for the value defined by the volume weight mean diameter (variation coefficient), is preferably, 100% or less, more preferably, 80% or less and, further preferably, 50% or less. The mono-dispersion can be determined from particle size (volume weighted mean diameter) obtained, for example, by a measuring method of irradiating a laser beam to an organic silver salt dispersed in a liquid, and determining a self correlation function of the fluctuation of scattered light to the change of time.

Known methods and the like can be applied to manufacturing methods and dispersing methods of an organic acid silver used in the invention. Description of the manufacturing and dispersing methods can be found as reference in the following patent related documents, for example, JP-A No. 10-62899; EP Nos. 0803763 A1, 0962812 A1; JP-A Nos. 11-349591, 2000-7683, 2000-72711, 2001-163827, 2001-163889, 2001-163890, 11-203413, 2001-188313, 2001-83652, 2002-6442, 2002-6442 and the like.

When a photosensitive silver salt is present together during dispersion of the organic silver salt, fog increases and the sensitivity becomes remarkably lower, so that it is more preferred that the photosensitive silver salt is not substantially contained during dispersion. In the invention, the amount of the photosensitive silver salt to be disposed in the aqueous dispersion, is preferably, 1 mol % or less, more preferably, 0.1 mol % or less per one mol of the organic acid silver salt in the solution and, further preferably, positive addition of the photosensitive silver salt is not conducted.

In the invention, it is possible to prepare a photosensitive material by mixing an organic silver salt aqueous dispersion and a photosensitive silver salt aqueous dispersion together. Mixing of two or more kinds of organic silver salt aqueous dispersions and two or more kinds of photosensitive silver salt aqueous dispersions together is a method preferably used for adjusting a photographic characteristic.

While an organic silver salt in the invention can be used in a desired coating amount, a total amount of silver including silver halide is preferably in the range of from 0.1 g/m² to 5 g/m² in terms of Ag and more preferably in the range of from 0.3 g/m² to 3 g/m² in terms of Ag. An amount of an organic silver salt is particularly preferably in the range of from 0.5 g/m² to 2.0 g/m² in terms of Ag. It is preferable that an amount of total silver preferably is 1.8 g/m² or less, more preferably 1.6 g/m² or less to improve the image stability. It is capable to obtain sufficient image density even with such lower silver coverage with proviso using a reducing agent distinguished in the present invention.

1-3. Reducing Agent

The photothermographic material of the invention contains a reducing agent for the organic silver salt. The reducing agent may be any substance (preferably, organic substance) capable of reducing silver ions into metallic silver. Examples of the reducing agent are described in JP-A No. 11-65021 (column Nos. 0043 to 0045) and EP-A 0803764 (p.7, line 34 to p. 18, line 12).

In the invention, the compound represented by the following general formula (R) is preferred.

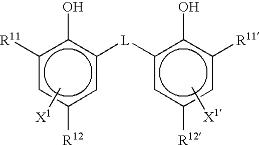

In general formula (R), R¹¹ and R^{11′} each independently represent an alkyl group having 1 to 20 carbon atoms. R¹² and R^{12′} each independently represent a hydrogen atom or a group capable of substituting for a hydrogen atom on a benzene ring. L represents a —S— group or a —CHR¹³— group. R¹³ represents a hydrogen atom or an alkyl group having 1 to 20 carbon atoms. X1 and X1¹ each independently represents a hydrogen atom or a group capable of substituting for a hydrogen atom on a benzene ring.

Each of the substituents is to be described specifically.

1) R¹¹ and R^{11′}

R¹¹ and R^{11′} each independently represent a substituted or unsubstituted alkyl group having 1 to 20 carbon atoms. The substituent for the alkyl group has no particular restriction and can include, preferably, aryl group, hydroxy group, alkoxy group, aryloxy group, alkylthio group, arylthio group, acylamino group, sulfoneamide group, sulfonyl group, phosphoryl group, acyl group, carbamoyl group, ester group, and halogen atom.

2) R¹² and R^{12′}, X1 and X1¹

R¹² and R^{12′} each independently represent a hydrogen atom or a group capable of substituting for a hydorgen atom on a benzene ring.

X1 and X1¹ each independently represent a hydrogen atom or a group capable of substituting for a hydorgen atom on a benzene ring. Each of the groups capable of substituting for a hydrogen atom on the benzene ring can include, preferably, alkyl group, aryl group, halogen atom, alkoxy group, and acylamino group.

3) L

L represents a —S— group or a —CHR¹³— group. R¹³ represents a hydrogen atom or an alkyl group having 1 to 20 carbon atoms in which the alkyl group may have a substituent.

Specific examples of the non-substituted alkyl group for R¹³ can include, for example, methyl group, ethyl group, propyl group, butyl group, heptyl group, undecyl group, isopropyl group, 1-ethylpentyl group, and 2,4,4-trimethylpentyl group.

Examples of the substituent for the alkyl group can include, like substituent R¹¹, a halogen atom, an alkoxy group, alkylthio group, aryloxy group, arylthio group, acylamino group, sulfoneamide group, sulfonyl group, phosphoryl group, oxycarbonyl group, carbamoyl group, and sulfamoyl group.

4) Preferred Substituents

R¹¹ and R^{11′} are, preferably, a secondary or tertiary alkyl group having 3 to 15 carbon atoms and can include, specifically, isopropyl group, isobutyl group, t-butyl group, t-amyl group, t-octyl group, cyclohexyl group, cyclopentyl group, 1-methylcyclohexyl group, and 1-methylcyclopropyl group. R¹¹ and R^{11′} each represents, more preferably, tertiary alkyl group having 4 to 12 carbon atoms and, among them, t-butyl group, t-amyl group, 1-methylcyclohexyl group are further preferred, t-butyl group being most preferred.

R¹² and R^{12′} are, preferably, alkyl groups having 1 to 20 carbon atoms and can include, specifically, methyl group, ethyl group, propyl group, butyl group, isopropyl group, t-butyl group, t-amyl group, cyclohexyl group, 1-methylcyclohexyl group, benzyl group, methoxymethyl group and methoxyethyl group. More preferred are methyl group, ethyl group, propyl group, isopropyl group, and t-butyl group.

X1 and X1¹ are, preferably, a hydrogen atom, halogen atom, or alkyl group, and more preferably, hydrogen atom.

L is preferably a group —CHR¹³—.

R¹³ is, preferably, a hydrogen atom or an alkyl group having 1 to 15 carbon atoms. The alkyl group is preferably methyl group, ethyl group, propyl group, isopropyl group and 2,4,4-trimethylpentyl group. Particularly preferred R¹³ is a hydrogen atom, methyl group, propyl group or isopropyl group.

In a case where R¹³ is a hydrogen atom, R¹² and R^{12′} each represents, preferably, an alkyl group having 2 to 5 carbon atoms, ethyl group and propyl group being more preferred and ethyl group being most preferred.

In a case where R¹³ is a primary or secondary alkyl group having 1 to 8 carbon atom, R¹² and R^{12′} each represents preferably methyl group. As the primary or secondary alkyl group of 1 to 8 carbon atoms for R¹³, methyl group, ethyl group, propyl group and isopropyl group are more preferred, and methyl group, ethyl group, and propyl group are further preferred.

In a case where each of R¹¹, R^{11′} and R¹², R^{12′} is methyl group, R¹³ is preferably a secondary alkyl group. In this case, the secondary alkyl group for R¹³ is preferably isopropyl group, isobutyl group and 1-ethylpentyl group, with isopropyl group being more preferred.

The reducing agent described above show various different thermo-developing performance depending on the combination of R¹¹, R^{11′} and R¹², R^{12′}, as well as R¹³. Since the thermal developing performances can be controlled by using two or more kinds of reducing agents at various mixing ratios, it is preferred to use two or more kinds of reducing agents in combination depending on the purpose.

Specific examples of the compounds represented by general formula (R) according to the invention are shown below but the invention is not restricted to them.

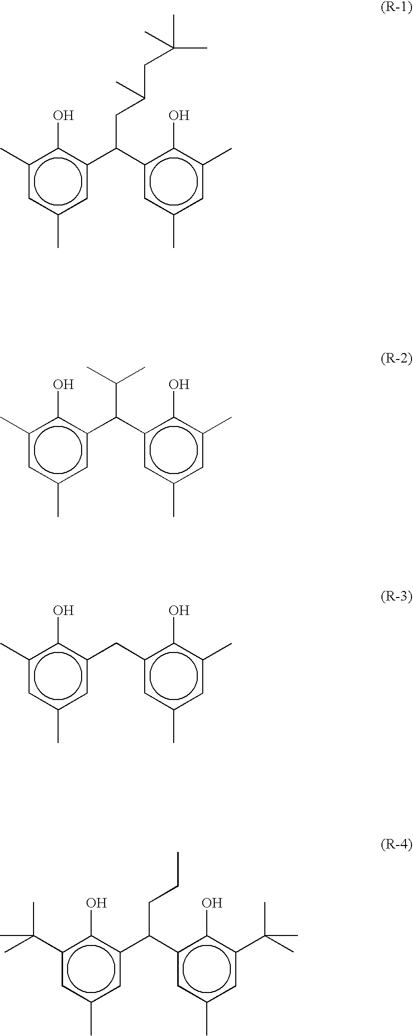

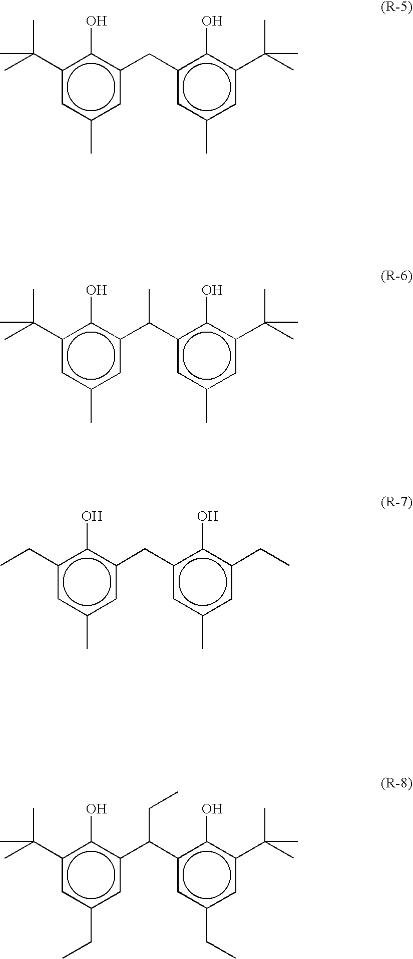

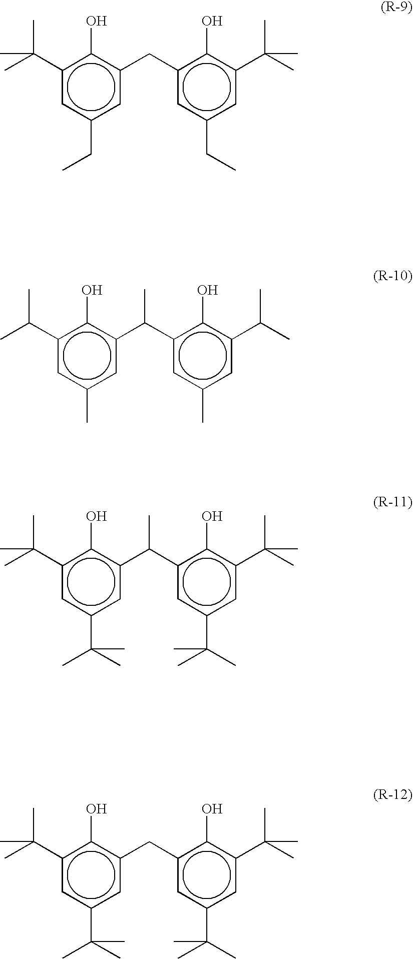

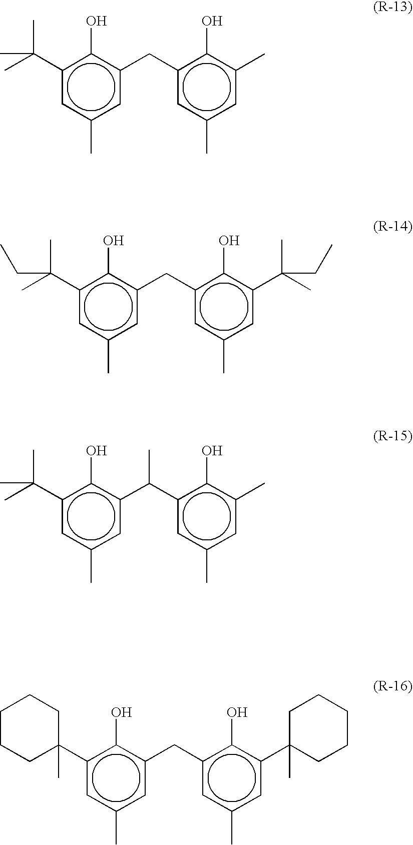

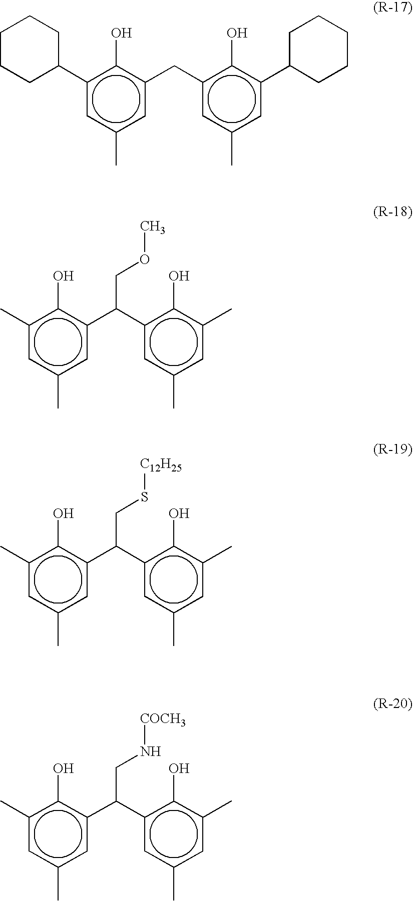

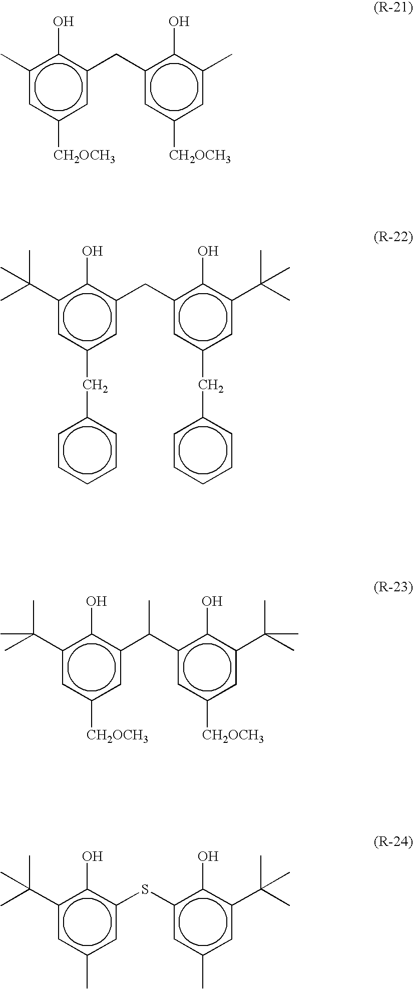

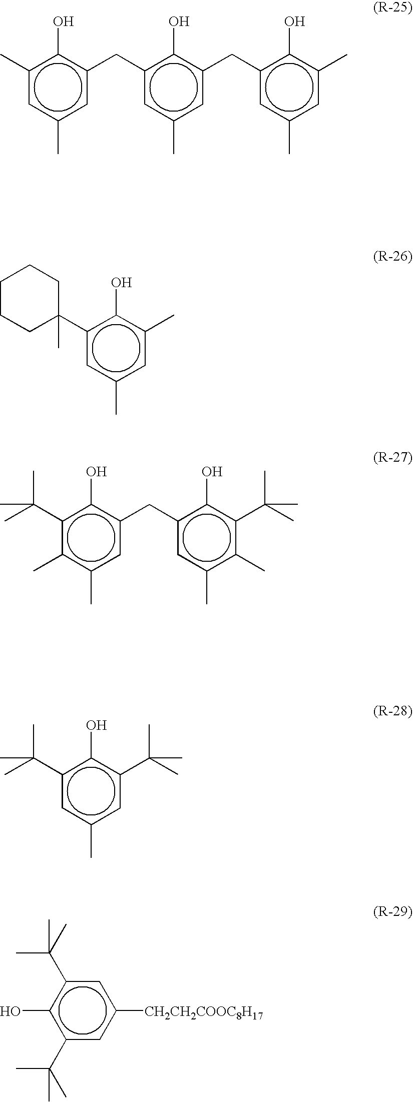

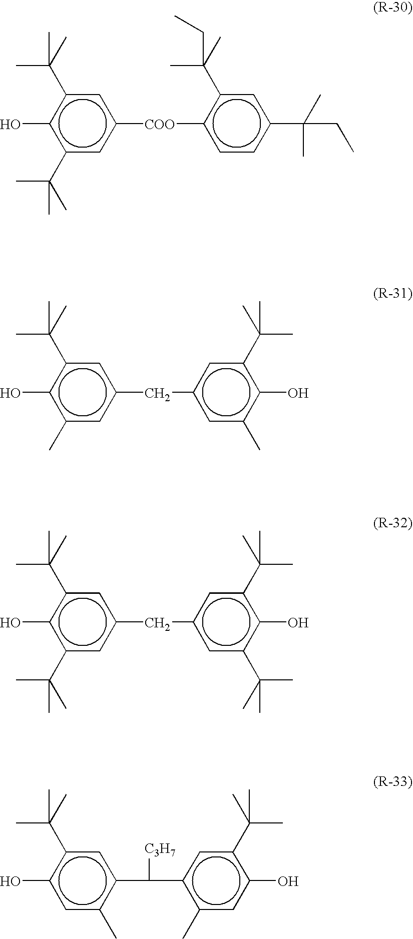

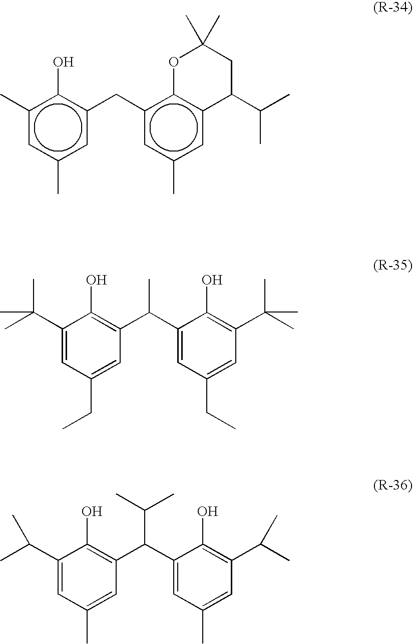

In the invention, the addition amount of the reducing agent is, preferably, 0.01 g/m² to 5.0 g/m², more preferably, 0.1 g/m² to 3.0 g/m², more preferably, 0.2 g/m² to 1.5 g/m², most preferably, 0.3 g/m² to 1.0 g/m². It is, preferably, contained by 5 mol % to 50 mol %, further preferably, 8 mol % to 30 mol %, and particularly preferably 10 mol % to 20 mol % per one mol of silver in the image forming layer.

Although the present reducing agent(s) can be added to an image forming layer containing organic silver salts and photosensitive silver halide or the layers adjacent thereto, it is preferable to add them to the image forming layer.

In the invention, the reducing agent may be incorporated into photosensitive material by being added into the coating solution, such as in the form of a solution, an emulsion dispersion, a solid particle dispersion, and the like.

As a well known emulsion dispersion method, there can be mentioned a method comprising dissolving the reducing agent in an auxiliary solvent such as oil, for instance, dibutyl phthalate, tricresyl phosphate, glyceryl triacetate, diethyl phthalate, and the like, as well as ethyl acetate, cyclohexanone, and the like; from which an emulsion dispersion is mechanically produced.

As solid particle dispersion method, there can be mentioned a method comprising dispersing the powder of the reducing agent in a proper medium such as water, by means of ball mill, colloid mill, vibrating ball mill, sand mill, jet mill, roller mill, or ultrasonics, thereby obtaining solid dispersion. The dispersion method by means of sand mill is preferably used. In this case, there can also be used a protective colloid (such as polyvinyl alcohol), or a surfactant (for instance, an anionic surfactant such as sodium triisopropylnaphthalenesulfonate (a mixture of compounds having the isopropyl groups in different substitution sites)). Preferably, a preservative (for instance, sodium benzoisothiazolinone salt) is added in the water dispersion.

In the invention, furthermore, the reducing agent is preferably used as solid dispersion, and is added in the form of fine particles having average particle size from 0.01 μm to 10 μm, and more preferably, from 0.05 μm to 5 μm and, further preferably, from 0.1 μm to 1 μm. In the invention, other solid dispersions are preferably used with this particle size range.

1-4. Development Accelerator

It is preferably to contain the development accelerator in the present photothermographic material.

In the present invention, it is more preferred to use as a development accelerator, hydrazine compounds represented by general formula (D) described in the specification of JP-A No. 2002-156727, and phenolic or naphtholic compounds represented by general formula (2) described in the specification of JP-A No. 2001-264929.

Particularly preferred development accelerators of the invention are compounds represented by the following general formulae (A-1) and (A-2).

Q₁-NHNH-Q₂ General formula (A-1)

(in which Q₁ represents an aromatic group or heterocyclic group coupling at a carbon atom to —NHNH-Q₂ and Q₂ represents a carbamoyl group, acyl group, alkoxycarbonyl group, aryloxycarbonyl group, sulfonyl group or sulfamoyl group).

In general formula (A-1), the aromatic group or heterocyclic group represented by Q₁ is, preferably, 5 to 7 membered unsaturated rings. Preferred examples are benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, and thiophene ring. Condensed rings in which the rings described above are condensed to each other are also preferred.

The rings described above may have substituents and in a case where they have two or more substituent groups, the substituents may be identical or different with each other. Examples of the substituents can include halogen atom, alkyl group, aryl group, carboamide group, alkylsulfoneamide group, arylsulfonamide group, alkoxy group, aryloxy group, alkylthio group, arylthio group, carbamoyl group, sulfamoyl group, cyano group, alkylsulfonyl group, arylsulfonyl group, alkoxycarbonyl group, aryloxycarbonyl group and acyl group. In a case where the substituents are groups capable of substitution, they may have further substituents and examples of preferred substituents can include halogen atom, alkyl group, aryl group, carbonamide group, alkylsulfoneamide group, arylsulfoneamide group, alkoxy group, aryloxy group, alkylthio group, arylthio group, acyl group, alkoxycarbonyl group, aryloxycarbonyl group, carbamoyl group, cyano group, sulfamoyl group, alkylsulfonyl group, arylsulfonyl group and acyloxy group.

The carbamoyl group represented by Q₂ is a carbamoyl group preferably having 1 to 50 carbon atoms and, more preferably, of 6 to 40 carbon atoms, for example, not-substituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbaoyl, N-3-pyridylcarbamoyl and N-benzylcarbamoyl.

The acyl group represented by Q₂ is an acyl group, preferably, having 1 to 50 carbon atoms and, more preferably, 6 to 40 carbon atoms and can include, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. Alkoxycarbonyl group represented by Q₂ is an alkoxycarbonyl group, preferably, of 2 to 50 carbon atom and, more preferably, of 6 to 40 carbon atoms and can include, for example, methoxycarbonyl, ethoxycarbonyl, isobutyloxycarbonyl, cyclehexyloxycarbonyl, dodecyloxycarbonyl and benzyloxycarbonyl.

The aryloxy carbonyl group represented by Q₂ is an aryloxycarbonyl group, preferably, having 7 to 50 carbon atoms and, more preferably, of 7 to 40 carbon atoms and can include, for example, phenoxycarbonyl, 4-octyloxyphenoxycarbonyl, 2-hydroxymethylphenoxycarbonyl, and 4-dodecyloxyphenoxycarbonyl. The sulfonyl group represented by Q₂ is a sulfonyl group, preferably, of 1 to 50 carbon atoms and, more preferably, of 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, and 4-dodecyloxyphenyl sulfonyl.

The sulfamoyl group represented by Q₂ is sulfamoyl group, preferably, having 0 to 50 carbon atoms, more preferably, 6 to 40 carbon atoms and can include, for example, not-substituted sulfamoyl, N-ethylsulfamoyl group, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. The group represented by Q₂ may further have a group mentioned as the example of the substituent of 5 to 7-membered unsaturated ring represented by Q₁ at the position capable of substitution. In a case where the group has two or more substituents, such substituents may be identical or different with each other.

Then, preferred range for the compounds represented by formula (A-1) is to be described. 5 to 6 membered unsaturated ring is preferred for Q₁, and benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, isooxazole ring and a ring in which the ring described above is condensed with a benzene ring or unsaturated hetero ring are further preferred. Further, Q₂ is preferably a carbamoyl group and, particularly, a carbamoyl group having hydrogen atom on the nitrogen atom is particularly preferred.

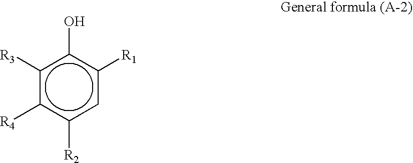

In general formula (A-2), R₁ represents an alkyl group, acyl group, acylamino group, sulfoneamide group, alkoxycarbonyl group, and carbamoyl group. R₂ represents a hydrogen atom, halogen atom, alkyl group, alkoxy group, aryloxy group, alkylthio group, arylthio group, acyloxy group and carbonate ester group. R₃, R₄ each represents a group capable of substituting for a hydrpgen atom on a benzene ring which is mentioned as the example of the substituent for general formula (A-1). R₃ and R₄ may join to each other to form a condensed ring.

R₁ is, preferably, an alkyl group having 1 to 20 carbon atoms (for example, methyl group, ethyl group, isopropyl group, butyl group, tert-octyl group, or cyclohexyl group), acylamino group (for example, acetylamino group, benzoylamino group, methylureido group, or 4-cyanophenylureido group), carbamoyl group (for example, n-butylcarbamoyl group, N,N-diethylcarbamoyl group, phenylcarbamoyl group, 2-chlorophenylcarbamoyl group, or 2,4-dichlorophenylcarbamoyl group), acylamino group (including ureido group or urethane group) being more preferred. R₂ is, preferably, a halogen atom (more preferably, chlorine atom, bromine atom), alkoxy group (for example, methoxy group, butoxy group, n-hexyloxy group, n-decyloxy group, cyclohexyloxy group or benzyloxy group), and aryloxy group (phenoxy group or naphthoxy group).

R₃ is, preferably a hydrogen atom, halogen atom or an alkyl group having 1 to 20 carbon atoms, the halogen atom being most preferred. R₄ is preferably a hydrogen atom, alkyl group or an acylamino group, with the alkyl group or the acylamino group being more preferred. Examples of the preferred substituent thereof are identical with those for R¹. In a case where R₄ is an acylamino group, R₄ may preferably be joined with R₃ to form a carbostyryl ring.

In a case where R₃ and R₄ in general formula (A-2) are joined to each other to form a condensed ring, a naphthalene ring is particularly preferred as the condensed ring. The same substituent as the example of the substituent referred to for general formula (A-1) may be joined to the naphthalene ring. In a case where general formula (A-2) is a naphtholic compound, R₁, is, preferably, a carbamoyl group. Among them, benzoyl group is particularly preferred. R₂ is, preferably, an alkoxy group or aryloxy group and, particularly, preferably an alkoxy group.

Preferred specific examples for the development accelerator of the invention are to be described below. The invention is not restricted to them.

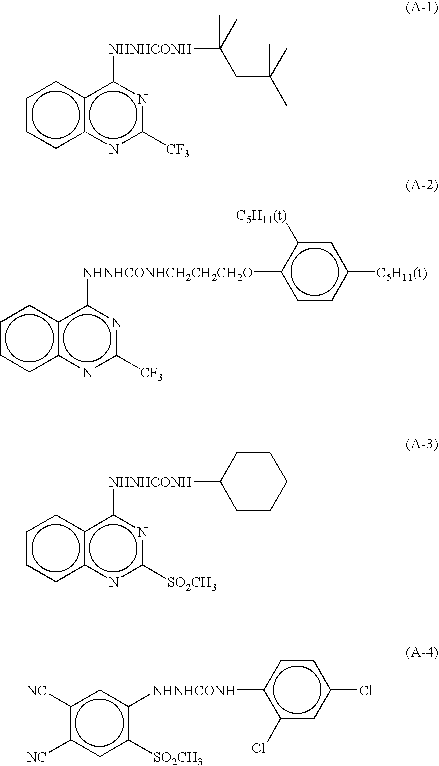

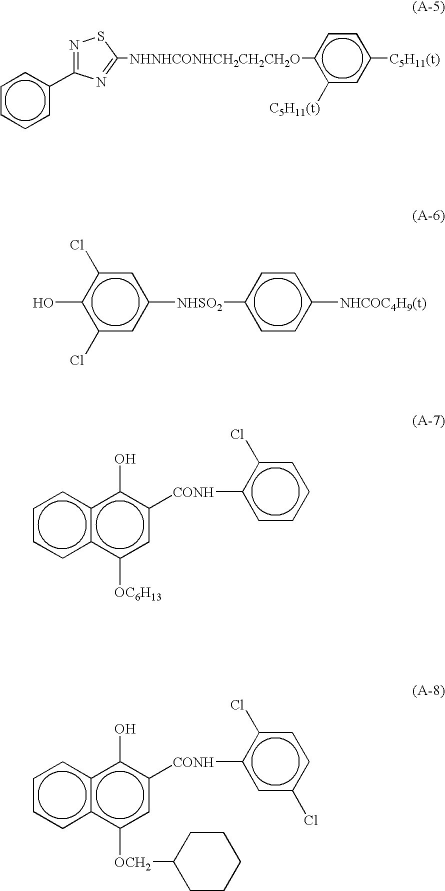

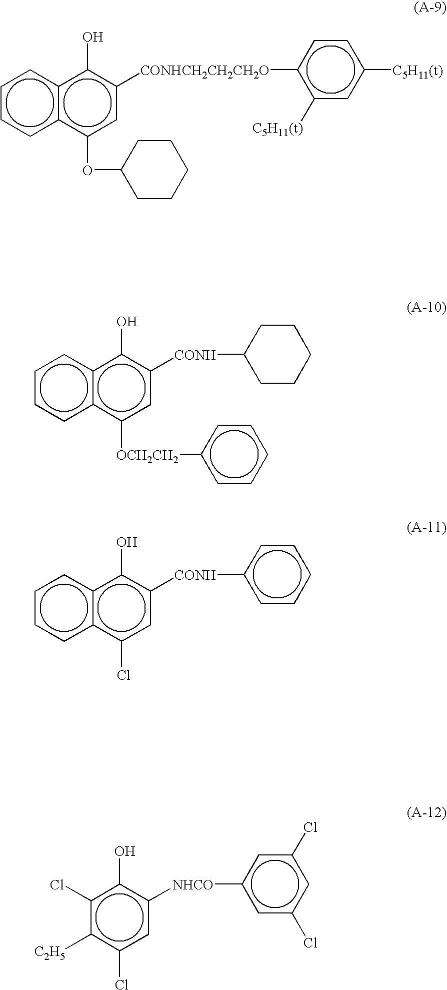

The development accelerator described above is used within a range from 0.1 mol % to 20 mol %, preferably, within a range from 0.5 mol % to 10 mol % and, more preferably, within a range from 1 mol % to 5 mol % with respect to the reducing agent. The introduction method to the photothermographic material can include, the same method as those for the reducing agent and, it is particularly preferred to add as a solid dispersion or an emulsion dispersion. In a case of adding as an emulsion dispersion, it is preferred to add as an emulsion dispersion dispersed by using a high boiling solvent which is solid at a normal temperature and an auxiliary solvent at a low boiling point, or to add as a so-called oilless emulsion dispersion not using the high boiling solvent.

Preferable development accelerators are also sulfoneamide phenolic compounds represented by general formula (A) described in the specification of JP-A No. 2000-267222, and specification of JP-A No. 2000-330234, hindered phenolic compound represented by general formula (II) described in JP-A No. 2001-92075, hydrazine series compounds represented by general formula (I) described in the specification of JP-A No. 10-62895 and the specification of JP-A No. 11-15116, represented by general formula (D) of JP-A No. 2002-156727 and represented by general formula (1) described in the specification of Japanese Patent Application No. 2001-074278, and phenolic or naphthalic compounds represented by general formula (2) described in the specification of JP-A No. 2001-264929 are used preferably as the development accelerator and they are added preferably.

1-5. Hydrogen Bonding Compound

In the invention, it is preferred to use in combination, a non-reducing compound having a group capable of reacting with an aromatic hydroxyl group (—OH) of the reducing agent group, and that is also capable of forming a hydrogen bond therewith.

As a group forming a hydrogen bond with a hydroxyl groups, there can be mentioned a phosphoryl group, a sulfoxido group, a sulfonyl group, a carbonyl group, an amido group, an ester group, an urethane group, an ureido group, a tertiary amino group, a nitrogen-containing aromatic group, and the like. Particularly preferred among them is phosphoryl group, sulfoxido group, amido group (not having >N—H moiety but being blocked in the form of >N—Rₐ (where, Rₐ represents a substituent other than H)), urethane group (not having >N—H moiety but being blocked in the form of >N—Rₐ (where, Rₐ represents a substituent other than H)), and ureido group (not having >N—H moiety but being blocked in the form of >N—Rₐ (where, Rₐ represents a substituent other than H)).

In the invention, particularly preferred as the hydrogen-bonding compound is the compound expressed by general formula (D) shown below.

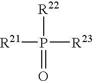

In general formula (D), R²¹ to R²³ each independently represent an alkyl group, an aryl group, an alkoxy group, an aryloxy group, an amino group, or a heterocyclic group, which may be substituted or not substituted.

In the case R²¹ to R² contain a substituent, examples of the substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, a phosphoryl group, and the like, in which preferred as the substituents are an alkyl group or an aryl group, e.g., methyl group, ethyl group, isopropyl group, t-butyl group, t-octyl group, phenyl group, a 4-alkoxyphenyl group, a 4-acyloxyphenyl group, and the like.

Specific examples of an alkyl group expressed by R²¹ to R²³ include methyl group, ethyl group, butyl group, octyl group, dodecyl group, isopropyl group, t-butyl group, t-amyl group, t-octyl group, cyclohexyl group, 1-methylcyclohexyl group, benzyl group, phenetyl group, 2-phenoxypropyl group, and the like.

As aryl groups, there can be mentioned phenyl group, cresyl group, xylyl group, naphthyl group, 4-t-butylphenyl group, 4-t-octylphenyl group, 4-anisidyl group, 3,5-dichlorophenyl group, and the like.

As alkoxyl groups, there can be mentioned methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, benzyloxy group, and the like.

As aryloxy groups, there can be mentioned phenoxy group, cresyloxy group, isopropylphenoxy group, 4-t-butylphenoxy group, naphthoxy group, biphenyloxy group, and the like.

As amino groups, there can be mentioned are dimethylamino group, diethylamino group, dibutylamino group, dioctylamino group, N-methyl-N-hexylamino group, dicyclohexylamino group, diphenylamino group, N-methyl-N-phenylamino, and the like.

Preferred as R²¹ to R²³ are an alkyl group, an aryl group, an alkoxy group, and an aryloxy group. Concerning the effect of the invention, it is preferred that at least one or more of R²¹ to R²³ are an alkyl group or an aryl group, and more preferably, two or more of them are an alkyl group or an aryl group. From the viewpoint of low cost availability, it is preferred that R to R² are of the same group.

Specific examples of hydrogen bonding compounds represented by general formula (D) of the invention and others are shown below, but it should be understood that the invention is not limited thereto.

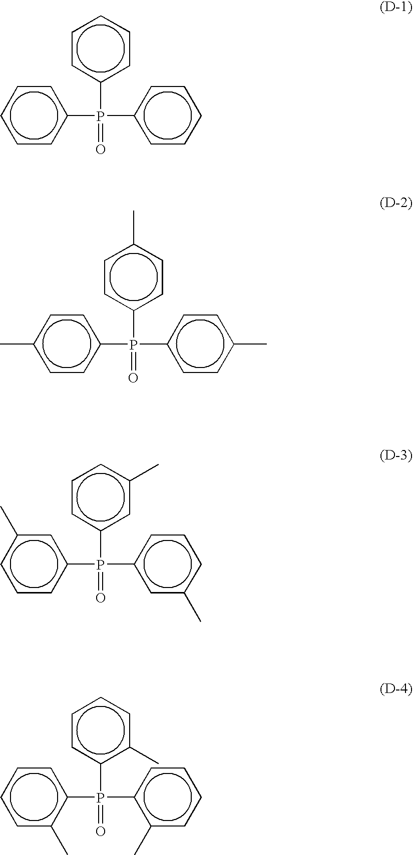

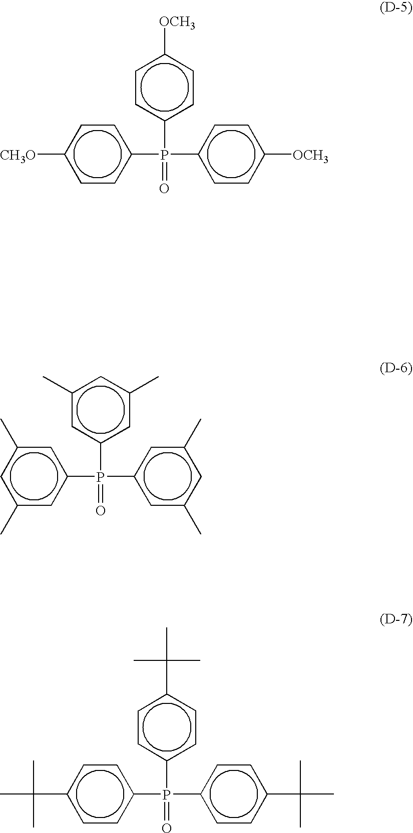

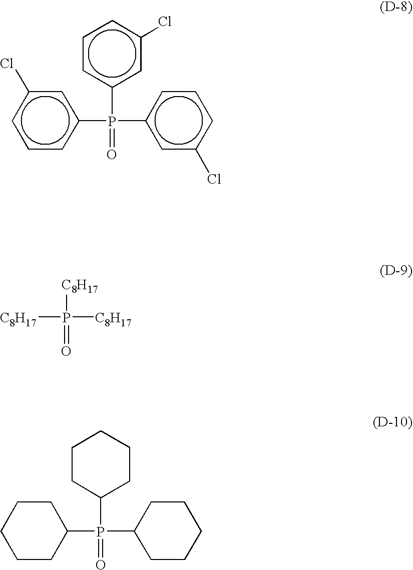

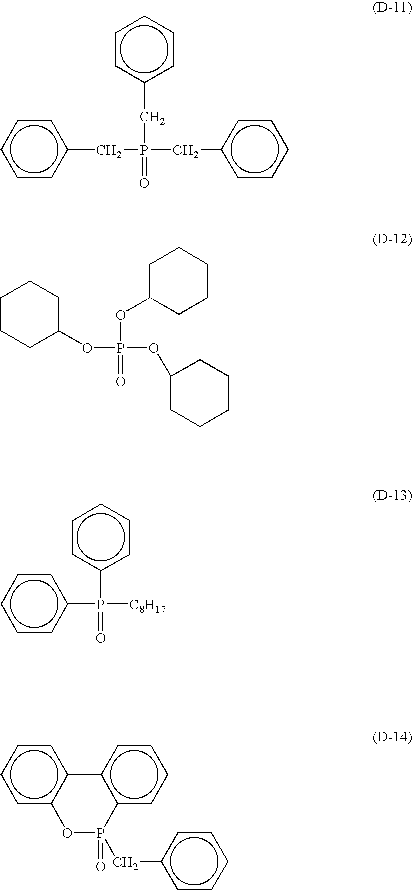

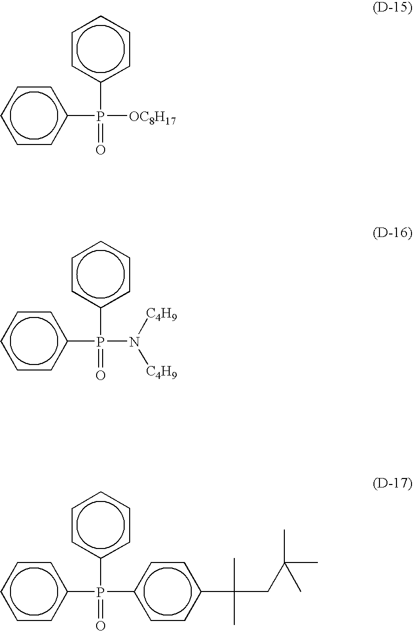

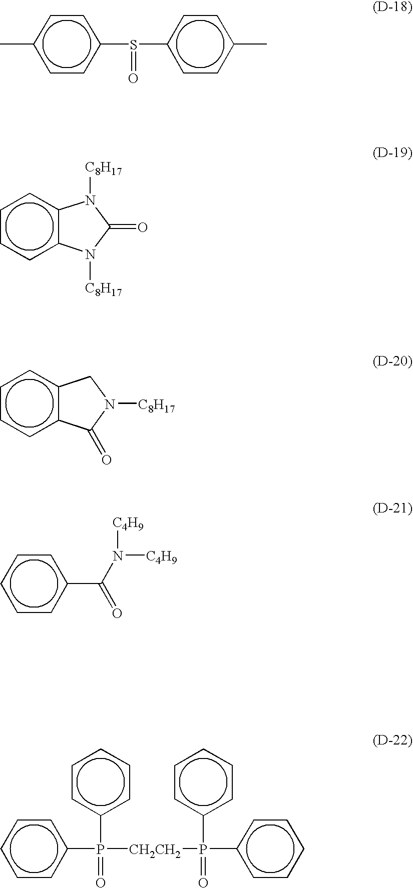

Specific examples of hydrogen bonding compounds other than those enumerated above can be found in those described in JPA Nos. 2001-281793 and 2002-14438.

The hydrogen bonding compounds used in the invention can be used in the photothermographic material by being incorporated into the coating solution in the form of solution, emulsion dispersion, or similar to the case of reducing agent. In the solution, these compounds forms a hydrogen-bonded complex with a compound having a phenolic hydroxyl group, and can be isolated as a complex in crystalline state depending on the combination of the reducing agent and the compound expressed by general formula (D).

It is particularly preferred to use the crystal powder thus isolated in the form of solid-dispersed fine particle dispersion, because it provides stable performance. Further, it is also preferred to use a method of leading to form complex during dispersion by mixing the reducing agent and the hydrogen bonding compound of the invention in the form of powders and dispersing them with a proper dispersion solvent using sand grinder mill and the like.

The hydrogen bonding compound in the invention is preferably used in a range of from 1 mol % to 200 mol %, more preferably from 10 mol % to 150 mol %, and most preferably, from 30 mol % to 100 mol %, with respect to the reducing agent.

1-6. Binder

(The First Embodiment of a Binder in an Image Forming Layer)

In the first embodiment of the photothermographic matrial of the invention, the binder of the image forming layer contains 60% by weight or more of polymer fine particle.

In the invention, the Tg of the binder of the layer including organic silver salts is preferably from −20° C. to 60° C., more preferably, from −10° C. to 50° C., further preferably, from 0° C. to 40° C.

In the specification, Tg was calculated according to the following equation.

1/Tg=Σ(Xi/Tgi)

Where, the polymer is obtained by copolymerization of n monomer compounds (from i=1 to i=n); Xi represents the mass fraction of the ith monomer (ΣXi=1), and Tgi is the glass transition temperature (absolute temperature) of the homopolymer obtained with the ith monomer. The symbol Σ stands for the summation from i=1 to i=n. Values for the glass transition temperature (Tgi) of the homopolymers derived from each of the monomers were obtained from J. Brandrup and E. H. Immergut, Polymer Handbook (3rd Edition)(Wiley-Interscience, 1989).

The polymer used for the binder may be of one kind or if necessary, two or more kinds of polymers may be used in combination. And, the polymer having Tg in the range mentioned above and the polymer having Tg not in the range mentioned above can be used in combination. In a case that two types or more of polymers differing in Tg may be blended for use, it is preferred that the weight-average Tg is in the range mentioned above.

The performance can be ameliorated particularly in the case a polymer latex having an equilibrium water content of 2% by weight or lower under 25° C. and 60% RH is used.

Most preferred embodiment is such prepared to yield an ion conductivity of 2.5 mS/cm or lower, and as such a preparation method, there can be mentioned a refining treatment using a separation function membrane after synthesizing the polymer.

The term “equilibrium water content under 25° C. and 60% RH” as referred herein can be expressed as follows:

Equilibrium water content under 25° C. and 60% RH=[(W1−W0)/W0]×100 (% by weight)

where, W1 is the weight of the polymer in moisture-controlled equilibrium under the atmosphere of 25° C. and 60% RH, and W0 is the absolutely dried weight at 25° C. of the polymer.

For the definition and the method of measurement for water content, reference can be made to Polymer Engineering Series 14, “Testing methods for polymeric materials” (The Society of Polymer Science, Japan, published by Chijin Shokan).

In the first embodiment of a binder in an image forming layer, the equilibrium water content under 25° C. and 60% RH is preferably 2% by weight or lower, but is more preferably, 0.01% by weight to 1.5% by weight, and is most preferably, 0.02% by weight to 1% by weight.

The binders used in the first embodiment of the present invention are, particularly preferably, polymers capable of being dispersed in aqueous solvent and exist as a polymer fine particle dispersion in a coating solution for the image forming layer. Examples of dispersed states may include a latex, in which water-insoluble fine particles of hydrophobic polymer are dispersed, or such in which polymer molecules are dispersed in molecular states or by forming micelles, and both are preferred. The average particle size of the dispersed particles is preferably in a range of from 1 nm to 50,000 nm, more preferably, 5 nm to 1000 nm. There is no particular limitation concerning particle size distribution of the dispersed particles, and may be widely distributed or may exhibit a monodisperse particle size distribution.

In the invention, preferred embodiment of the polymers capable of being dispersed in aqueous solvent includes hydrophobic polymers such as acrylic polymers, poly(ester), rubber (e.g., SBR resin), poly(urethane), poly(vinyl chloride), poly(vinyl acetate), poly(vinylidene chloride), poly(olefin), and the like. As the polymers above, usable are straight chain polymers, branched polymers, or crosslinked polymers; also usable are the so-called homopolymers in which single monomer is polymerized, or copolymers in which two or more types of monomers are polymerized. In the case of a copolymer, it may be a random copolymer or a block copolymer.

The molecular weight of these polymers is, in number average molecular weight, in a range of from 5,000 to 1000,000, preferably from 10,000 to 200,000. Those having too small molecular weight exhibit insufficient mechanical strength on forming the image forming layer, and those having too large molecular weight are also not preferred because the filming properties result poor.

Specific examples of preferred polymer latexes are given below, which are expressed by the starting monomers with % by weight given in parenthesis. The molecular weight is given in number average molecular weight. In the case polyfunctional monomer is used, the concept of molecular weight is not applicable because they build a crosslinked structure. Hence, they are denoted as “crosslinking”, and the molecular weight is omitted. Tg represents glass transition temperature.

P-1; Latex of -MMA(70)-EA(27)-MAA(3)-(molecular weight 37000, Tg 61° C.)

P-2; Latex of -MMA(70)-2EHA(20)-St(5)-AA(5)-(molecular weight 40000, Tg 59° C.)

P-3; Latex of -St(50)-Bu(47)-MAA(3)-(crosslinking, Tg −17° C.)

P-4; Latex of -St(68)-Bu(29)-AA(3)-(crosslinking, Tg 17° C.)

P-5; Latex of -St(71)-Bu(26)-AA(3)-(crosslinking, Tg 24° C.)

P-6; Latex of -St(70)-Bu(27)-IA(3)-(crosslinking)

P-7; Latex of -St(75)-Bu(24)-AA(1)-(crosslinking, Tg 29° C.)

P-8; Latex of -St(60)-Bu(35)-DVB(3)-MAA(2)-(crosslinking)

P-9; Latex of -St(70)-Bu(25)-DVB(2)-AA(3)-(crosslinking)

P-10; Latex of -VC(50)-MMA(20)-EA(20)-AN(5)-AA(5)-(molecular weight 80000)

P-11; Latex of -VDC(85)-MMA(5)-EA(5)-MAA(5)-(molecular weight 67000)

P-12; Latex of -Et(90)-MAA(10)-(molecular weight 12000)

P-13; Latex of -St(70)-2EHA(27)-AA(3)-(molecular weight 130000, Tg 43° C.)

P-14; Latex of -MMA(63)-EA(35)-AA(2)-(molecular weight 33000, Tg 47° C.)

P-15; Latex of -St(70.5)-Bu(26.5)-AA(3)-(crosslinking, Tg 23° C.)

P-16; Latex of -St(69.5)-Bu(27.5)-AA(3)-(crosslinking, Tg 20.5° C.)

In the structures above, abbreviations represent monomers as follows. MMA: methyl metacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, IA: itaconic acid.

The polymer latexes above are commercially available, and polymers below are usable. As examples of acrylic polymers, there can be mentioned Cevian A-4635, 4718, and 4601 (all manufactured by Daicel Chemical Industries, Ltd.), Nipol Lx811, 814, 821, 820, and 857 (all manufactured by Nippon Zeon Co., Ltd.), and the like; as examples of poly(ester), there can be mentioned FINETEX ES650, 611, 675, and 850 (all manufactured by Dainippon Ink and Chemicals, Inc.), WD-size and WMS (all manufactured by Eastman Chemical Co.), and the like; as examples of poly(urethane), there can be mentioned HYDRAN AP10, 20, 30, and 40 (all manufactured by Dainippon Ink and Chemicals, Inc.), and the like; as examples of rubber, there can be mentioned LACSTAR 7310K, 3307B, 4700H, and 7132C (all manufactured by Dainippon Ink and Chemicals, Inc.), Nipol Lx416, 410, 438C, and 2507 (all manufactured by Nippon Zeon Co., Ltd.), and the like; as examples of poly(vinyl chloride), there can be mentioned G351 and G576 (all manufactured by Nippon Zeon Co., Ltd.), and the like; as examples of poly(vinylidene chloride), there can be mentioned L502 and L513 (all manufactured by Asahi Chemical Industry Co., Ltd.), and the like; as examples of poly(olefin), there can be mentioned Chemipearl S120 and SA100 (all manufactured by Mitsui Petrochemical Industries, Ltd.), and the like.

The polymer latexes above may be used alone, or may be used by blending two types or more depending on needs.

Particularly preferred as the polymer latex for use in the first embodiment of the invention is that of styrene-butadiene copolymer. The weight ratio of monomer unit for styrene to that of butadiene constituting the styrene-butadiene copolymer is preferably in a range of from 40:60 to 95:5. Further, the monomer unit of styrene and that of butadiene preferably accounts for 60% by weight to 99% by weight with respect to the copolymer. The preferred range of the molecular weight is the same as that described above.

As the latex of styrene-butadiene copolymer preferably used in the first embodiment of the invention, there can be mentioned P-3 to P-8 and P-15, or commercially available LACSTAR-3307B, 7132C, Nipol Lx416, and the like.

In the layer containing organic silver salt of the photothermographic material according to the first embodiment of the invention, if necessary, there can be added hydrophilic polymers such as gelatin, polyvinyl alcohol, methyl cellulose, hydroxypropyl cellulose, carboxymethyl cellulose, and the like.

The hydrophilic polymers above are added at an amount of 30% by weight or less, preferably 20% by weight or less, with respect to the total weight of the binder incorporated in the image forming layer.

According to the invention, the layer containing organic silver salt (image forming layer) is preferably formed by using polymer latex for the binder. According to the amount of the binder for the layer containing organic silver salt, the weight ratio for total binder to organic silver salt (total binder/organic silver salt) is preferably in a range of 1/10 to 10/1, more preferably 1/5 to 4/1.

The layer containing organic silver salt is, in general, a photosensitive layer (image forming layer) containing a photosensitive silver halide, i.e., the photosensitive silver salt; in such a case, the weight ratio for total binder to silver halide (total binder/silver halide) is in a range of from 400 to 5, more preferably, from 200 to 10.

The total content of binder in the image forming layer of the first embodiment of the invention is preferably in a range of from 0.2 g/m² to 30 g/m², more preferably from 1 g/m² to 15 g/m². In the image forming layer of the invention, there may be added a crosslinking agent for crosslinking, or a surfactant and the like to improve coating properties.

(The Second Embodiment of a Binder in an Image Forming Layer)

As binders used for the image forming layer in the photothermographic material of the second embodiment of the present invention, polymers copolymerized with a monomer represented by the following formula (M) in a range of from 10% by weight to 70% by weight are preferably employed.

CH₂═CR⁰¹—CR⁰²═CH₂ Formula (M)

wherein R⁰¹ and R⁰² represent a group selected from a hydrogen atom, an alkyl groups having one to 6 carbon atoms, a halogen atom, and a cyano group, with proviso that R⁰¹ and R⁰² do not represent a hydrogen atom at the same time.

The alkyl group for R⁰¹ and R⁰² preferably is an alkyl group having one to 4 carbon atoms, and more preferably is an alkyl group having one to 2 carbon atoms. The halogen atom preferably is a fluorine atom, a chlorine atom, or a bromine atom is preferred, and more preferably is a chlorine atom.

R⁰¹ and R⁰² most preferably are a hydrogen atom for one of them and a methyl group or a chlorine atom for the other.

Specific examples of monomer represented by general formula (M) are shown below:

2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

A Binder incorporated in the photothermographic material of the second embodiment is a polymer copolymerized with a monomer represented by general formula (M), wherein the copolymerization composition ratio of a monomer represented by general formula (M) is in a range of from 10% by weight to 70% by weight, preferably from 15% by weight to 65% by weight, and more preferably from 20% by weight to 60% by weight. When a polymerization composition ratio of monomer represented by general formula (M) is less than 10% by weight, a cutting brittleness is deteriorated because of decreasing of a bonding component in the binder. When said ratio is more than 70% by weight, an image stability after processing is deteriorated because of too much increasing of the bonding component and an incereased mobility of the binder.

There is no particular restriction on a monomer used for the copolymerization with a monomer represented by general formula (M), and any other monomers are preferably usable if conventional radical polymerization process or ionic polymerization process is applicable to the monomers. Monomers preferably usable in the invention are selected from the following monomer groups (a) to (j) independently and freely employed in combination.

Monomer Groups (a) to (j)

(a) Conjugated dienes: 1,3-butadiene, 1,3-pentadiene, 1-phenyl-1,3-butadiene, 1-α-naphthyl-1,3-butadiene, 1-β-naphthyl-1,3-butadiene, 1-bromo-1,3-butadiene, 1-chloro-1,3-butadiene,1,1,2-trichloro-1,3-butadiene, cyclopentadiene, etc.

(b) Olefins: ethylene, propylene, vinyl chloride, vinylidene chloride, 6-hydroxy-1-hexene, 4-pentenoic acid, 8-methyl noneoic acid methyl ester, vinyl sufonic acd, trimethylvinyl silane, trimethoxyvinyl silane, 1,4-divinyl cyclohexane, 1,2,5-trvinyl cyclohexane, etc.

(c) α,β-unsaturated carboxylic acids and their salts: acrylic acid, methacrylic acid, itaconic acid, maleic acid, sodium acrylate, ammonium methacrylate, potassium itaconate, etc.

(d) α,β-unsaturated carboxylic esters: alkylacrylate (for example, methylacylate, ethylacrylate, butylacrylate, cyclohexylacrylate, 2-ethylhexylacrylate, dodecylacrylate, etc.), substituted alkylacrylate (for example, 2-chloroethylacrylate, benzylacrylate, 2-cyanoethylacrylate, etc.), alkylmethacrylate (for example, methylmethacrylate, butylmethacrylate, 2-ethylhexyl methacrylate, dodecylmethacrylate, etc.), substituted alkylmethacrylate (for example, 2-hydroxyethyl methacrylate, glycidyl-methacrylate, glycerine monomethacrylate, 2-acetoxyethyl-methacrylate, tetrahydro furfuryl methacrylate, 2-methoxyethyl methacrylate, polypropyreneglycol monomethacrylate (molar addition number of polyoxypropyrene is from two to 100), 3-N,N,-dimethyl aminopropyl methacrylate, chloro-3-N,N,N-trimethyl ammoniopropyl methacrylate, 2-carboxyethyl methacrylate, 3-sulfopropyl methacrylate, 4-oxysulfobutyl methacrylate, 3-tri-methoxysilyl propyl methacrylate, allylmethacrylate, 2-isocyanatoethyl methacrylate, etc.), unsaturated dicarboxylic acid derivatives (for example, monobutyl maleate, dimethyl maleate, monoomethyl itaconate, dibutyl itaconate), polyfunctional esters (for example, ethyleneglycol diacrylate, ethyleneglcol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerthyritol hexaacrylate, 1,2,4-cyclohexane tetramethacrylate, etc.).

(e) β-unsaturated carboxylicamides: acrylamide, methacrylamide, N-methyl acrylamide, N,N-dimethyl acrylamide, N-methyl-N-hydroxyethyl methacrylamide, N-tert-butyl acrylamide, N-tert-octyl methacrylamide, N-cyclohexyl acrylamide, N-phenyl acrylamide, N-(2-aceto acetoxyethyl)acrylamide, N-acryloyl morphorine, diacetone acrylamide, itaconic diamide, N-methyl maleimide, 2-acrylamide methylpropane sulfonic acid, methylene bis-acrylamide, dimethacryloyl piperazine, etc.

(f) unsaturated nitriles: acrylonitrile, metacrylonitrile, etc.

(f) styrenes and their derivatives: styrene, vinyl toluene, p-tert-butyl styrene, vinyl benzoic acid, methyl vinyl benzoate, α-methyl styrene, p-chloromethyl styrene, vinyl naphthalene, p-hydroxymethyl styrene, sodium p-styrene sulfonate, potassium p-styrene sulfinate, p-aminomethyl styrene, 1,4-divinyl benzene, etc.

(h) vinyl ethers: methylvinyl ether, butylvinyl ether, methoxyethyl vinyl ether, etc.

(i) vinyl esters: vinyl acetate, vinyl propionate, vinyl benzoate, vinyl salicylate, vinyl chloroacetate, etc.

(j) the other monomers: N-vinyl imidazole, 4-vinyl pridine, N-vinyl pyrrolidone, 2-vinyl oxazoline, 2-isopropenyl oxazoline, divinyl sulfonate, etc.

Specific preferred examples of polymer copolymerized with a monomer represented by general formula (M) are given below:

copolymers with styrene (for example, random copolymer or block polymer, etc.), copolymers with styrene and butadiene (for example, random copolymer, butadiene-isoprene-styrene block copolymer, styrene-butadiene-isoprene-styrene block copolymer etc.), copolymers with ethylene and propylene, copolymers with acrylonitrile, copolymers with iso-butyrene, copolymers with acrylic esters (for example, as acrylic ester, ethyl acrylate, butyl acrylate, etc. can be used), and copolymers with acrylic ester and acrylonitrile (the same acrylic esters as mentioned above can be used), and more preferred is a copolymer with styrene.

In addition to the above component, the polymer incorporated in the photothermographic material of the second embodiment is preferably copolymerized with a monomer having an acidic group. As acidic group, preferred is a carboxylic acid, a sulfonic acid, and a phosphoric acid. Copolymerization ratio of the acidic group is preferably in a range of from 1% by weight to 20% by weight, more preferably from 1% by weight to 10% by weight.

Examples of monomer having acidic group are: acrylic acid, methacrylic acid, itaconic acid, sodium p-styrene sulfonate, isopyrene sulfonic acid and phoshoryl ethyl methacrylate, etc.

As binders incorporated in the photothermographic materials of the second embodiment, polymers copolymerized with monomers represented by formula (M) can be blended with any other polymers. Preferred polymer suitable for the blended use is transparent or translucent and generally colorless. They are natural polymers, polymers and copolymers; and synthetic resins, polymers and copolymers; and other film-forming mediums such as, gelatins, rubbers, poly(vinyl alcohols), hydroxyethyl celluloses, cellulose acetates, cellulose acetate butylates, poly(vinyl pyrrolidones), casein, starch, poly(acrylic acids), poly(methyl methacrylic acids), poly(vinyl chlorides), poly(methacrylic acids), styrene/maleic anhydride copolymers, styrene-acrylonitrile copolymers, styrene-butadiene copolymers, poly(vinyl acetals), [for example, poly(vinyl formal) or poly(vinyl butyral)], poly(esters), poly(urethanes), phenoxy resin, poly(vinylidene chlorides), poly(epoxides), poly(carbonates), poly(vinyl acetates), poly(olefines), cellulose esters, poly(amides).

The binder may also be coated and formed from water, an organic solvent or an emulsion.

As binders incorporated in the photothermographic material of the second embodiment, a glass transition temperature (Tg) of polymer is preferably in a range of from −30° C. to 70° C., more preferably from −10° C. to 35° C., most preferably from 0° C. to 40° C. with regard to the cutting brittleness and the image stability. As the binder used in the invention, two or more polymers can be blended. In the case, weight average Tg preferably falls in the above range in consideration of the composition. When phase separation is observed in the polymer or the polymer has a core/shell structure, each phase or layer has Tg within the above mentioned range.

Polymers used as the binder incorporated in the photothermographic material of the second embodiment can be easily synthesized by solution polymerization, suspension polymerization, emulsion polymerization, dispersion polymerization, anionic polymerization, cationic polymerization, and the like. Among them, preferred is emulsion polymerization because of forming latex. In the emulsion polymerization, water or mixed solvent with water and water miscible organic solvents (e.g., methanol, ethanol, or acetone and the like) is used for the dispersion medium. Monomer mixture of from 5% by weight to 150% by weight based on the dispersion medium are used, and emulsifier and polymerization initiator can be added to the total volume of monomer used, and then the mixture is polymerized with stirring at from 30° C. to 100° C., preferably from 60° C. to 90° C., during 3 to 24 hours. The synthetic conditions, such as dispersion medium, monomer concentration, polymerization initiator amount, emulsifier amount, amount of dispersion agents, reaction temperature, addition method of monomer, are properly determined regarding types of monomer used. And also, dispersing agent can be preferably employed in required.

The emulsion polymerization are done generally according to the following references; “Gosei Jushi Emulsion (Synthetic Resin Emulsion)” (edited by Taira Okuda and Hiroshi Inagaki, and published by Kobunshi Kankokai (1978)), “Gosei Latex no Oyo (Application of Synthetic Latex)” (edited by Takaaki Sugimura, Yasuo Kataoka, Soichi Suzuki, and Keiji Kasahara, and published by Kobunshi Kankokai (1993)). and “Gosei Latex no Kagaku (Chemistry of Synthetic Latex)” (Soichi Murai, published by Kobunshi Kankokai (1070)). For the emulsion polymerization process to synthesize the polymer latex used in the invention, overall polymerization, monomer addition method (continuously or dividedly), emulsion addition method, and seed polymerization, can be selected. Preferred are overall polymerization, monomer addition method (continuously or dividedly), and emulsion addition method, in respect to the productivity of the latex formed.

As polymerization initiators as mentioned above, the following compounds which generate radicals can be employed: inorganic peroxide compounds such as persulfate and perhydroxides, and peroxides (described in the brochure on “Organic Peroxides” published by Nippon Yushi Co., Ltd), and azo compounds (described in the brochure on “Azo-type Polymerization Initiator” published by Wako Chemical Co., Ltd). Among them, watersoluble peroxides such as persulfate, or watersoluble azo compounds described in the said brochure are preferably employed. Preferred examples are ammonium persulfate, sodium persulfate, potassium persulfate, azobis(2-methylpropione amidine) hydrochloride, azobis(2-methyl-N-(2-hydroxyethyl) propione amide), azobis cyano valeric acid, and more preferably peroxide compounds such as ammonium persulfate, sodium persufate, and potassium persulfate, in respect to the image stability, the solubility of the compounds, and the cost performance.

The addition amount of the polymerization initiator as mentioned above is in a range of from 0.3% by weight to 2.0% by weight, preferably from 0.4% by weight to 1.75% by weight, more preferably from 0.5% by weight to 1.5% by weight based on the total amount of monomer used. When the amount of polymerization initiator is less than 0.3% by weight, the image stability is deteriorated. When the amount is more than 2.0% by weight, the coating productivity is deteriorated because the latex is easily aggregated.

As polymerization emulsifiers as mentioned above, any surfactants such as an anionic surfactant, a nonionic surfactant, a cationic surfactant or an amphoteric surfactant can be employed, preferably an anionic surfactant is employed in respect to the dispersibility and the image stability, and more preferred is sulfonic acid type anionic surfactant which maintains the polymerization stability even in a small amount and resists to the hydrolysis. Preferred is a long chain alkyl diphenylether disulfonate such as “PELEX SS-H” produced by Kao Co., Ltd, and most preferred a low electrolyte-type surfactant such as “PIONIN A-43-S” produced by Takemoto Yushi Co., Ltd.

As polymerization emulsifiers as mentioned above, a sulfonic acid-type surfactant is added in a range of from 0.1% by weight to 10.0% by weight based on the total amount of monomer used, preferably from 0.2% by weight to 7.5% by weight, and more preferably from 0.3% by weight to 5.0% by weight. When the addition amount of the polymerization emulsifier is less than 0.1% by weight, the emulsion polymerization process is unstable, and the amount is more than 10.0% by weight, the image stability is deteriorated.

For synthesis of the polymer latex used in the present invention, a chelating agent is preferably employed. Chelating agent is a compound which coordinates (chelates) with polyvalent ions, for example, metal ions such as iron ion or alkaline earth metal ions such as calcium ion and the like. Compounds described in JP-B-No. 6-8956, U.S. Pat. No. 5,053,322, JP-A-Nos.4-73645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433,7-306504, 9-43792, 8-314090, 10-182571, 10-182570, and 11-190892 can be employed.

As chelating agents as mentioned above, preferred are inorganic chelating agents (sodium tripolyphosphate, sodium hexametaphosphate, sodium tetrapolyphosphate, etc.), amino polycarboxylic acid type chelating agents (nitrilo triacetate, ethylenediamine tetraacetate, etc.), organic phoshonic acid type chelating agents (such as compounds described in Research Disclosure No.18170, JP-A-Nos.52-102726, 53-42730, 56-97347, 54-121127, 55-4024, 55-4025, 55-29883, 55-126241, 55-65955, 55-65956, 57-179843, 54-61125, and West Germany Patent No. 1045373), polyaminophenol type chelating agents, and polyamine type chelating agents. Most preferred are amino polycarboxylic acid derivatives.

Preferred examples of the amino polycarboxylic acid derivatives as mentioned above are the compounds described in the table of “EDTA (Chemistry of Complexan)” published by Nankodo, 1977. Some part of the carboxylic acid group can be substituted to form alkali metal salt such as sodium or potassium, or ammonium salt. Particularly preferred examples of amino polycarboxylic acid derivatives are: imino diacetic acid, N-methyl imino diacetic acid, N-(2-aminoethyl)imino diacetic acid, N-(carbamoyl methyl)imino diacetic acid, nitrilo triacetic acid, ethylene diamine-N,N′-diacetic acid, ethylenenediamine-N,N′-di-α-propionic acid, ethylenediamine-N,N′-di-β-propionic acid, N,N′-ethylene bis(α-6-hydroxyphenyl) glycine, N,N′-di(2-hydroxylbenzyl)ethylenediamine-N,N′-diacetic acid, ethylenediamine-N,N′-diacetic acid-N,N′-diacetohydroxamic acid, N-hydroxyethyl ethylenediamine-N,N′,N′-triacetic acid, ethylenediamine-N,N,N′,N′-tetraacetic acid, 1,2-propyrene diamine-N,N,N′,N′-tetraacetic acid, d,1-2,3-diamino butane-N,N,N′,N′-tetraacetic acid, meso-2,3-diamino butane-N,N,N′,N′-tetraacetic acid, 1-phenyl ethylenediamine-N,N,N′,N′-tetraacetic acid, d,1-1,2-diphenyl ethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraacetic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diamino butene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2′-oxy-bis(ethylimino diacetic acid), 2,2′-ethylene dioxy-bis(ethylimino diacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylene triamine-N,N,N′,N″,N″-pentaacetic acid, triethylene tetramine-N,N,N′,N″,N′″,N′″-hexaacetic acid, 1,2,3-triamino propane-N,N,N′,N″,N′″,N′″-hexaacetic acid, and compounds, some part of whose carboxylic acid group is substituted to form alkali metal salt such as sodium or potassium, or ammonium salt.

The addition amount of the chelating agent as mentioned above is, preferably in a range of from 0.01% by weight to 0.4% by weight based on the total amount of monomer used, more preferably from 0.02% by weight to 0.3% by weight, most preferably from 0.03% by weight to 0.15% by weight. When the addition amount of chelating agent is less than 0.01% by weight, the coating productivity are deteriorated because of insufficient coordination of metal ions mixed in the polymer latex making process and the dispersion stability to aggregation. When the addition amount is more than 0.4% by weight, the coating productivity is deteriorated because of the increased viscosity of polymer latex.

For synthesis of polymer latexes used in the invention, a chain transfer agent is preferably employed. Preferred chain transfer agents are described in J. Brandrup and E. H. Immergut, Polymer Handbook (3 rd Edition) (Wiley-Interscience, 1989). Among them, sulfur containing compound is more preferred, because of the high chain transfer ability and the effectiveness in a small amount. Hydrophobic mercaptan-type chain transfer agents such as tert-dodecyl mercaptan, n-dodecyl mercaptan, and the like are particularly preferred.

The addition amount of the chain transfer agent as mentioned above is preferably, in a range of from 0.2% by weight to 2.0% by weight based on the total amount of monomers used, more preferably, from 0.3% by weight to 1.8% by weight, most preferably from 0.4% by weight to 1.6% by weight. When the addition amount is less than 0.2% by weight, the cutting brittleness is deteriorated. When the amount is more than 2.0% by weight, the image stability is deteriorated.

In addition to the aforesaid compounds for the emulsion polymerization of the present invention, compounds described in any Synthetic Rubber Handbooks known in the art, such as electrolytes, stabilizers, viscosity increasing agents, deforming agents, anti-oxidants, vulcanizing agents, anti-freezing agents, gelling agents, and valcanization accelerators may be preferably employed.

<Specific Examples of the Polymers Used in the Invention>

As examples of the polymer used in the invention, polymers (P-1) to (p-29) are illustrated below, however the invention is not limited to these compounds. Wherein x, y, z, z′ in the chemical formula represent the weight percentage ratio of each monomer in the polymer component, and the summation of x, y, z, z′ amounts to 100%. Tg represents glass transition temperature of the dry film obtained from the polymer.

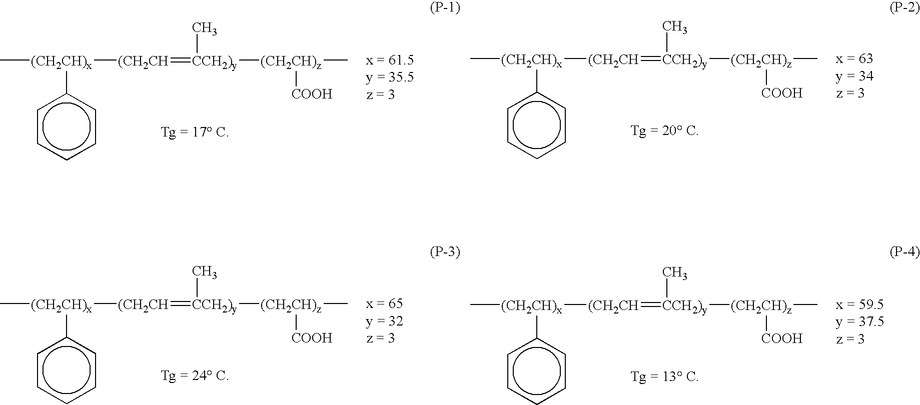

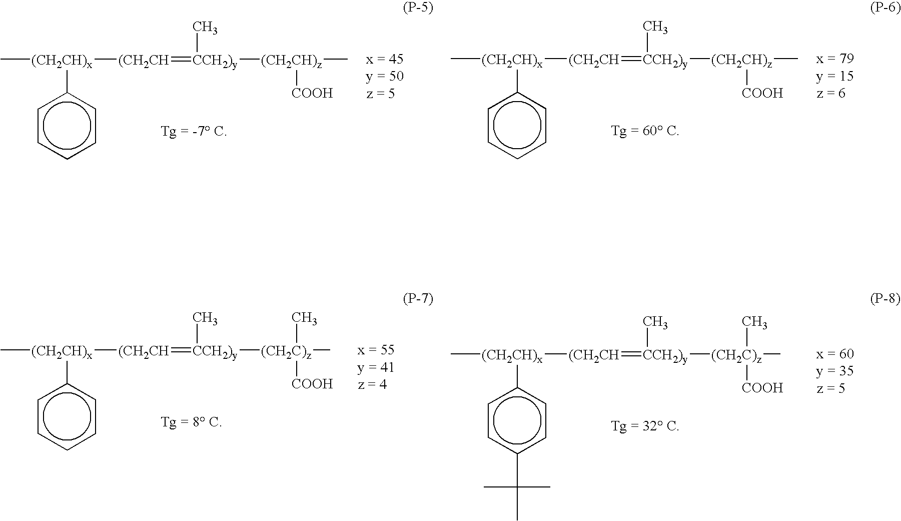

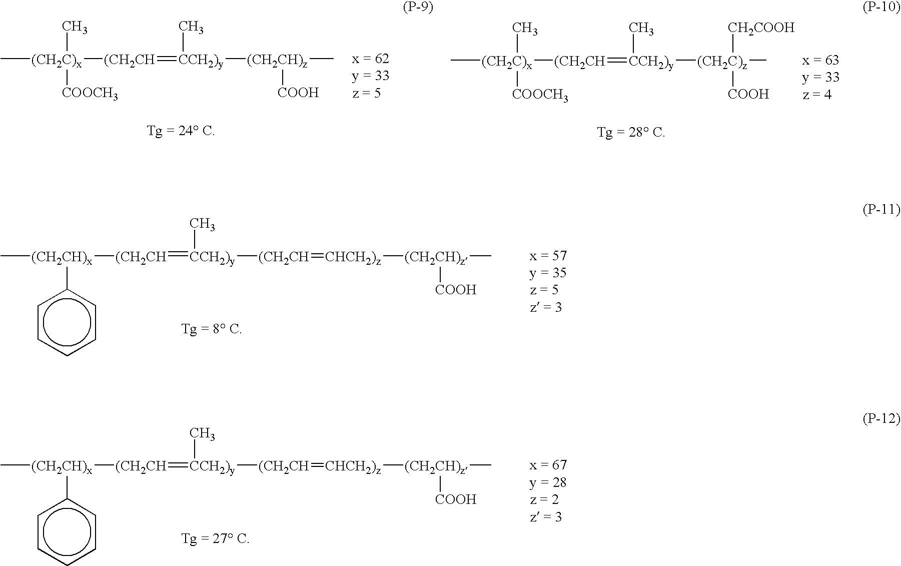

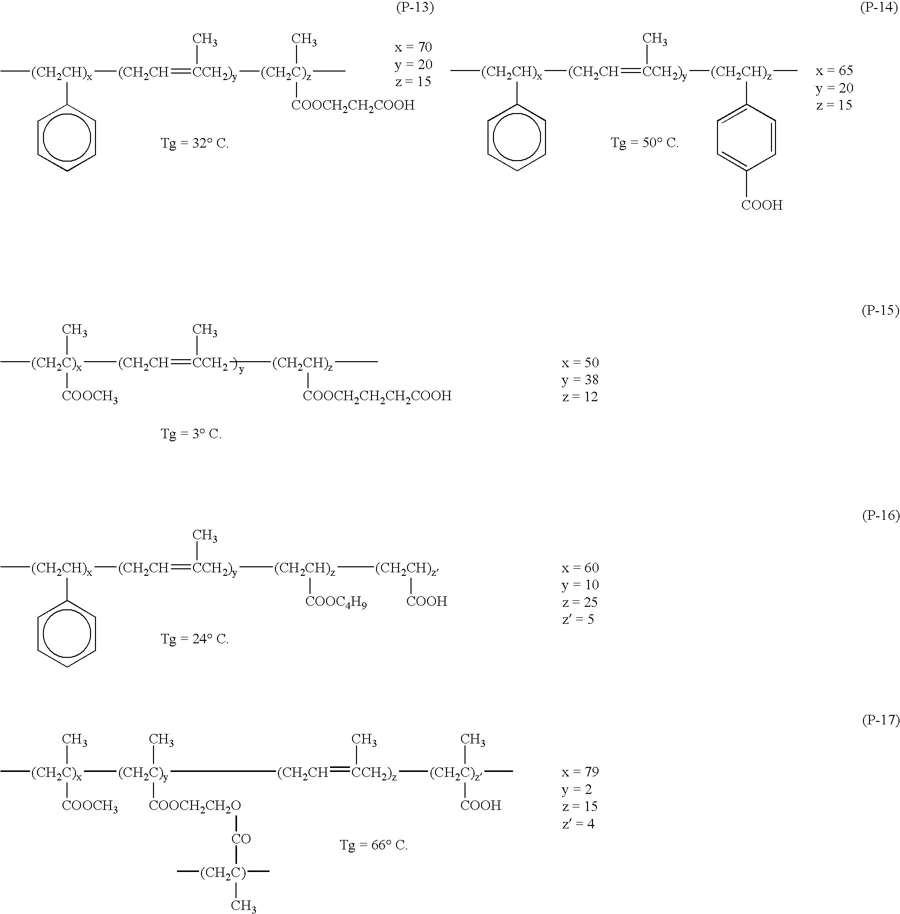

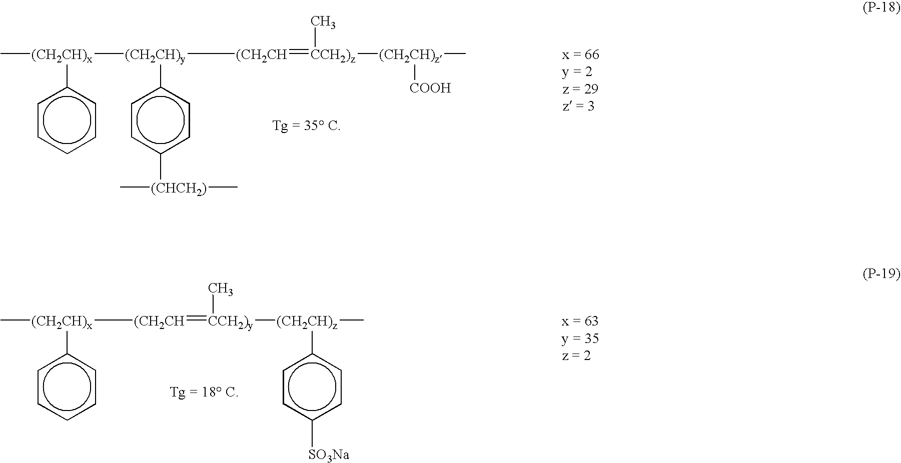

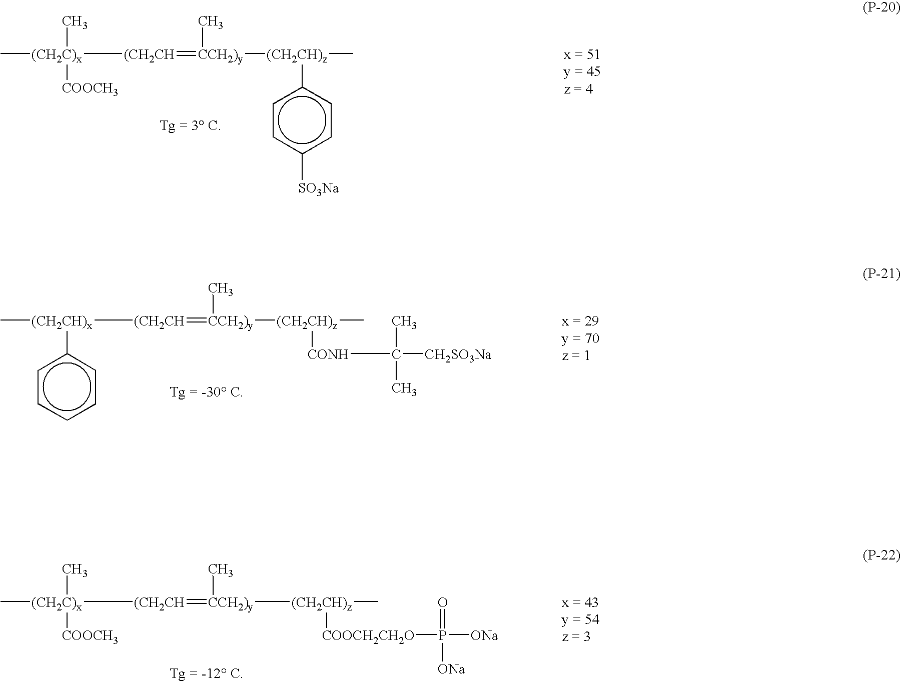

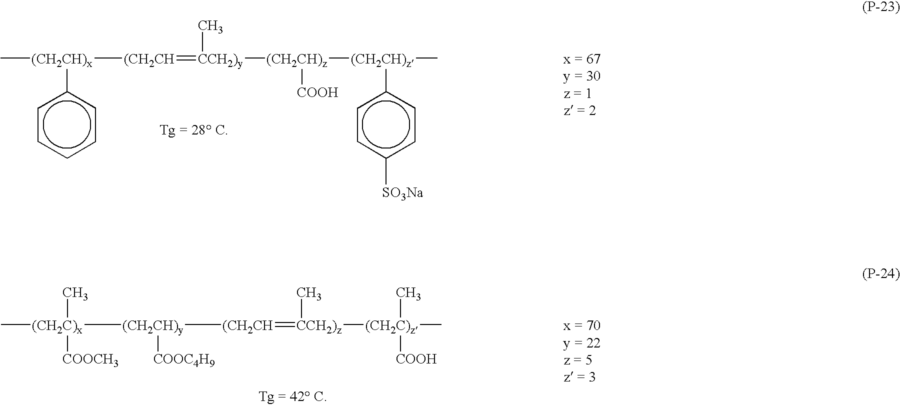

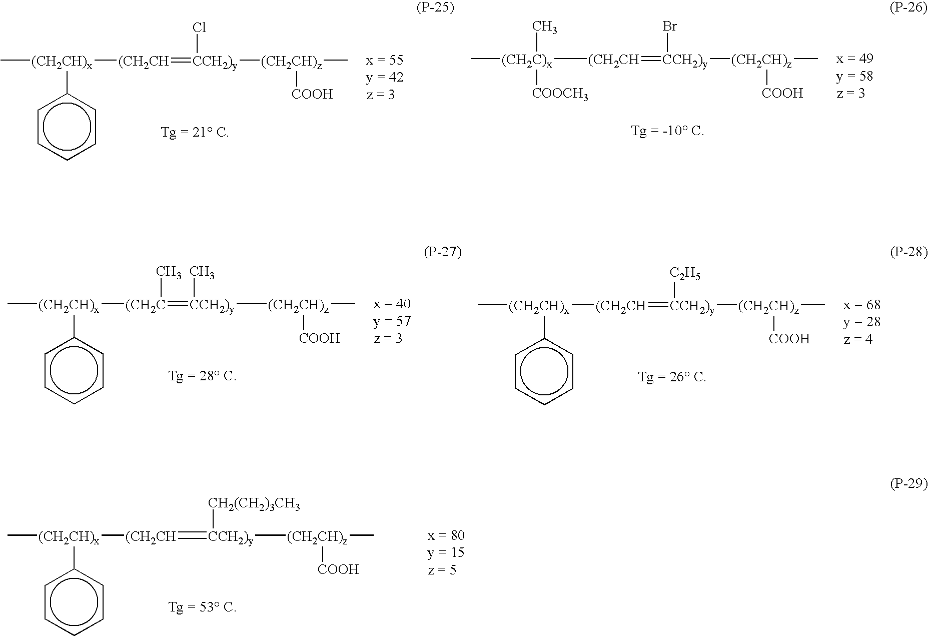

The examples of synthetic procedure of the polymer used in the invention are described below, however the invention is not limited to these synthesizing methods. The other mentioned polymers can also be synthesized by the same procedure.

SYNTHESIS EXAMPLE 1

Synthesis of the Aforementioned Polymer P-1:

Into the reaction vessel of gas monomer reaction apparatus (type TAS-2J manufactured by Tiatsu Garasu Kogyo Ltd.), 1500 g of distilled water were poured, and heated for 3 hours at 90° C. to make passive film over the stainless steel-made vessel surface and stainless steel-made stirring device, thereafter, 584.86 g of distilled water deaerated by nitrogen gas for one hour, 9.45 g of surfactant (“PIONIN A-43-3” produced by Takemoto Yushi Co., Ltd.), 20.25 g of 1 mol/L sodium hydroxide, 0.216 g of ethylenediamine tetraacetic acid tetrasodium salt, 332.1 g of styrene, 191.7 g of isoprene, 16.2 g of acrylic acid, and 4.32 g of tert-dodecyl mercaptan were added into the reaction vessel. And then the reaction vessel was sealed and stirred at the stirring rate of 222 rpm and elevated the inner temperature up to 60° C. A solution obtained by dissolving 2.7 g of ammonium persulfate in 50 mL of water was added to the aforesaid mixture and kept for 7 hours with stirring, furthermore the mixture was heated to 90° C. with stirring for 3 hours. After the reaction was finished, the inner temperature of the vessel was cooled to room temperature. The polymers obtained was filtered through filter cloth (mesh: 225), then 1145 g (solid content 45% by weight, particle size 112 nm) of the mentioned polymer P-1 were obtained.

### SYNTHESIS EXAMPLE 2

Synthesis of the Aforementioned Polymer P-2:

Into the reaction vessel of gas monomer reaction apparatus (type TAS-2J manufactured by Tiatsu Garasu Kogyo Ltd.) pretreated to make passive film as described in Synthesis Example 1, 350.92 g of distilled water deaerated by nitrogen gas for one hour, 3.78 g of surfactant (“PIONIN A-43-S” produced by Takemoto yushi Co., Ltd.), 20.25 g of 1 mol/L sodium hydroxide, 0.216 g of ethylenediamine tetraacetic acid tetrasodium salt, 34.02 g of styrene, 18.36 g of isoprene, 1.62 g of acrylic acid, and 2.16 g of tert-dodecyl mercaptan were added, therafter the reaction vessel was sealed and stirred at the stirring rate of 222 rpm and elevated the inner temperature to 65° C., and then a solution obtained by dissolving 1.35 g of ammonium persulfate in 50 mL of water was added to the aforesaid mixture and kept for 2 hours with stirring. Separately, 233.94 g of distilled water, 5.67 g of surfactant (“PIONIN A-43-S” produced by Takemoto Yushi Co., Ltd.), 306.18 g of styrene, 165.24 g of isoprene, 14.58 g of acrylic acid, 2.16 g of tert-dodecyl mercaptan and 1.35 g of ammonium persulfate were added into the other vessel to prepare emulsion with stirring. The resulting emulsion was poured dropwise over 8 hours to the said reaction vessel, after the addition, they were kept for 2 hours with stirring. Thereafter the resulting mixture was elevated to 90° C. with stirring for 3 hours. After the reaction was finished, the inner temperature of the vessel was cooled to room temperature. The polymers obtained was filtered through filter cloth (mesh: 225), then 1147 g (solid content 45% by weight, particle size 121 nm) of the mentioned polymer P-2 were obtained.

### SYNTHESIS EXAMPLE 3

Synthesis of the Aforementioned Polymer P-4:

Into the reaction vessel of Gas monomer reaction apparatus (type TAS-2J manufactured by Tiatsu Garasu Kogyo Ltd.,) pretreated to make passive film as described in Synthesis Example 1, 578.11 g of distilled water deaerated by a nitrogen gas for one hour, 16.2 g of surfactant (“PELEX SS-H” produced by Kao Co., Ltd.), 20.25 g of 1 mol/L sodium hydroxide, 0.216 g of ethylenediamine tetraacetic acid tetrasodium salt, 321.3 g of styrene, 202.5 g of isoprene, 16.2 g of acrylic acid and 4.32 g of tert-dodecyl mercaptan were added, thereafter the reaction vessel was sealed and stirred at the stirring rate of 225 rpm and elevated the inner temperature to 60° C., a solution obtained by dissolving 2.7 g of ammonium persulfate in 25 mL of water was added to the aforesaid mixture, and kept for 5 hours with stirring. Furthermore a solution obtained dissolving 1.35 g of ammonium persulfate dissolved in 25 mL of water was added to the mixture while heating to 90° C. with stirring for 3 hours. After the reaction finished, the inner temperature of the vessel was cooled to room temperature. The polymers obtained was filtered through filter cloth (mesh: 225), then 1139 g (solid content 45% by weight, particle size 105 nm) of the mentioned polymer P-4 were obtained.

As solvents for coating solution of the polymer latex used in the invention, an aqueous solvent is preferably employed, but water miscible organic solvent also may be used in combination. As water miscible solvents employed in the present invention, preferred are alcohols such as methyl alcohol, ethyl alcohol, propyl alcohol, and the like, cellosolves such as methyl cellosolve, ethyl cellosolve, butyl cellosolve, and the like, ethyl acetate, or dimethyl formamide, and the like. The addition amount of organic solvent as mentioned above is preferably in an amount of less than 50% by weight of the total solvent, and more preferably less than 30% by weight.

For polymer latex used in the invention, the polymer concentration in the latex solution is 10% by weight to 70% by weight, more preferably, 20% by weight to 60% by weight, and most preferably, 30% by weight to 55% by weight.

The equilibrium water content of polymer latex under 25° C. and 60% RH is preferably 2% by weight or lower, but is more preferably, 0.01% by weight to 1.5% by weight, and is most preferably, 0.02% by weight to 1.0% by weight.

In the layer containing organic silver salt of the photosensitive material according to the invention, if necessary, there can be added hydrophilic polymers such as gelatin, polyvinyl alcohol, methyl cellulose, hydroxypropyl cellulose, carboxymethyl cellulose, and the like. The hydrophilic polymers above are added at an amount of 30% by weight or less, preferably 20% by weight or less, with respect to the total weight of the binder incorporated in the layer containing organic silver salt.

According to the invention, the layer containing organic silver salt (image forming layer) is preferably formed by using polymer latex for the binder. According to the amount of the binder for the layer containing organic silver salt, the weight ratio for total binder to organic silver salt (total binder/organic silver salt) is preferably 1/10 to 10/1, more preferably 1/3 to 5/1, most preferably 1/1 to 3/1.

The weight ratio for total binder in an image forming layer to silver halide (total binder/silver halide) is 400 to 5, more preferably, 200 to 10.

The total binder content in the image forming layer is preferably 0.2 g/m² to 30 g/m², more preferably 1 g/m² to 15 g/m², most preferably 2 g/m² to 10 g/m². In the image forming layer of the invention, there may be added a crosslinking agent for crosslinking, or a surfactant and the like to improve coating properties.

The polymer latex described above contains a halogen ion in an amount of 500 ppm or less thereof.

In the case the layer containing organic silver salt is formed by first applying a coating solution containing 30% by weight or more of water in the solvent and by then drying, wherein the sovent is water or mixed aqueous solvent containing water miscible organic solvent at 70% by weight or less.

Examples of solvents other than water may include any of water-miscible organic solvents such as methyl alcohol, ethyl alcohol, isopropyl alcohol, methyl cellosolve, ethyl cellosolve, dimethylformamide and ethyl acetate. A water content in a solvent is more preferably 50% by weight or more and still more preferably 70% by weight or more.

Examples of a preferable solvent composition is compositions, besides water=100, are compositions in which methyl alcohol is contained in water at ratios of water/methyl alcohol=90/10 and 70/30, in which dimethylformamide is further contained at a ratio of water/methyl alcohol/dimethylformamide=80/15/5, in which ethyl cellosolve is further contained at a ratio of water/methyl alcohol/ethyl cellosolve=85/10/5, and in which isopropyl alcohol is further contained at a ratio of water/methyl alcohol/isopropyl alcohol=85/10/5 (wherein the numerals presented above are values in % by weight).

1-7. Antifoggant

1) Organic Polyharogen Compound

As an antifoggant, stabilizer and stabilizer precursor usable in the invention, there can be mentioned those disclosed as patents in paragraph number 0070 of JP-A No. 10-62899 and in line 57 of page 20 to line 7 of page 21 of EP-A No. 0803764A1, the compounds described in JP-A Nos. 9-281637 and 9-329864, in U.S. Pat. No. 6,083,681, and in EP-A No. 1048975. Furthermore, the antifoggant preferably used in the invention is an organic halogen compound, and those disclosed in paragraph Nos. 0111 to 0112 of JP-A No. 11-65021 can be enumerated as examples thereof. In particular, the organic halogen compound expressed by formula (P) in JP-A No. 2000-284399, the organic polyhalogen compound expressed by formula (II) in JP-A No. 10-339934, and organic polyhalogen compounds described in JP-A Nos. 2001-31644 and 2001-33911 are preferred.

In the invention, preferred polyhalogen compounds are the compounds expressed by general formula (H) below:

Q-(Y)_{N}—C(Z₁)(Z₂)X General formula (H)

In general formula (H), Q represents an alkyl group, an aryl group, or a heterocyclic group; Y represents a divalent connecting group; N represents 0 or 1; Z₁ and Z₂ represent a halogen atom; and X represents hydrogen atom or an electron attracting group.

In general formula (H), Q preferably is a phenyl group substituted by an electron-attracting group whose Hammett substitution coefficient σp yields a positive value. For the details of Hammett substitution coefficient, reference can be made to Journal of Medicinal Chemistry, Vol. 16, No. 11 (1973), pp. 1207 to 1216, and the like.

As such electron-attracting groups, examples include, halogen atoms (fluorine atom (σp value: 0.06), chlorine atom (σp value: 0.23), bromine atom (σp value: 0.23), iodine atom (σp value: 0.18)), trihalomethyl groups (tribromomethyl (σp value: 0.29), trichloromethyl (σp value: 0.33), trifluoromethyl (σp value: 0.54)), a cyano group (σp value: 0.66), a nitro group (σp value: 0.78), an aliphatic aryl or heterocyclic sulfonyl group (for example, methanesulfonyl (σp value: 0.72)), an aliphatic aryl or heterocyclic acyl group (for example, acetyl (σp value: 0.50) and benzoyl (σp value: 0.43)), an alkinyl (e.g., C≡CH (σp value: 0.23)), an aliphatic aryl or heterocyclic oxycarbonyl group (e.g., methoxycarbonyl (σp value: 0.45) and phenoxycarbonyl (σp value: 0.44)), a carbamoyl group (σp value: 0.36), sulfamoyl group (op value: 0.57), sulfoxido group, heterocyclic group, and phosphoryl group.

Preferred range of the σp value is from 0.2 to 2.0, and more preferably, from 0.4 to 1.0.

Preferred as the electron-attracting groups are carbamoyl group, an alkoxycarbonyl group, an alkylsulfonyl group, and an alkylphosphoryl group, and particularly preferred among them is carbamoyl group.

X preferably is an electron-attracting group, more preferably, a halogen atom, an aliphatic aryl or heterocyclic sulfonyl group, an aliphatic aryl or heterocyclic acyl group, an aliphatic aryl or heterocyclic oxycarbonyl group, carbamoyl group, or sulfamoyl group; particularly preferred among them is a halogen atom.

Among halogen atoms, preferred are chlorine atom, bromine atom, and iodine atom; more preferred are chlorine atom and bromine atom; and particularly preferred is bromine atom.

Y preferably represents —C(═O)—, —SO—, or —SO₂—; more preferably, —C(═O)— or —SO₂—; and particularly preferred is —SO₂—. N represents 0 or 1, and preferred is 1.

Specific examples of the compounds expressed by general formula (H) of the invention are shown below.

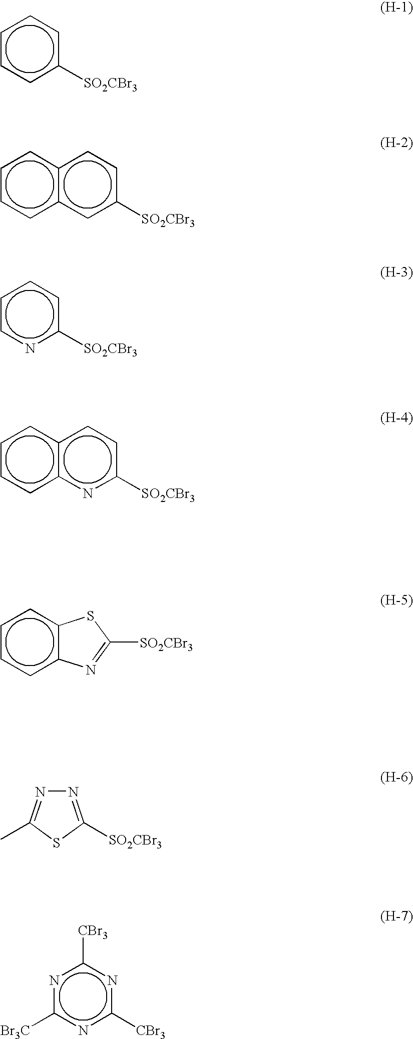

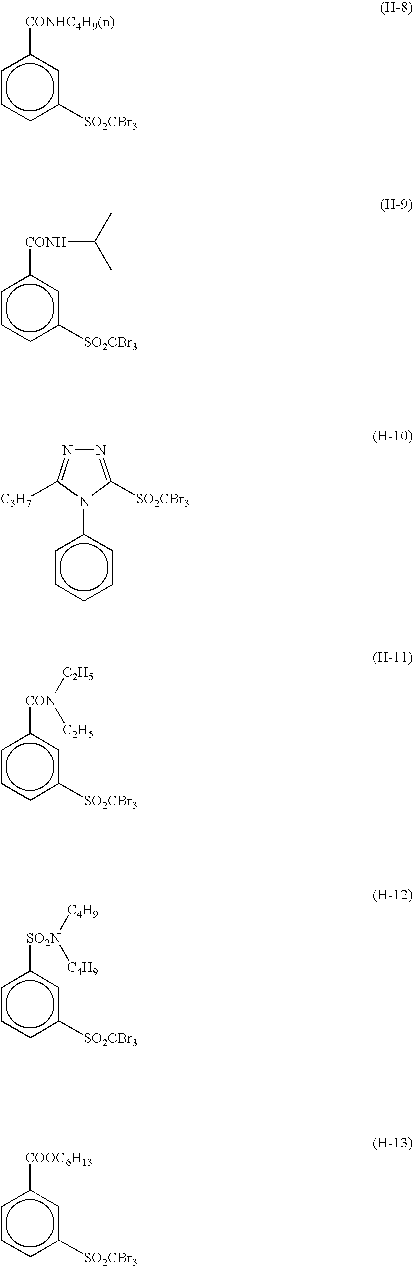

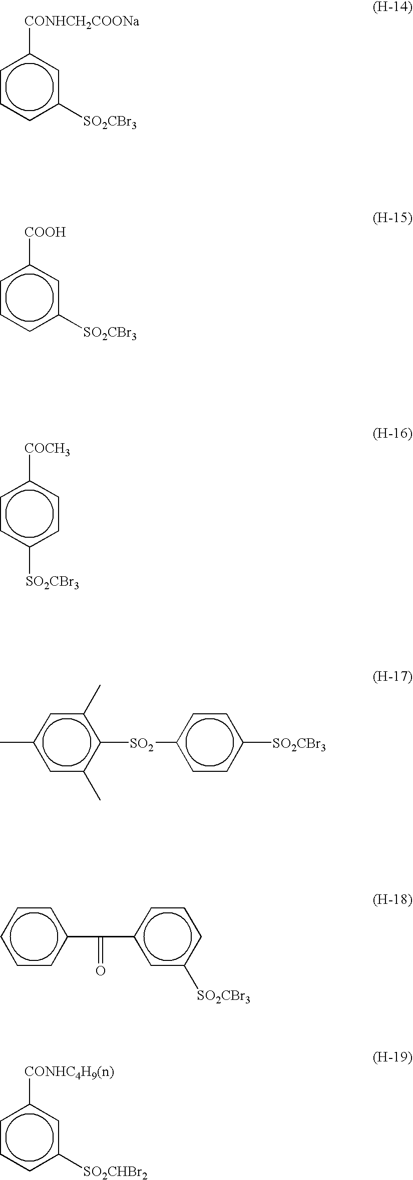

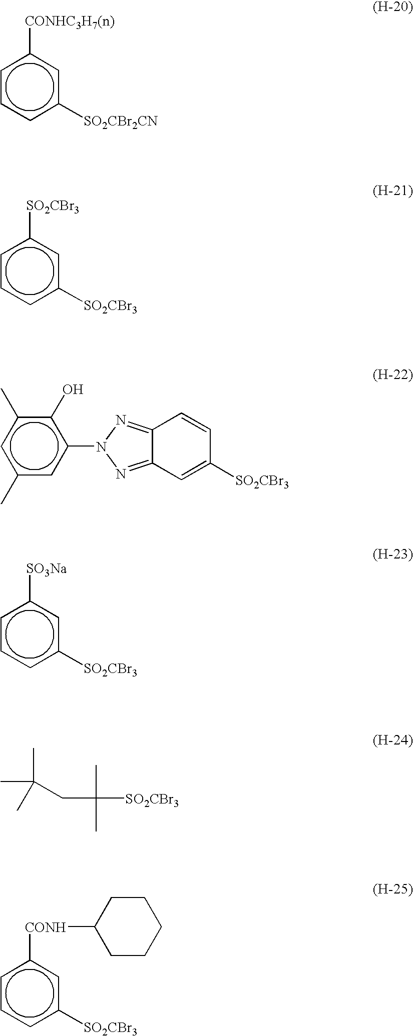

The compounds expressed by general formula (H) of the invention are preferably used in an amount of from 10⁻⁴ mol to 0.8 mol, more preferably, 10⁻³ mol to 0.1 mol, and most preferably, 5×10⁻³ mol to 0.05 mol, per one mol of non-photosensitive silver salt incorporated in the image forming layer.

Particularly, in a case where a silver halide having a composition of a high silver iodide content, an amount of addition of a compound expressed by the general formula (H) is important in order to obtain a sufficient anti-fogging effect and the compound is most preferably used in the range of from 5×10⁻³ mol to 0.03 mol.

In the invention, a method of incorporating a compound expressed by the general formula (H) into a photosensitive material is described in a method of incorporating a reducing agent described above.

A melting point of a compound expressed by the general formula (H) is preferably 200° C. or lower and more preferably 170° C. or lower.

Examples of other organic polyhalides used in the invention are disclosed in paragraphs Nos. 0111 to 0112 of JP-A No. 11-65021. Preferable examples thereof are an organic halide expressed by the formula (P) described in JP-A No. 11-87297, an organic polyhalide expressed by the general formula (II) described in JP-A No. 10-339934 and an organic polyhalide described in JP-A No. 11-205330.

2) Other Antifoggants

As other antifoggants, there can be mentioned a mercury (II) salt described in paragraph number 0113 of JP-A No. 11-65021, benzoic acids described in paragraph number 0114 of the same literature, a salicylic acid derivative described in JP-A No. 2000-206642, a formaline scavenger compound expressed by general formula (S) in JP-A No. 2000-221634, a triazine compound related to claim 9 of JP-A No. 11-352624, a compound expressed by general formula (III), 4-hydroxy-6-methyl-1,3,3a, 7-tetrazaindene and the like, as described in JP-A No. 6-11791.

The photothermographic material of the invention may further contain an azolium salt in order to prevent fogging. As azolium salts, there can be mentioned a compound expressed by general formula (XI) as described in JP-A No. 59-193447, a compound described in JP-B No. 55-12581, and a compound expressed by general formula (II) in JP-A No. 60-153039. The azolium salt may be added to any part of the photosensitive material, but as the addition layer, preferred is to select a layer on the side having thereon the photosensitive layer, and more preferred is to select a layer containing organic silver salt.

The azolium salt may be added at any time of the process of preparing the coating solution; in the case the azolium salt is added into the layer containing the organic silver salt, any time of the process may be selected, from the preparation of the organic silver salt to the preparation of the coating solution, but preferred is to add the salt after preparing the organic silver salt and just before the coating. As the method for adding the azolium salt, any method using a powder, a solution, a fine-particle dispersion, and the like, may be used. Furthermore, it may be added as a solution having mixed therein other additives such as sensitizing agents, reducing agents, toners, and the like.

In the invention, the azolium salt may be added at any amount, but preferably, it is added in a range of from 1×10⁻⁶ mol to 2 mol, and more preferably, from 1×10⁻³ mol to 0.5 mol per one mol of silver.

1-8. Other Additives

1) Mercapto Compounds, Disulfides and Thiones

In the invention, mercapto compounds, disulfide compounds, and thione compounds may be added in order to control the development by suppressing or enhancing development, to improve spectral sensitization efficiency, and to improve storage properties before and after development. Descriptions can be found in paragraph Nos. 0067 to 0069 of JP-A No. 10-62899, a compound expressed by general formula (I) of JP-A No. 10-186572 and specific examples thereof shown in paragraph Nos. 0033 to 0052, and in lines 36 to 56 in page 20 of EP No. 0803764A1. Among them, mercapto-substituted heterocyclic aromatic compound described in JP-A Nos. 9-297367, 9-304875, and 2001-100358, and the like, are particularly preferred.

2) Toner

In the photothermographic material of the present invention, the addition of a toner is preferred. The description of the toner can be found in JP-A No.10-62899 (paragraph Nos. 0054 to 0055), EP-A No.0803764A1 (page21, lines 23 to 48), JP-A Nos.2000-356317 and 2000-187298. Preferred are phthalazinones (phthalazinone, phthalazinone derivatives and metal salts thereof, e.g., 4-(1-naphthyl)phthalazinone, 6-chlorophthalazinone, 5,7-dimethoxyphthalazinone and 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate and tetrachlorophthalic anhydride); phthalazines (phthalazine, phthalazine derivatives and metal salts thereof, e.g., 4-(1-naphthyl)phthalazine, 6-isopropylphthalazine, 6-terbutylphthalazine, 6-chlorophthalazine, 5,7-dimethoxyphthalazine and 2,3-dihydrophthalazine); combinations of phthalazines and phthalic acids. In the silver halide having a high silver iodide content, particularly preferred is a combination of phthalazines and phthalic acids.

Preferred addition amount of the phthalazines in the invention is in the range from 0.01 mol to 0.3 mol, and more preferably 0.02 mol to 0.1 mol per one mol of organic silver salt.

This addition amount is one important factor for the problem of development acceleration when using a silver halide emulsion having a high silver iodide content. By selecting appropriate addition amount, both of sufficient development performance and low fogging will be possible.

3) Plasticizer and Lubricant

Plasticizers and lubricants usable in the photothermographic material of the invention are described in paragraph No. 0117 of JP-A No. 11-65021. Lubricants are described in paragraph Nos. 0061 to 0064 of JP-A No. 11-84573 and in paragraph Nos. 0049 to 0062 of Japanese Patent Application No. 11-106881.

4) Dyes and Pigments

From the viewpoint of improving image tone, of preventing the generation of interference fringes and of preventing irradiation on laser exposure, various types of dyes and pigments (for instance, C.I. Pigment Blue 60, C.I. Pigment Blue 64, and C.I. Pigment Blue 15:6) may be used in the photosensitive layer of the invention. Detailed description can be found in WO No. 98/36322, JP-A Nos. 10-268465 and 11-338098, and the like.

5) Ultra-High Contrast Promoting Agent

In order to form ultra-high contrast image suitable for use in graphic arts, it is preferred to add an ultra-high contrast promoting agent into the image forming layer. Details on the ultra-high contrast promoting agents, method of their addition and addition amount can be found in paragraph No. 0118, paragraph Nos. 0136 to 0193 of JP-A No. 11-223898, as compounds expressed by formulae (H), (1) to (3), (A), and (B) in Japanese Patent Application No. 11-87297, as compounds expressed by formulae (III) to (V)(specific compound: chemical No.21 to chemical No.24) in Japanese Patent Application No. 11-91652; as an ultra-high contrast accelerator, description can be found in paragraph No. 0102 of JP-A No. 11-65021, and in paragraph Nos. 0194 to 0195 of JP-A No. 11-223898.

In the case of using formic acid or formates as a strong fogging agent, it is preferably incorporated into the side having thereon the image forming layer containing photosensitive silver halide, at an amount of 5 mmol or less, preferably, 1 mmol or less per one mol of silver.

In the case of using an ultra-high contrast promoting agent in the photothermographic material of the invention, it is preferred to use an acid resulting from hydration of diphosphorus pentaoxide, or its salt in combination. Acids resulting from the hydration of diphosphorus pentaoxide or salts thereof include metaphosphoric acid (salt), pyrophosphoric acid (salt), orthophosphoric acid (salt), triphosphoric acid (salt), tetraphosphoric acid (salt), hexametaphosphoric acid (salt), and the like.

Particularly preferred acids obtainable by the hydration of diphosphorus pentaoxide or salts thereof include orthophosphoric acid (salt) and hexametaphosphoric acid (salt). Specifically mentioned as the salts are sodium orthophosphate, sodium dihydrogen orthophosphate, sodium hexametaphosphate, ammonium hexametaphosphate, and the like.

The amount of usage of the acid obtained by hydration of diphoshorus pentaoxide or the salt thereof (i.e., the coverage per 1 m² of the photosensitive material) may be set as desired depending on the sensitivity and fogging, but preferred is an amount of 0.1 mg/m² to 500 mg/m², and more preferably, of 0.5 mg/m² to 100 mg/m².

6) Antihalation Dye

It is preferred that the photothermographic material of the present invention contains a dye having absorption at the exposure wavelength region in at least one layer of an image forming layer and a light insensitive layer to prevent a halation at the exposure. The said light insensitive layer is located in nearer side to a support than an image forming layer (may be an antihalation layer or a subbing layer) or in opposite side to an image forming layer toward a binder.

In the case, wherine the exposure wavelength is in the infrared region, an infrared dye may be used and in the case, wherein the exposure wavelength is in the ultraviolet region, an ultraviolet absorbing dye may be used, whereby both dyes preferably have no absorption in the visible region or have a little visible absorption.

In the case where the exposure wavelength is present in the visible region, it is preferred to allow substantially no color of the dye to remain after the image formation and to use the color bleaching method by heating at the thermal development. In particular, the light insensitive layer is preferably rendered to function as a thermal bleaching antihalation layer by adding thereto a thermal bleaching dye and a base precursor. These techniques are described in JP-A No.11-231457 and the like.

The addition amount of antihalation dye is determined depending on the usage of the dye. In general, the decolorizable dye is preferably used in the amount where the optical density (absorbance) measured at the objective wavelength shows more than 0.1. Particularly, the optical density is preferably 0.15 to 2. For attaining such optical density, the addition amount of the dye is generally on the order of 0.001 g/m² to 1 g/m².

In the case where the exposure source is a laser beam, it is enough that the antihalation layer has the absorption in the narrow wavelength region correspondent to the peak of the radiation wavelength, therefore it is possible to be a lower coating amount of the dye and to produce photosensitive material with lower cost.

Shorter the radiation peak wavelength of laser beam is, more fine definition image recording is possible. Therefore, the radiation peak wavelength of laser beam is preferably 350 nm to 430 nm, more preferably 380 nm to 420 nm from the practical point of view.

In the case where the laser beam as the exposure light source has the radiation peak wavelength at 350 nm to 430 nm, it is preferred that the antihalation dye has the absorption maximum at the wavelength between 350 nm to 430 nm. Further, in the case where the radiation peak wavelength of laser beam is present between 380 nm to 420 nm, it is preferred that the dye described above has the absorption maximum at the wavelength between 380 nm to 420 nm.

The layer comprising the dye having an absorption maximum at the wavelength between 350 nm to 430 nm preferably may be an image forming layer, a light insensitive layer (may be an antihalation layer) in the nearer side to the support than an image forming layer, or a light insensitive layer on the back side in opposite to the image forming layer toward the support.

The kind of dye described above is not particularly limited as far as it has an absorption maximum between 350 nm to 430 nm. The absorption maximum measured between 350 nm to 430 nm may be either of a main absorption or a sub absorption. Specific examples of the dye having an absorption maximum between 350 nm to 430 nm are an azo dye, an azomethine dye, a quinone dye (e.g., an anthraquinone dye, a naphthoquinone dye and the like), a quinoline dye (e.g., a quinophthalone dye and the like), a methine dye (e.g., a cyanine dye, a merocyanine dye, an oxonol dye, a styryl dye, an arylidene dye, an aminobutadiene dye and the like and a polymethine dye is also contained), a carbonium dye (e.g., a cationic dye such as diphenylmethane dye, a triphenylmethane dye a xanthene dye, an acridine dye and the like), an azine dye (e.g., a cationic dye such as a thiazine dye, an oxazine dye, a phenazine dye and the like), an aza [18] π electron dye (e.g., a porphin dye, a tetrazaporphin dye, a phthalocyanine dye and the like), an indigoid dye (e.g., indigo, a thioindigo dye and the like), a squalenium dye, a croconium dye, a pyrromethene dye, a nitro-nitroso dye, a benzotriazole dye, a triazine dye and the like can be described. An azo dye, an azomethine dye, a quinone dye, a quinoline dye, a methine dye, an aza [18] π electron dye, an indigoid dye and a pyrromethene dye are preferable and an azo dye, an azomethine dye and a methine dye are more preferable and a methine dye are most preferable. These dyes may be present in a solid fine particle dispersion or in an aggregation state (a liquid crystal state also contained) and may be used with two or more kinds of dyes in combination.

A dye having larger absorption at the exposure wavelength is preferably used as the antihalation dye because the coating amount of the dye can be reduced. Therefore, an antihalation dye preferably has a narrow half value width and a sharp absorption peak on an absorption spectrum. In another way, it is also preferred to use a dye under the condition wherein the dye shows such absorption. In order to the dye to have larger absorption and sharper absorption spectrum, it is preffered to be used under the dispersion state of solid fine particle or the aggregation state. A dye having an ionic hydrophilic group preferably is used for formation of an aggregation state. The half value width of the dye preferably is 100 nm or less, more preferably 75 nm or less and most preferably 50 nm or less.

The antihalation dye either may be bleached after the image forming or may not be bleached. In the case where the dye is not bleached (from now on, this is called non-bleaching dye), the dye preferably is not remarkable in visual and the ratio of the absorption at the exposure wavelength to the absorption at 425 nm, preferably is larger. For example, in the case, wherein the photographic material is exposed by a laser diode having a radiation at 405 nm, the ratio of an absorption at 405 nm to the absorption at 425 nm is preferably 5 or more, more preferably 10 or more and particularly preferably 15 or more.

As examples of these dyes, an aminobutadiene dye, the merocyanine dye in which an acidic nucleus and an alkaline nucleus directory connect with each other or a polymethine dye may be described. And in the case of non-bleaching dye, it can be added as aqueous solution if it might be water-soluble.

In another case, an antihalation dye preferably is bleached in thermal development process. As the color bleaching method, following methods are known and any method thereof can be used.

(1) The color bleaching method by the reaction of a coloring matter (dye) composed of an electron donating color forming organic compound and an acidic developer and a specifcal dye bleaching agent at the thermal development described in such as JP-A Nos. 9-34077 and 2001-51371.

(2) The color bleaching method by a combination of the said bleaching dye and the radical generating compound by the light irradiation or the heating and the bleaching dye, described in such as JP-A Nos. 9-133984,2000-29168, 2000-284403 and 2000-347341.

(3) The color bleaching method by a combination of the said bleaching dye and a compound which can release an alkali or a nucleophile by heating and bleach the dye, described in U.S. Pat. Nos. 5,135,842, 5,258,724, 5,314,795, 5,324,627, 5,384,237, JP-A Nos. 3-26765, 6-222504, 6-222505 and 7-36145.

(4) The color bleaching method of dye througth an intra-molecular ring closure reaction by the thermal self decomposition of the dye described in U.S. Pat. No. 4,894,358, JP-A Nos. 2-289856 and 59-182436.

(5) The color bleaching method of the dye by the combination of the intra-molecular ring closure bleaching dye having an exellent bleaching property and a base or a base precursor described in JP-A Nos.6-82948, 11-231457 and 2000-112058, 2000-281923, 2000-169248.

Among them, the combination of the color bleaching agent (a radical generator, a base precursor, a nucleophile generator) and the bleaching dye is preferable, because it is easy to be consistent with the bleaching property at the thermal development and the stock stability at the non-development. Particularly, the combination of the intra-molecular ring closure bleaching dye and a base precursor is more preferable, because it can be consistent with the bleaching property and the stability.

The intra-molecular ring closure bleaching dye is preferred to have a polymethine chromophore and more preferably a polymethine dye having a group which can generate a nucleophilic at the position where a 5 to 7 ring can be formed by the reaction at the polymethine part part by the reaction of the base.

The polymethine dye having the group which can become the nucleophilic group by dissociation at the position capable of a 5 to 7 ring formation is most preferable, such as represented by the following general formulae (1) and (2).

Particularly, the dye represented by the following general formulae (1) and (2) is preferably used.

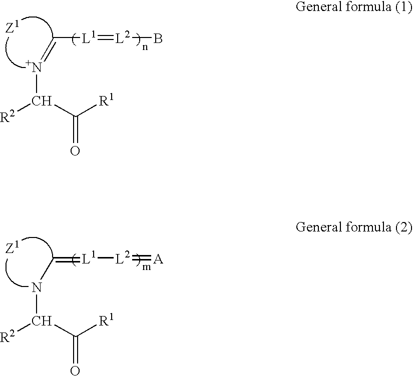

In general formulae (1) and (2), R¹ represents a hydrogen atom, an aliphatic group, an aromatic group, —NR²¹R²⁶, —OR²¹ and —SR²¹. R²¹ and R²⁶ each independently represent a hydrogen atom, an aliphatic group, an aromatic group, or R²¹ and R²⁶ may bind each other to form a nitrogen containing heterocyclic ring. R² represents a hydrogen atom, an aliphatic group, an aromatic group, or R¹ and R² may bind each other to form a 5 or 6 membered ring. L¹ and L² each independently represent a substituted or unsubstituted methine group, wherein the substituents of methine group may bind each other to form an unsaturated alicyclic ring, or an unsaturated hetero cyclic ring. Z¹ represents the atomic group necessary to form a 5 or 6 membered nitrogen containing hetero cyclic ring and the nitrogen containing hetero cyclic ring may condense with an aromatic ring and the nitrogen containing hetero cyclic ring and the condensed ring may have substituents. A represents an acidic nucleus and B represents an aromatic group, an unsubstituted heterocyclic group or a group represented by the following general formula (3). n and m each represent an integral number of 1 to 3. When n and m each represent 2 or more, L¹ and L² which represent 2 or more may be the same or different.

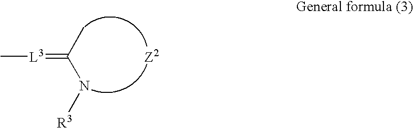

In general formula (3), L³ represents a substituted or unsubstituted methine group and may bind with L² to form an unsaturated alicyclic ring or an unsaturated heterocyclic ring. R³ represents a aliphatic group or a aromatic group. Z² represents an atomic group necessary to form a 5 or 6 membered nitrogen containing heterocyclic ring, wherein the nitrogen containing heterocyclic ring may condense with an aromatic ring, and the nitrogen containing heterocyclic ring and the condensed ring may have substituents.

In the formula above described, R¹ represents a hydrogen atom, an aliphatic group, an aromatic group, —NR²¹R²⁶, —OR²¹ and —SR²¹. R²¹ and R²⁶ each independently represents a hydrogen atom, an aliphatic group, an aromatic group or R²¹ and R²⁶ may bind each other to form a nitrogen containing hetero cyclic ring. R¹ preferably represents —NR²¹R²⁶, —OR²¹ and —SR²¹. R²¹ preferably represents an aliphatic group or an aromatic group and more preferably an unsubstituted alkyl group, a substituted alkyl group, an unsubstituted aralkyl group, a substituted aralkyl group, an unsubstituted aryl group and a substituted aryl group. R²⁶ preferably represents a hydrogen atom or an aliphatic group and more preferably a hydrogen atom, an unsubstituted alkyl group or a substituted alkyl group. The nitrogen containing heterocyclic ring formed by binding with R²¹ and R²⁶ preferably is a 5 or 6 membered ring. The nitrogen containing heterocyclic ring may have a hetero atom except for nitrogen atom (e.g., a oxygen atom, a sulfur atom).

In the specification of the present invention, “an aliphatic group” means an unsubstituted alkyl group, a substituted alkyl group, an unsubstituted alkenyl group, a substituted alkenyl group, an unsubstituted alkynyl group, a substituted alkynyl group, an unsubstituted aralkyl group, and a substituted aralkyl group. In the present invention, an unsubstituted alkyl group, a substituted alkyl group, an unsubstituted alkenyl group, a substituted alkenyl group, an unsubstituted aralkyl group and a substituted aralkyl group are preferable and an unsubstituted alkyl group, a substituted alkyl group, an unsubstituted aralkyl group and a substituted aralkyl group are more preferable. Further, a chain aliphatic group is more preferable than an alicyclic group. A chain aliphatic group may be branched. The unsubstituted alkyl group has preferably 1 to 30 carbon atoms, more preferably 1 to 15, still more preferably 1 to 10 and most preferably 1 to 8 carbon atoms. An alkyl part of a substituted alkyl group is similar to that in the preferred range of an unsubstituted alkyl group.

The unsubstituted and substituted alkenyl group have preferably 2 to 30 carbon atoms, more preferably 2 to 15, still more preferably 2 to 12, and most preferably 2 to 8 carbon atoms. An alkenyl part of a substituted alkenyl group and an alkynyl part of a substituted alkynyl group are similar to that in the each preferred range of an unsubstituted alkenyl group and an unsubstituted alkynyl group respectively. The unsubstituted aralkyl group have preferably 7 to 35 carbon atoms, more preferably 7 to 20, still more preferably 7 to 15 and most preferably 7 to 10 carbon atoms. The aralkyl part of a substituted aralkyl group is similar to that in the preferred range of an unsubstituted aralkyl group.

Examples of a substituent of an aliphatic group (a substituted alkyl group, a substituted alkenyl group, a substituted alkynyl group and a substituted aralkyl group) include a halogen atom (fluorine atom, chlorine atom and bromine atom), a hydroxy group, an alkoxy group, an aryloxy group, a silyloxy group, an oxy group substituted at a hetero ring, an acyloxy group, a carbamoyloxy group, an alkoxycarbonyloxy group, an aryloxycarbonyloxy group, a nitro group, a sulfo group, a carboxyl group, an acyl group, an alkoxycarbonyl group, an aryloxycarbonyl group, a carbamoyl group, an alkylthiocarbonyl group, a hetero ring group, a cyano group, an amino group (an anilino group is included), an acylamino group, an aminocarbonylamino group, an alkoxycarbonylamino group, an aryloxycarbonylamino group, a sulfamoylamino group, an alkyl and arylsulfonylamino group, a mercapto group, an alkylthio group, an arylthio group, a mercapto group attached to a hetero ring, a sulfamoyl group, an alkyl and arylsulfinyl group, an alkyl and arylsulfonyl group an alkoxycarbonyl group, an imido group, a phosphino group, a phosphinyl group, a phosphinyloxy group a phosphinylamino group, a phosphono group and a silyl group. A carboxyl group, a sulfo group and a phosphono group may be the corresponding salt states. The cation, which forms a salt with a carboxyl group, a phosphono group, and a sulfo group, preferably is an ammonium ion and an alkali metal ion (e.g., lithium ion, sodium ion and potassium ion).

In the specification of the present invention, “an aromatic group” means an unsubstituted aryl group or a substituted aryl group. The unsubstituted aryl group preferably has 6 to 30 carbon atoms, more preferably 6 to 20, still more preferably 6 to 15 and most preferably 6 to 12 carbon atoms. The aryl part of a substituted aryl group is the same as that in the preferred range of an unsubstituted aryl group. As examples of a substituent of an aromatic group (a substituted aryl group), the examples in an aliphatic group and the examples in the substituent of an aliphatic group can be described.

In general formula (1) and (2) described above, R² represents a hydrogen atom, an aliphatic group, or an aromatic group, wherein R¹ and R² may bind each other to form a 5 or 6 membered ring. The definition of an aliphatic group and an aromatic group is the same as that described above. R² preferably represents a hydrogen atom, or an aliphatic group and more preferably a hydrogen atom, or an alkyl group and still more preferably a hydrogen atom, or an alkyl group having 1 to 15 carbon atoms and most preferably a hydrogen atom.

In general formula (1), (2) and (3) described above, L¹, L² and L³ each independently represent a methine group which may be substituted. The substituents of methine group may bind each other to form an unsubstituted aliphatic ring or an unsubstituted heterocyclic ring. Examples of a methine group include a halogen atom, an aliphatic group and an aromatic group. The definition of an aliphatic group and an aromatic group is the same as that described above. The substituents of methine group may bind each other to form an unsaturated aliphatic ring or an unsaturated heterocyclic ring. The unsaturated aliphatic ring is more preferable than the unsaturated heterocyclic ring. The formed ring is preferably a 5 or 6 membered ring, more preferably a cyclopentene ring or a cyclohexene ring. It is particularly preferred that the methine group is unsubstituted or substituted by an alkyl group or an aryl group at the meso position.

In general formula (1) described above, n represents the integral of 1 to 3 and preferably 1 or 2. When n is 2 or more, the repeated methine group may be the same or different. In general formula (2) described above, m represents the integral of 1 to 3 and preferably 1 or 2. When m is 2 or more, the repeated methine group may be the same or different.

In general formula (1) and (2) described above, Z¹ represents the atomic group necessary to form a 5 or 6 membered nitrogen containing heterocyclic ring and may condense with an aromatic ring, wherein the nitrogen containing heterocyclic ring and the condensed ring may have substituents. As the examples of the nitrogen containing heterocyclic ring, an oxazole ring, a thiazole ring, a selenazole ring, a pyrrole ring, a pyrroline ring, an imidazole ring and a pyridine ring are included. A 5 membered ring is more preferable than a 6 membered ring. The nitrogen containing heterocyclic ring may condense with an aromatic ring (benzene ring and naphthalene ring). The nitrogen containing heterocyclic ring and the condensed ring may have substituents. As the examples of substituent, the substituent of the aromatic group described above can be described and a halogen atom (fluorine atom, chlorine atom and bromine atom), a hydroxy group, a nitro group, a carboxyl group, a sulfo group, an alkoxy group, an aryl group and an alkyl group are preferable. A carboxyl group and a sulfo group may be a salt state. As the cation which forms a salt with a carboxyl group and a sulfo group, an ammonium ion and an alkali metal ion (e.g., sodium ion and potassium ion) are preferable.

In general formula (1), B represents an aromatic group, an unsaturated heterocyclic ring group or general formula (3) described above. The definition of an aromatic group is the same as that described above. As the aromatic group represented by B, a substituted or unsubstituted phenyl group is preferable. As the substituent, a halogen atom, an amino group, an acylamino group, an alkoxy group, an aryloxy group, an alkyl group, an alkylthio group and an aryl group are preferably and an amino group, an acylamino group, an alkoxy group and an alkyl group at the 4 position are particularly preferable. As the unsaturated heterocyclic ring group represented by B, a 5 or 6 membered heterocyclic ring group composed of a carbon atom, an oxygen atom and a sulfer atom is preferable. Among them, a 5 membered ring is particularly preferable. As the preferred examples, a substituted or unsabstituted pyrrole, indole, thiophene and furan can be described.

In general formula (3) described above, Z² represents the atomic group necessary to form a 5 or 6 membered nitrogen containing heterocyclic ring and may be the same as Z¹ or different. The examples of nitrogen containing heterocyclic ring described above can be demonstrated the same examples described in the case of Z¹. In general formula (3) described above, R³ represents an aliphatic group or an aromatic group and an aliphatic group is preferable, and —CHR²(COR¹) that is similar to the substituent on a nitrogen atom of general formula (1) described above is most preferable.

In general formula (2) described above, A represents an acidic nucleus. The acidic nucleus preferably is a group in which one or more (usually two) hydrogen atoms are removed from a cyclic ketomethylene compound or a compound having a methylene group put between two electron withdrawing groups. As the examples of cyclic ketomethylene compound, a 2-pyrazoline-5-one, a rhodanine, a hydantoin, a thiohydantoin, an 2,4-oxazolidinedione, an isoxazolone, a barbituric acid, a thiobarbituric acid, an indanedione, a dioxopyrazolopyridine, a Meldrum's acid, a hydroxypyridine, a pyrazolidinedione, a 2,6-dihydrofuran-2-one and a pyrroline-2-one can be described. These may have a substituent.

The compounds having a methylene group put between the electron withdrawing groups described above can be represented as Z^{a} CH₂Z^{b}. Z^{a} and Z^{b} each independently represent —CN, —SO₂R^{a1}, —COR^{a1}, —COOR^{a2}, —CONHR^{a2}, —SO₂NHR^{a2}, —[C═C(CN)₂]R^{a1} and —C[═C(CN)₂] NHR^{a1}. R^{a1} represents an alkyl group, an aryl group or a heterocyclic ring group and R^{a2} represents a hydrogen atom, an alkyl group, an aryl group or a heterocyclic ring group and R^{a1} and R^{a2} each may have a substituent. Among these acidic nuclei, a 2-pyrazoline-5-one, an isoxazolone, a barbituric acid, an indanedione, a hydroxypyridine, a pyrazolidinedione and a dioxopyrazolopyridine are more preferably.

The dye represented by general formula (1) preferably forms a salt with an anion. In the case, wherein the dye represented by general formula (1) described above has an anionic group such as a carboxyl group and a sulfo group as a substituent, the dye can form an intra-moleculer salt. In the other case besides this, the dye preferably forms a salt with an anion outside of a molecule. An anion is preferably mono or divalent and more preferably monovalent. As the examples of anion, a halogen ion (Cl⁻, Br⁻, I⁻), a p-toluene sulfonate ion, an ethyl sulfonate ion, a 1,5-disulfonaphthalene dianion, PF₆⁻, BF₄⁻, and ClO₄⁻ can be included.

The dye represented by general formula (1) and (2) described above may be used under a molecular dispersion state, but preferably under a solid fine particle dispersion state or an aggregation state. In order to form the aggregation state of the dye described above, the dye preferably has an ionic hydrophilic group. The ionic hydrophilic group contains a sulfo group, a carboxyl group, a phosphono group a quaternary ammonium group and the like, and preferably a carboxyl group, a phosphono group and a sulfo group and more preferably a carboxyl group and a sulfo group. A carboxyl group, a phosphono group and a sulfo group may be a salt state and as the examples of counter ion to form a salt, an ammonium ion, an alkali metal ion (e.g., lithium ion, sodium ion and potassium ion) and an organic cation (e.g., tetramethylammonium ion, tetramethylguanidium ion and tetramethylphosphonium ion) are included.

General formula of an amino butadiene dye and a merocyanine dye as a non-bleaching dye for an antihalation can be shown below.

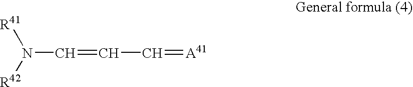

In the formula, R⁴¹ and R⁴² each independently represent a hydrogen atom, an aliphatic group, an aromatic group or the non metal atomic group necessary to form a 5 or 6 membered ring. And either one of R⁴¹ and R⁴² may bind with a methine group adjacent to a nitrogen atom to form a 5 or 6 membered ring. A⁴¹ represents an acidic nucleus.

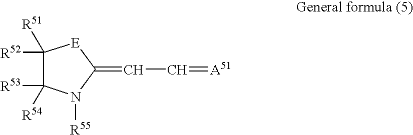

In the formula, R⁵¹ to R⁵⁵ each independently represent a hydrogen atom, an aliphatic group or an aromatic group and R⁵¹ and R⁵⁴ may join together to form a double bond. When R⁵¹ and R⁵⁴ join together to form a double bond, R⁵² and R⁵³ may join together to form a benzene ring or a naphthalene ring. R⁵⁵ represents an aliphatic group or an aromatic group and E represents an oxygen atom, a sulfur atom, an ethylene group, >N—R⁵⁶ or >C(R⁵⁷) (R⁵⁸), and R⁵⁶ represents an aliphatic group or an aromatic group, and R⁵⁷ and R⁵⁸ each independently represent a hydrogen atom or an aliphatic group. A⁵¹ represents an acidic nucleus.

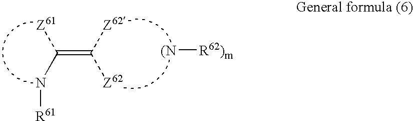

In the formula, R⁶¹ represents a hydrogen atom, an aliphatic group or an aromatic group. R⁶² represents a hydrogen atom, an aliphatic group or an aromatic group. Z⁶¹ represents an atomic group necessary to form a nitrogen containing heterocyclic ring. Z⁶² and Z^{62′} represent an atomic group necessary to form a heterocyclic ring or a noncyclic terminal acidic group by joining with (N—R⁶²)ₘ. However, Z⁶¹, Z⁶² and Z^{62′} each may condense to form a ring. m represents 0 or 1.

Following, a dye represented by general formula (4), (5), and (6) is described in detail.

For an aliphatic group and an aromatic group of R⁴¹, R⁴², R⁵¹ to R⁵⁸, R⁶¹ and R⁶² in general formula (4), (5) and (6), the similar aliphatic group and aromatic group as those described in R¹ can be applied. The examples of subsutituent also are similar to those one.

For an acidic nucleus represented by A⁴¹ and A⁵¹, similar one as those described in A of general formula (2) can be applied, and preferably applied a group in which one ore more (usually two) hydrogen atoms are removed from a ketomethylene compound or a compound having a methylene group put between two electron withdrawing groups. As more preferable examples of methylene compound, Z^{a}CH₂Z^{b} (the same definition described in A of general formula (2)), a 2-pyrazoline-5-one, an isoxazolone, a barbituric acid, an indanedione, a Meldrum's acid, a hydroxypyridine, a pyrazolidinedione, a dioxopyrazolopyridine and the like can be described. These may have a substituent.

As a 5 or 6 membered ring formed by binding with R⁴¹ and R⁴², a pyrrolidine ring, a pyperidine ring a morphorine ring and the like can be described as preferred examples.

In general formula (6) described above, Z⁶¹ is an atomic group necessary to form a 5 or 6 membered nitrogen containing heterocyclic ring and the nitrogen containing heterocyclic ring may condense with an aromatic ring. The nitrogen containing heterocyclic ring and the condensed ring may have a substituent. As the examples of nitrogen containing heterocyclic ring described above, a thiazoline nucleus, a thiazole nucleus, a benzothiazole nucleus, an oxazoline nucleus, an oxazolole nucleus, a benzoxazole nucleus, a selenazoline nucleus, a selenazole nucleus, a benzoselenazole nucleus, a tellurazoline nucleus, a tellurazole nucleus, a benzotellurazole nucleus, a 3,3-dialkylindolenine nucleus (e.g., 3,3-dimethylindolenine), an imidazoline nucleus, an imidazole nucleus, a benzimidazole nucleus, a 2-pyridine nucleus, a 4-pyridine nucleus, a 2-quinoline nucleus, a 4-quinoline nucleus, a 1-isoquinoline nucleus, a 3-isoquinoline nucleus, an imidazo[4,5-b]quinoxaline nucleus, an oxadiazole nucleus, a thiadiazole nucleus, a tetrazole nucleus, a pyrimidine nucleus and the like can be described. A thiazoline nucleus, a thiazole nucleus, a benzothiazole nucleus, an oxazoline nucleus, an oxazole nucleus, a benzoxazole nucleus, 3,3-dialkylindolenine nucleus (e.g., 3,3-dimethylindolenine), an imidazoline nucleus, an imidazole nucleus, a benzimidazole nucleus, a 2-pyridine nucleus, a 4-pyridine nucleus, a 2-quinoline nucleus, a 4-quinoline nucleus, a 1-isoquinoline nucleus and a 3-isoquinoline nucleus are preferably. And a thiazoline nucleus, a thiazole nucleus, a benzothiazole nucleus, an oxazoline nucleus, an oxazole nucleus, a benzoxazole nucleus, 3,3-dialkylindolenine nucleus (e.g., 3,3-dimethylindolenine), an imidazoline nucleus, an imidazole nucleus and a benzimidazole nucleus are more preferably. And a thiazoline nucleus, a thiazole nucleus, a benzothiazole nucleus, an oxazoline nucleus, an oxazole nucleus and a benzoxazole nucleus are particularly preferably. And a thiazoline nucleus, an oxazoline nucleus and a benzoxazole nucleus are most preferably. The nitrogen containing heterocyclic ring may condense with an aromatic ring (benzene ring and naphthalene ring). The nitrogen containing heterocyclic ring and the condensed ring may have a substituent. As the examples of substituent, a substituent of the aromatic group described above can be described, and preferably described a halogen atom (fluorine atom, chlorine atom and bromine atom), a hydroxy group, a nitro group, a carboxyl group, a sulfo group, an alkoxy group, an aryl group and an alkyl group. A carboxyl group and a sulfo group may be a salt state. As the cation which forms a salt with a carboxyl group and a sulfo group, an ammonium ion and an alkali metal ion (e.g., sodium ion and potassium ion) are preferable.

Z⁶² and Z^{62′} and (N—R⁶²)m represent an atomic group necessary to form a heterocyclic ring and a noncyclic acidic terminal group by joining each other. As a heterocyclic ring (preferably a 5 or 6 membered heterocyclic ring), any heterocyclic ring can be applied, and an acidic nucleus preferably can be applied.

Next, an acidic nucleus and a noncylic acidic terminal group are explained. As an acidic nucleus and a noncylic acidic terminal group, any acidic nucleus in merocyanine dye and any noncyclic acidic terminal group can be applied. Z⁶² preferably represents a thiocarbonyl group, a carbonyl group, an ester group, an acyl group, a carbamoyl group, a cyano group, a sulfonyl group and more preferably a thiocarbonyl group and a carbonyl group. Z^{62′} represents a residual atomic group necessary to form an acidic nucleus and a noncyclic acidic terminal group. In the case where a noncyclic acidic terminal group is formed, a thiocarbonyl group, a carbonyl group, an ester group, an acyl group, a carbamoyl group, a cyano group, a sulfonyl group and the like are preferable.

m represents 0 or 1 and preferably 1.

The acidic nucleus and the noncyclic acidic terminal group herein are described in, for example, James, “The theory of the Photographic Process”, MaCmillan publishing Co., Inc., the 4^{th} ed., pages 197 to 200, (1977). Herein, the noncyclic acidic terminal group means a group not to form a ring among an acidic terminal group that is to say an electron accepting terminal group.

Typical examples of an acidic nucleus and a noncyclic acidic terminal group are described in U.S. Pat. Nos. 3,567,719, 3,575,869, 3,804,634, 3,837,862, 4,002,480, 4,925,777, JP-A No. 3-167546, U.S. Pat. Nos. 5,994,051, 5,747,236 and the like.

The acidic nucleus preferably is a heterocyclic ring (preferably, a 5 or 6 membered nitrogen containing heterocyclic ring) composed of a carbon atom, a nitrogen atom and/or chalcogen atom (typically, an oxygen atom, a sulfur atom, a selenium atom and a tellurium atom) and more preferably a 5 or 6 membered nitrogen containing heterocyclic ring composed of a carbon atom, a nitrogen atom and/or chalcogen atom (typically, an oxygen atom, a sulfur atom, a selenium atom and a tellurium atom). As typical examples, the nucleus of 2-pyrazoline-5-one, pyrazolidine-3,5-dione, imidazoline-5-one, hydantoin, 2- or 4-thiohydantoin, 2-iminoxazolidine-4-one, 2-oxazoline-5-one, 2-thioxazolidine-2,5-dione, 2-thioxazoline-2,4-dione, isoxazolidine-5-one, 2-thiazoline-4-one, thiazolidine-4-one, thiazolidine-2,4,-dione, rhodanine, thiazolidine-2,4-dithione, isorhodanine, indane-1,3-dione, thiophene-3-one, thiophene-3-one-1,1-dioxide, indoline-2-one, indoline-3-one, 2-oxoindazolinium, 3-oxoindazolinium, 5,7-dioxo-6,7-dihydrothiazolo[3,2-a]pyrimidine, cyclohexane-1,3-dione, 3,4-dihydroisoquinoline-4-one, 1,3-dioxane-4,6-dione, barbituric acid, 2-thiobarbituric acid, chromane-2,4-dione, indazoline-2-one, pyrido[1,2-a]pyrimidine-1,3-dione, pyrazolo[1,5-b]quinazolone, pyrazolo[1,5-a]benzimidazole, pyrazolopyrydone, 1,2,3,4-tetrahydroquinoline-2,4-dione, 3-oxo-2,3-dihydrobenzo[d]thiophene-1,1-dioxide, 3-dicyanomethine-2,3-dihydrobenzo[d]thiophene-1,1-dioxide, a nucleus having an exo-methylene structure formed by substitution of the carbonyl group or a thiocarbonyl group in the nuclei above described at an active methylene position of acidic nucleus, a nucleus having an exo-methylene structure formed by substitution at an active methylene position of active methylene compound having a ketomethylene or a cyanomethylene structure which can be a starting material of noncyclic acidic terminal group and a nucleus having a repeating structure of these nuclei are described.

An acidic nucleus and a noncyclic acidic terminal group described above may be substituted by a substutuent described above as an example of the substituent in an aromatic group and and the ring may be condensed.

As Z⁶², Z^{62′} and (N—R⁶²)m, hydantoin, 2- or 4-thiohydantoin, 2-oxazoline-5-one, 2-thioxazoline-2,4-dione, thiazolidine-2,4,-dione, rhodanine, thiazolidine-2,4-dithione, barbituric acid and 2-thiobarbituric acid are preferable and hydantoin, 2- or 4-thiohydantoin, 2-oxazoline-5-one, rhodanine, barbituric acid and 2-thiobarbituric acid are more preferable and 2- or 4-thiohydantoin, 2-oxazoline-5-one and rhodanine are especially preferable.

In the case where a dye represented by general formulae (4) to (6) described above is water-soluble, it is preferred that the dye has an ionic hydrophilic group. The examples and the preferred examples of ionic hydrophilic group are similar to those described in general formulae (1) and (2).

Typical examples of antihalation dye for preferred use are shown below, but the antihalation dyes are not limited to following typical examples.

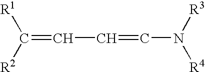

| No | —R¹ | —R² | —R³ | —R⁴ |
|---|---|---|---|---|
| 1 | —CN | —CO₂CH₃ | —nC₄H₉ | —nC₄H₉ |
| 2 | —CN | —CN | —nC₆H₁₃ | —nC₆H₁₃ |
| 3 | —CN | 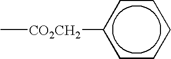 | 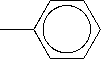 | —nC₄H₉ |
| 4 | —CN | —CN | 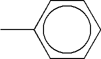 | —nC₆H₁₃ |
| 5 | —CN | —CN | 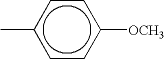 | —C₂H₅ |
| 6 | —COCH₃ | —COCH₃ | —C₂H₅ | —C₂H₅ |
| 7 | —COCH₃ | —CO₂C₂H₅ | —C₂H₅ | —C₂H₅ |
| 8 | —COCH₃ | —CO₂C₂H₅ | —CH₂CH₂—O—CH₂CH₂— | |
| 9 | 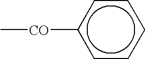 | —CO₂C₂H₅ | —nC₆H₁₃ | —nC₆H₁₃ |
| 10 | —COCH₃ | 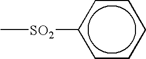 | —C₂H₅ | —C₂H₅ |
| 11 | —COCH₃ | 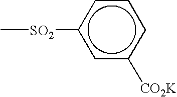 | —CH₂CH₂SO₃K | —CH₂CH₂SO₃K |
| 12 | —COCH₃ | 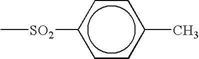 | —H | —tC₄H₉ |
| 13 | —COCH₃ | —CONHCH₂CH₂SO₃Na | —C₂H₅ | —C₂H₅ |
| 14 | —COCH₃ | 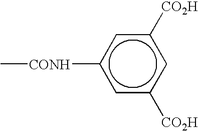 | 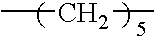 | |
| 15 | 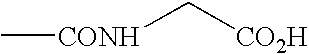 | 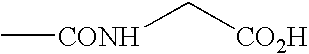 | 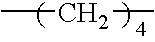 | |
| 16 | —CONHCH₂CH₂SO₃Na | —CONHCH₂CH₂SO₃Na | nC₃H₇ | nC₃H₇ |
| 17 | —COCH₃ | —CO₂C₂H₅ | —CH₂CH₂SO₃Na | —CH₂CH₂SO₃Na |
| 18 | —CO₂C₂H₅ | —CO₂C₂H₅ | 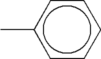 | —CH₂CH₂SO₃Na |

| | |
|---|---|
| 19 | 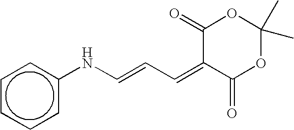 |
| 20 | 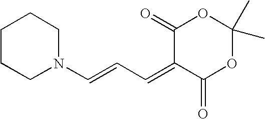 |
| 21 | 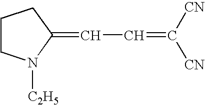 |
| 22 | 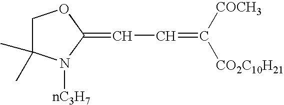 |
| 23 | 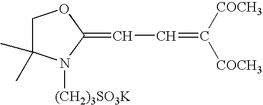 |
| 24 | 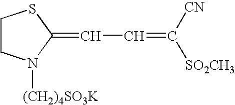 |
| 25 | 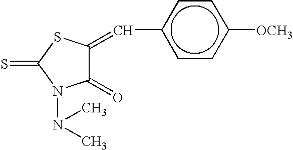 |
| 26 | 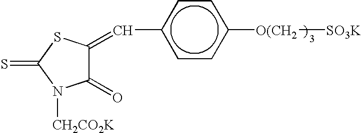 |
| 27 | 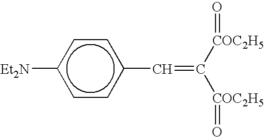 |
| 28 | 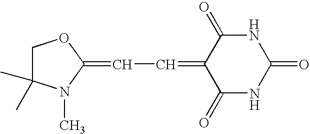 |
| 29 | 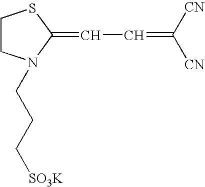 |
| 30 | 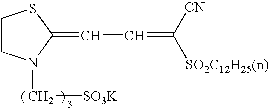 |
| 31 | 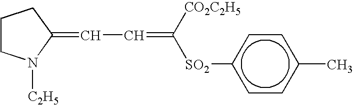 |
| 32 | 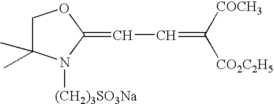 |

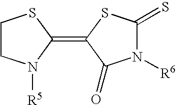

| No. | R⁵ | R⁶ |
|---|---|---|
| 33 | —C₂H₅ | —CH₂CO₂H |
| 34 | —nC₆H₁₃ | 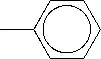 |
| 35 | 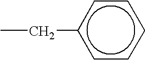 | —nC₁₂H₂₅ |
| 36 | 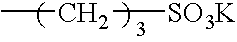 | —H |
| 37 | 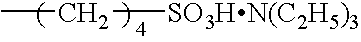 | —CH₂CO₂H |
| 38 | 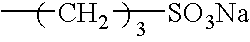 | 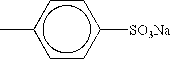 |
| 39 | —nC₃H₇ | 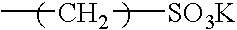 |

| | |
|---|---|
| 40 | 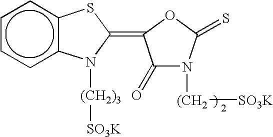 |
| 41 | 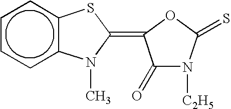 |
| 42 | 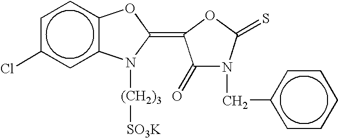 |
| 43 | 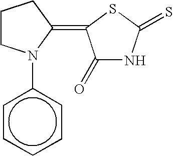 |
| 44 | 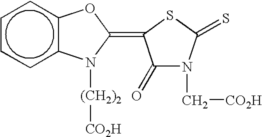 |
| 45 | 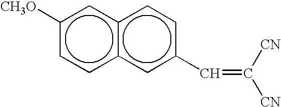 |
| 46 | 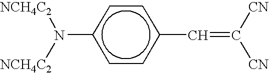 |
| 47 | 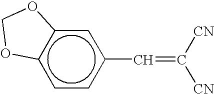 |
| 48 | 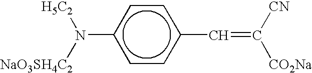 |
| 49 | 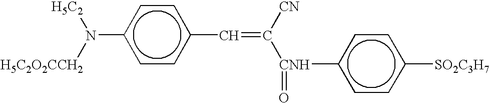 |
| 50 | 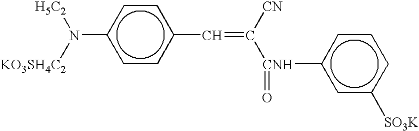 |
| 51 | 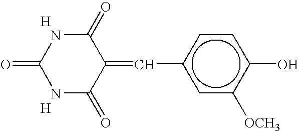 |
| 52 | 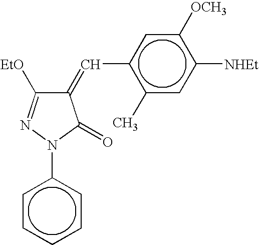 |
| 53 | 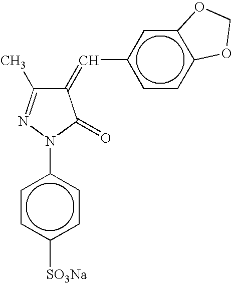 |
| 54 | 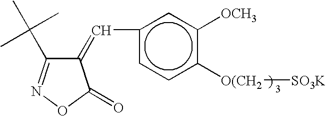 |
| 55 | 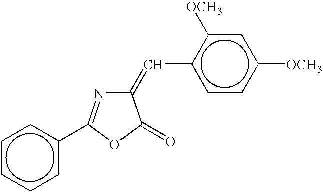 |
| 56 | 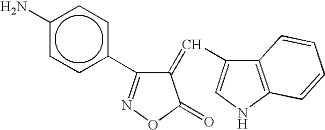 |
| 57 | 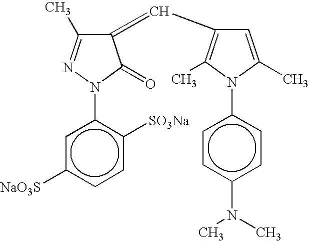 |
| 58 | 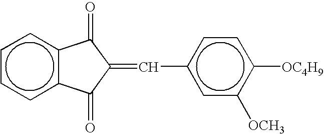 |
| 59 | 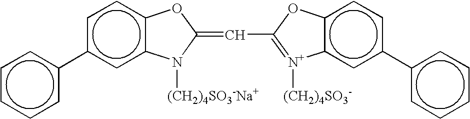 |
| 60 | 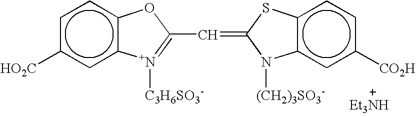 |
| 61 | 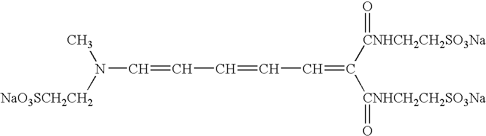 |
| 62 | 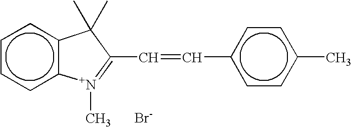 |
| 63 | 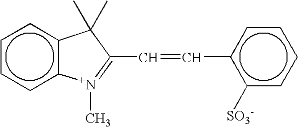 |
| 64 | 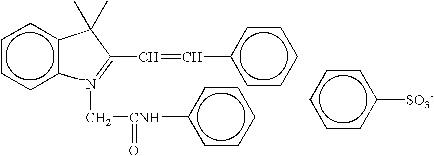 |
| 65 | 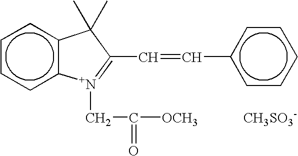 |
| 66 | 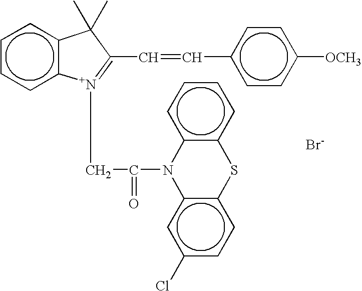 |
| 67 | 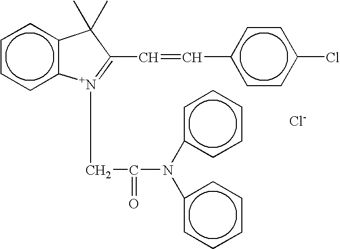 |
| 68 | 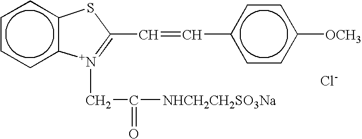 |
| 69 | 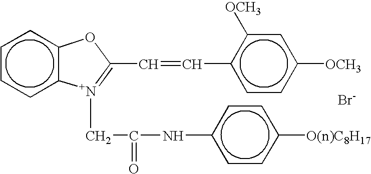 |
| 70 | 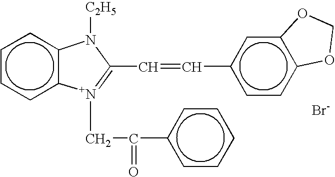 |
| 71 | 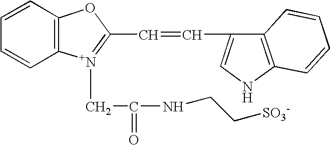 |
| 72 | 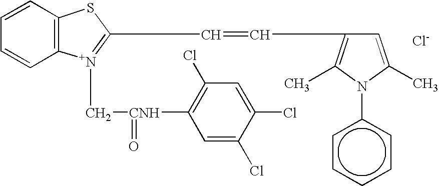 |
| 73 | 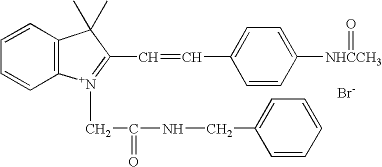 |
| 74 | 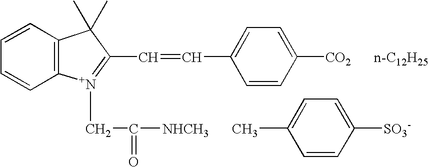 |
| 75 | 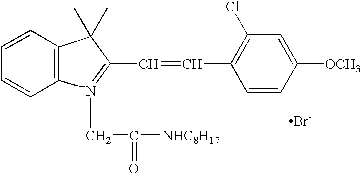 |
| 76 | 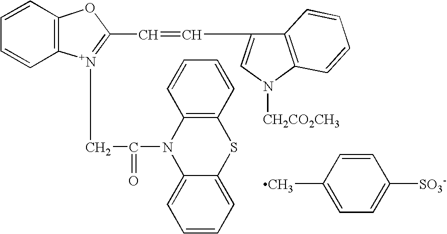 |
| 77 | 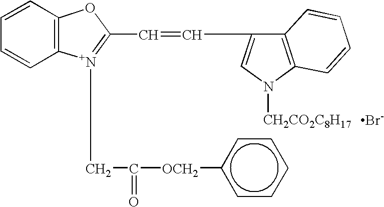 |
| 78 | 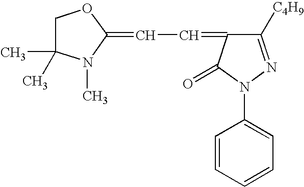 |
| 79 | 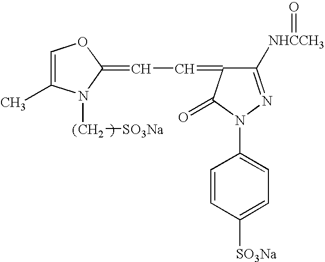 |
| 80 | 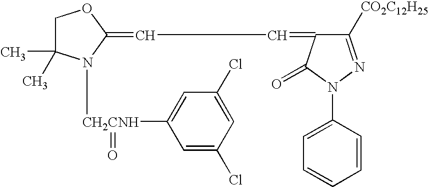 |
| 81 | 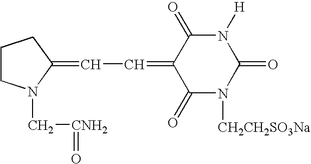 |
| 82 | 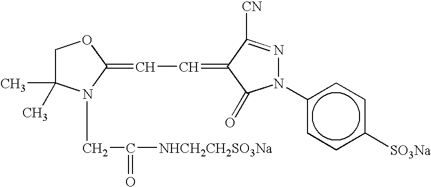 |
| 83 | 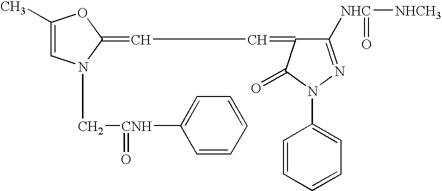 |
| 84 | 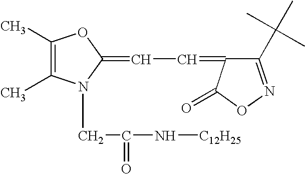 |
| 85 | 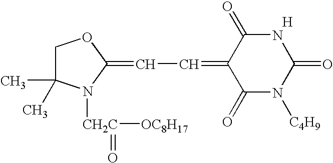 |
| 86 | 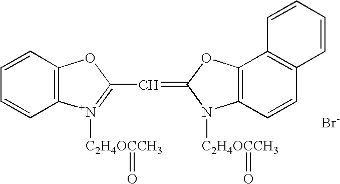 |
| 87 | 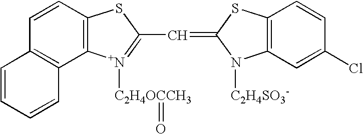 |
| 88 | 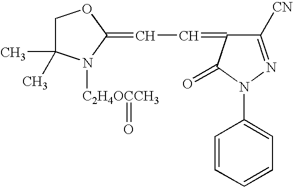 |
| 89 | 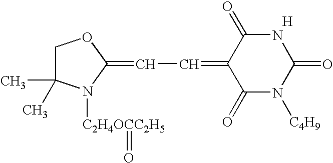 |
| 90 | 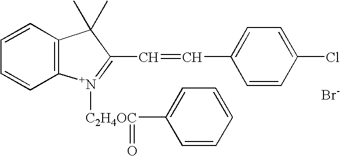 |
| 91 | 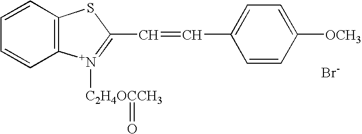 |
| 92 | 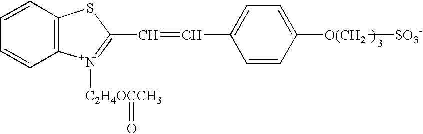 |
| 93 | 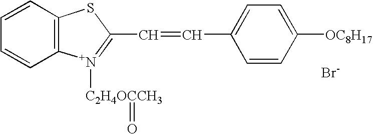 |

As the synthesis of antihalation dye, the general synthesis is described in Frances Harmer, The Cyanine Dyes and Related Compounds, Interscience Publishers, 1964. Specifically, the synthesis can be performed by the method based on the method described in JP-A Nos. 11-231457, 2000-112058, 2000-86927 and 2000-86928.

In the case to decolorize an antihalation dye at the thermal developing process, the color bleaching can be made by an action of a color bleaching agent under the thermal condition. Particularly, the dye represented by general formulae (1) and (2) described above is bleached by an action of a base, wherein the base causes a deprotonation from an active methylene group and the resulting nucleophile attacks to the methylene chain in a molecule and then the intra-molecular ring closure is occurred and finally the dye is decolorized. Therefore, as the base usable for this reaction, any base can be used as far as it can cause the deprotonation of active methylene group in the dye. Though the ring number newly formed by an intra-molecular ring closure reaction is not especially limited, a 5 to 7 membered ring is preferable and a 5 or 7 membered ring is more preferable. The actually colorless compound formed in this way is stable compound and does not return to the original dye. And there is no coloring problem caused by returning of the bleached dye back to the original dye.

A heating temperature in the bleaching reaction of above described dye is preferably 40° C. to 200° C. and more preferably 80° C. to 150° C. and still more preferably 100° C. to 130° C. and most preferably 115° C. to 125° C. The heating time is preferably 5 seconds to 120 seconds and more preferably 10 seconds to 60 seconds and still more preferably is 12 seconds to 30 seconds and most preferably is 14 seconds to 25 seconds. In the photothermographic material, the heating for thermal development can be used for decolorizing of dye.

A heat response type base precursor, which generates a base by heating (described after in detail), is preferably used. In this case, the actual temperature and heating time are determined under the consideration of the temperature or the time necessary for thermal development and the temperature and the time necessary for the thermal decomposition.

The color bleaching agent necessary for bleaching reaction is preferably a radical, a nucleophile, a base or a precursor thereof. In the case where a dye represented by general formula (1) or (2) described above is used, it is preferred to bleach by using a base or a base precursor. A base necessary for bleaching reaction means a base in a wide sense and contains a nucleophile (Lewis base) in addition to a base in a narrow sense. When a base and a dye coexist, there is a fear of the bleaching reaction progressing a little, even if under the room temperature. Therefore, a base is preferably isolated from a dye physically or chemically, and the isolation is released at the time to be decoloried, for example by heating, resulting a contact (reaction) of the dye and the base. There are three physical isolation method of both compounds: namely to make at least one of the base and the dye described above enclose in a microcapsule; to make at least one of the base and the dye described above enclose in a fine particle of a heat melting compound; or to make the dye described and the base described above contain in a different layer each other. One type of the microcapule described above is exploded by pressure and the other is exploded by heating. It is convenient to use the thermal explosion type (heat response type) of microcapsule, as the bleaching reaction described above progresses easily under the thermal condition. At least one of a base and a dye is enclosed in a microcapsule to isolate each other. It is also preffered to enclose both of them in different capsules each other. In the case wherein an outer shell of a microcapsule is opaque, it is preferred that a dye is contained in the outside of microcapsule and a base is contained in the microcapsule. As the heat response microcapsule, it is described in Hiroyuki Moriga, NYUMON TOKUSYUSI NO KAGAKU, 1975 and JP-A No. 1-150575.

As the heat melting compound described above to isolate a dye and a base described above, a wax and the like can be used. The isolation can be done by the addition of at least one of a dye and a base (preferably a base) in a fine particle of a heat melting compound. A melting point of a heat melting compound described above is preferably between a room temperature and a heating temperature at which a bleaching reaction occurs. In the case, wherein a dye and a base are isolated by incorporating to different layers each other, it is preferred that a barrier layer containing a heat melting compound is arranged between those layers.

A chemical isolation of a dye and a base is practically convenient and preffered. As the chemical isolation method of both, it is preferred to use a base precursor capable to generate (releasing of base is also contained) a base by heating. As the base precursor described above, a thermal decomposition type base precursor is typically and a thermal decomposition type base precursor composed of a carboxylic acid and a base (decarbonation type) is particularly typically. When the decarbonation type base precursor is heated, the carboxyl group of carboxylic acid is decarbonated and an organic base is released. As the carboxylic acid composing of the thermal decomposition type base precursor, sulfonyldiacetic acid and propiolic acid which can decarbonate easily can be used. A sulfonyldiacetic acid and propiolic acid having a substituent group having an aromaticity to promote a decarbonation (an aryl group and an unsaturated heterocyclic ring group) is preffered. A base precursor with a sulfonyldiacetic acid is described in JP-A No. 59-168441 and a base precursor with a propiolic acid salt is described in JP-A No. 59-180537. As a base component of a decarbonation type base precursor, an organic base is preferable and amidines, guanidines and these derivatives are more preferable. The organic base is preferably a diacidic base, a triacidic base or a tetraacidic base and more preferably diacidic base and most preferably an amidine derivative or a guanidine derivative.

As the precursor of a diacidic base, a triacidic base and a tetreaacidic base of amidine derivative, it is described in JP-B No. 7-59545. As the precursor of a diacidic base, a triacidic base and a tetreaacidic base of guanidine derivative, it is described in JP-B No. 8-10321. The diacidic base of amidine derivative or guanidine derivative is composed of (A) two amidine parts or guanidine parts, (B) the substituent of amidine part or guanidine part and (C) divalent connecting group to bind two amidine parts or guanidine parts. As the examples of substituent of (B), an alkyl group (a cycloalkyl group is contained), an alkenyl group, an alkynyl group, an aralkyl group and a heterocyclic residual group are included. Two or more substituents may bind together to form a nitrogen containing heterocyclic ring. The connecting group of (C) is preferably an alkylene group or a phenylene group. As the example of diacidic base precursor of amidine derivative or guanidine derivative, the base precursor described in compound 55 to compound 95 in JP-A No.11-231457 can be preferably used in the present invention.

When the dye described above is bleached, the optical density after thermal development can be decreased to 0.1 or less. Two or more bleaching dyes may be used together in a photothermographic material. Similarly, two or more base precursors may be used in combination. In a thermal bleaching process, wherein a base and a dye described above are used, it is preferable to use a compound which can decrease a melting point of a base precursor at 3° C. or more by mixing with a base precursor. Such melting point decreasing compound is described in JP-A No. 11-352626 and the examples are diphenylsulfone, 4-chlorophenyl(phenyl)sulfone, 2-naphthylbenzoate and the like.

A layer containing an antihalation dye preferably contains a binder with the dye. As a binder, a hydrophilic polymer (e.g., a polyvinyl alcohol, a gelatin) is preferable. In general, an addition amount of an antihalation dye in a photothermographic material is preferably in a range wherein an optical density (absorbance) shows 0.1 or more and more preferably 0.2 to 2.0. The amount of dye needed for obtaining those optical density can be smaller by using an aggregation dye and generally is 0.001 g/m² to 0.2 g/m² and preferably 0.001 g/m² to 0.1 g/m² and more preferably 0.001 g/m² to 0.05 g/m². In an embodiment wherein an antihalation dye is bleached, it is possible to make the optical density decrease to 0.1 or less by the dye bleaching. Two or more dyes may be used in combination. Similarly, two or more base precursors may be used in combination. An amount of a base precursor (mol) for usage preferably is 1 to 100 times toward an addition amount of dye (mol) and more preferably 3 to 30 times. A base precursor is preferably dispersed and contained in either layer of photothermographic material as a solid fine particle state.

As an addition method for an antihalation dye to a light insensitive layer, an addtion of a solid fine particle dispersion or an aggregation dispersion of dye to the coating solution for the light insensitive layer can be adopted. The addition method generally is similar to the addition method of dye generally used in the photothermographic material.

1-9. Preparation of Coating Solution

A preparation temperature of an image forming layer coating solution of the invention is preferably 30° C. to 65° C., more preferably 35° C. or higher and lower than 60° C., and still more preferably 35° C. to 55° C. It is preferable to keep a temperature of the image forming layer coating solution immediately after addition of a polymer latex at 30° C. to 65° C.

2. Layer Constitution and Other Constituting Components

The photothermographic material according to he invention may have a non-photosensitive layer in addition to the image forming layer. The non-photosensitive layers can be classified depending on the layer arrangement into (a) a surface protective layer provided on the image forming layer (on the side farther from the support), (b) an intermediate layer provided among plural image forming layers or between the image forming layer and the protective layer, (c) an undercoat layer provided between the image forming layer and the support, and (d) a back layer provided to the side opposite to the image forming layer.

Furthermore, a layer that functions as an optical filter may be provided as (a) or (b) above. An antihalation layer may be provided as (c) or (d) to the photosensitive material.

1) Surface Protective Layer

The photothermographic material of the invention may further comprise a surface protective layer with an object to prevent adhesion of the image forming layer. The surface protective layer may be a single layer, or plural layers. Description on the surface protective layer may be found in paragraph Nos. 0119 to 0120 of JP-A No. 11-65021 and in JP-A No. 2001-348546.

Preferred as the binder of the surface protective layer of the invention is gelatin, but polyvinyl alcohol (PVA) may be used preferably instead, or in combination. As gelatin, there can be used an inert gelatin (e.g., Nitta gelatin 750), a phthalated gelatin (e.g., Nitta gelatin 801), and the like.

Usable as PVA are those described in paragraph Nos. 0009 to 0020 of JP-A No. 2000-171936, and preferred are the completely saponified product PVA-105 and the partially saponified PVA-205 and PVA-335, as well as modified polyvinyl alcohol MP-203 (trade name of products from Kuraray Ltd.).

The coverage of polyvinyl alcohol (per 1 m² of support) in the protective layer (per one layer) is preferably in a range of from 0.3 g/m² to 4.0 g/m², and more preferably, from 0.3 g/m² to 2.0 g/m².

The coating amount of the total binder (including water-soluble polymer and latex polymer) in the surface protective layer (per one layer) is preferably 0.3 g/m² to 5.0 g/m², more preferably, 0.3 g/m² to 2.0 g/m² per one m² of a support.

2) Back Layer

Back layers usable in the invention are described in paragraph Nos. 0128 to 0130 of JP-A No. 11-65021.

In the invention, coloring matters having maximum absorption in the wavelength range of from 300 nm to 450 nm may be added in order to improve a color tone of developed images and a deterioration of the images during aging. Such coloring matters are described in, for example, JP-A Nos. 62-210458, 63-104046, 63-103235, 63-208846, 63-306436, 63-314535, 01-61745, 2001-100363, and the like. Such coloring matters are generally added in the range of from 0.1 mg/m² to 1 g/m², preferably to the back layer provided to the side opposite to the photosensitive layer.

3) Matting Agent

A matting agent may be preferably added to the photothermographic material of the invention in order to improve transportability. Description on the matting agent can be found in paragraphs Nos. 0126 to 0127 of JP-A No.11-65021. The amount of adding the matting agents is preferably in the range from 1 mg/m² to 400 mg/m², more preferably, from 5 mg/m² to 300 mg/m², with respect to the coating amount per one m² of the photosensitive material.

The mattness on the image forming layer surface is not restricted as far as star-dust trouble occurs, but the mattness of 30 seconds to 2000 seconds is preferred, particularly preferred, 40 seconds to 1500 seconds as Beck's smoothness. Beck's smoothness can be calculated easily, by seeing Japan Industrial Standared (JIS) P8119 “The method of testing Beck's smoothness for papers and sheets using Beck's test apparatus”, or TAPPI standard method T479.

The matting degree of the back layer in the invention is preferably in a range of 1200 seconds or less and 10 seconds or more; more preferably, 800 seconds or less and 20 seconds or more; most preferably, 500 seconds or less and 40 seconds or more when expressed by Beck smoothness.

In the present invention, a matting agent is preferably contained in an outermost layer, in a layer which can be function as an outermost layer, or in a layer nearer to outer surface, and also preferably is contained in a layer which can function as so coiled protective layer.

4) Polymer Latex

In the photothermographic material of the present invention, it is preferred to incorporate polymer latex in the surface protective layer and the back layer.

As such polymer latexes, descriptions can be found in “Gosei Jushi Emulsion (Synthetic resin emulsion)” (Taira Okuda and Hiroshi Inagaki, Eds., published by Kobunshi Kankokai (1978)), “Gosei Latex no Ouyou (Application of synthetic latex)” (Takaaki Sugimura, Yasuo Kataoka, Soichi Suzuki, and Keiji Kasahara, Eds., published by Kobunshi Kankokai (1993)), and “Gosei Latex no Kagaku (Chemistry of synthetic latex)” (Soichi Muroi, published by Kobunshi Kankokai (1970)). More specifically, there can be mentioned a latex of methyl methacrylate (33.5% by weight)/ethyl acrylate (50% by weight)/methacrylic acid (16.5% by weight) copolymer, a latex of methyl methacrylate (47.5% by weight)/butadiene (47.5% by weight)/itaconic acid (5% by weight) copolymer, a latex of ethyl acrylate/methacrylic acid copolymer, a latex of methyl methacrylate (58.9% by weight)/2-ethylhexyl methacrylate (25.4% by weight)/styrene (8.6% by weight)/2-hydroethyl methacrylate (5.1% by weight)/acrylic acid copolymer, a latex of methyl methacrylate (64.0% by weight)/styrene (9.0% by weight)/butyl acrylate (20.0% by weight)/2-hydroxyethyl methacrylate (5.0% by weight)/acrylic acid copolymer (2.0% by weight), and the like.

The polymer latex in the surface protective layer preferably is contained in an amount of 10% by weight to 90% by weight, particularly preferably, of 20% by weight to 80% by weight of the total weight of binder.

5) Surface pH

The surface pH of the photothermographic material according to the invention preferably yields a pH of 7.0 or lower, more preferably, 6.6 or lower, before thermal development treatment. Although there is no particular restriction concerning the lower limit, the lower limit of pH value is about 3, and the most preferred surface pH range is from 4 to 6.2.

From the viewpoint of reducing the surface pH, it is preferred to use an organic acid such as phthalic acid derivative or a non-volatile acid such as sulfuric acid, or a volatile base such as ammonia for the adjustment of the surface pH. In particular, ammonia can be used favorably for the achievement of low surface pH, because it can easily vaporize to remove it before the coating step or before applying thermal development.

It is also preferred to use a non-volatile base such as sodium hydroxide, potassium hydroxide, lithium hydroxide, and the like, in combination with ammonia. The method of measuring surface pH value is described in paragraph No. 0123 of the specification of JP-A No. 2000-284399.

6) Hardener

A hardener can be used in each of image forming layer, protective layer, back layer, and the like. As examples of the hardener, descriptions of various methods can be found in pages 77 to 87 of T. H. James, “THE THEORY OF THE PHOTOGRAPHIC PROCESS, FOURTH EDITION” (Macmillan Publishing Co., Inc., 1977). Preferably used are, in addition to chromium alum, sodium salt of 2,4-dichloro-6-hydroxy-s-triazine, N,N-ethylene bis(vinylsulfonacetamide), and N,N-propylene bis(vinylsulfonacetamide), polyvalent metal ions described in page 78 of the above literature and the like, polyisocyanates described in U.S. Pat. No. 4,281,060, JP-A No. 6-208193 and the like, epoxy compounds of U.S. Pat. No. 4,791,042 and the like, and vinyl sulfone based compounds of JP-A No. 62-89048.

The hardener is added as a solution, and the solution is added to the coating solution for forming the protective layer 180 minutes before coating to just before coating, preferably 60 minutes before to 10 seconds before coating. However, so long as the effect of the invention is sufficiently exhibited, there is no particular restriction concerning the mixing method and the conditions of mixing.

As specific mixing methods, there can be mentioned a method of mixing in the tank, in which the average stay time calculated from the flow rate of addition and the feed rate to the coater is controlled to yield a desired time, or a method using static mixer as described in Chapter 8 of N. Harnby, M. F. Edwards, A. W. Nienow (translated by Koji Takahashi) “Liquid Mixing Technology” (Nikkan Kogyo Shinbun, 1989), and the like.

7) Surfactant

As the surfactant, the solvent, the support, antistatic agent or the electrically conductive layer, and the method for obtaining color images applicable in the invention, there can be mentioned those disclosed in paragraph Nos. 0132, 0133, 0134, 0135, and 0136, respectively, of JP-A No. 11-65021. The lubricant is described in paragraph Nos. 0061 to 0064 of JP-A No. 11-84573.

In the invention, preferably used are fluorocarbon surfactant. Specific examples of fluorocarbon surfactants can be found in those described in JP-A Nos. 10-197985, 2000-19680, and 2000-214554. Polymer fluorocarbon surfactants described in JP-A 9-281636 can be also used preferably. For the photothermographic material in the invention, the fluorocarbon surfactants described in JP-A Nos. 2002-82411, 2001-242357, and 2001-264110 are preferably used. Especially, the usage of the fluorocarbon surfactants described in JP-A Nos. 2001-242357 and 2001-264110 in an aqueous coating solution is preferred viewed from the standpoint of capacity in static control, stability of the coating side state and sliding facility. The fluorocarbon surfactant described in JP-A No. 2001-264110 is mostly preferred because of high capacity in static control and that it needs small amount to use.

According to the invention, the fluorocarbon surfactant can be used on either side of image forming layer side or back layer side, but is preferred to use on the both sides. Further, it is particularly preferred to use in combination with electrically conductive layer including aforementioned metal oxides. In this case the amount of the fluorocarbon surfactant on the side of the electrically conductive layer can be reduced or removed.

The amount of the fluorocarbon surfactant used is preferably in the range of 0.1 mg/m² to 100 mg/m² on each side of image forming layer and back layer, more preferably 0.3 mg/m² to 30 mg/m², further preferably 1 mg/m² to 10 mg/m².

8) Antistatic Agent

The photothermographic material of the invention preferably contains an electrically conductive layer including metal oxides or electrically conductive polymers. The antistatic layer may serve as an undercoat layer, or a back surface protective layer, and the like, but can also be placed specially. As an electrically conductive material of the antistatic layer, metal oxides having enhanced electric conductivity by the method of introducing oxygen defects or different types of metallic atoms into the metal oxides are preferably for use. Examples of metal oxides are preferably selected from ZnO, TiO₂ and SnO₂. As the combination of different types of atoms, preferred are ZnO combined with Al, In; SnO₂ with Sb, Nb, P, halogen atoms, and the like; TiO₂ with Nb, Ta, and the like; Particularly preferred for use is SnO₂ combined with Sb. The amount of adding different types of atoms is preferably in a range of from 0.01 mol % to 30 mol %, and particularly preferably, in a range of from 0.1 mol % to 10 mol %. The shape of the metal oxides can include, for example, spherical, needle-like, or plate-like shape. The needle-like particles, with the rate of (the major axis)/(the minor axis) is more than 2.0, or more preferably, 3.0 to 50, is preferred viewed from the standpoint of the electric conductivity effect. The metal oxides is used preferably in the range from 1 mg/m² to 1000 mg/m², more preferably from 10 mg/m² to 500 mg/m², and further preferably from 20 mg/m² to 200 mg/m². The antistatic layer can be laid on either side of the image forming layer side or the back layer side, it is preferred to set between the support and the back layer. Examples of the antistatic layer in the invention include described in JP-A Nos. 11-65021, 56-143430, 56-143431, 58-62646, and 56-120519, and in paragraph Nos. 0040 to 0051 of JP-A No. 11-84573, U.S. Pet. No. 5,575,957, and in paragraph Nos. 0078 to 0084 of JP-A No. 11-223898.

9) Support

As the transparent support, favorably used is polyester, particularly, polyethylene terephthalate, which is subjected to thermal treatment in the temperature range of from 130° C. to 185° C. in order to relax the internal strain caused by biaxial stretching and remaining inside the film, and to remove strain ascribed to heat shrinkage generated during thermal development. In the case of a photothermographic material for medical use, the transparent support may be colored with a blue dye (for instance, dye-1 described in the example of JP-A No. 8-240877), or may be uncolored. As to the support, it is preferred to apply undercoating technology, such as water-soluble polyester described in JP-A No. 11-84574, a styrene-butadiene copolymer described in JP-A No. 10-186565, and a vinylidene chloride copolymer described in JP-A No. 2000-39684. The moisture content of the support, whereon an image forming layer and a back layer are coated, is preferably 0.5% by weight or less.

10) Other Additives

Furthermore, antioxidant, stabilizing agent, plasticizer, UV absorbent, or a coating aid may be added to the photothermographic material. Each of the additives is added to either of the photosensitive layer or the non-photosensitive layer. Reference can be made to WO No. 98/36322, EP-A No. 803764A1, JP-A Nos. 10-186567 and 10-18568, and the like.

11) Coating Method

The photothermographic material of the invention may be coated by any method. More specifically, various types of coating operations inclusive of extrusion coating, slide coating, curtain coating, immersion coating, knife coating, flow coating, or an extrusion coating using the type of hopper described in U.S. Pat. No. 2,681,294 are used. Preferably used is extrusion coating or slide coating described in pages 399 to 536 of Stephen F. Kistler and Petert M. Shweizer, “LIQUID FILM COATING” (Chapman & Hall, 1997), and most preferably used is slide coating. Example of the shape of the slide coater for use in slide coating is shown in Figure 11b.1, page 427, of the same literature. If desired, two or more layers can be coated simultaneously by the method described in pages 399 to 536 of the same literature, or by the method described in U.S. Pat. No. 2,761,791 and British Patent No. 837,095. Particularly preferred in the invention is the method described in JP-A Nos. 2001-194748, 2002-153808, 2002-153803, and 2002-182333.

The coating solution for the layer containing organic silver salt in the invention is preferably a so-called thixotropic fluid. For the details of this technology, reference can be made to JP-A No. 11-52509. The viscosity of the coating solution for the layer containing organic silver salt in the invention at a shear velocity of 0.1S⁻¹ is preferably from 400 mPa·s to 100,000 mPa·s, and more preferably, from 500 mPa·s to 20,000 mPa·s. At a shear velocity of 1000S⁻¹, the viscosity is preferably from 1 mPa·s to 200 mPa·s, and more preferably, from 5 mPa·s to 80 mPa·s.

In the case of mixing two types of liquids on preparing the coating solution of the invention, known in-line mixer and in-plant mixer can be used favorably. Preferred in-line mixer of the invention is described in JP-A No. 2002-85948, and the in-plant mixer is described in JP-A No. 2002-90940.

The coating solution of the invention is preferably subjected to defoaming treatment to maintain the coated surface in a fine state. Preferred defoaming treatment method in the invention is described in JP-A No. 2002-66431.

In the case of applying the coating solution of the invention to the support, it is preferred to perform diselectrification in order to prevent the adhesion of dust, particulates, and the like due to charge up. Preferred example of the method of diselectrification for use in the invention is described in JP-A No. 2002-143747.

Since a non-setting coating solution is used for the image forming layer in the invention, it is important to precisely control the drying wind and the drying temperature. Preferred drying method for use in the invention is described in detail in JP-A Nos. 2001-194749 and 2002-139814.

In order to improve the film-forming properties in the photothermographic material of the invention, it is preferred to apply a thermal treatment immediately after coating and drying. The temperature of the thermal treatment is preferably in a range of from 60° C. to 100° C. at the film surface, and heating time is preferably in a range of from 1 second to 60 seconds. More preferably, heating is performed in a temperature range of from 70° C. to 90° C. at the film surface for a duration of from 2 seconds to 10 seconds. A preferred method of thermal treatment for the invention is described in JP-A No. 2002-107872.

Furthermore, the production methods described in JP-A Nos. 2002-156728 and 2002-182333 are favorably used in the invention in order to stably and continuously produce the photothermographic material of the invention.

The photothermographic material is preferably of mono-sheet type (i.e., a type which can form image on the photothermographic material without using other sheets such as an image-receiving material).

12) Wrapping Material

In order to suppress fluctuation from occurring on the photographic performance during a preservation of the photosensitive material of the invention before thermal development, or in order to improve curling or winding tendencies, it is preferred that a wrapping material having low oxygen transmittance and/or vapor transmittance is used. Preferably, oxygen transmittance is 50 mL/atm·m²·day or lower at 25° C., more preferably, 10 mL/atm·m²·day or lower, and most preferably, 1.0 mL/atm·m²·day or lower. Preferably, vapor transmittance is 10 g/atm·m²·day or lower, more preferably, 5 g/atm·m²·day or lower, and most preferably, 1 g/atm·m²·day or lower. As specific examples of a wrapping material having low oxygen transmittance and/or vapor transmittance, reference can be made to, for instance, the wrapping material described in JP-A Nos.8-254793 and 2000-206653.

13) Other Applicable Techniques

Techniques which can be used for the photothermographic material of the invention also include those in EP803764A1, EP883022A1, WO98/36322, JP-A Nos. 56-62648, 58-62644, JP-A Nos. 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-20699, 2001-275471, 2001-275461, 2000-313204, 2001-292844, 2000-324888, 2001-293864, and 2001-348546.

14) Multi-Color Photothermographic Material

Constitution of the multi-color photothermographic material may include a combination of these two layers for each color. Alternatively, all ingredients may be included into a single layer as described in U.S. Pat. No. 4,708,928.

In instances of multi-color photothermographic materials, each photosensitive layer is in general, held distinctively each other by using a functional or nonfunctional barrier layer between each photosensitive layer as described in U.S. Pat. No. 4,460,681.

3. Image Forming Method

3-1. Exposure

Although the photosensitive material of the invention may be subjected to exposure by any methods, laser beam is preferred as an exposure light source. Particularly, silver halide emulsion of high content of silver iodide had a problem having low photosensitivity, but this problem was solved with the use of high intensity like laser beam. And it made clear that it needs small amount of energy to record an image. Using thus strong light in a short time made it possible to achieve photosensitivity to the purpose.

Especially, for giving the exposure intensity to provide maximum density (Dmax), the light intensity on the surface of the photographic material is preferably in the range of 0.1 W/mm² to 100 W/mm², more preferably 0.5 W/mm² to 50 W/mm², most preferably 1 W/mm² to 50 W/mm².

As Laser beam according to the invention, preferably used are gas laser (Ar⁺, He—Ne, He—Cd), YAG laser, pigment laser, laser diode. Laser diode and second harmonics generator element can also be used. Preferred laser is determined corresponding to the peak absorption wavelength of spectral sensitizer and the like, but preferred is He—Ne laser of red through infrared emission, red laser diode, or Ar⁺, He—Ne, He—Cd laser of blue through green emission, blue laser diode. Meanwhile, modules having SHG (Second Hermonic Generator) chip and laser diode which are integrated, or blue laser diode have been espcially developed recently, and thus laser output devices for short wavelength region have attracted the attention. Blue laser diode has been expected as a light source with increasing demand hereafter because image recording with high definition is possible, and increased recording density, as well as stable output with longer operating life are enabled. The peak wavelength of laser beam is 350 nm to 440 nm, preferably 380 nm to 410 nm.

It is preferable to use a laser diode for exposure in the present invention, that is the light intensity is 1 mW/mm² to 50 mW/mm², and the peak wavelength of laser beam is 350 nm to 440 nm, more preferably 380 nm to 410 nm.

Laser beam which oscillates in a longitudinal multiple modulation by a method such as high frequency superposition is also preferably employed.

3-2. Thermal Development

Although the development of the photothermographic material of the invention is usually performed by elevating the temperature of the photothermographic material exposed imagewise, any method may be used for this thermal development process. The temperature for the development is preferably 80° C. to 250° C., preferably 100° C. to 140° C., and more preferably 110° C. to 130° C.

Time period for the development is preferably 1 second to 60 seconds, more preferably 3 seconds to 30 seconds, particularly preferably 5 seconds to 25 seconds, and most preferably 7 seconds to 15 seconds.

In the process for the thermal development, plate type heater processes are preferred. Preferable process for the thermal development by a plate type heater may be a process described in JP-A NO. 11-133572, which discloses a thermal developing device in which a visible image is obtained by bringing a photothermographic material with a formed latent image into contact with a heating means at a thermal development region, wherein the heating means comprises a plate heater, and plurality of retainer rollers are oppositely provided along one surface of the plate heater, the thermal developing device is characterized in that thermal development is performed by passing the photothermographic material between the retainer rollers and the plate heater. It is preferred that the plate heater is divided into 2 to 6 portions, with the leading end having the lower temperature by 1° C. to 10° C.

Such a process is also described in JP-A NO. 54-30032, which allows for excluding moisture and organic solvents included in the photothermographic material out of the system, and also allows for suppressing the change of shapes of the support of the photothermographic material upon rapid heating of the photothermographic material.

3-3. System

Examples of a medical laser imager equipped with a light exposing part and a thermal developing part include Fuji Medical Dry Laser Imager FM-DP L. In connection with FM-DPL, description is found in Fuji Medical Review No. 8, pages 39 to 55. It goes without mentioning that those techniques may be applied as the laser imager for the photothermographic material of the invention. In addition, the present photothermographic material can be also applied as a photothermographic material for the laser imager used in “AD network” which was proposed by Fuji Film Medical Co., Ltd. as a network system accommodated to DICOM standard.

4. Application of the Invention

The image forming method in which the photothermographic material of the invention is used is preferably employed as image forming methods for photothermographic materials for use in medical imaging, photothermographic materials for use in industrial photographs, photothermographic materials for use in graphic arts, as well as for COM, through forming black and white images by silver imaging.

### EXAMPLES

The present invention is specifically explained by way of Examples below, which should not be construed as limiting the invention thereto.

In first, a support and many materials used for coating to make the photothermographic materials in the present axamples are discribed below.

1. Support

1-1. Preparation of PET Support

PET having IV (intrinsic viscosity) of 0.66 (measured in phenol/tetrachloroethane=6/4 (weight ratio) at 25° C.) was obtained according to a conventional manner using terephthalic acid and ethylene glycol. The product was pelletized, dried at 130° C. for 4 hours, melted at 300° C. Thereafter, the mixture was extruded from a T-die and rapidly cooled to form a non-tentered film having such a thickness that the thickness should become 175 μm after tentered and thermal fixation.

The film was stretched along the longitudinal direction by 3.3 times using rollers of different peripheral speeds, and then stretched along the transverse direction by 4.5 times using a tenter machine. The temperatures used for these operations were 10° C. and 130° C., respectively. Then, the film was subjected to thermal fixation at 240° C. for 20 seconds, and relaxed by 4% along the transverse direction at the same temperature. Thereafter, the chucking part was slit off, and both edges of the film were knurled. Then the film was rolled up at the tension of 4 kg/cm² to obtain a roll having the thickness of 175 μm.

(Surface Corona Discharge Treatment)

Both surfaces of the support were treated at room temperature at 20 m/minute using Solid State Corona Discharge Treatment Machine Model 6 KVA manufactured by Piller GmbH. It was proven that treatment of 0.375 kV·A·minute/m² was executed, judging from the readings of current and voltage on that occasion. The frequency upon this treatment was 9.6 kHz, and the gap clearance between the electrode and dielectric roll was 1.6 mm.

1-2. Undercoating of Support

(1) Preparation of Coating Solution for Undercoat Layer Formula (1) (for Undercoat Layer on the Image Forming Layer Side)

| | | |
|---|---|---|
| Pesresin A-520 manufactured by Takamatsu Oil & | 59 | g |
| Fat Co., Ltd. (30% by weight solution) | | |
| polyethyleneglycol monononylphenylether (average | 5.4 | g |
| ethylene oxide number = 8.5) 10% by weight solution | | |
| MP-1000 manufactured by Soken Chemical & | 0.91 | g |
| Engineering Co., Ltd. (polymer fine particle, mean | | |
| particle diameter of 0.4 μm) | | |
| distilled water | 935 | mL |

Formula (2) (for first layer on the back surface)

| | | |
|---|---|---|
| Styrene-butadiene copolymer latex (solid content | 158 | g |
| of 40% by weight, styrene/butadiene weight ratio = 68/32) | | |
| 8% by weight aqueous solution of 2,4-dichloro-6- | 20 | g |
| hydroxy-S-triazine sodium salt | | |
| 1% by weight aqueous solution of sodium | 10 | mL |
| laurylbenzenesulfonate | | |
| distilled water | 854 | mL |

Formula (3) (for second layer on the back surface)

| | | |
|---|---|---|
| SnO₂/SbO (9/1 weight ratio, mean particle diameter | 84 | g |
| of 0.038 μm, 17% by weight dispersion) | | |
| gelatin (10% by weight aqueous solution) | 89.2 | g |
| METOLOSE TC-5 manufactured by Shin-Etsu Chemical | 8.6 | g |
| Co., Ltd. (2% by weight aqueous solution) | | |
| MP-1000 manufactured by Soken Chemical & | 0.01 | g |
| Engineering Co., Ltd. | | |
| 1% by weight aqueous solution of sodium | 10 | mL |
| dodecylbenzenesulfonate | | |
| NaOH (1% by weight) | 6 | mL |
| Proxel (manufactured by Imperial Chemical | 1 | mL |
| Industries PLC) | | |
| distilled water | 805 | mL |

Both surfaces of the biaxially tentered polyethylene terephthalate support having the thickness of 175 μm were subjected to the corona discharge treatment as described above. Thereafter, the aforementioned formula (1) of the coating solution for the undercoat was coated on one surface (image forming layer side) with a wire bar so that the amount of wet coating became 6.6 mL/m² (per one side), and dried at 180° C. for 5 minutes. Then, the aforementioned formula (2) of the coating solution for the undercoat was coated on the reverse face (back surface) with a wire bar so that the amount of wet coating became 5.7 mL/m², and dried at 180° C. for 5 minutes. Furthermore, the aforementioned formula (3) of the coating solution for the undercoat was coated on the reverse face (back surface) with a wire bar so that the amount of wet coating became 7.7 mL/m², and dried at 180° C. for 6 minutes. Thus, an undercoated support was produced.

2. Back Layer

2-1. Preparation of Coating Solution for Back Layer

[symbol] Preparation of Coating Solution for Antihalation Layer

[symbol]

32.7 g of alkali-treated gelatin, 0.77 g of monodispersed polymethyl methacrylate fine particles (mean particle size of 8 μm, standard deviation of particle diameter of 0.4), 0.08 g of benzoisothiazolinone, 0.3 g of sodium polystyrenesulfonate, 0.06 g of blue dye-1, 1.5 g of ultraviolet absorber dye, and 5.0 g of acrylic acid/ethyl acrylate copolymer latex (copolymerization rate 5/95), and 1.7 g of N,N′-ethylene-bis(vinylsulfonamido) were mixed. The pH of the coating solution was adjusted to 6.0 with 1 mol/L sodium hyudroxide. Then, water was added to give the total volume of 818 mL to prepare a coating solution for the antihalation layer.

[symbol] Preparation of Coating Solution for Back Surface Protective Layer

[symbol]

A vessel was kept at 40° C., and thereto were added 66.5 g of gelatin, liquid paraffin emulsion at 5.4 g equivalent to liquid paraffin, 0.1 g of benzoisothiazolinone, 0.27 g of di(2-ethylhexyl) sodium sulfosuccinate, 13.6 mL of a 2% by weight solution of a fluorochemical surfactant (F-1), and 10.0 g of an acrylic acid/ethyl acrylate copolymer (copolymer weight ratio of 5/95). The pH was adjusted to 6.0 with 1 mol/L aqueous sodium hydroxide solution, and then water was added to give the volume of 1000 mL to prepare a coating solution for the back surface protective layer.

2-2. Coating of Back Layer

The back surface side of the undercoated support as described above was subjected to simultaneous double coating so that the coating solution for the antihalation layer gives the coating amount of gelatin of 0.88 g/m², and so that the coating solution for the back surface protective layer gives the coating amount of gelatin of 1.2 g/m², followed by drying to produce a back layer.

3. Preparation of Coating Materials

1) Preparation of Silver Halide Emulsion

[symbol] Preparation of Silver Halide Emulsion-1

[symbol]

To 1420 mL of distilled water was added 4.3 mL of a 1% by weight potassium iodide solution. Further, a liquid added with 3.5 mL of 0.5 mol/L sulfuric acid and 36.7 g of phthalated gelatin was kept at 42° C. while stirring in a stainless steel reaction pot, and thereto were added total amount of: solution A prepared through diluting 22.22 g of silver nitrate by adding distilled water to give the volume of 195.6 mL; and solution B prepared through diluting 21.8 g of potassium iodide with distilled water to give the volume of 218 mL, over 9 minutes at a constant flow rate. Thereafter, 10 mL of a 3.5% by weight aqueous solution of hydrogen peroxide was added thereto, and 10.8 mL of a 10% by weight aqueous solution of benzimidazole was further added.

Moreover, a solution C prepared through diluting 51.86 g of silver nitrate by adding distilled water to give the volume of 317.5 mL and a solution D prepared through diluting 60 g of potassium iodide with distilled water to give the volume of 600 mL were added. A controlled double jet method was executed through adding total amount of the solution C at a constant flow rate over 120 minutes, accompanied by adding the solution D while maintaining the pAg at 8.1. Hexachloroiridium (III) potassium salt was added to give 1×10-4 mol per one mol of silver at 10 minutes post initiation of the addition of the solution C and the solution D in its entirety. Moreover, at 5 seconds after completing the addition of the solution C, a potassium iron (II) hexacyanide aqueous solution was added at a total amount of 3×10⁻⁴ mol per one mol of silver. The mixture was adjusted to the pH of 3.8 with 0.5 mol/L sulfuric acid. After stopping stirring, the mixture was subjected to precipitation/desalting/water washing steps. The mixture was adjusted to the pH of 5.9 with 1 mol/L sodium hydroxide to produce a silver halide dispersion having the pAg of 8.0.

The above-mentioned silver halide dispersion was kept at 38° C. with stirring, and thereto was added 5 mL of a 0.34% by weight methanol solution of 1,2-benzoisothiazoline-3-one, followed by elevating the temperature to 47° C. At 20 minutes after elevating the temperature, sodium benzene thiosulfonate in a methanol solution was added at 7.6×10⁻⁵ mol per one mol of silver. At additional 5 minutes later, a tellurium sensitizer C in a methanol solution was added at 2.9×10⁻⁴ mol per one mol of silver and subjected to aging for 91 minutes.

Thereto was added 1.3 mL of a 0.8% by weight N,N′-dihydroxy-N″,N″-diethylmelamine in methanol, and at additional 4 minutes thereafter, 5-methyl-2-mercaptobenzimidazole in a methanol solution at 4.8×10⁻³ mol per one mol of silver, 1-phenyl-2-heptyl-5-mercapto-1,3,4-triazole in a methanol solution at 5.4×10⁻³ mol per one mol of silver were added to produce a silver halide emulsion-1.

Grains in thus prepared silver halide emulsion were pure silver iodide grains having a mean sphere equivalent diameter of 0.040 μm, a variation coefficient of 18%, and tetrahedron grains shaped having planes of (001), (100) and (101). The ratio of phase was 30%, determined by powder Xray diffraction analysis. Grain size and the like were determined from the average of 1000 grains using an electron microscope.

[symbol] Preparation of Silver Halide Emulsion-2

[symbol]

Preparation of silver halide emulsion-2 was conducted in a similar manner to the process in the preparation of the silver halide emulsion-1 except that: the temperature of the reaction solution was altered to 65° C., and 5 mL of a 5% by weight 2,2′-(ethylenedithio)diethanol in methanol was added after adding the solutions A and B, solution D was addded by controlled double jet method keeping pAg at 10.5, bromoaurate at 5.0×10⁻⁴ mol per one mol of silver and potassium thiocyanate at 2.0×10⁻³ mol per one mol of silver added after the addition of the tellurium sensitizer in chemical sensitizing step.

Grains in thus prepared silver halide emulsion were pure silver iodide tabular grains having a mean circle equivalent diameter of 0.164 μm, a mean thichness of 0.032 μm, a mean aspect ratio of 5, a mean sphere equivalent diameter of 0.11 μm, and a variation coefficient thereof of 23%. The ratio of γ phase determined by powder X ray diffraction analysis was 80%. Grain size and the like were determined from the average of 1000 grains using an electron microscope.

[symbol] Preparation of Silver Halide Emulsion-3

[symbol]

Preparation of silver halide emulsion-3 was conducted in a similar manner to the process in the preparation of the silver halide emulsion-1 except that the temperature of the reaction solution was altered to 27° C., and a solution D was added by controlled double jet method keeping pAg at 10.2.

Grains in thus prepared silver halide emulsion were pure silver iodide grains having a mean sphere equivalent diameter of 0.022 μm, a variation coefficient of 17%. These were dodecahedron grains shaped having planes of (001), {1(−1)0} and (101). Almost of the grains were phase, determined by powder Xray diffraction analysis. Grain size and the like were determined from the average of 1000 grains using an electron microscope.

<<Preparation of Silver Halide Emulsion A for Coating Solution>>

The silver halide emulsion-1, the silver halide emulsion-2, and the silver halide emulsion-3 were dissolved at 5:2:3 as molar ratio of silver, and thereto was added benzothiazolium iodide at 7×10⁻³ mol per one mol of silver with a 1% by weight aqueous solution. Further, water was added thereto to give the content of silver of 38.2 g per one kg of the emulsion for a coating solution, and 1-(3-methylureidophenyl)-5-mercaptotetrazole was added to give 0.34 g per 1 kg of the emulsion for a coating solution.

Further, as “a compound that can be one-electron-oxidized to provide a one-electron oxidation product, which releases one or more electrons”, the compounds Nos.2, 20 and 26 were added respectively in the amount of 2×10⁻³ mol per one mol of silver halide.

Thereafter, as “a compound having an adsorption group and a reducing group”, the compound Nos. (19), (49), and (71) were added respectively in the amount of 8×10⁻³ mol per one mol of silver halide.

2) Preparation of Silver Salt of Fatty Acid

<<Purification of Behenic Acid>>

Behenic acid manufactured by Henkel Co. (trade name: Edenor C22-85R) in an amount of 100 kg was admixed with 1200 kg of isopropyl alcohol, and dissolved at 50° C. The mixture was filtrated through a 10 μm filter, and cooled to 30° C. to allow recrystallization. Cooling speed for the recrystallization was controlled to be 3° C./hour. Thus resulting crystal was subjected to centrifugal filtration, and washing was performed with 100 kg of isopropyl alcohol. Thereafter, the crystal was dried. Thus resulting crystal was esterified, and subjected to GC-FID analysis to give the results of the content of behenic acid being 96 mol %, lignoceric acid 2 mol %, and arachidic acid 2 mol %. In addition, erucic acid was included at 0.001 mol % or less.

<<Preparation of Dispersion of Silver Salt of Fatty Acid>>

88 kg of purified behenic acid, 422 L of distilled water, 49.2 L of an aqueous sodium hydroxide solution at the concentration of 5 mol/L, 120 L of t-butyl alcohol were admixed, and subjected to a reaction with stirring at 75° C. for one hour to give a solution of a sodium behenate. Separately, 206.2 L of an aqueous solution of 40.4 kg of silver nitrate (pH 4.0) was provided, and kept at a temperature of 10° C. A reaction vessel charged with 635 L of distilled water and 30 L of t-butyl alcohol was kept at 30° C., and thereto were added the total amount of the solution of a sodium behenate and the total amount of the aqueous silver nitrate solution with sufficient stirring at a constant flow rate over 93 minutes and 15 seconds, and 90 minutes, respectively. Upon this operation, during first 11 minutes following the initiation of adding the aqueous silver nitrate solution, the added material was restricted to the aqueous silver nitrate solution alone. The addition of the solution of a sodium behenate was thereafter started, and during 14 minutes and 15 seconds following the completion of adding the aqueous silver nitrate solution, the added material was restricted to the solution of a sodium behenate alone. The temperature inside of the reaction vessel was then set to be 30° C., and the temperature outside was controlled so that the liquid temperature could be kept constant. In addition, the temperature of a pipeline for the addition system of the solution of a sodium behenate was kept constant by circulation of warm water outside of a double wall pipe, so that the temperature of the liquid at an outlet in the leading edge of the nozzle for addition was adjusted to be 75° C. Further, the temperature of a pipeline for the addition system of the aqueous silver nitrate solution was kept constant by circulation of cool water outside of a double wall pipe. Position at which the solution of a sodium behenate was added and the position at which the aqueous silver nitrate solution was added were arranged symmetrically with a shaft for stirring located at a center. Moreover, both of the positions were adjusted to avoid contact with the reaction liquid.

After completing the addition of the solution of a sodium behenate, the mixture was left to stand at the temperature as it is for 20 minutes. The temperature of the mixture was then elevated to 35° C. over 30 minutes followed by aging for 210 minutes. Immediately after completing the aging, solid matters were filtered out with centrifugal filtration. The solid matters were washed with water until the electric conductivity of the filtrated water became 30 μS/cm. A silver salt of fatty acid was thus obtained. The resulting solid matters were stored as a wet cake without drying.

When the shape of the resulting particles of the silver behenate was evaluated by an electron micrography, a crystal was revealed having a=0.21 μm, b=0.4 μm and c=0.4 μm on the average value, with a mean aspect ratio of 2.1, and a variation coefficient of 11% (a, b and c are as defined aforementioned.).

To the wet cake corresponding to 260 kg of a dry solid matter content, were added 19.3 kg of polyvinyl alcohol (trade name: PVA-217) and water to give the total amount of 1000 kg. Then, slurry was obtained from the mixture using a dissolver blade. Additionally, the slurry was subjected to preliminary dispersion with a pipeline mixer (manufactured by MIZUHO Industrial Co., Ltd.: PM-10 type).

Next, a stock liquid after the preliminary dispersion was treated three times using a dispersing machine (trade name: Microfluidizer M-610, manufactured by Microfluidex International Corporation, using Z type Interaction Chamber) with the pressure controlled to be 1150 kg/cm² to give a dispersion of the silver behenate. For the cooling manipulation, coiled heat exchangers were equipped fore and aft of the interaction chamber respectively, and accordingly, the temperature for the dispersion was set to be 18° C. by regulating the temperature of the cooling medium.

3) Preparation of Reducing Agent Dispersion

<<Preparation of Reducing Agent-1 Dispersion>>

To 10 kg of a reducing agent-1 (2,2′-methylenebis-(4-ethyl-6-tert-butylphenol)) and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours. Thereafter, 0.2 g of a benzoisothiazolinone sodium salt and water were added thereto, thereby adjusting the concentration of the reducing agent to be 25% by weight. This dispersion was subjected to thermal treatment at 60° C. for 5 hours to obtain a reducing agent-1 dispersion. Particles of the reducing agent included in the resulting reducing agent dispersion had a median diameter of 0.40 μm, and a maximum particle diameter of 1.4 μm or less. The resultant reducing agent dispersion was subjected to filtration with a polypropylene filter having a pore size of 3.0 μm to remove foreign substances such as dust, and stored.

<<Preparation of Reducing Agent-2 Dispersion>>

To 10 kg of a reducing agent-2 (6,6′-di-t-butyl-4,4′-dimethyl-2,2′-butylidenediphenol)) and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minutes. Thereafter, 0.2 g of a benzoisothiazolinone sodium salt and water were added thereto, thereby adjusting the concentration of the reducing agent to be 25% by weight. This dispersion was warmed at 40° C. for one hour, followed by a subsequent thermal treatment at 80° C. for one hour to obtain a reducing agent-2 dispersion. Particles of the reducing agent included in the resulting reducing agent-2 dispersion had a median diameter of 0.50 μm, and a maximum particle diameter of 1.6 μm or less. The resultant reducing agent-2 dispersion was subjected to filtration with a polypropylene filter having a pore size of 3.0 μm to remove foreign substances such as dust, and stored.

<<Preparation of Reducing Agent-3 Dispersion>>

To 10 kg of a reducing agent-3 and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minutes. Thereafter, 0.2 g of a benzoisothiazolinone sodium salt and water were added thereto, thereby adjusting the concentration of the reducing agent to be 25% by weight. This dispersion was warmed at 40° C. for one hour, followed by a subsequent thermal treatment at 80° C. for one hour to obtain a reducing agent-3 dispersion. Particle size could not be determined. The resultant reducing agent-3 dispersion was subjected to filtration with a polypropylene filter having a pore size of 3.0 μm to remove foreign substances such as dust, and stored.

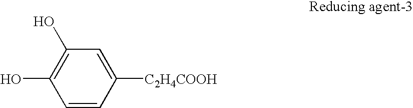

4) Preparation of Hydrogen Bonding Compound-1 Dispersion

To 10 kg of a hydrogen bonding compound-1 (tri(4-t-butylphenyl)phosphineoxide) and 16 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 4 hours. Thereafter, 0.2 g of a benzoisothiazolinone sodium salt and water were added thereto, thereby adjusting the concentration of the hydrogen bonding compound to be 25% by weight. This dispersion was warmed at 40° C. for one hour, followed by a subsequent thermal treatment at 80° C. for one hour to obtain a hydrogen bonding compound-1 dispersion. Particles of the hydrogen bonding compound included in the resulting hydrogen bonding compound-1 dispersion had a median diameter of 0.45 μm, and a maximum particle diameter of 1.3 μm or less. The resultant hydrogen bonding compound-1 dispersion was subjected to filtration with a polypropylene filter having a pore size of 3.0 μm to remove foreign substances such as dust, and stored.

5) Preparation of Dispersion of Development Accelerator and Color-Tone-Adjusting Agent

<<Preparation of Development Accelerator-1 Dispersion>>

To 10 kg of a development accelerator-1 and 20 kg of a 10% by weight aqueous solution of modified polyvinyl alcohol (manufactured by Kuraray Co., Ltd., Poval MP203) was added 10 kg of water, and thoroughly mixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 3 hours and 30 minuets. Thereafter, 0.2 g of a benzoisothiazolinone sodium salt and water were added thereto, thereby adjusting the concentration of the development accelerator to be 20% by weight. Accordingly, a development accelerator-1 dispersion was obtained. Particles of the development accelerator included in the resulting development accelerator dispersion had a median diameter of 0.48 μm, and a maximum particle diameter of 1.4 μm or less. The resultant development accelerator dispersion was subjected to filtration with a polypropylene filter having a pore size of 3.0 μm to remove foreign substances such as dust, and stored.

<<Preparation of Dispersion of Development Accelerator-2 and Color-Tone-Adjusting Agent-1>>

Also concerning solid dispersions of a development accelerator-2 and a color-tone-adjusting agent-1, dispersion was executed in a similar manner to the development accelerator-1, and thus dispersions of 20% by weight and 15% by weight were respectively obtained.

6) Preparation of Polyhalogen Compound Dispersion

<<Preparation of Organic Polyhalogen Compound-i Dispersion>>

An organic polyhalogen compound-1 (tribromomethane sulfonylbenzene) in an amount of 10 kg, 10 kg of a 20% by weight aqueous solution of modified polyvinyl alcohol (manufactured by Kuraray Co., Ltd., Poval MP203), 0.4 kg of a 20% by weight aqueous solution of sodium triisopropylnaphthalenesulfonate and 14 kg of water were added, and thoroughly admixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 5 hours. Thereafter, 0.2 g of a benzoisothiazolinone sodium salt and water were added thereto, thereby adjusting the concentration of the organic polyhalogen compound to be 30% by weight. Accordingly, an organic polyhalogen compound-1 dispersion was obtained. Particles of the organic polyhalogen compound included in the resulting polyhalogen compound dispersion had a median diameter of 0.41 μm, and a maximum particle diameter of 2.0 μm or less. The resultant organic polyhalogen compound dispersion was subjected to filtration with a polypropylene filter having a pore size of 10.0 μm to remove foreign substances such as dust, and stored.

<<Preparation of Organic Polyhalogen Compound-2 Dispersion>>

An organic polyhalogen compound-2 (N-butyl-3-tribromomethane sulfonylbenzoamide) in an amount of 10 kg, 20 kg of a 10% by weight aqueous solution of modified polyvinyl alcohol (manufactured by Kuraray Co., Ltd., Poval MP203) and 0.4 kg of a 20% by weight aqueous solution of sodium triisopropylnaphthalenesulfonate were added, and thoroughly admixed to give slurry. This slurry was fed with a diaphragm pump, and was subjected to dispersion with a horizontal sand mill (UVM-2: manufactured by IMEX Co., Ltd.) packed with zirconia beads having the mean particle diameter of 0.5 mm for 5 hours. Thereafter, 0.2 g of a benzoisothiazolinone sodium salt and water were added thereto, thereby adjusting the concentration of the organic polyhalogen compound to be 30% by weight. This fluid dispersion was heated at 40° C. for 5 hours to obtain an organic polyhalogen compound-2 dispersion. Particles of the organic polyhalogen compound included in the resulting polyhalogen compound dispersion had a median diameter of 0.40 μm, and a maximum particle diameter of 1.3 μm or less. The resultant organic polyhalogen compound dispersion was subjected to filtration with a polypropylene filter having a pore size of 3.0 μm to remove foreign substances such as dust, and stored.

7) Preparation of Phthalazine Compound-1 Solution

Modified polyvinyl alcohol MP203 manufactured by Kuraray Co., Ltd., in an amount of 8 kg was dissolved in 174.57 kg of water, and then thereto were added 3.15 kg of a 20% by weight aqueous solution of sodium triisopropylnaphthalenesulfonate and 14.28 kg of a 70% by weight aqueous solution of a phthalazine compound-1 (6-isopropyl phthalazine) to prepare a 5% by weight phthalazine compound-1 solution.

8) Preparation of Aqueous Solution of Mercapto Compound

<<Preparation of an Aqueous Solution of Mercapto Compound-1>>

A mercapto compound-1 (1-(3-sulfophenyl)-5-mercaptotetrazole sodium salt) in an amount of 7 g was dissolved in 993 g of water to give a 0.7% by weight aqueous solution.

<<Preparation of an Aqueous Solution of Mercapto Compound-2>>

A mercapto compound-2 (1-(3-methylureidophenyl)-5-mercaptotetrazole) in an amount of 20 g was dissolved in 980 g of water to give a 2.0% by weight aqueous solution.

9) Preparation of Pigment-1 Dispersion)

C.I. Pigment Blue 60 in an amount of 64 g and 6.4 g of DEMOL N manufactured by Kao Corporation were added to 250 g water and thoroughly mixed to give slurry. Zirconia beads having the mean particle diameter of 0.5 mm were provided in an amount of 800 g, and charged in a vessel with the slurry. Dispersion was performed with a dispersing machine (1/4G sand grinder mill: manufactured by IMEX Co., Ltd.) for 25 hours. Thereto was added water to adjust so that the concentration of the pigment became 5% by weight to obtain a pigment-1 dispersion. Particles of the pigment included in thus resulting pigment dispersion had a mean particle diameter of 0.21 μm.

10) Preparation of Binder Solution or Dispersion

<<Preparation of SBR Latex Solution-1>>

SBR latex was prepared as described below.

To a polymerization tank of a gas monomer reaction apparatus (manufactured by Taiatsu Techno Corporation, TAS-2J type), were charged 287 g of distilled water, 7.73 g of a surfactant (Pionin A-43-S (manufactured by TAKEMOTO OIL & FAT CO., LTD.): solid matter content of 48.5% by weight), 14.06 mL of 1 mol/L sodium hydroxide, 0.15 g of ethylenediamine tetraacetate tetrasodium salt, 258.75 g of styrene, 11.25 g of acrylic acid, and 3.0 g of tert-dodecyl mercaptan, followed by sealing of the reaction vessel and stirring at a stirring rate of 200 rpm. Degassing was conducted with a vacuum pump, followed by repeating nitrogen gas replacement several times. Tereto was injected 105 g of 1,3-butadiene, and the inner temperature was elevated to 60° C. Thereto was added a solution of 1.95 g of ammonium persulfate dissolved in 50 mL of water, and the mixture was stirred for 5 hours as it stands. The temperature was further elevated to 90° C., followed by stirring for 5 hours. After completing the reaction, the inner temperature was lowered to reach to the room temperature, and thereafter the mixture was treated by adding 1 mol/L sodium hydroxide and ammonium hydroxide to give the molar ration of Na⁺ ion NH₄⁺ ion=1:5.3, and thus, the pH of the mixture was adjusted to 8.4. Thereafter, filtration with a polypropylene filter having the pore size of 1.0 μm was conducted to remove foreign substances such as dust followed by storage. Accordingly, SBR latex was obtained in an amount of 774.7 g. Upon the measurement of halogen ion by ion chromatography, concentration of chloride ion was revealed to be 3 ppm. As a result of the measurement of the concentration of the chelating agent by high performance liquid chromatography, it was revealed to be 145 ppm.

The aforementioned latex had the mean particle diameter of 90 nm, Tg of 20° C., solid matter concentration of 44% by weight, the equilibrium moisture content at 25° C., 60% RH of 0.6% by weight, ionic conductance of 4.80 mS/cm (measurement of the ionic conductance performed using a conductivity meter CM-30S manufactured by To a Electronics Ltd. for the latex stock solution (44% by weight) at 25° C.) and pH of 8.4.

<<Preparation of Acrylate Latex Solution>>

Into three necked glass flask with cooling tube and stirring device, 296 g of distilled water, 10.89 g of surfactant (“SANDET BL” produced by Sanyo Kasei Co., Ltd., which was purified with Micro Acilyzer G3 manufactured by Asahi Kasei Co., Ltd, (membrane used: AC110-800) until electric conductivity of the filtrate became unchanged; solid content 27.6% by weight), 15 ml of 1 mol/L sodium hydroxide, 0.3 g of nitrilo triacetic acid, 165 g of methyl methacrylate, 120 g of butylacrylate, 12 g of sodium styrene sulfonate, 3 g of methyl bis-acrylamide, and 2.4 g of tert-dodecyl mercaptan were added in a nitrogen gas atmosphere, and elevated the inner temperature to 60° C. and stirred with at the stirring rate of 200 rpm, thereafter a solution obtained by dissolving 0.6 g of sodium persulfate in 40 mL of water was added to the aforesaid mixture and stirred for 5 hours, and then heated to 90° C. with stirring for 3 hours. After the reaction was finished, the inner temperature was cooled to room temperature. The polymer obtained were filtered by paper towel, then 622 g of acrylic latex were obtained (solid content 45% by weight, particle size 108 nm, average molecular weight 140,000, and Tg=20° C.), the measurement of halogen ion by an ion chromatography showed that the concentration of residual chloride ion was 10 p.p.m., and the measurement by a high speed liquid chromatography showed that residual chelating agent concentration was 450 p.p.m.

<<Preparation of PVA Solution>>

As PVA binder, Polyvinyl alcohol “PVA-217” produced by Kuraray Co., Ltd. was used. “PVA-217” was dissolved previously at 90° C. for 90 min, and a 5% by weight solution was employed.

<<Preparation of Gelatin Solution>>

As gelatin binder, inert gelatin was used. The gelatin was dissolved previously at 60° C. for 60 min, and a 16% by weight solution was employed.

Chemical structures of the compounds used in Examples of the invention are shown below.

Compound 2 that can be one-electron-oxidized to provide a one-electron oxidation product which releases one or more electrons

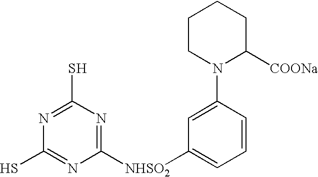

Compound 20 that can be one-electron-oxidized to provide a one-electron oxidation product which releases one or more electrons

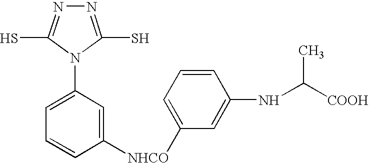

Compound 26 that can be one-electron-oxidized to provide a one-electron oxidation product which releases one or more electrons

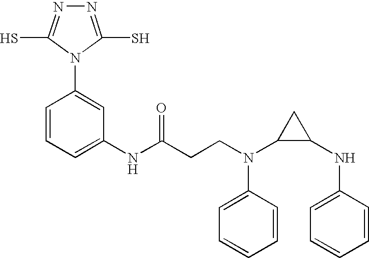

Compound (19) having adsorption group and reducing group

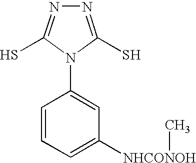

Compound (49) having adsorption group and reducing group

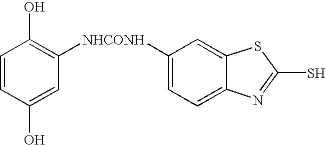

Compound (71) having adsorption group and reducing group

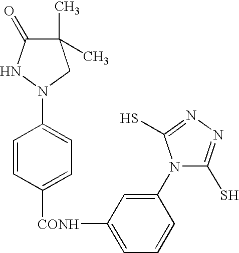

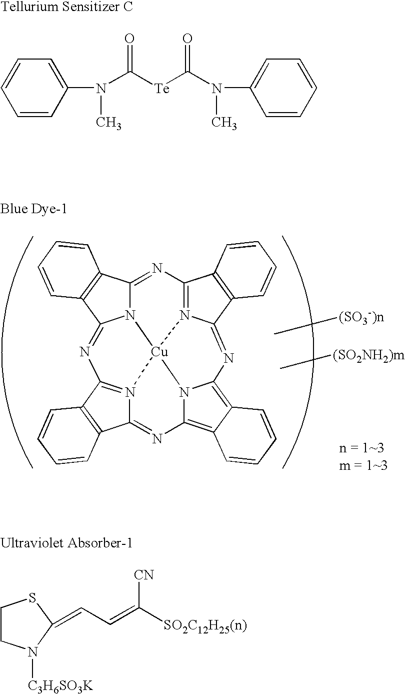

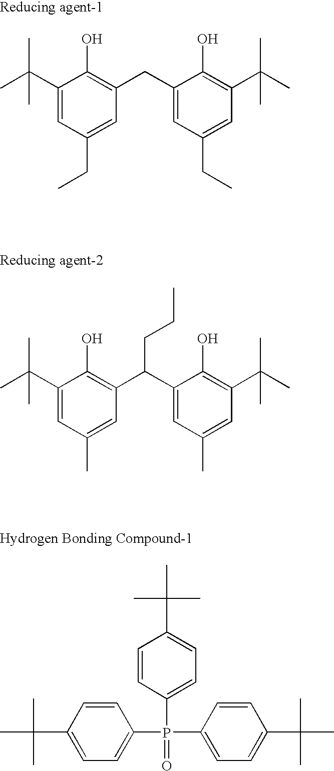

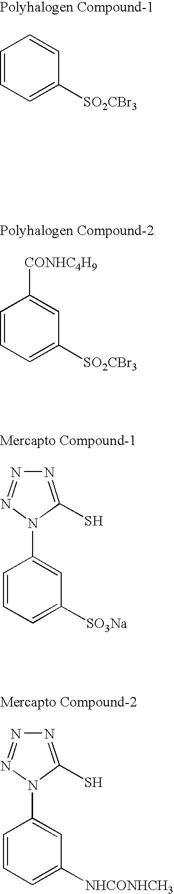

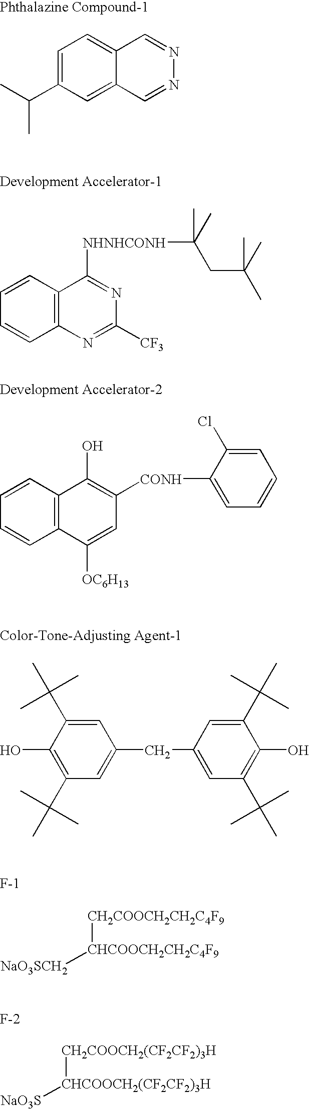

### Example 1

1. Preparation of Coating Solutions

1) Preparation of Coating Solution for Image Forming Layer

[symbol] Preparation of Coating Solution for Image Forming Layer-1

[symbol]

To the dispersion of the silver behenate obtained as described above in an amount of 1000 g and 276 mL of water were serially added the pigment-1 dispersion, the organic polyhalogen compound-1 dispersion, the organic polyhalogen compound-2 dispersion, the phthalazine compound-1 solution, the SBR latex (Tg: 20° C.) solution, the reducing agent-1 dispersion, the reducing agent-2 dispersion, the hydrogen bonding compound-1 dispersion, the development accelerator-1 dispersion, the development accelerator-2 dispersion, the color-tone-adjusting agent-1 dispersion, the mercapto compound-1 aqueous solution and the mercapto compound-2 aqueous solution. The coating solution for the image forming layer prepared by adding the silver halide mixed emulsion A thereto followed by thorough mixing just prior to the coating was fed directly to a coating die, and was coated.

Viscosity of the coating solution for the image forming layer was measured with a B type viscometer from Tokyo Keiki, and was revealed to be 25 [mPa·s] at 40° C. (No. 1 rotor, 60 rpm).

Viscosity of the coating solution at 25° C. when it was measured using RFS fluid spectrometer manufactured by Rheometrix Far-East Co. Ltd. was 242, 65, 48, 26, and 20 [mPa·s], respectively, at the shearing rate of 0.1, 1, 10, 100, 1000 [1/second].

The amount of zirconium in the coating solution was 0.52 mg per one g of silver.

[symbol] Preparations of Coating Solution for Image Forming Layer-2 to −8

[symbol]

Preparations of coating solution for image forming layer-2 to −8 were conducted in the similar manner to the preparation of coating solution for image forming layer-1, except that using dispersions mentioned in Table-1, instead of using the SBR latex (Tg: 20° C.) solution, the reducing agent-1 dispersion, and the reducing agent-2 dispersion for coating solution. The other bindes than SBR latex were replaced at the same coating amount by weight to SBR latex, and the reducing agents at the same coating amount by mol to image forming layer-1 at total.

2) Preparation of Coating Solution for Intermediate Layer

To 1000 g of polyvinyl alcohol PVA-205 (manufactured by Kuraray Co., Ltd.), 272 g of the pigment-1 dispersion, and 4200 mL of a 19% by weight solution of methyl methacrylate/styrene/butyl acrylate/hydroxyethyl methacrylate/acrylic acid copolymer (weight ratio of the copolymerization of 64/9/20/5/2) latex, were added 27 mL of a 5% by weight aqueous solution of aerosol OT (manufactured by American Cyanamid Co.), 135 mL of a 20% by weight aqueous solution of ammonium secondary phthalate and water to give total amount of 10000 g. The mixture was adjusted with sodium hydroxide to give the pH of 7.5. Accordingly, the coating solution for the intermediate layer was prepared, and was fed to a coating die to provide 9.1 mL/m².

Viscosity of the coating solution was 58 [mPa·s] which was measured with a B type viscometer at 40° C. (No. 1 rotor, 60 rpm)

3) Preparation of Coating Solution for First Layer of Surface Protective Layers

In water was dissolved 64 g of inert gelatin, and thereto were added 112 g of a 19% by weight solution of methyl methacrylate/styrene/butyl acrylate/hydroxyethyl methacrylate/acrylic acid copolymer (weight ratio of the copolymerization of 64/9/20/5/2) latex, 30 mL of a 15% by weight methanol solution of phthalic acid, 23 mL of a 10% by weight aqueous solution of 4-metyl phthalic acid, 28 mL of 0.5 mol/L sulfuric acid, 5 mL of a 5% by weight aqueous solution of aerosol OT (manufactured by American Cyanamid Co.), 0.5 g of phenoxyethyl alcohol, and 0.1 g of benzoisothiazolinone. Water was added to give total amount of 750 g. Immediately before coating, 26 mL of a 4% by weight chrome alum which had been mixed with a static mixer was fed to a coating die so that the amount of the coating solution became 18.6 mL/m².

Viscosity of the coating solution was 20 [mPa·s] which was measured with a B type viscometer at 40° C. (No. 1 rotor, 60 rpm)

4) Preparation of Coating Solution for Second Layer of Surface Protective Layers

In 800 mL of water were dissolved 80 g of inert gelatin and thereto were added 102 g of a 27.5% by weight solution of methyl methacrylate/styrene/butyl acrylate/hydroxyethyl methacrylate/acrylic acid copolymer (weight ratio of the copolymerization of 64/9/20/5/2) latex, 5.4 mL of a 2% by weight solution of a fluorocarbon surfactant (F-1), 5.4 mL of a 2% by weight aqueous solution of a fluorocarbon surfactant (F-2), 23 mL of a 5% by weight aqueous solution of aerosol OT (manufactured by American Cyanamid Co.), 4 g of polymethyl methacrylate fine particles (mean particle diameter of 0.7 μm) and 21 g of polymethyl methacrylate fine particles (mean particle diameter of 4.5 μm), 1.6 g of 4-methyl phthalic acid, 4.8 g of phthalic acid, 44 mL of 0.5 mol/L sulfuric acid, and 10 mg of benzoisothiazolinone. Water was added to give total amount of 650 g. Immediately before coating, 445 mL of a aqueous solution containing 4% by weight chrome alum and 0.67% by weight phthalic acid was mixed to give a coating solution for the second surface protective layer, which was fed to a coating die so that 8.3 mL/m² could be provided.

Viscosity of the coating solution was 19 [mPa·s] which was measured with a B type viscometer at 40° C. (No. 1 rotor, 60 rpm).

2. Preparation of Photothermographic Materials

[symbol] Coating of Photothermographic Material-1

[symbol]

Reverse surface of the back surface was subjected to simultaneous overlaying coating by a slide bead coating method in order of the image forming layer-1, intermediate layer, first layer of the surface protective layers and second layer of the surface protective layers starting from the undercoated face, and thus a sample of the photothermographic material-1 was produced. In this method, the temperature of the coating solution was adjusted to 31° C. for the image forming layer and intermediate layer, to 36° C. for the first layer of the surface protective layers, and to 37° C. for the second layer of the surface protective layers.

The coating amount of each compound for the image forming layer (g/m²) is as follows.

| | |
|---|---|
| Silver salt of fatty acid | 5.27 |
| Pigment (C.I. Pigment Blue 60) | 0.036 |
| Polyhalogen compound-1 | 0.09 |
| Polyhalogen compound-2 | 0.14 |
| Phthalazine compound-1 | 0.18 |
| SBR latex | 9.43 |
| Reducing agent-1 | 0.55 |
| Reducing agent-2 | 0.22 |
| Hydrogen bonding compound-1 | 0.28 |
| Development accelerator-1 | 0.025 |
| Development accelerator-2 | 0.020 |
| Color-tone-adjusting agent-1 | 0.008 |
| Mercapto compound-1 | 0.002 |
| Mercapto compound-2 | 0.006 |
| Silver halide (on the basis of Ag content) | 0.046 |

[symbol] Coating of Photothermographic Material 2 to 8

[symbol]

Preparations of photothermographic material 2 to 8 were conducted in the similar manner to the preparation of photothermographic material-1 except that using the coating solution for image forming layer 2 to 8, instead of using of the coating solution for image forming layer-1.

Conditions for coating and drying are as follows.

The support was decharged by ionic wind, and coating was performed at the speed of 160 m/min.

The clearance between the leading end of the coating die and the support being 0.10 mm to 0.30 mm, and with the pressure in the vacuum chamber set to be lower than atmospheric pressure by 196 Pa to 882 Pa. In the subsequent cooling zone, the coating solution was cooled by wind having the dry-bulb temperature of 10° C. to 20° C. Thereafter, transportation with no contact was carried out, and the coated support was dried with an air of the dry-bulb of 23° C. to 45° C. and the wet-bulb of 15° C. to 21° C. in a helical type contactless drying apparatus. After drying, moisture conditioning was performed at 25° C. in the humidity of 40% RH to 60% RH. Then, the film surface was heated to be 70° C. to 90° C. After heating, the film surface was cooled to 25° C.

Thus prepared photothermographic material had the mattness of 550 seconds on the image forming layer side surface, and 130 seconds on the back surface as Beck's smoothness. In addition, measurement of the pH of the film surface on the image forming layer side surface gave the result of 6.0.

3. Evaluation of Photographic Performances

[symbol] Preparation

[symbol]

The resulting sample was cut into a half-cut size (43 cm in length×35 cm in width), and was wrapped with the following packaging material under an environment of 25° C. and 50% RH, and stored for 2 weeks at an ambient temperature.

[symbol] Packaging Material

[symbol]

PET 10 μm/PE 12 μm/aluminum foil 9 μm/Ny 15 μm/polyethylene 50 μm containing carbon at 3% by weight, oxygen permeability: 0.02 mL/atm·m²·25° C. day, vaporpermeability: 0.10 g/atm·m²·25° C. day.

[symbol] Exposure and Thermal Development

[symbol]

Exposure was performed on samples using a Fuji medical dry laser imager FM-DP L in which a NLHV 3000E laser diode fabricated by Nichia Corporation as a laser diode beam source was mounted in an exposure portion thereof and a beam diameter thereof was adjusted to about 100 μm. Other exposure conditions were as follows: exposure of a photothermographic material was performed for 10⁻⁶ sec with a photothermographic material surface illumination intensity at 0 mW/mm² and at various values from 1 mW/mm² to 1000 mW/mm². A light-emission wavelength of laser beam was 405 nm. Thermal development was performed in conditions that 4 panel heaters were set to be 112° C.-118° C.-120° C.-120° C., and a total thermal development time was set to 14 sec at an increased transport speed. Evaluation on an image obtained was performed with a densitometer.

1) Sensitivity, Dmax, and Dmin

Densities of obtained images were measured with a Macbeth Densitometer TD904. A sensitivity is defined as a reciprocal of an exposure value at which an optical density of Dmin(fog)+3.0 is obtained, and in Table-1, a sensitivity of the photothermographic material-1 is set to 0 and sensitivity differences (ΔS) to the photothermographic material-1 were shown.

Dmax and Dmin are also deterimned as a maximum density (Dmax) and a minimum density (Dmin).

2) Image Stability (Print-Out)

Sample-1 to 8 on which images were formed by photothermal development were stored for 3 days under illumination of a fluorescent lamp with an intensity of 1000 Lux, followed by calculation on an increment ΔDmin a fog density (Dmin₂) in a Dmin portion.

ΔDmin=Dmin₂−Dmin

Relative ΔDmins to sample-1 were shown in Table 1 as 100 of ΔDmin of sample-1.

TABLE 1

| Sample | Binder | | Reducing | | | | Print-out |
|---|---|---|---|---|---|---|---|
| No | Polymer | Tg (° C.) | agent | Sensitivity | Dmax | Dmin | ΔDmin |
| 1 | SBR-1 | 20 | R-9, R-4 | 0.0 | 4.52 | 0.16 | 100 |
| 2 | Acryl latex | 20 | R-9, R-4 | −0.02 | 4.45 | 0.17 | 125 |
| 3 | PVA | 85 | R-9, R-4 | −0.12 | 3.56 | 0.15 | 220 |
| 4 | Gelatin | 70 | R-9, R-4 | −0.55 | 1.55 | 0.14 | 133 |
| 5 | SBR-1 | 20 | Reducing agent-3 | 0.35 | 4.62 | 0.82 | 152 |
| 6 | Acryl latex | 20 | Reducing agent-3 | 0.38 | 4.59 | 0.56 | 166 |
| 7 | PVA | 85 | Reducing agent-3 | 0.02 | 4.50 | 0.25 | 268 |
| 8 | Gelatin | 70 | Reducing agent-3 | −0.10 | 3.11 | 0.19 | 332 |

As shown in Table 1, the photothermographic material-1 and -2 comprising silver halide of high silver iodide content were improved sensitivity and excellent in discrimination by using an aqueous polymer fine particle dispersion as a binder and a bis-phenol type reducing agent. The prin-out was also improved in present invention.

### Example 2

(Preparation of SBR Latex-2 to -8)

SBR latexs having different Tg shown Table 2 were prepared in the similar manner to the preparation of SBR latex-1, except that the ratio of styrene to butadiene was properly variated.

(Preparation of Coating Solution for Image Forming Layer-9 to -15)

Coating solution for image forming layer-9 to -15 were prepared, in the similar manner to the preparation of coating solution for image forming layer-1, except using of SBR Latex-2 to −8 instead of of SBR Latex-1.

(Preparation of Photothermographic Material-9 to -15)

Photothermographic material-9 to -15 were prepared, in the similar manner to the preparation of photothermographic material-1, except using of coating solution for image forming layer-9 to -15 instead of coating solution for image forming layer-1.

(Evaluation of Photographic Performances)

Photothermographic Material-9 to −15 were evaluated in the similar manner to Example 1, resulted in Table 2.

TABLE 2

| Sample | Binder | | Reducing | | Print-out |
|---|---|---|---|---|---|
| No | Polymer | Tg(° C.) | agent | Sensitivity | ΔDmin |
| 9 | SBR-2 | −20 | R-9, R-4 | 0.01 | 118 |
| 10 | SBR-3 | −10 | R-9, R-4 | 0.02 | 106 |
| 11 | SBR-4 | 5 | R-9, R-4 | −0.01 | 102 |
| 12 | SBR-5 | 30 | R-9, R-4 | 0.01 | 96 |
| 13 | SBR-6 | 40 | R-9, R-4 | 0.0 | 95 |
| 14 | SBR-7 | 60 | R-9, R-4 | −0.05 | 93 |
| 15 | SBR-8 | 70 | R-9, R-4 | −0.22 | 92 |

Sensitivity was shown as difference to that of sample 1, which was notated as 0.0.

Print-out was shown as a relative value to that of sample 1, which was notated as 100.

As shown in Table 2, high sensitive and very low fogging photothermogaraphic materials were obtained, even though using a binder of different Tg, as far as using an aqueous polymer fine particle dispersion as a binder of image forming layer. Especially, sample 11 to 13 using the binder of Tg 5° C. to 40° C. resulted excellent performances.

### Example 3

Photothermographic material-16 to -19 were prepared, in the similar manner to the preparation of photothermographic material-1, except that replacing a reducing agent to that shown in Table 3. Evaluation of these samples was conducted as Example 1, resulting as Table 3.

TABLE 3

| Sample | Binder | | Reducing | | Print-out |
|---|---|---|---|---|---|
| No | Polymer | Tg(° C.) | agent | Sensitivity | ΔDmin |
| 16 | SBR-1 | 20 | R-2 | −0.12 | 95 |
| 17 | SBR-1 | 20 | R-6 | 0.01 | 101 |
| 18 | SBR-1 | 20 | R-10 | 0.07 | 98 |
| 19 | SBR-1 | 20 | R-23 | 0.11 | 98 |

As shown in Table 3, high sensitive and very low fogging photothermogaraphic materials were obtained, even though using a variety kind of the reducing agents, as far as using a bisphenol type reducing agent, espesially those preferably represented by general formula (R), wherein R¹¹ and R^{11′} are secondary or tertially alkyl group having 3 to 15 carbon atoms.

### Example 4

1. Preparation of Support with Back Layer

Support with back layer was prepared, in the similar manner to Example 1, except using a back layer described below instead of the back layer in Example 1.

1) Preparation of Coating Solution for Back layer

[symbol] Preparation of Coating Solution for Antihalation Layer

[symbol]

60 g of gelatin, 24.5 g of polyacrylamide, 2.2 g of a 1 mol/L aqueous sodium hydroxide solution, 2.4 g of monodispersed polymethyl methacrylate fine particles (mean particle size of 8 μm, standard deviation of particle diameter of 0.4), 0.08 g of benzoisothiazolinone, 0.3 g of sodium polystyrenesulfonate, 0.21 g of blue dye-1, 0.15 g of yellow dye-1, and 8.3 g of acrylic acid/ethyl acrylate copolymer latex (copolymerization rate 5/95) were mixed. Then, water was added to give the total volume of 818 mL to prepare a coating solution for the antihalation layer.

[symbol] Preparation of Coating Solution for Back Surface Protective Layer

[symbol]

A vessel was kept at 40° C., and thereto were added 40 g of gelatin, liquid paraffin emulsion at 1.5 g equivalent to liquid paraffin, 35 mg of benzoisothiazolinone, 6.8 g of a 1 mol/L aqueous sodium hydroxide solution, 0.5 g of sodium t-octylphenoxyethoxyethanesufonate, 0.27 g of sodium polystyrenesulfonate, 5.4 mL of a 2% by weight solution of a fluorocarbon surfactant (F-1), 6.0 g of acrylic acid/ethyl acrylate copolymer latex (copolymer weight ratio of 5/95), and 2.0 g of N,N′-ethylene-bis(vinylsufoneacetamide) were admixed. Then water was added to give the volume of 1000 mL to prepare a coating solution for the back surface protective layer.

2) Coating of Back Layer

The back surface side of the undercoated support was subjected to simultaneous double coating so that the coating solution for the antihalation layer gives the coating amount of gelatin of 0.88 g/m², and so that the coating solution for the back surface protective layer gives the coating amount of gelatin of 1.2 g/m², followed by drying to produce a back layer.

2. Image Forming Layer, Intermediate Layer, and Surface Protective Layer

2-1. Preparing Materials for Coating

1) Preparation of Mixed Emulsion B for Coating Solution

Mixed emulsion B for coating solution was prepared, in the similar manner to mixed emulsion A for coating solution, except that the compound having adsorption group to silver halide and reducing group (19), (49) and (71) were excluded.

2) Preparation of Binder Solution

Latex solution of compound (P-1), (P-2), and (P-4) explained above synthetic examples were adusted to pH 8.35 with 25% by weight NH₄OH solution. Thereafter, filtration with a polypropylene filter having the pore size of 1.0 μm was conducted to remove foreign substances such as dust followed by storage, resulted a binder solution containing solid matter of 44% by weight.

Other polymer latex solutions shown in Table 4 were prepared in the similar manner to above mentioned solutions.

3) Preparations of Coating Solution-20 to −27 for Image Forming Layer

To the dispersion of the silver salt of fatty acid in an amount of 1000 g and 276 mL of water were serially added the pigment-1 dispersion, the organic polyhalogen compound-1 dispersion, the organic polyhalogen compound-2 dispersion, the phthalazine compound-1 solution, polymer latex solution (indicated in Table 4), the reducing agent-1 dispersion, the reducing agent-2 dispersion, the hydrogen bonding compound-1 dispersion, the development accelerator-1 dispersion, the development accelerator-2 dispersion, the color-tone-adjusting agent-1 dispersion, the mercapto compound-1 aqueous solution and the mercapto compound-2 aqueous solution. The coating solution for the image forming layer was prepared by adding the mixed silver halide emulsion B for coating solution thereto followed by thorough mixing just prior to the coating was fed directly to a coating die.

2-2) Preparation of Photothermographic Materials

Reverse surface of the back surface was subjected to simultaneous overlaying coating by a slide bead coating method in order of the image forming layer, intermediate layer, first layer of the surface protective layer and second layer of the surface protective layer starting from the undercoated face in the similar manner to example 1.

TABLE 4

| Sample | Polymer | Photographic Property | | |
|---|---|---|---|---|
| No | latex | fog | Sensitivity | Dmax |
| 20 | P-1 | 0.16 | 0.0 | 4.56 |
| 21 | P-2 | 0.16 | 0.01 | 4.55 |
| 22 | P-4 | 0.16 | 0.01 | 4.50 |
| 23 | P-5 | 0.16 | 0.0 | 4.58 |
| 24 | P-6 | 0.16 | −0.01 | 4.52 |
| 25 | P-11 | 0.16 | 0.0 | 4.59 |
| 26 | P-18 | 0.16 | 0.01 | 4.55 |
| 27 | P-20 | 0.16 | 0.0 | 4.57 |

The coating amount of each compound for the image forming layer (g/m²) is as follows.

| | |
|---|---|
| Silver salt of fatty acid | 5.27 |
| Pigment (C. I. Pigment Blue 60) | 0.036 |
| Polyhalogen compound-1 | 0.09 |
| Polyhalogen compound-2 | 0.14 |
| Phthalazine compound-1 | 0.18 |
| Polymer latex (indicated in Table 4) | 9.43 |
| Reducing agent-1 | 0.55 |
| Reducing agent-2 | 0.22 |
| Hydrogen bonding compound-1 | 0.28 |
| Development accelerator-1 | 0.025 |
| Development accelerator-2 | 0.020 |
| Color-tone-adjusting agent-1 | 0.008 |
| Mercapto compound-1 | 0.002 |
| Mercapto compound-2 | 0.006 |
| Silver halide (on the basis of Ag content) | 0.046 |

The condition of coating was similar to Example 1.

Thus prepared photothermographic material had the mattness of 550 seconds on the image forming layer side surface, and 130 seconds on the back surface as Beck's smoothness. In addition, measurement of the pH of the film surface on the image forming layer side surface gave the result of 6.0.

Chemical structure of the compound used in present example of the invention is shown below.

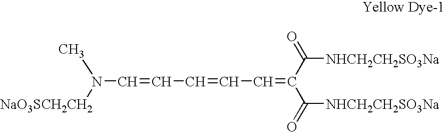

3. Evaluation of Photographic Performances

3-1. Sample Preparation, Exposure and Thermal Development

Sample preparation, exposure and thermal development were done as similar to example 1.

3-2. Evaluation Details and Results

1) Fog: an optical density in non-exposure part was measured with Macbeth Densitometer.

2) Sensitvity: a sensitivity is defined as a reciprocal of an laser output value at which an optical density 3.2 is obtained, and in Table 4, a sensitivity of the photothermographic material 20 is set to 0 and sensitivity differences (ΔS) to the photothermographic material-20 were shown. The laser output value for the photothermographic material-20 at which an optical density 3.2 is obtained was 15 mW.

3) Maximum density(Dmax): Dmax is a maximum saturated density on increasing exposure.

As shown in Table 4, the sample-20 to −27 in present invention gave a sufficient sensitivity to record an image by an exposure on above laser diode, having lower fog and higher optical image density.

### Example 5

The effects of the present invention were compared with through varying the kind of polymer latex.

1) Polymer latex derived from a monomer represented by general formula (M): Tg 17° C., an average particle diameter of 112 nm.

2) SBR latex solution-9 prepared in the similar to SBR latex solution-1 in Example 1, except that arrannging a monomer composition to give Tg of 17° C. resulted an average particle diameter of 12 nm.

(Preparation of Samples)

Sample-28 to -35 were prepared in the in the similar manner to sample-20 in Example 4, except that a binder in an image forming layer and an addition amount of organic polyhalogen compounds as indicated in Table 5.

TABLE 5

| | | Polyhalogen | Polyhalogen |
|---|---|---|---|
| Sample | Polymer | compound-1 | compound-2 |
| No | latex | (g/m²) | (g/m²) |
| 28 | P-1 | 0.09 | 0.14 |
| 29 | P-1 | 0.07 | 0.11 |
| 30 | P-1 | 0.05 | 0.08 |
| 31 | P-1 | 0.04 | 0.06 |
| 32 | SBR-9 | 0.09 | 0.14 |
| 33 | SBR-9 | 0.07 | 0.11 |
| 34 | SBR-9 | 0.05 | 0.08 |
| 35 | SBR-9 | 0.04 | 0.06 |

(Evaluation of Photographic Performances)

Photographic performances were evaluated in the similar manner to Example 4.

An image stability was evaluated as below.

1) Evaluation of an Image Stability 1 (Dark Stability)

The developed images were kept in condition of 60° C. and relative humidity of 40% for 10 days. The optional density difference at Dmin part before and after the above keeping (ΔDmin) was measured.

2) Evaluation of an Image Stability 2 (Test with Isotonic Sodium Chloride Solution)

Test with isotonic sodium chloride solution is a simulation of finger mark test.

The developed images were immersed in an isotonic sodium chloride solution for one minute, and after drying thereof kept in condition of 60° C. and relative humidity of 40% for 4 days. The optical density difference at Dmin part before and after the above keeping (ΔDmin) was measured.

Results obtained were indicated in Table 6.

As understood from Table 6, sample-28 to -35 in present invention resulted a high sensitivity and an excellent image stability with a relatively small addition of organic polyhalogen compounds.

TABLE 6

| | | | | | Test with |
|---|---|---|---|---|---|
| | | | | | isotonic sodium |
| | | | | Dark stability of | chloride |
| Sample | Photographic property | | | developed image | solution |
| No | fog | Sensitivity | Dmax | ΔDmin | ΔDmin |
| 28 | 0.16 | 0 | 4.56 | 0.05 | 0.07 |
| 29 | 0.16 | 0.03 | 4.62 | 0.06 | 0.09 |
| 30 | 0.16 | 0.06 | 4.68 | 0.08 | 0.11 |
| 31 | 0.16 | 0.10 | 4.70 | 0.09 | 0.13 |
| 32 | 0.16 | 0.02 | 4.28 | 0.15 | 0.42 |
| 33 | 0.16 | 0.05 | 4.32 | 0.22 | 0.65 |
| 34 | 0.16 | 0.07 | 4.35 | 0.35 | 0.79 |
| 35 | 0.16 | 0.11 | 4.40 | 0.59 | 0.98 |

What is claimed is:

1. A photothermographic material comprising, at least a photosensitive silver halide, a non-photosensitive organic silver salt, a reducing agent and a binder on at least one side of a support, wherein a content of silver iodide in the photosensitive silver halide is 5% by mole or more, the binder contains polymer latex in an amount of 60% by weight or more, and the reducing agent is a compound represented by the following general formula (R): 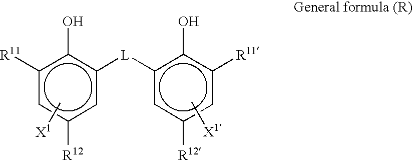
wherein R¹¹ and R^{11′} each independently represent an alkyl group having 1 to 20 carbon atoms, R¹² and R^{12′} each independently represent a hydrogen atom or a group capable of substituting for a hydrogen on a benzene ring, L represents a —S— group or a —CHR¹³— group, R¹³ represents a hydrogen atom or an alkyl group having 1 to 20 carbon atoms, and X1 and X1¹ each independently represent a hydrogen atom or a group capable of substituting for a hydrogen on a benzene ring.

2. The photothermographic material according to claim 1, wherein the polymer latex is a polymer having a glass transition temperature of −20° C. to 60° C.

3. The photothermographic material according to claim 1, wherein the polymer latex contains a styrene-butadiene copolymer.

4. The photothermographic material according to claim 1, wherein the binder contains polymer latex copolymerized using 10% by weight to 70% by weight of the monomer represented by the following general formula (M):
CH₂═CR⁰¹—CR⁰²═CH₂ General formula (M)
wherein R⁰¹ and R⁰² are each independently a hydrogen atom, an alkyl group having 1 to 6 carbon atoms, a halogen atom or a cyano group, provided that R⁰¹ and R⁰² are not both hydrogen atoms.

5. The photothermographic material according to claim 4, wherein, in general formula (M), R⁰¹ is a hydrogen atom and R⁰² is a methyl group.

6. The photothermographic material according to claim 4, wherein the polymer latex is copolymerized using 1% by weight to 20% by weight of a monomer having an acidic group.

7. The photothermographic material according to claim 4, wherein a glass transition temperature of the polymer latex is −30° C. to 70° C.

8. The photothermographic material according to claim 4, wherein a glass transition temperature of the polymer latex is −10° C. to 35° C.

9. The photothermographic material according to claim 4, wherein the polymer latex contains a halogen ion in the latex solution in an amount of 500 ppm or less thereof.

10. The photothermographic material according to claim 4, wherein the polymer latex is a styrene-isoprene copolymer latex.

11. The photothermographic material according to claim 1, wherein R¹¹ and R^{11′} are each independently a secondary or a tertiary alkyl group having 3 to 15 carbon atoms, in the reducing agent represented by general formula (R).

12. The photothermographic material according to claim 1, further comprising a development accelerator.

13. The photothermographic material according to claim 12, wherein the development accelerator contains a compound represented by the following general formula (A-1):
Q₁-NHNH-Q₂ General formula (A-1)
wherein Q₁ is an aromatic group bonding to —NHNH-Q₂ via a carbon atom, or is a heterocyclic group; and Q₂ is a carbamoyl group, an acyl group, an alkoxycarbonyl group, an aryloxycarbonyl group, a sulfonyl group, or a sulfamoyl group.

14. The photothermographic material according to claim 12, wherein the development accelerator contains a compound represented by the following general formula (A-2): 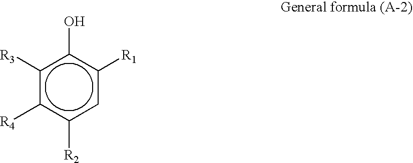
wherein R₁ represents an alkyl group, an acyl group, an acylamino group, a sulfonamide group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group, or a carbonic ester group; and R₃ and R₄ each independently represent a group which can be substituted for a hydrogen on the benzene ring.

15. The photothermographic material according to claim 1, further comprising an organic polyhalogen compound as an antifoggant.

16. The photothermographic material according to claim 15, wherein the organic polyhalogen compound is represented by the following general formula (H):
Q-(Y)n-C(Z₁)(Z₂)X General formula (H)
wherein Q is an alkyl group, an aryl group, or a heterocyclic group; Y is a divalent linking group; n is 0 or 1; Z₁ and Z₂ are each a halogen atom; and X is a hydrogen atom or an electron attractive group.

17. The photothermographic material according to claim 1, wherein the content of the silver iodide in the photosensitive silver halide is 40% by mole or more.

18. The photothermographic material according to claim 1, wherein an average grain size of the photosensitive silver halide is 5 nm to 80 nm.

19. The photothermographic material according to claim 1, wherein an average grain size of the photosensitive silver halide is 5 nm to 40 nm.

20. The photothermographic material according to claim 1, wherein the photosensitive silver halide is formed in the absence of the non-photosensitive organic silver salt.

21. The photothermographic material according to claim 1, further containing a compound that can be one-electron-oxidized to provide a one-electron oxidation product which releases one or more electrons.

22. An image forming method using the photothermographic material according to claim 1, wherein the photothermographic material is exposed by scanning with a laser beam.

23. The image forming method according to claim 22, wherein the laser is emitted from a laser diode.

24. The image forming method according to claim 23, wherein the laser diode has a peak strength in a wavelength of 350 nm to 440 nm, and has an intensity of 1 mW/mm² to 50 W/mm².

25. The image forming method according to claim 23, wherein the laser diode has a peak strength in a wavelength of 380 nm to 410 nm.
